(19) United States
(12) Patent Application Publication
(10) Pub. No.: US 2024/0204253 A1
(43) Pub. Date: Jun. 20, 2024

(54) COMPOUNDS FOR ENHANCING THE SOLID-ELECTROLYTE INTERPHASE (SEI) OF SILICON-BASED ANODE MATERIALS IN LITHIUM-ION BATTERIES, AND ELECTROLYTES, BATTERIES, AND METHODS RELATING THERETO

(71) Applicant: Sila Nanotechnologies, Inc., Alameda, CA (US)

(72) Inventors: William Elliott GENT, San Francisco, CA (US); Kostiantyn TURCHENIUK, Oakland, CA (US); Natasha Bunga TERAN, San Leandro, CA (US)

(21) Appl. No.: 18/523,597

(22) Filed: Nov. 29, 2023

Related U.S. Application Data
(60) Provisional application No. 63/385,277, filed on Nov. 29, 2022.

(51) Int. Cl. H01M 10/0567; H01M 4/04; H01M 4/36; H01M 4/38; H01M 4/583; H01M 10/0525; H01M 10/0568; H01M 10/0569

(52) U.S. Cl. CPC H01M 10/0567; H01M 4/0404; H01M 4/362; H01M 4/386; H01M 4/583; H01M 10/0525; H01M 10/0568; H01M 10/0569; H01M 2004/028

(57) ABSTRACT

Compounds suitable for use in lithium-ion battery electrolytes are disclosed. An example of a suitable compound is lithium difluoro(bisoxalato) phosphate. A lithium-ion battery electrolyte includes a lithium salt composition and an electrolyte compound composition. In some embodiments, the lithium salt composition comprises one or more of the suitable compounds, a concentration of the suitable compounds in the lithium-ion battery electrolyte being in a range of about 0.1 mol. % to about 20 mol. %. In some implementations, the lithium salt composition may also comprise LiPF6. Lithium-ion batteries employing such electrolytes are also disclosed.

### CROSS-REFERENCE TO RELATED APPLICATIONS

The present application for patent claims the benefit of U.S. Provisional Application No. 63/385,277, entitled “NOVEL COMPOUNDS FOR ENHANCING THE SOLID-ELECTROLYTE INTERPHASE (SEI) OF SILICON-BASED ANODE MATERIALS IN LITHIUM-ION BATTERIES, AND ELECTROLYTES, BATTERIES, AND METHODS RELATING THERETO,” filed Nov. 29, 2022, assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicle, grid storage and other important applications.

However, despite the increasing commercial prevalence of batteries, further development of these batteries is needed, particularly for applications in low- or zero-emission, hybrid-electrical or fully electric vehicles, consumer electronics, wearable devices, energy-efficient cargo ships and locomotives, drones, aerospace applications, and power grids. In particular, further improvements are desired for various rechargeable batteries, such as rechargeable Li and Li-ion batteries, rechargeable Na and Na-ion batteries, and rechargeable K and K-ion batteries, to name a few.

A broad range of electrolyte compositions may be utilized in the construction of Li and Li-ion batteries and other metal and metal-ion batteries. However, for improved cell performance (e.g., low and stable resistance, high cycling stability, high-rate capability, good thermal stability, long calendar life, etc.), the optimal choice of electrolyte needs to be developed for specific types and specific sizes of active particles in both the anode and cathode, specific total battery cell capacities as well as the specific operational conditions (e.g., temperature, charge rate, discharge rate, voltage range, capacity utilization, etc.). In many cases, the choice of electrolyte components and their ratios is not trivial and may be counterintuitive.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries. Unfortunately, Li and Li-ion battery cells with such anodes and conventional electrolytes often require the use of such large amounts of conventional solid-electrolyte interphase (SEI)-building additives to maintain acceptable cycle stability that prevents their use at elevated (e.g., 40-100° C.) or low temperatures (e.g., about −60° C. to about +10° C., or about −30° C. to about +10° C.) or undesirably limits their calendar life or does not allow such cells to be charged to high voltages (e.g., above about 4.1-4.3 V) or limit rate performance or cycle stability when subjected to fast charge. Performance of such battery cells may become particularly poor when the cells are charged to above about 4.3-4.4 V and even more so when the cells are charged to above about 4.5 V. Higher cell voltage, broader operational temperature window, fast charging, good rate capability and longer cycle life, however, are advantageous for most applications. Such cells may suffer from excessive capacity degradation (e.g., above about 5%), large volume expansion (e.g., above about 10%) and significant gassing (e.g., above about 10% thickness change) when exposed to high temperatures (e.g., above about 50-90° C.) in a fully charged state (e.g., state-of-charge, SOC of about 90-100%) for a prolonged time (e.g., about 12-168 hours). Passing such elevated temperature charging tests is required for most applications. Performance of such cells may also become particularly poor when the anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs.

In certain types of rechargeable batteries, charge storing anode materials may be produced as high-capacity (nano)composite powders (e.g., at least partially comprised of active material nanomaterials or nanostructures), which exhibit moderately high volume changes (e.g., about 8-180 vol. %) during the first charge-discharge cycle and moderate volume changes (e.g., about 5-50 vol. %) during the subsequent charge-discharge cycles. A subset of such charge-storing anode particles may include anode particles with an average size (e.g., diameter or thickness) in the range of about 0.2 to about 40 microns (micrometers). Such a class of charge-storing particles offers great promises for scalable manufacturing and achieving high cell-level energy density and other performance characteristics. Unfortunately, such particles are relatively new and their use in cells using conventional electrolytes may result in relatively poor cell performance characteristics and limited cycle stability. Performance of such battery cells may become particularly poor when the cells are charged to above about 4.1-4.3 V, more so when the cells are charged to above about 4.3-4.4 V and even more so when the cells are charged to above about 4.5 V. Higher cell voltage, broader operational temperature window and longer cycle life, fast charge capability and high power, however, are advantageous for most applications. Such cells may suffer from excessive capacity degradation (e.g., above about 5%), large volume expansion (e.g., above about 10%) and significant gassing when exposed to high temperatures (“high-temperature outgassing”) (e.g., about 50-90° C. or higher) in a fully charged state (e.g., state-of-charge, SOC, of about 90-100%) for a prolonged time (e.g., about 12-168 hours). Passing such elevated temperature charging tests is required for most applications. Cell performance may also become particularly poor when the high-capacity (nano)composite anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs. Similarly, cell performance may degrade when the porosity of such an anode (e.g., the volume occupied by the spacing between the (nano)composite active anode particles in the electrode and filled with electrolyte, exclusive of closed pores, if any, within the particles themselves that are inaccessible to electrolyte) becomes moderately small (e.g., about 25-35 vol. % after the first charge-discharge cycle) and more so when the porosity of the anode becomes small (e.g., about 5-25 vol. % after the first charge-discharge cycle) or when the amount of a binder and conductive additives in the electrode becomes moderately small (e.g., about 5-15 wt. %) and more so when the amount of the binder and conductive additives in the electrode becomes small (e.g., about 0.5-5 wt. %). Higher electrode density and lower binder and conductive additive content, however, are advantageous for increasing cell energy density and reducing cost. Lower binder content may also be advantageous for increasing cell rate performance.

Examples of materials that exhibit moderately high-volume changes (e.g., about 8-180 vol. %) during the first charge-discharge cycle and moderate volume changes (e.g., about 5-50 vol. %) during the subsequent charge-discharge cycles include (nano)composites comprising so-called conversion-type (which includes both so-called chemical transformation and so-called “true conversion” subclasses) and so-called alloying-type active electrode materials. In the case of metal-ion batteries (such as Li-ion batteries), examples of such conversion-type active electrode materials include, but are not limited to, metal fluorides (such as lithium fluoride, iron fluoride, copper fluoride, bismuth fluoride, their mixtures and alloys, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type active electrode materials include, but are not limited to, silicon, germanium, antimony, aluminum, magnesium, zinc, gallium, arsenic, phosphorous, silver, cadmium, indium, tin, lead, bismuth, their alloys, mixtures and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

Examples of the described silicon (Si)-comprising anode particles with gravimetric capacities in the range from about 800 mAh/g to about 3000 mAh/g (per mass of Si-comprising anode particles in a Li-free state) may comprise both Si and carbon (C), which will be referred to herein as Si anode materials or Si—C anode materials in this disclosure, even if such anode particles comprise elements other than Si and C (e.g., oxygen (O), nitrogen (N), phosphorous (P), aluminum (Al), boron (B), sulfur (S), selenium (Se), hydrogen (H), to name a few), as long as the total atomic fraction of Si and C atoms in such materials is in the range from about 50 at. % to about 100 at. %. In some designs, such Si or Si—C anode materials may be in the form of nanocomposites (e.g., Si—C composite particles comprising Si nanoparticles or nanostructures deposited at least in part within pores of a C-comprising porous scaffold).

In certain types of rechargeable batteries, anodes comprising Si or Si—C anode particles may additionally comprise other active materials, including intercalation-type active materials, such as particles comprising graphite, soft carbons, hard carbons, their various combinations. In this case, the anode may attain superior stability or reduced swell or other advantageous (for some applications) characteristics. An example of anodes with lower swell during initial charge or subsequent discharge-charge cycles may comprise the mixture (or fusion, in some designs) of conversion-type or alloying-type silicon-comprising anode particles with graphite or soft or hard carbons (or their various combinations), so-called silicon-graphite blends. In such a blended anode the Si or Si—C nanocomposite is, for example, from about 20 to 80% by capacity from Si, while the rest of the capacity is from graphite or soft or hard carbon or their various mixtures. Such materials offer much higher volumetric and gravimetric energy density than the intercalation-type graphite electrodes commonly used in commercial Li-ion batteries. In addition, in such blended anode, the graphite may be composed of natural, artificial or a mixture of natural and artificial graphites. In some designs, it is more advantageous to use natural graphite or a mixture of natural and artificial graphites since some graphites may exhibit relatively large swell at the graphite particle level. This is also advantageous to reducing the overall anode swell in blends since such graphite particles are able to accommodate stresses caused by the high-swelling Si-comprising anode particles. Such properties of Si—C nanocomposite-graphite blends may offer overall moderate volume changes during the first cycle and low volume changes during the subsequent charging cycles. Such properties are advantageous for high-capacity loading anode particles, which also comes with the reduced cost of manufacturing of such battery cells. The development of electrolytes and additives for such silicon-graphite blends may leverage cell performance due to (i) slower capacity degradation due to lower swelling, (ii) reduced outgassing at high temperatures (“high-temperature outgassing”) (e.g., about 50-90° C. or higher) in a fully charged state (e.g., state-of-charge, SOC, of about 90-100%) for a prolonged time (e.g., about 12-168 hours) as those may require reduced amounts of gassing inducing electrolyte additives or components, and/or (iii) reduced cell impedance due to the lower use of additives.

Accordingly, there remains a need for improved electrolytes, additives, batteries, components, and other related materials and manufacturing processes.

### SUMMARY

Embodiments disclosed herein address the above stated needs by providing improved electrolytes, batteries, components, and other related materials and manufacturing processes.

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a lithium-ion battery electrolyte includes an electrolyte compound composition; and a lithium salt composition comprising one or more of compounds of formula Salt2: LiPF₍₆₋₂ₙ₎(A₁₀²)ₙ Salt2, wherein:
A₁₀² is of formula A₁₀(1):

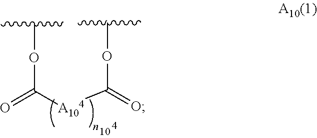

A₁₀⁴ is of formula A₁₀(2):

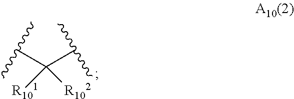

each of R₁₀¹ and R₁₀² is H; and n₁₀⁴ is 0; and a concentration of the one or more compounds in the lithium-ion battery electrolyte is in a range of about 0.1 mol. % to about 20 mol. %.

In some aspects, the one or more compounds comprise lithium difluoro(bisoxalato) phosphate (LiDFOP) with formula Compound No. 53:

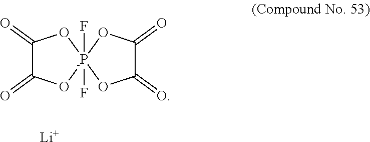

In some aspects, the lithium-ion battery electrolyte comprises fluoroethylene carbonate (FEC).

In some aspects, the lithium salt composition comprises lithium difluoro(oxalato)borate (LiDFOB) of formula Compound No. 43:

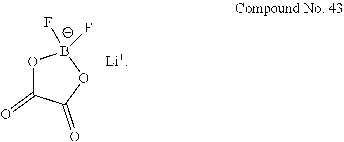

In some aspects, the lithium salt composition comprises LiPF₆.

In some aspects, a concentration of the lithium salt composition in the lithium-ion battery electrolyte is in a range from about 1 mol. % to about 20 mol. %.

In some aspects, the lithium-ion battery electrolyte does not comprise fluoroethylene carbonate (FEC).

In some aspects, the electrolyte compound composition comprises a non-fluoroethylene carbonate (FEC) cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC), and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on or in the anode current collector; a cathode disposed on or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising one or more compounds of formula Cyc3:

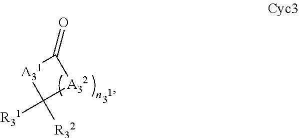

wherein: R₃¹ is H; R₃² is nitrile; A₃¹ is —O—; A₃² is —O—R₃⁴—; R₃⁴ is C₁₋₃ alkanediyl; n₃¹ is 1; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

In some aspects, the one or more compounds comprise 2-oxo-1,3-dioxolane-4-carbonitrile (ECCN) of formula Compound No. 51:

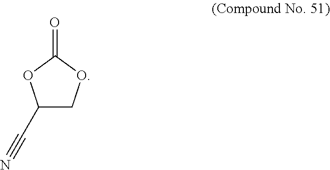

In some aspects, the lithium-ion battery electrolyte comprises fluoroethylene carbonate (FEC).

In some aspects, the lithium salt composition comprises lithium difluoro(bisoxalato) phosphate (LiDFOP) of formula Compound No. 53:

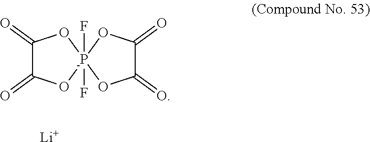

In some aspects, the lithium salt composition comprises lithium difluoro(oxalato)borate (LiDFOB) of formula Compound No. 43:

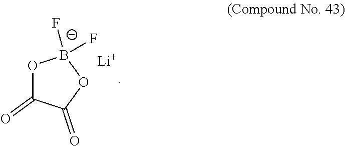

In some aspects, the lithium-ion battery electrolyte does not comprise fluoroethylene carbonate (FEC).

In some aspects, the electrolyte compound composition comprises a non-fluoroethylene carbonate (FEC)cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on or in the anode current collector; a cathode disposed on or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising one or more compounds of formula Oth1:

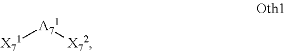

wherein: A₇¹ is C₁₋₆ alkanediyl; each of X₇¹ and X₇² is of formula X₇(1):

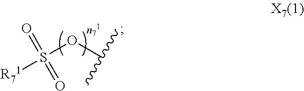

each R₇¹ is F; each n₇¹ is 0; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

In some aspects, the one or more compounds comprise ethane-1,2-disulfonyl difluoride (EDSDF) of formula Compound No. 52:

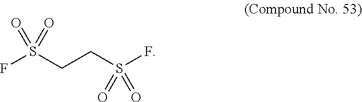

In some aspects, the lithium-ion battery electrolyte comprises fluoroethylene carbonate (FEC).

In some aspects, the lithium salt composition comprises lithium difluoro(bisoxalato) phosphate (LiDFOP) of formula Compound No. 53):

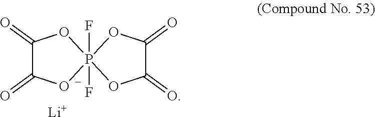

In some aspects, the lithium salt composition comprises lithium difluoro(oxalato)borate (LiDFOB) of formula Compound No. 43:

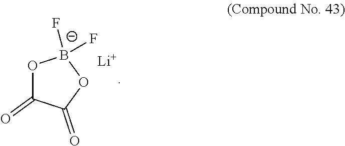

In some aspects, the lithium-ion battery electrolyte does not comprise fluoroethylene carbonate (FEC).

In some aspects, the electrolyte compound composition comprises a non-FEC cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on or in the anode current collector; a cathode disposed on or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising fluoroethylene carbonate (FEC) and one or more compounds of formula Cyc1:

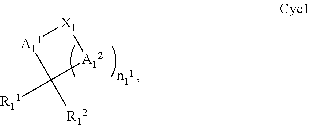

wherein: X₁ is of formula X₁(1):

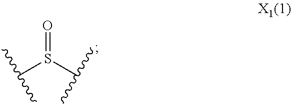 [SMILES: *S(*)=O]

each of R₁¹ and R₁² is H; A₁¹ is —O—; A₁² is —O—R₁⁷—; R₁⁷ is C₁₋₃ alkanediyl; n₁¹ is 1; and a concentration of the FEC in the lithium-ion battery electrolyte is in a range of about 0.1 mol. % to about 40 mol. %; a concentration of the one or more compounds in the lithium-ion battery electrolyte is in a range of about 5 mol. % to about 95 mol. %; and a concentration of the lithium salt composition in the lithium-ion battery electrolyte is in a range from about 1 mol. % to about 20 mol. %.

In some aspects, the one or more compounds comprise ethylene sulfite (ESi) of formula Compound No. 3:

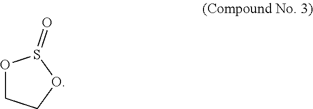

In some aspects, the lithium salt composition comprises lithium difluoro(bisoxalato) phosphate (LiDFOP) of formula Compound No. 53:

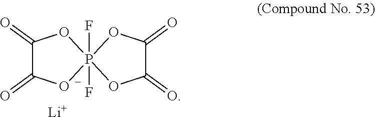

In some aspects, the lithium salt composition comprises lithium difluoro(oxalato)borate (LiDFOB) of formula Compound No. 43:

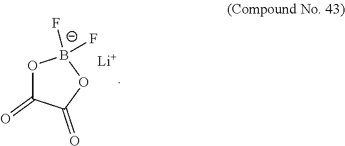

In some aspects, the electrolyte compound composition comprises a non-FEC cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on and/or in the anode current collector; a cathode disposed on and/or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising fluoroethylene carbonate (FEC) and one or more compounds of formula Cyc3:

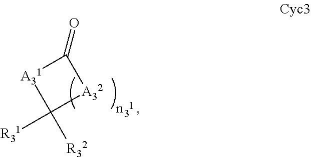

wherein: R₃¹ is H; R₃² is of formula R₃(1):

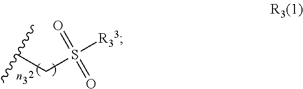

A₃¹ is O—R₃⁴—; A₃² is —C₁₋₄ alkanediyl-; R₃³ is F; R₃⁴ is C₁₋₃ alkanediyl; n₃¹ is 1; n₃² is 0 or 1; a concentration of the one or more compounds in the lithium-ion battery electrolyte is in a range of about 5 mol. % to about 95 mol. %.; and a concentration of the lithium salt composition in the lithium-ion battery electrolyte is in a range from about 1 mol. % to about 20 mol. %.

In some aspects, n₃² is 0; and the one or more compounds comprise 5-oxotetrahydrofuran-3-sulfonyl fluoride (GBLSF) of formula Compound No. 19:

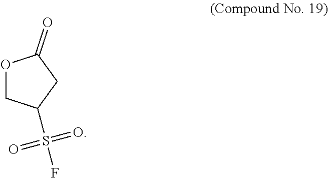

In some aspects, the lithium salt composition comprises lithium difluoro(bisoxalato) phosphate (LiDFOP) (of formula Compound No. 53:

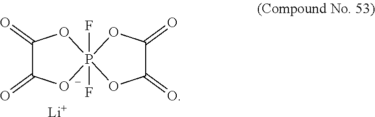

In some aspects, the lithium salt composition comprises lithium difluoro(oxalato)borate (LiDFOB) of formula Compound No. 43:

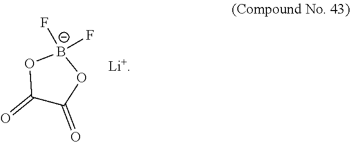

In some aspects, the electrolyte compound composition comprises a non-FEC cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on and/or in the anode current collector; a cathode disposed on and/or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising one or more compounds of formula Cyc4:

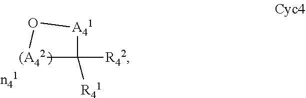

wherein: R₄¹ is of formula R₄(1):

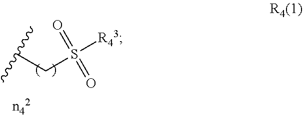

R₄² is H; A₄¹ is —CH₂—; R₄³ is F; n₄¹ is 0; n₄² is 0 or 1; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

In some aspects, n₄² is 1; and the one or more compounds comprise oxiran-2-ylmethanesulfonyl fluoride (OrMSF) of formula Compound No. 20:

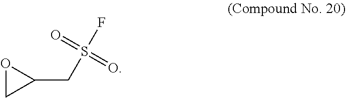

In some aspects, the lithium-ion battery electrolyte comprises fluoroethylene carbonate (FEC).

In some aspects, the lithium salt composition comprises lithium difluoro(bisoxalato) phosphate (LiDFOP) of formula Compound No. 53:

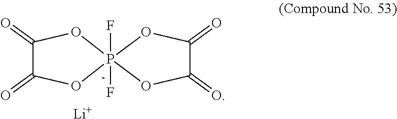

In some aspects, the lithium salt composition comprises lithium difluoro(oxalato)borate (LiDFOB) of formula Compound No. 43:

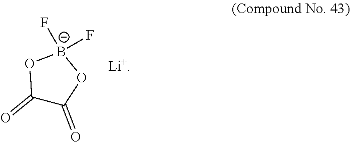

In some aspects, the lithium-ion battery electrolyte does not comprise fluoroethylene carbonate (FEC).

In some aspects, the electrolyte compound composition comprises a non-fluoroethylene carbonate (FEC) cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on or in the anode current collector; a cathode disposed on or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising fluoroethylene carbonate (FEC) and one or more of the compounds of formula Est1:

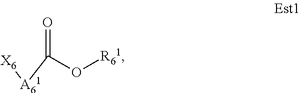

wherein: R₆¹ is C₁₋₆ alkyl; A₆¹ is of formula A₆(1):

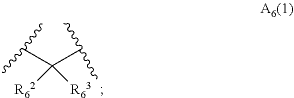

### X₆ is

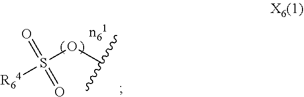

each of R₆² and R₆³ is F; R₆⁴ is F; n₆¹ is 0 or 1; a concentration of the FEC in the lithium-ion battery electrolyte is in a range of about 0.1 mol. % to about 40 mol. %; and a concentration of the FEC in the lithium-ion battery electrolyte is in a range of about 0.1 mol. % to about 40 mol. %; and a concentration of the one or more compounds in the lithium-ion battery electrolyte is in a range of about 0.1 mol. % to about 5 mol. %; and a concentration of the lithium salt composition in the lithium-ion battery electrolyte is in a range from about 1 mol. % to about 20 mol. %.

In some aspects, n₆¹ is 0; and the one or more compounds comprise methyl 2,2-difluoro-2-(fluorosulfonyl)acetate (MDFA) of formula Compound No. 22:

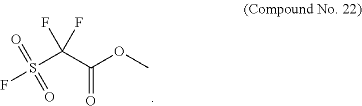

In some aspects, the lithium salt composition comprises lithium difluoro(bisoxalato) phosphate (LiDFOP) of formula Compound No. 53:

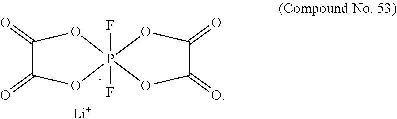

In some aspects, the lithium salt composition comprises lithium difluoro(oxalato)borate (LiDFOB) of formula Compound No. 43:

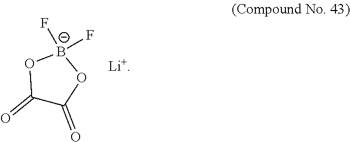

In some aspects, the electrolyte compound composition comprises a non-FEC cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on or in the anode current collector; a cathode disposed on or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising one or more compounds of formula Oth1:

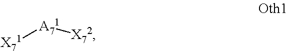

wherein: A₇¹ is C₁₋₆ alkanediyl; X₇¹ is carbonitrile; X₇² is of formula X₇(1):

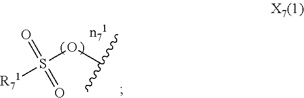

R₇¹ is F; n₇¹ is 0 or 1; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

In some aspects, n₇¹ is 0; and the one or more compounds comprise cyanomethanesulfonyl fluoride (CMSF) of formula Compound No. 29:

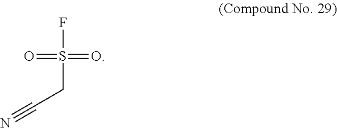

In some aspects, the lithium-ion battery electrolyte comprises fluoroethylene carbonate (FEC).

In some aspects, the lithium salt composition comprises lithium difluoro(bisoxalato) phosphate (LiDFOP) of formula Compound No. 53:

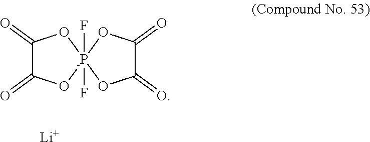

In some aspects, the lithium salt composition comprises lithium difluoro(oxalato)borate (LiDFOB) of formula Compound No. 43:

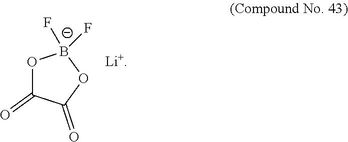

In some aspects, the lithium-ion battery electrolyte does not comprise fluoroethylene carbonate (FEC).

In some aspects, the electrolyte compound composition comprises a non-fluoroethylene carbonate (FEC) cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on or in the anode current collector; a cathode disposed on or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising fluoroethylene carbonate (FEC) and one or more of the compounds of formula Oth1:

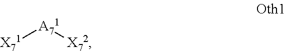

wherein: A₇¹ is C₂₋₆ alkenediyl; X₇¹ is H; X₇² is of formula X₇(1):

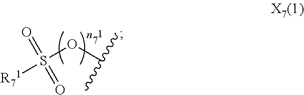

R₇¹ is F; n₇¹ is 0; a concentration of the FEC in the lithium-ion battery electrolyte is in a range of about 0.1 mol. % to about 40 mol. %; and a concentration of the one or more compounds in the lithium-ion battery electrolyte is in a range of about 5 mol. % to about 95 mol. %; and a concentration of the lithium salt composition in the lithium-ion battery electrolyte is in a range from about 1 mol. % to about 20 mol. %.

In some aspects, the one or more compounds comprise ethenesulfonyl fluoride (ESF) of formula Compound No. 31:

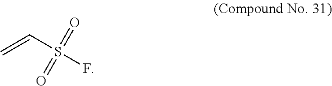

In some aspects, the lithium salt composition comprises lithium difluoro(bisoxalato) phosphate (LiDFOP) of formula Compound No. 53:

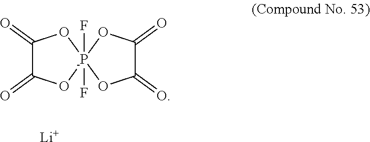

In some aspects, the lithium salt composition comprises lithium difluoro(oxalato)borate (LiDFOB) of formula Compound No. 43:

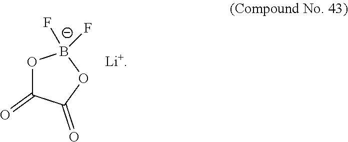

In some aspects, the electrolyte compound composition comprises a non-FEC cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on and/or in the anode current collector; a cathode disposed on and/or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising fluoroethylene carbonate (FEC) and one or more of the compounds of formula Oth1:

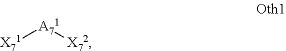

wherein: A₇¹ is —O—; X₇¹ is of formula X₇(4):

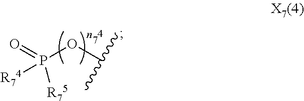

X₇² is C₁₋₆ alkyl; each of R₇⁴ and R₇⁵ is, independently, C₁₋₆ alkoxy; n₇⁴ is 0; a concentration of the FEC in the lithium-ion battery electrolyte is in a range of about 0.1 mol. % to about 40 mol. %; a concentration of the one or more compounds in the lithium-ion battery electrolyte is in a range of about 0.1 mol. % to about 5 mol. %; and a concentration of the lithium salt composition in the lithium-ion battery electrolyte is in a range from about 1 mol. % to about 20 mol. %.

In some aspects, the one or more compounds comprise triisopropyl phosphate (TIP) of formula Compound No. 36:

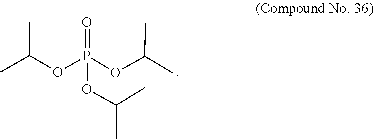

In some aspects, the lithium salt composition comprises lithium difluoro(bisoxalato) phosphate (LiDFOP) of formula Compound No. 53:

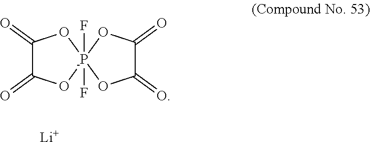

In some aspects, the lithium salt composition comprises lithium difluoro(oxalato)borate (LiDFOB) of formula Compound No. 43:

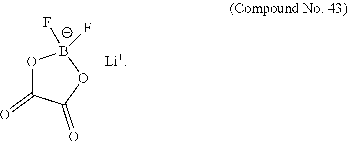

In some aspects, the electrolyte compound composition comprises a non-FEC cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on or in the anode current collector; a cathode disposed on or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

In an aspect, a lithium-ion battery electrolyte includes a lithium salt composition comprising LiPF₆; and an electrolyte compound composition comprising fluoroethylene carbonate (FEC) and one or more compounds of formula Oth1:

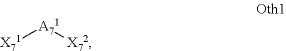

wherein: A₇¹ is —O—; X₇¹ is of formula X₇(2):

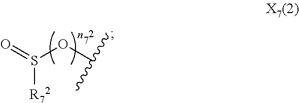

X₇² is C₁₋₆ alkyl; R₇² is C₁₋₆ alkoxy; n₇² is 0; a concentration of the FEC in the lithium-ion battery electrolyte is in a range of about 0.1 mol. % to about 40 mol. %; a concentration of the one or more compounds in the lithium-ion battery electrolyte is in a range of about 5 mol. % to about 95 mol. %; and a concentration of the lithium salt composition in the lithium-ion battery electrolyte is in a range from about 1 mol. % to about 20 mol. %.

In some aspects, the one or more compounds comprise dimethyl sulfite (DMS) of formula Compound No. 37:

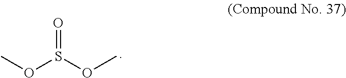

In some aspects, the lithium salt composition comprises lithium difluoro(bisoxalato) phosphate (LiDFOP) of formula Compound No. 53:

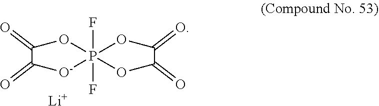

In some aspects, the lithium salt composition comprises lithium difluoro(oxalato)borate (LiDFOB) of formula Compound No. 43:

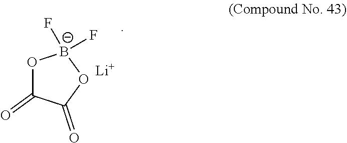

In some aspects, the electrolyte compound composition comprises a non-FEC cyclic carbonate.

In some aspects, the non-FEC cyclic carbonate is ethylene carbonate (EC); and a concentration of the EC in the lithium-ion battery electrolyte is about 50 mol. % or lower.

In some aspects, the non-FEC cyclic carbonate is vinylene carbonate (VC); and a concentration of the VC in the lithium-ion battery electrolyte is about 5 mol. % or lower.

In some aspects, the electrolyte compound composition comprises one or more of ethyl propionate, ethyl isobutyrate, ethyl acetate, propyl propionate, dimethyl carbonate, ethyl methyl carbonate, and diethyl carbonate.

In some aspects, the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB), a total concentration of the one or more additive compounds in the lithium-ion battery electrolyte being about 10 mol. % or lower.

In an aspect, a lithium-ion battery includes an anode current collector; a cathode current collector; an anode disposed on and/or in the anode current collector; a cathode disposed on and/or in the cathode current collector; and the lithium-ion battery electrolyte ionically coupling the anode and the cathode, wherein: the anode comprises composite particles comprising silicon and carbon.

In some aspects, the composite particles comprise porous carbon in which the silicon is deposited.

In some aspects, at least some of the silicon is present in the porous carbon as Si nanoparticles.

In some aspects, a mass of the silicon is in a range of about 3 wt. % to about 80 wt. % of a total mass of the anode.

In some aspects, the anode comprises graphitic carbon particles substantially free of silicon.

One aspect is directed to compounds of formula Cyc1 (202 in FIG. 2) for use in the electrolyte compound composition of an electrolyte for a Li-ion battery. Some examples of covalent compounds of formula Cyc1 are: 1,3,2-dioxathiolane 2,2-dioxide (DTD) (Compound No. 1, 302 in FIG. 3), fluoroethylene sulfite (Compound No. 2, 304), ethylene sulfite (ESi) (Compound No. 3, 306), 3-(2,2,2-trifluoroethyl)-1,2,3-oxathiazolidine 2-oxide (Compound No. 4, 308), and diethyl (2-oxido-1,2,3-oxathiazolidin-3-yl)phosphonate (Compound No. 6, 312).

Yet another aspect is directed to compounds of formula Cyc3 (502 in FIG. 4) for use in the electrolyte compound composition of an electrolyte for a Li-ion battery. Some examples of covalent compounds of formula Cyc3 are: 2-oxotetrahydrofuran-3-sulfonyl fluoride (Compound No. 17, 612 in FIG. 5), 5-oxotetrahydrofuran-3-sulfonyl fluoride (GBLSF) (Compound No. 19, 616), and 2-oxo-1,3-dioxolane-4-carbonitrile (ECCN) (Compound No. 51, 618).

Yet another aspect is directed to compounds of formula Cyc4 (702 in FIG. 6) for use in the electrolyte compound composition of an electrolyte for a Li-ion battery. An example of a covalent compound of formula Cyc4 is: oxiran-2-ylmethanesulfonyl fluoride (OrMSF) (Compound No. 20, 802 in FIG. 7).

Yet another aspect is directed to compounds of formula Est1 (1102 in FIG. 10) for use in the electrolyte compound composition of an electrolyte for a Li-ion battery. An example of a covalent compound of formula Est1 is: methyl 2,2-difluoro-2-(fluorosulfonyl)acetate (MDFA) (Compound No. 22, 1202 in FIG. 11).

Yet another aspect is directed to compounds of formula Oth1 (1302 in FIG. 12) for use in the electrolyte compound composition of an electrolyte for a Li-ion battery. Some examples of covalent compounds of formula Oth1 (Oth1-Covalent) are: cyanomethanesulfonyl fluoride (CMSF) (Compound No. 29, 1402 in FIG. 13), ethenesulfonyl fluoride (ESF) (Compound No. 31, 1406), triisopropyl phosphate (TIP) (Compound No. 36, 1416), dimethyl sulfite (DMS) (Compound No. 37, 1418), and ethane-1,2-disulfonyl difluoride (EDSDF) (Compound No. 52, 1420).

Yet another aspect is directed to compounds of formula Salt1 (boron-comprising salts, 1902 in FIG. 16) or Salt2 (phosphorus-comprising salts, 1904) for use in the lithium salt composition of an electrolyte for a Li-ion battery. An example of a salt compound of formula Salt2 is: lithium difluoro(bisoxalato) phosphate (LiDFOP) (Compound No. 53, 2022). An example of a salt compound of formula Salt1 is: lithium difluoro(oxalato)borate (LiDFOB) (Compound No. 43, 2006).

Yet another aspect is directed to a lithium-ion battery electrolyte. In some embodiments, the lithium-ion battery electrolyte includes a lithium salt composition and an electrolyte compound composition comprising fluoroethylene carbonate (FEC) and one or more selected covalent compounds (e.g., a Cyc1 compound, Compound Nos. 1, 2, 3, 4, 6, a Cyc3 compound, Compound Nos. 17, 19, and 51, a Cyc4 compound, Compound No. 20, an Est1 compound, Compound No. 22, an Oth1-Covalent compound, Compound Nos. 29, 31, 36 37, and 52). In some embodiments, a concentration of the FEC in the lithium-ion battery electrolyte is in a range of about 0.1 mol. % to about 40 mol. %, and a concentration of the one or more of the selected covalent compounds in the lithium-ion battery electrolyte is in a range of about 0.1 mol. % to about 5 mol. %.

Yet another aspect is directed to a lithium-ion battery electrolyte. In some embodiments, the lithium-ion battery electrolyte includes a lithium salt composition and an electrolyte compound composition comprising fluoroethylene carbonate (FEC) and one or more selected covalent compounds (e.g., a Cyc1 compound, Compound Nos. 1, 2, 3, 4, 6, a Cyc3 compound, Compound Nos. 17, 19, and 51, a Cyc4 compound, Compound No. 20, an Est1 compound, Compound No. 22, an Oth1-Covalent compound, Compound Nos. 29, 31, 36 37, and 52). In some embodiments, a concentration of the FEC in the lithium-ion battery electrolyte is in a range of about 0.1 mol. % to about 40 mol. %, and a concentration of the one or more of the selected covalent compounds in the lithium-ion battery electrolyte is in a range of about 5 mol. % to about 95 mol. %.

Yet another aspect is directed to a lithium-ion battery electrolyte. In some embodiments, the lithium-ion battery electrolyte includes a lithium salt composition and an electrolyte compound composition comprising one or more selected covalent compounds (e.g., a Cyc1 compound, Compound Nos. 1, 2, 3, 4, 6, a Cyc3 compound, Compound Nos. 17, 19, and 51, a Cyc4 compound, Compound No. 20, an Est1 compound, Compound No. 22, an Oth1-Covalent compound, Compound Nos. 29, 31, 36 37, and 52). In some embodiments, a concentration of the one or more of the selected covalent compounds in the lithium-ion battery electrolyte is in a range of about 0.1 mol. % to about 95 mol. %.

Yet another aspect is directed to a lithium-ion battery electrolyte. In some embodiments, the lithium-ion battery electrolyte includes a lithium salt composition comprising one or more selected salt compounds (e.g., a Salt1 compound, Compound No. 43, a Salt2 compound, Compound No. 53, a Salt3 compound) and an electrolyte compound composition In some embodiments, a concentration of the one or more of the selected salt compounds in the lithium-ion battery electrolyte is in a range of about 0.1 mol. % to about 20 mol. %.

Another aspect is directed to a lithium-ion battery comprising an anode current collector, a cathode current collector, an anode disposed on or in the anode current collector, a cathode disposed on or in the cathode current collector, and electrolyte ionically coupling the anode and the cathode. In some embodiments, the electrolyte is any of the electrolytes as described herein.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the electrolytes, components, materials, methods, and other techniques described herein may be implemented.

FIG. 2 illustrates a molecular formula Cyc1 and several of its substituent groups.

FIG. 3 illustrates selected example compounds of formula Cyc1.

FIG. 4 illustrates a molecular formula Cyc3 and several of its substituent groups.

FIG. 5 illustrates selected example compounds of formula Cyc3.

FIG. 6 illustrates a molecular formula Cyc4 and several of its substituent groups.

FIG. 7 illustrates a selected example compound of formula Cyc4.

FIG. 8 illustrates a molecular formula Cyc5 and several of its substituent groups.

FIG. 9 illustrates a selected example compound of formula Cyc5.

FIG. 10 illustrates a molecular formula Est1 and several of its substituent groups.

FIG. 11 illustrates selected example compounds of formula Est1.

FIG. 12 illustrates a molecular formula Oth1 and several of its substituent groups.

FIG. 13 illustrates selected example compounds of formula Oth1.

FIG. 14 illustrates a molecular formula Oth3 and several of its substituent groups.

FIG. 15 illustrates selected example compounds of formula Oth3.

FIG. 16 illustrates molecular formulas Salt1, Salt2, and Salt3, and several of their substituent groups.

FIG. 17 illustrates selected example compounds of formula Salt1 and formula Salt2.

FIG. 18 is a graphical plot 2102 of the differential capacity (dQ/dV) of the first charge showing the onset voltages of reduction of example electrolytes.

FIG. 19 is graphical plot 2202 of the capacity retention (in % of initial capacity) as a function of cycle number, for Li-ion battery cells comprising electrolytes ELY #1 and ELY #2. ELY #2 is an example of an electrolyte comprising ethylene sulfite (ESi) or compound No. 3, shown as 306 in FIG. 3.

FIG. 20 shows a Table 1 (2302) which shows the electrolyte compositions and associated selected battery performance characteristics for electrolytes ELY #1 and ELY #2. ELY #2 is an example of an electrolyte comprising ethylene sulfite (ESi) or compound No. 3, shown as 306 in FIG. 3.

FIG. 21 shows a Table 2 (2402) which shows the electrolyte compositions and associated selected battery performance characteristics for electrolytes ELY #3 and ELY #4. ELY #4 is an example of an electrolyte comprising ethylene sulfite (ESi) or compound No. 3, shown as 306 in FIG. 3.

FIG. 22 is graphical plot 2502 of the capacity retention (in % of initial capacity) as a function of cycle number, for Li-ion battery cells comprising electrolytes ELY #5 and ELY #6. ELY #6 is an example of an electrolyte comprising ethylene sulfite (ESi) or compound No. 3, shown as 306 in FIG. 3.

FIG. 23 shows a Table 3 (2602) which shows the electrolyte compositions and associated selected battery performance characteristics for electrolytes ELY #5 and ELY #6. ELY #6 is an example of an electrolyte comprising ethylene sulfite (ESi) or Compound No. 3, shown as 306 in FIG. 3.

FIG. 24 shows a Table 4 (2702) which shows the electrolyte compositions and associated selected battery performance characteristics for electrolytes ELY #7 and ELY #8. ELY #8 is an example of an electrolyte comprising 5-oxotetrahydrofuran-3-sulfonyl fluoride (GBLSF) or Compound No. 19, shown as 616 in FIG. 5.

FIG. 25 shows a Table 5 (2802) which shows the electrolyte compositions and associated selected battery performance characteristics for electrolytes ELY #9 and 10. ELY #10 is an example of an electrolyte comprising oxiran-2-ylmethanesulfonyl fluoride (OrMSF) or Compound No. 20, shown as 802 in FIG. 7.

FIG. 26 shows a Table 6 (2902) which shows the electrolyte compositions and associated selected battery performance characteristics for electrolytes ELY #11 and ELY #12. ELY #12 is an example of an electrolyte comprising Methyl 2,2-difluoro-2-(fluorosulfonyl)acetate (MDFA) or Compound No. 22, shown as 1202 in FIG. 11.

FIG. 27 shows a Table 7 (3002) which shows the electrolyte compositions and associated selected battery performance characteristics for electrolytes ELY #13 and ELY #14. ELY #14 is an example of an electrolyte comprising methyl 2,2-difluoro-2-(fluorosulfonyl)acetate (MDFA) or Compound No. 22, shown as 1202 in FIG. 11.

FIG. 28 shows a Table 8 (3102) which shows the electrolyte compositions and associated selected battery performance characteristics for electrolytes ELY #15 and ELY #16. ELY #16 is an example of an electrolyte comprising ethenesulfonyl fluoride (ESF) or Compound No. 31, shown as 1404 in FIG. 13.

FIG. 29 shows a Table 9 (3202) which shows the electrolyte compositions and associated selected battery performance characteristics for electrolytes ELY #17 and 18. ELY #18 is an example of an electrolyte comprising cyanomethanesulfonyl fluoride (CMSF) or Compound No. 29, shown as 1402 in FIG. 13.

FIG. 30 shows a Table 10 (3302) which shows the electrolyte compositions and associated selected battery performance characteristics for electrolytes ELY #19 and ELY #20. ELY #20 is an example of an electrolyte comprising dimethyl sulfite (DMS) or Compound No. 37, shown as 1418 in FIG. 13.

FIG. 31 shows a Table 11 (3402) which shows the electrolyte compositions and associated selected battery performance characteristics for electrolytes ELY #21 and ELY #22. ELY #21 is an example of an electrolyte comprising 1,3,2-dioxathiolane 2,2-dioxide (DTD) or Compound No. 1, shown as 302 in FIG. 3. ELY #22 is an example of an electrolyte comprising Triisopropyl phosphate (TIP) or Compound No. 36, shown as 1416 in FIG. 13.

FIG. 32 shows a Table 12 (3502) which shows the electrolyte compositions and associated selected battery performance characteristics for electrolytes ELY #23 and ELY #24. ELY #24 is an example of an electrolyte comprising lithium difluoro(oxalato)borate (LiDFOB) or Compound No. 43, shown as 2006 in FIG. 17.

FIG. 33 shows a Table 13 (3602) which shows the electrolyte compositions and associated selected battery performance characteristics for electrolytes ELY #25, ELY #26, ELY #27, ELY #28, and ELY #29. ELY #25 is an example of an electrolyte comprising ECCN or Compound No. 51, shown as 618 in FIG. 5.

FIG. 34 is graphical plot 3702 of the capacity retention (in % of initial capacity) as a function of cycle number, for Li-ion battery cells comprising electrolytes ELY #25, ELY #26, ELY #27, ELY #28, and ELY #29. ELY #25 is an example of an electrolyte comprising ECCN or Compound No. 51, shown as 618 in FIG. 5.

FIG. 35 is a scheme 3802 which shows the synthesis of diethyl (2-oxido-1,2,3-oxathiazolidin-3-yl)phosphonate (Compound No. 6), shown as 312 in FIG. 3.

FIG. 36 is a scheme 3902 which shows the synthesis of 3-(2,2,2-trifluoroethyl)-1,2,3-oxathiazolidine 2-oxide (Compound No. 4), shown as 308 in FIG. 3.

FIG. 37 is a scheme 4002 which shows the synthesis of 2-oxotetrahydrofuran-3-sulfonyl fluoride (Compound No. 17), shown as 612 in FIG. 5.

FIG. 38 is a scheme 4102 which shows the synthesis of ethane-1,2-disulfonyl difluoride (Compound No. 52), shown as 1420 in FIG. 13.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in)° ° C. between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | | Measurement | |
|---|---|---|---|
| Type | Property Type | Instrumentation | Measurement Technique |
| Active | Coulombic | Potentiostat | Charge (current) is passed to |
| Material | Efficiency | | an electrode containing the |
| | | | active material of interest until |
| | | | a given voltage limit is |
| | | | reached. Then, the current is |
| | | | reversed (discharge current) |
| | | | until a second voltage limit is |
| | | | reached. The ratio of the two |
| | | | charges passed determines the |
| | | | Coulombic Efficiency (CE). In |
| | | | the simplest case, the charge |
| | | | and discharge currents may be |
| | | | constant and often have |
| | | | absolute values that are the |
| | | | same or close to each other. It |
| | | | should be understood though |
| | | | that in some experiments, |
| | | | either charge current or |
| | | | discharge current or both may |
| | | | be changing during such |
| | | | experiments (e.g., be initially |
| | | | constant and when the voltage |
| | | | limit is reached, diminishing |
| | | | to a predetermined value). In |
| | | | addition, the absolute value of |
| | | | the charge and discharge |
| | | | currents may differ. |
| Active | Partial Vapor | Manometer | The partial vapor pressure of |
| Material | Pressure (e.g., | | an active material in a mixture |
| | Torr.) at a | | (e.g., composite particle) at a |
| | Temperature | | particular temperature is given |
| | (e.g., K) | | by the known vapor pressure |
| | | | of the active material |
| | | | multiplied by its mole fraction |
| | | | in the mixture. |
| Active | Volume | Gas pycnometer | Gas pycnometer measures the |
| Material | | | skeletal volume of a material |
| Particle | | | by gas displacement using the |
| | | | volume-pressure relationship |
| | | | of Boyle's Law. A sample of |
| | | | known mass is placed into the |
| | | | sample chamber and |
| | | | maintained at a constant |
| | | | temperature. An inert gas, |
| | | | typically helium, is used as the |
| | | | displacement medium. |
| | | | Note: A vol. % change may be |
| | | | calculated from two volume |
| | | | measurements of the active |
| | | | material particle. |
| Active | Open Internal | nitrogen | Nitrogen sorption/desorption |
| Material | Pore Volume | sorption/desorption | isotherm (typically at 77 K) is |
| Particle | (e.g., cc/g or | isotherm | collected and analyzed to |
| | cm³/g) | | estimate the total amount of |
| | | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such as |
| | | | Non-Local Density Functional |
| | | | Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in combination |
| | Size | electron microscope | with image analyses, laser |
| | Distributions | (TEM), scanning | microscopy (for larger |
| | (e.g., nm) | transmission | particles and larger pores) in |
| | | microscope (STEM), | combination with image |
| | | laser microscope, | analyses, optical microscopy |
| | | Synchrotron X-ray, | (for larger particles and larger |
| | | X-ray microscope | pores), neutron scattering, X- |
| | | | ray scattering, X-ray |
| | | | microscopy imaging may be |
| | | | employed to measure pore |
| | | | sizes (average pore size or |
| | | | pore size distribution) in |
| | | | different size ranges (in |
| | | | addition to the analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing them to the |
| | | | theoretical density of the |
| | | | individual material |
| | | | components present in Si— |
| | | | comprising particles. In |
| | | | addition, closed internal pore |
| | | | volume may be estimated by |
| | | | comparing the total pore |
| | | | volume estimated from |
| | | | neutron scattering and the |
| | | | nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced by |
| | (e.g., nm) | | a solid can be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), |
| | | | X-ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing |
| Particle | fraction or wt. | | the mass fraction of a material |
| | %, mg, number of | | in the particle relative to the |
| | atoms, etc.) | | total particle mass. |
| | | | Note #2: The capacity |
| | | | attributable to particular active |
| | | | material(s) in the particle may |
| | | | be derived from the |
| | | | composition, based on the |
| | | | known (e.g., theoretical or |
| | | | practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be characterized |
| | | | by a number of atoms of a |
| | | | particular element (e.g., Fe, F, |
| | | | C, etc.). In case of atoms, the |
| | | | number of atoms may be |
| | | | estimated from the weight of |
| | | | that atom in the particle (e.g., |
| | | | based on gas chromatography) |
| Active | Composition | X-ray Fluorescence | |
| Material | (e.g., mass | (XRF), Inductively | |
| Particle | fraction or wt. | Coupled Plasma | |
| | % of various | Optical Emission | |
| | atomic | Spectroscopy (ICP- | |
| | elements or | OES); Energy | |
| | molecules, | Dispersive | |
| | atomic | Spectroscopy (EDS), | |
| | fraction or at. | Wavelength | |
| | % of various | Dispersive | |
| | elements, etc.) | Spectroscopy (WDS), | |
| | | Electron Energy Loss | |
| | | Spectroscopy (EELS), | |
| | | Nuclear Magnetic | |
| | | Resonance (NMR); | |
| | | Secondary Ion Mass | |
| | | Spectrometry (SIMS); | |
| | | X-Ray Photoelectron | |
| | | Spectroscopy (XPS); | |
| | | Fourier Transform | |
| | | Infrared Spectroscopy | |
| | | (FTIR) and Raman | |
| | | Spectroscopy | |
| | | (Raman) | |
| Active | Specific | Potentiostat | An electrode containing an |
| Material | Capacity | | active anode or cathode |
| Particle, | | | material of interest is charged |
| Battery Half- | | | or discharged (by passing |
| Cell | | | electrical current to the |
| | | | electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) gives |
| | | | this quantity (e.g., in mAh/g). |
| | | | The active mass is computed |
| | | | by multiplying the total mass |
| | | | of the electrode by the active |
| | | | material mass fraction. Both |
| | | | reversible and irreversible |
| | | | capacity during charge or |
| | | | discharge may be calculated in |
| | | | this way. |
| Active | BET SSA | BET instrument | A sample is placed into a |
| Material | (e.g., m²/g) | | sealed chamber at 77 K, where |
| Particle | | | nitrogen is introduced at |
| | | | increasing pressure. The |
| | | | change in pressure of the |
| | | | nitrogen is used to calculate |
| | | | the surface area of the sample. |
| Active | Aspect Ratio | SEM, TEM | The dimensions and shape of |
| Material | | | the particles are typically |
| Particle | | | measured by using SEM or |
| | | | TEM or (for large particles) by |
| | | | using optical microscopy. |
| Active | True Density | Argon Gas | True density values may be |
| Material | of Particle | Pycnometer | measured by using an argon |
| Particle | (e.g., g/cc or | | gas pycnometer and |
| | g/cm³) | | comparing to the theoretical |
| | | | density of the individual |
| | | | material components present |
| | | | in the particle. |
| Active | Particle Size | Dynamic light | laser particle size distribution |
| Material | Distribution | scattering particle size | analysis (LPSA) on well- |
| Particle | (e.g., nm or | analyzer, scanning | dispersed particle suspensions |
| Population | μm) | electron microscope | in one example or by image |
| | | | analysis of electron |
| | | | microscopy images, or by |
| | | | other suitable techniques. |
| | | | While there are diverse |
| | | | processes of measuring PSDs, |
| | | | laser particle size distribution |
| | | | analysis (LPSA) is quite |
| | | | efficient for some applications. |
| | | | Note that other types of |
| | | | particle size distribution (e.g., |
| | | | by SEM image analysis) could |
| | | | also be utilized (and may even |
| | | | lead to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D10), a fiftieth- |
| | | | percentile volume-weighted |
| | | | particle size parameter (e.g., |
| | | | abbreviated as D50), a |
| | | | ninetieth-percentile volume- |
| | | | weighted particle size |
| | | | parameter (e.g., abbreviated as |
| | | | D90), and a ninety-ninth- |
| | | | percentile volume-weighted |
| | | | particle size parameter (e.g., |
| | | | abbreviated as D99). |
| Active | Width (e.g., | PSA | Parameters relating to |
| Material | nm) | | characteristic widths of the |
| Particle | | | PSD may be derived from |
| Population | | | these particle size parameters, |
| | | | such as D50-D10 |
| | | | (sometimes referred to herein |
| | | | as a left width), D90-D50 |
| | | | (sometimes referred to herein |
| | | | as a right width), and D90- |
| | | | D10 (sometimes referred to |
| | | | herein as a full width). |
| Active | Cumulative | Computed via LPSA | A cumulative volume fraction, |
| Material | Volume | data | defined as a cumulative |
| Particle | Fraction | | volume of the composite |
| Population | | | particles with particle sizes of |
| | | | a threshold particle size or |
| | | | less, divided by a total volume |
| | | | of all of the composite |
| | | | particles, may be estimated by |
| | | | LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m²/g) | | nitrogen sorption-desorption at |
| Particle | | | cryogenic temperatures, such |
| Population | | | as about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar mass of the |
| | | | salt is then used to calculate |
| | | | the total number of moles of |
| | | | salt in the solution. The moles |
| | | | of salt is then divided by the |
| | | | total volume to obtain the |
| | | | solvent concentration in M |
| | | | (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar volume of |
| | | | each solvent is then used to |
| | | | calculate the total number of |
| | | | moles of solvent in the |
| | | | solution. The moles of solvent |
| | | | is then divided by the total |
| | | | volume to obtain the solvent |
| | | | concentration in M (mol/L). |
| Electrode | Composition | Balance | The mass fraction of a |
| | (e.g., mass | | material (e.g., active material, |
| | fraction or wt. | | active material particle, |
| | %) | | binder, etc.) in the electrode is |
| | | | calculated based on a |
| | | | measured or estimated mass of |
| | | | the material and a measured or |
| | | | estimated mass of the |
| | | | electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be measured |
| | | | before being mixed into a |
| | | | slurry to estimate their mass in |
| | | | a casted electrode. The mass |
| | | | of materials deposited onto the |
| | | | casted electrode may be |
| | | | measured by comparing the |
| | | | weight of the casted electrode |
| | | | before/after the material |
| | | | deposition. |
| Electrode | Areal Binder | balance | A mass fraction of the binder |
| | Loading (e.g., | | in the battery electrode, |
| | mg/m²) | | divided by a product of (1) a |
| | | | mass fraction of the active |
| | | | material (e.g., Si—C |
| | | | nanocomposite, etc.) particles |
| | | | in the battery electrode, and |
| | | | (2) a Brunauer-Emmett-Teller |
| | | | (BET) specific surface area of |
| | | | the active material particle |
| | | | population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical capacity |
| | material | | of the active material. For |
| | capacity | | example, the average wt. % of |
| | fraction) | | active material in each active |
| | | | material particle may be |
| | | | measured and used to calculate |
| | | | the mass of the active material |
| | | | based on the mass of the active |
| | | | material particles before being |
| | | | mixed in the slurry. This |
| | | | process may be repeated if the |
| | | | electrode includes two or more |
| | | | active materials to calculate |
| | | | the relative capacity |
| | | | attribution for each active |
| | | | material in the electrode. |
| Electrode | Capacity | Potentiostat and | Determine the average specific |
| | Attributable | balance | capacity (mAh/g) of active |
| | to Active | | material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may be |
| | | | repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in the slurry. |
| | Electrode | | |
| Electrode | Areal | Potentiostat and | Areal capacity loading is the |
| | Capacity | balance | weight of the coated active |
| | Loading (e.g., | | material per unit area (g/cm²) |
| | mAh/cm²) | | multiplied by the gravimetric |
| | | | capacity of the active material |
| | | | (not the electrode, but the |
| | | | active material itself with zero |
| | | | binder and zero electrolyte; |
| | | | mAh/g). |
| Electrode | Coulombic | Potentiostat | The change in charge inserted |
| | Efficiency | | (or extracted) to an electrode |
| | | | divided by the charge |
| | | | extracted (or inserted) from |
| | | | the electrode during a |
| | | | complete electrochemical |
| | | | cycle within given voltage |
| | | | limits. Because the direction |
| | | | of charge flow is opposite for |
| | | | cathodes and anodes, the |
| | | | definition is dependent on the |
| | | | electrode. |
| | | | Coulombic Efficiency is |
| | | | measured for both materials by |
| | | | constructing a so-called half- |
| | | | cell, which is an |
| | | | electrochemical cell consisting |
| | | | of a cathode or anode material |
| | | | of interest as the working |
| | | | electrode and a lithium metal |
| | | | foil which functions as both |
| | | | the counter and reference |
| | | | electrode. Then, charge is |
| | | | either inserted or removed |
| | | | from the material of interest |
| | | | until the cell voltage reaches |
| | | | an appropriate limit. Then, the |
| | | | process is reversed until a |
| | | | second voltage limit is |
| | | | reached, and the charge passed |
| | | | in both steps is used to |
| | | | calculate the Coulombic |
| | | | Efficiency, as described |
| | | | above. |
| Battery Cell | Rate | Potentiostat | This is the time it takes to |
| | Performance | | charge or discharge a battery |
| | | | between a given state of |
| | | | charge. It is measured by |
| | | | charging or discharging a |
| | | | battery and measuring the time |
| | | | until a specified amount of |
| | | | charge is passed, or until the |
| | | | battery operating voltage |
| | | | reaches a specified value. |
| Battery Cell | Cell | Potentiostat | A battery consisting of a |
| | Discharge | | relevant anode and cathode is |
| | Voltage | | charged and discharged within |
| | (e.g., V) | | certain voltage limits and the |
| | | | charge-weighted cell voltage |
| | | | during discharge is computed. |
| Battery Cell | Operating | Potentiostat and | Average temperature of |
| | Temperature | thermocouples | battery cell as measured at the |
| | | | positive/negative terminal/ |
| | | | cell shaft/etc. while |
| | | | charging/discharging, or at a |
| | | | certain voltage level, or while |
| | | | a load is applied, etc. |
| Battery Half- | Anode | Potentiostat | An electrode containing an |
| Cell | Discharge | | active anode material (or a |
| | (de-lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or a |
| | (lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | The VED is calculated by first |
| | Energy | | calculating the energy per unit |
| | Density | | area of the battery, and then |
| | (VED) | | dividing the energy per unit |
| | | | area by the sum of the |
| | | | illustrative anode, cathode, |
| | | | separator, and current collector |
| | | | thicknesses |
| Battery Cell | Internal | Potentiostat | The internal resistance (also |
| | Resistance | | known as impedance in many |
| | (impedance) | | contexts) is measured by |
| | | | applying small pulses of |
| | | | current to the battery cell and |
| | | | recording the instantaneous |
| | | | change in cell voltage. |

It will be appreciated that some embodiments described below may be used on their own or in various combinations in order to achieve the most desirable Li-ion battery (or Li-ion battery cell) characteristics for a particular application.

In some embodiments described below, certain parameters (e.g., temperature, state-of-charge (SOC), etc.) are defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

While the description below may describe certain examples of suitable intercalation-type cathodes (including high voltage cathodes) in the context of lithium nickel cobalt aluminum oxides (NCA), lithium nickel cobalt manganese aluminum oxides (NCMA), lithium nickel oxides (LNO), layered or spinel lithium manganese oxides (LMO), high voltage spinels such as lithium nickel manganese oxides (LMNO), lithium nickel manganese cobalt oxides (NCM), lithium cobalt oxide (LCO), lithium cobalt aluminum oxides (LCAO), lithium iron phosphate (LFP), LNP (lithium nickel phosphate), lithium manganese phosphate (LMP), lithium iron manganese phosphate (LMFP), lithium cobalt phosphate (LCP), various disordered rocksalt cathodes (DRS) such as lithium manganese titanium oxides (LMTO) or oxyfluorides (LMTOF) or lithium manganese zirconium oxides (LMZO) or oxyfluorides (LMZOF) or lithium vanadium oxides (LVO) or oxyfluorides (LVOF) or lithium molybdenum oxides (LMoO) or oxyfluorides (LMoOF) or other types of DRS oxide and oxyfluoride materials (which may comprise, for example, Li (in case of Li- or Li-ion batteries; or Na in case of Na- and Na-ion batteries) and one, two, three or more of the following metals: Mn, V, Ti, Mo, Ni, Fe, Cu, Nb, Y, Hf, Zr, W, Ta, Mg) and other lithium transition metal (TM) oxide or oxyfluoride or phosphate or sulfate (or mixed) cathodes that rely on the intercalation of lithium (Li) and changes in the TM oxidation state (including, but not limited to, those that may be doped or heavily doped; including, but not limited to, those that have gradient in composition or core-shell morphology; including, but not limited to those that may be partially fluorinated or comprise some meaningful fraction of fluorine (e.g., about 0.001-10 at. %) in their composition, etc.), it will be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, Sn, Si, or Ge).

While the description below may describe certain examples of suitable intercalation-type graphites to be used in the anode, it will be appreciated that various aspects of this disclosure may be applicable to soft-type synthetic graphite (or, broadly, carbon), hard-type synthetic graphite (or, broadly, carbon), and pitch coat natural or synthetic graphite; including but not limited to those which exhibit discharge capacity from about 340 to about 372 mAh/g; including but not limited to those which exhibit low, moderate and high swelling; including but not limited to those which exhibit good and poor compression, including but not limited to those which exhibit Brunauer-Emmett-Teller (BET) surface area of about 0.5 to about 20 m²/g (in some designs, from about 0.5 to 4 m²/g; in other designs, from about 4 to about 20 m²/g); including but not limited to those which exhibit first cycle lithiation efficiency of about 90% and more; including but not limited to those which exhibit particle sizes (volume-averaged dimensions) from about 1 to about 40 μm (in some designs, from about lum to about 8 μm; in other designs, from about 8 μm to about 18 μm; in yet other designs, from about 18 μm to about 40 μm); including but not limited to those which exhibit true densities (e.g., measured using a helium or nitrogen pycnometry) ranging from about 1.5 g/cm³ to about 2.3 g/cm³; including but not limited to those which exhibit poor, moderate, or good cycle life when used on their own; including but not limited to those which are coated and comprise coatings with coating thickness to appreciably improve compression and springing during cycling.

While the description below may also describe certain examples of the electrode material formulations in a Li-free state (for example, as in silicon-comprising nanocomposite anodes or metal fluoride cathodes), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others), partially or fully lithiated intercalation-type cathodes, some of which were described above. In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector. Moreover, as used here, an Li-free state is used to refer to a material that is free of electrochemically active Li, and other types of Li such as in electrochemically inactive compounds may (optionally) be part of such an Li-free material.

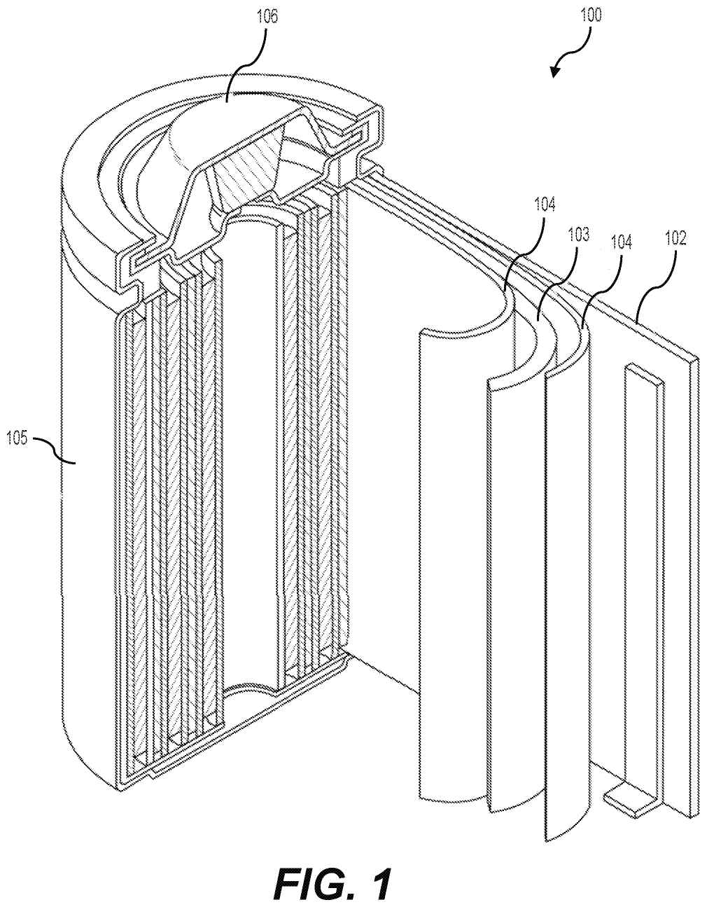

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). In some implementations, battery 100 also includes an anode current collector and a cathode current collector. The anode is disposed on the anode current collector and the cathode is disposed on the cathode current collector.

Electrodes utilized in Li-ion batteries are typically produced by (i) formation of a slurry comprising active materials, conductive additives, binder solutions and, in some cases, surfactant or other functional additives; (ii) casting the slurry onto a metal current collector foil (e.g., Cu foil for most anodes and Al foil for most cathodes); and (iii) drying the casted electrodes to completely evaporate the solvent (often additionally densifying or calendaring the electrodes to achieve a desired electrode density and other properties).

Conventional anode materials utilized in Li-ion batteries are of an intercalation-type, whereby metal ions are intercalated into and occupy interstitial positions of such materials during the charge or discharge of a battery. Such anodes experience small or very small volume changes when used in electrodes. Polyvinylidene fluoride, also known as polyvinylidene difluoride (PVDF), carboxymethyl cellulose (CMC) and styrene-butadiene rubber (SBR) are the most common binders used in these electrodes (CMC is often combined with SBR). Carbon black is the most common conductive additive used in these electrodes. However, such anodes exhibit relatively small gravimetric and volumetric capacities (typically less than about 370 mAh/g rechargeable specific capacity in the case of graphite- or hard carbon-based anodes and less than about 600 mAh/cm³ rechargeable volumetric capacity at the electrode level without considering the volume of the current collector foils).

During battery (such as a Li-ion battery) operation, conversion-type materials change (convert) from one crystal structure to another (hence the name “conversion”-type, e.g., an electrochemical reaction). This process is also accompanied by breaking chemical bonds and forming new ones. During (e.g., Li-ion) battery operation, Li ions are inserted into alloying-type materials forming lithium alloys (hence the name “alloying”-type). Sometimes, “alloying”-type electrode materials are considered to be a subclass of “conversion”-type electrode materials.

Alloying-type (or, more broadly, conversion-type) anode materials for use in Li-ion batteries offer higher gravimetric and volumetric capacities compared to intercalation-type anodes. For example, Earth-abundant silicon (Si) offers approximately 10 times higher gravimetric capacity and approximately 3 times higher volumetric capacity compared to an intercalation-type graphite (or graphite-like carbon) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Formation of (nano)composite Si-comprising particles (including, but not limited to, Si-carbon composites, Si-metal composites, Si-polymer composites, Si-ceramic composites, composites comprising various combinations of nanostructured Si, carbon, polymer, ceramic and metal or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells. In some designs, Si may be doped or heavily doped with nitrogen (N), phosphorous (P), boron (B) or aluminum (Al) or other elements or be allowed with metals. In addition to Si-based composites, silicon oxides (SiOₓ) or oxynitrides (SiOₓN_{y}) or nitrides (SiN_{y}) or other Si element-comprising particles (including those that are partially reduced by Li or Mg) may reduce volume changes and improve cycle stability, although commonly at the expense of higher first cycle losses or faster degradation or both. In addition to Si-comprising anodes, other examples of such high-capacity (e.g., nanocomposite) anodes comprising alloying-type (or, more broadly, conversion-type) active materials include, but are not limited to, those that comprise germanium, antimony, aluminum, magnesium, zinc, gallium, arsenic, phosphorous, silver, cadmium, indium, tin, lead, bismuth, their alloys, and others. In addition to anodes comprising active materials in a metallic form, other interesting types of high-capacity (including nanocomposite) anodes may comprise metal oxides (including silicon oxide, lithium oxide, etc.), metal nitrides (including silicon nitride, etc.), metal oxy-nitrides (including silicon oxy-nitride, etc.), metal phosphides (including lithium phosphide), metal hydrides, and others.

High-capacity (nano)composite anode powders (including, but not limited to, those that comprise Si, e.g., Si-comprising active material deposited within pore(s), including surface pore(s) and/or open internal pore(s) and/or closed internal pore(s) of a monolithic scaffolding structure, such as a C-comprising monolithic scaffolding structure), which exhibit moderately high volume changes (e.g., about 8-about 180 vol. %) during the first charge-discharge cycle, moderate volume changes (e.g., about 5-about 50 vol. %) during the subsequent charge-discharge cycles and an average size in the range from about 0.2 to about 40 microns (for some applications, more preferably from about 0.4 to about 20 microns) may be particularly attractive for battery applications in terms of manufacturability and performance characteristics. In particular, a subclass of such anode powders with specific surface area in the range from about 0.5 m²/g to about 50 m²/g (in some designs, from about 0.5 m²/g to about 2 m²/g; in other designs, from about 2 m²/g to about 12 m²/g; in yet other designs, from about 12 m²/g to about 50 m²/g) performed particularly well in some embodiments. In some designs, electrodes with electrode areal capacity loading from moderate (e.g., from about 2 to about 4 mAh/cm²) to high (e.g., from about 4 to about 12 mAh/cm²) and ultra-high (e.g., above about 12 mAh/cm²) are also particularly attractive for use in cells. In some designs, a near-spherical or a spheroidal or an ellipsoid (inc. oblate spheroid) shape of these composite particles may additionally be very attractive for increasing rate performance and volumetric capacity (density) of the electrodes. In some designs, Si-comprising anode particles may exhibit high gravimetric capacities in the range from about 800 mAh/g to about 3000 mAh/g (per mass of Si-comprising anode particles in a Li-free state). In some designs, a subset of anodes with Si-comprising anode particles may include anodes with an electrode layer exhibiting capacity in the range from about 400 mAh/g to about 2800 mAh/g (per mass of the electrode layer, not counting the mass of the current collector, in a Li-free state). Such a class of charge-storing anodes may offer great potential for increasing gravimetric and volumetric energy density of rechargeable batteries.

Unfortunately, high-capacity (nano)composite anode powders, which exhibit moderately high volume changes (e.g., about 8-about 180 vol. %) during the first charge-discharge cycle, moderate volume changes (e.g., about 5-about 50 vol. %) during the subsequent charge-discharge cycles, an average size in the range from about 0.2 to about 40 microns and relatively low density (e.g., about 0.5-3.8 g/cc), are relatively new and their performance characteristics and limited cycle stability are typically relatively poor, particularly when used with conventional electrolytes and particularly at elevated temperatures (e.g., at or above battery operating temperatures, e.g., above about 50-80° C.) or when charged to high voltages (e.g., above about 4-4.3 V) and stored at such voltages at elevated temperatures (e.g., above about 50-80° C.). In some designs, degradation of Li-ion cells with such active anode materials may become particularly undesirably fast for cells comprising medium (e.g., about 3-4 g/Ah) or small (e.g., about 2-3 g/Ah) or very small (e.g., about 1-2 g/Ah) amount of conventional electrolyte when normalized by total cell capacity. However, in some designs, using a medium or a small amount of electrolyte may be particularly attractive for reducing cell fabrication costs or certain side reactions and for maximizing the energy density of cells. In some designs, degradation of Li-ion cells with such active anode materials may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). However, large, or ultra-large or gigantic cells may be particularly attractive for use in some electric transportation or grid storage applications. In some designs, degradation of Li-ion cells with such active anode materials may become particularly undesirably fast if electrode areal capacity loading is moderate (e.g., from about 2 to about 4 mAh/cm²) and even more so if electrode areal capacity loading is high (e.g., from about 4 to about 12 mAh/cm²) or ultra-high. Higher capacity loading, however, is advantageous in some designs for increasing cell energy density and reducing cell manufacturing costs. Similarly, the cell performance may suffer when such an electrode (e.g., anode) porosity (e.g., volume occupied by the spacing between the (nano)composite active anode particles in the electrode and filled with electrolyte, exclusive of closed pores, if any, within the particles themselves that are inaccessible to electrolyte) becomes moderately small (e.g., about 25-about 35 vol. %) and more so when the electrode (e.g., anode) porosity becomes small (e.g., about 5-about 25 vol. %) or when the amount of the binder and conductive additives in the electrode (e.g., anode) becomes moderately small (e.g., about 6-about 15 wt. %, total) and more so when the amount of the binder and conductive additives in the electrode (e.g., anode) becomes small (e.g., about 0.5-about 5 wt. %, total). Higher electrode density and lower binder content, however, are advantageous for increasing cell energy density and reducing cost in certain applications. In some designs, lower binder content may also be advantageous for increasing cell rate performance. Thus, in spite of some improvements that may be achieved with the formation and utilization of such alloying-type (or conversion-type) active material(s)-comprising (e.g., nanocomposite) anode materials as well as electrode formulations, however, substantial additional improvements in cell performance characteristics may be achieved with improved composition and preparation of electrolytes (e.g., liquid electrolytes), beyond what is known or shown by the conventional state-of-the-art.

The inventors have found that, in some designs, Li-ion battery cells comprising anode electrodes based on high-capacity nanocomposite anode particles or powders (comprising conversion- or alloying-type active anode materials) that experience certain volume changes during cycling (moderately high volume changes (e.g., an increase by about 8-about 180 vol. % or a reduction by about 8-about 70 vol. %) during the first charge-discharge cycle and moderate volume changes (e.g., about 5-about 50 vol. %) during the subsequent charge-discharge cycles) and an average size in the range from about 0.2 to about 40 microns (such as Si-based nanocomposite anode powders, among many others) may be able to overcome some or all of the above-mentioned challenges when paired with specific compositions of electrolytes or electrolyte additives that provide significantly improved performance (particularly for high-capacity loadings or small electrolyte fractions or large cells). The inventors also found that, in some designs, Li-ion battery cells comprising graphite or graphite-like carbon (including but not limited to soft and hard carbon) anode particles, may also benefit from some of such specific compositions of electrolyte or electrolyte additives.

For example, (i) continuous volume changes in high-capacity nanocomposite particles during cycling in combination with (ii) electrolyte reaction and decomposition on the electrically conductive electrode surface at electrode operating potentials (e.g., mostly electrochemical electrolyte reduction in the case of Si-based anodes) may lead to a continuous (even if relatively slow) consumption of the finite electrolyte and Li atoms to form undesirable species such as gasses (e.g., CO₂, CO, H₂, CH₄), which cause undesirable cell swelling and rupture, or soluble products (e.g., LiOCH₃, LiOCH₂CH₃) that may subsequently undergo reaction at the cathode to generate gasses, react with and decompose other electrolyte components, or cause undesirable self-discharge of the cell even when no current is drawn through an external circuit. Such consumption of the finite electrolyte and Li atoms in the battery cell results in irreversible losses in cell capacity and increases the cell resistance by both reducing the Li-ion concentration (thereby decreasing the electrolyte conductivity) and reducing the total volume of liquid electrolyte, resulting in reduced contact area between the active electrode materials and the electrolyte. In some designs, the formation of a so-called solid electrolyte interphase (SEI) layer on the surface of the nanocomposite anode particles through the addition of certain SEI-forming (also termed “SEI-builder” below) components to the electrolyte is able to inhibit or prevent the further reaction of the same or other electrolyte components, slowing capacity fade, reducing the rate of resistance growth, improving cycle life, improving calendar life, and reducing self-discharge rates. The SEI layer is formed due to the generation of typically insoluble products that precipitate on or near the anode electrode surfaces through reaction and decomposition (e.g., electrochemical reduction) of the SEI forming components at the electrode surfaces. Such decomposition products may be inorganic (e.g., LiF, Li₂O, Li₂CO₃, Li₂SO₄, Li₃PO₄, Li₂S) or organic (e.g., linear or branched oligomeric or polymeric ethers, linear or branched oligomeric or polymeric alkanes, linear or branched oligomeric or polymeric alkenes) or mixed in nature, and typically allow for Li ion conduction between the electrolyte and the anode particles while inhibiting or preventing reaction of the electrolyte components (e.g., solvents) with the anode surfaces.

An electrolyte may contain one or more components that may serve as SEI builders. For example, a conventional electrolyte may contain one or more lithium salts and an electrolyte compound composition. A conventional salt used in most conventional Li-ion battery electrolytes is LiPF₆. Examples of less common salts (e.g., explored primarily in research publications or, in some cases, never even described in Li-ion battery electrolyte applications, but may still be applicable and useful) include: lithium tetrafluoroborate (LiBF₄), lithium perchlorate (LiClO₄), lithium hexafluoroantimonate (LiSbF₆), lithium hexafluoroarsenate (LiAsF₆) lithium hexafluorosilicate (Li₂SiF₆), lithium hexafluoroaluminate (Li₃AlF₆), lithium bis(oxalato)borate (LiB(C₂O₄)₂) (LiBOB), various lithium imides (such as SO₂FN⁻(Li)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li)SO₂PhCF₃, and others), lithium difluorophosphate (LFO), and others.

A typical electrolyte compound composition comprises a co-solvent portion (e.g., ethylene carbonate (EC), dimethyl carbonate (DMC), ethyl methyl carbonate (EMC), diethyl carbonate (DEC), propyl propionate (PP), ethyl propionate (EP), serving to dissolve the Li salt(s), achieve a high degree of separation of anions and cations in solution, achieve low viscosity, and achieve high ionic conductivity) and an additive portion (e.g., vinylene carbonate (VC), fluoroethylene carbonate (FEC), adiponitrile (ADN), serving to tune various electrolyte behaviors such as SEI forming and outgassing at high temperature and high voltage).

In some designs, the addition of some known SEI-forming electrolyte compounds (e.g., ethylene carbonate (EC), fluoroethylene carbonate (FEC), and vinylene carbonate (VC)) may generate initially effective SEIs during a cell's first charge-discharge cycle, but such SEIs may be damaged by repeated moderately high volume changes (e.g., about 5-about 50 vol. % or higher), such as those exhibited by high-capacity nanocomposite particles during cycling, resulting in cracking, delamination, and exfoliation of the SEI (sometimes referred to as “mechanical instability” or just “instability” of the SEI). A damaged SEI is typically more porous, less uniform, covers less of the anode electrode surfaces, and is less effective at inhibiting reaction between the electrolyte and the anode, leading to accelerated capacity fade, increased gas generation, accelerated self-discharge, reduced cycle life, accelerated resistance growth, and reduced calendar life. In some designs, larger volume changes may lead to inferior performance, which may be related to damages in the SEI layer formed on the anode, to the non-uniform lithiation and delithiation of the electrode particles within the electrodes, disconnection of the electrode particles from the parent electrode, cracking and pulverization of the electrode particles, and/or other factors. In some designs, such SEI instability may be mitigated through the incorporation of higher fractions of the known SEI forming components in the liquid electrolyte. However, Li and Li-ion battery cells comprising high-capacity (nano)composite anode powders, which exhibit moderately high volume changes during the first charge-discharge cycle, moderate volume changes during the subsequent charge-discharge cycles and an average size in the range from about 0.2 to about 40 microns and conventional electrolytes often require the use of such large amounts of conventional SEI-building additives to maintain acceptable SEI stability that prevents their use at elevated or low temperatures or undesirably limits their calendar life or does not allow such cells to be charged to high voltages (e.g., above about 4.1-4.3 V). In some designs, performance of such battery cells may become particularly poor when the cells are charged to above about 4.3-4.4 V and even more so when the cells are charged to above about 4.5 V. In some designs, degradation of such Li-ion cells may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). In some designs, degradation of such Li-ion cells may become particularly undesirably fast for cells comprising medium (e.g., about 3-4 g/Ah) or small (e.g., about 2-3 g/Ah) amount of electrolyte when normalized by total cell capacity. In some designs, such cells (e.g., cells with high amounts of conventional SEI-building additives) may suffer from excessive capacity degradation (e.g., above about 5%), large volume expansion (e.g., above about 10%) and significant gassing when exposed to high temperatures (e.g., above about 50-90° C.) in a fully charged state (e.g., state-of-charge, SOC, of about 90-100%) for a prolonged time (e.g., about 12-168 hours). However, passing such elevated temperature charging tests is often required for most applications, and higher cell voltage, broader operational temperature window and longer cycle life are advantageous for most applications. In some designs, the addition of some known cathode solid electrolyte interphase (CEI)-forming additives (e.g., adiponitrile (ADN), hexane tri carbonitrile (HTCN), succinonitrile (SN), propane sultone (PS), citraconic anhydride (CN), and others) may induce the formation of a protective film on the cathode, reducing further electrolyte oxidation and gassing, but often at the expense of reduced SEI stability on the anode or other undesirable effects, such as reduced electrolyte conductivity.

In some designs, despite the presence of known SEI forming components (e.g., ethylene carbonate (EC), fluoroethylene carbonate (FEC), and vinylene carbonate (VC)) in the electrolyte, an effective SEI may not be formed due to the preferential reaction at the anode electrode surfaces of other components which do not form effective SEI, leading to undesirably fast capacity fade, excessive gas generation, fast self-discharge, low cycle life, fast resistance growth, and short calendar life. Preferential reduction of components may be measured through analysis of the differential plot of capacity with respect to voltage (dQ/dV) during a battery's first charge. When subjected to the same charging conditions (e.g., a constant charging current), preferential reduction of a particular component over other components may present as the cell first reaching a certain low differential capacity (e.g., 1 V/(mAh/g_{anode}), where g_{anode} represents the total mass in grams of the anode active material in the cell) at a lower voltage than when that component is absent from the electrolyte while keeping all other cell designs (e.g., anode composition and morphology, cathode composition and morphology, etc.) approximately the same. Such preferential reaction of some components may be due to their having a higher electrochemical reduction potential than other components, which may result in a faster rate of decomposition at the anode within the cell's operating voltages. Such preferential reaction of some components may also be due to their greater propensity to coordinate to Li ions in the liquid electrolyte solution than other components, which may also result in a faster rate of decomposition at the anode. In cells with graphite or graphitic carbon anode active materials, preferential coordination to Li ions may also lead to co-intercalation of the electrolyte component with Li into the graphite particles, resulting in exfoliation and destruction of the graphite layered structure and rapid loss of capacity. Nonetheless, incorporation of electrolyte components with higher reduction potentials, greater propensity to coordinate Li ions, or SEI forming properties that are worse than known SEI forming components (e.g., compounds that may not be good SEI formers in some cases such as ethyl propionate, ethyl isobutyrate, ethyl acetate, methyl acetate, propyl propionate, ethyl isovalerate, ethyl trimethylacetate, methyl butyrate, dimethyl carbonate, ethyl methyl carbonate, diethyl carbonate, methyl phenyl carbonate, diphenyl carbonate, hexamethyl acetone, pinacolone, methyl ethyl ketone, diethyl ketone, methyl isopropyl ketone, diisopropyl ketone, ethyl isopropyl ketone, heptane, hexane, octane, cyclohexane, cycloheptane, benzene, chlorobenzenes, fluorotoluenes, fluoroxylenes, fluoroheptanes, fluorooctanes, fluorohexanes, fluoropentanes, ethyl methyl sulfite, diethyl sulfite, 1,3-propylene sulfite, 1,2-propylene sulfite, trimethyl phosphate, triethyl phosphate, triphenyl phosphate, 1,1,2,2-tetrafluoroethyl 2,2,3,3-tetrafluoropropyl ether, sulfolane, ethyl isopropyl sulfone, ethyl methyl sulfone, hexamethylphosphoramide, N,N′-dimethylpropyleneurea (DMPU), 1,3-dimethyl-2-imidazolidinone, acetonitrile, propionitrile, trimethylaceonitrile, dimethyl sulfoxide, pentadecafluorotriethylamine, N,N-dimethylformamide, and others) may be desirable as these components may confer other performance benefits including reduced electrolyte oxidation on the cathode (particularly at higher voltages or elevated temperature), reduced outgassing at high temperature and high voltage, improved voltage stability, reduced viscosity, increased conductivity, and improved rate capability.

In some designs, swelling of binder(s) in electrolyte(s) depends not just on the binder composition(s), but may also depend on the electrolyte composition(s). Furthermore, in some designs, such swelling (and the resulting performance reduction) often correlates with the reduction in elastic modulus upon exposure of binders to electrolytes. In this sense, the smaller the reduction in modulus in certain electrolytes, the more stable the binder-linked (nano)composite active particles/conductive additives interface becomes. In some designs, the reduction in binder modulus by over about 15-20% may result in a noticeable reduction in performance. In an example, the reduction in the binder modulus by about two times (2×) may result in a substantial performance reduction. In a further example, the reduction in modulus by about five or more times (e.g., about 5×-500×) may result in a very significant performance reduction. Therefore, selecting an electrolyte composition that does not induce significant binder swelling may be highly preferential for certain applications. In some examples, it may be preferred to select an electrolyte composition that reduces the binder modulus by less than about 30% (more preferably, by no more than about 10%) when exposed to electrolyte. In anodes which comprise more than one binder composition, in some designs, it may be preferred to select an electrolyte composition where at least one binder does not reduce the modulus by over about 30% (more preferably, by no more than about 10%) when exposed to electrolyte.

In some designs it is advantageous to use binders with functional groups which do not chemically or electrochemically interact with the electrolyte components, such as Li salts, FEC, VC, co-solvents, Li salt additives, and high-temperature (HT, e.g., 40-100° C.) storage additives. The inventors have found that, in some designs, the presence of carboxylate or carboxylic acid groups in the binders may result in excessive capacity degradation (e.g., above about 5%), large volume expansion (e.g., above about 10%) and significant gassing when exposed to high temperatures (e.g., above about 50-90° C.) in a fully charged state (e.g., state-of-charge, SOC, of about 90-100%) for a prolonged time (e.g., about 12-168 hours). It may be advantageous in some such designs to use a greater amount of CEI-forming components in ELY formulations to cut HT outgassing.

One or more embodiments of the present disclosure relate to specific electrolyte compositions that mitigate or overcome some or all of the above-discussed limitations and substantially enhance performance of various types of metal-ion (e.g., Li-ion) cells comprising high-capacity nanocomposite anode materials (for example, materials comprising conversion-type or alloying-type active materials) that may comprise Si in their composition, may experience certain volume changes during cycling (for example, moderately high volume changes (e.g., about 8-about 160 or about 180 vol. %) during the first charge-discharge cycle and moderate volume changes (e.g., about 5-about 50 vol. %) during the subsequent charge-discharge cycles), may exhibit an average particle size in the range from about 0.2 to about 40 microns and a specific surface area in the range from about 0.5 to about 50 m²/g (in some designs, from about 0.5 to about 2 m²/g; in other designs, from about 2 to about 12 m²/g; in yet other designs, from about 12 to about 50 m²/g), may be formulated with such electrodes in moderate (e.g., about 2-about 4 mAh/cm²) and high areal capacity loadings (e.g., about 4-about 12 mAh/cm²) with high packing density (electrode porosity filled with electrolyte in the range from about 5 to about 35 vol. % after the first charge-discharge cycle) and relatively low binder content (e.g., about 0.5-about 14 wt. %), may comprise moderate or small amount of electrolyte per cell capacity (e.g., less than about 4 g/mAh), may be charged to moderately high (e.g., above about 4.1-4.3 V) or high (e.g., above about 4.3-4.4 V) or very high (e.g., above about 4.5-4.8 V) voltages, may be exposed to temperatures above about 40° C. at high state of charge (e.g., SOC of about 70-100%) during testing or operation, may be produced as large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more).

Conventional cathode materials utilized in Li-ion batteries are of an intercalation-type and commonly crystalline and polycrystalline. Such cathodes typically exhibit a highest charging potential of less than about 4.3 V vs. Li/Li⁺, gravimetric capacity of less than about 190 mAh/g (based on the mass of active material) and volumetric capacity of less than about 800 mAh/cm³ (based on the volume of the electrode and not counting the volume occupied by the current collector foil). For given anodes, higher energy density in Li-ion batteries may be achieved either by using high-voltage cathodes (cathodes with a highest charging potential from about 4.3 V vs. Li/Li⁺ to about 5.1 V vs. Li/Li⁺) or by using cathodes comprising so-called conversion-type cathode materials (including, but not limited to, those that comprise F or S in their composition). Some high-voltage intercalation-type cathodes may comprise nickel (Ni). Some high-voltage intercalation-type cathodes may comprise manganese (Mn). Some high-voltage intercalation-type cathodes may comprise titanium (Ti). Some high-voltage intercalation-type cathodes may comprise tantalum (Ta). Some high-voltage intercalation-type cathodes may comprise niobium (Nb). Some high-voltage intercalation-type cathodes may comprise vanadium (V). Some high-voltage intercalation-type cathodes may comprise iron (Fe). Some high-voltage intercalation-type cathodes may comprise cobalt (Co). Some high-voltage intercalation-type cathodes may comprise aluminum (Al). Some high-voltage intercalation-type cathodes may comprise, as a dopant, silicon (Si), tin (Sn), antimony (Sb), or germanium (Ge) or their various combinations. In some designs, high-voltage intercalation-type cathode particles may comprise fluorine (F) as a dopant in their structure or the surface layer. Some high-voltage intercalation-type cathodes may comprise phosphorous (P) as a dopant. Some high-voltage intercalation-type cathodes may comprise sulfur (S) as a dopant. Some high-voltage intercalation-type cathodes may comprise selenium (Se) as a dopant. Some high-voltage intercalation-type cathodes may comprise tellurium (Te) as a dopant. Some high-voltage intercalation-type cathodes may comprise iron (Fe). Some high-voltage intercalation-type cathodes may comprise magnesium (Mg). Some high-voltage intercalation-type cathodes may comprise zirconium (Zr).

Combination of such (or similar) types of higher energy density cathodes with high-capacity (e.g., Si based) anodes may result in high cell-level energy density. Unfortunately, the cycle stability and other performance characteristics of such cells may not be sufficient for some applications, at least when used in combination with conventional electrolytes.

One or more embodiments of the present disclosure are thereby directed to electrolyte compositions that work well for a combination of (i) a subclass of moderate-to-high capacity (e.g., about 140-360 mAh/g per mass of active materials, in some designs), high-voltage intercalation-type cathodes (which may be layered cathodes in some designs; which may comprise Ni or Co or Mn or Ti or V or a combination of some of such and other metals in some designs, such as, for example, LCO (lithium cobalt oxides), NCA (lithium nickel cobalt aluminum oxides), NCMA (lithium nickel cobalt manganese aluminum oxides), LNO (lithium nickel oxides), layered or spinel lithium manganese oxides (LMO), high voltage spinels such as lithium nickel manganese oxides (LMNO), lithium nickel manganese cobalt oxides (NCM), lithium cobalt aluminum oxides (LCAO), lithium iron phosphate (LFP), LNP (lithium nickel phosphate), lithium manganese phosphate (LMP), lithium iron manganese phosphate (LMFP), lithium cobalt phosphate (LCP), various disordered rocksalt cathodes (DRS) such as lithium manganese titanium oxides (LMTO) or oxyfluorides (LMTOF) or lithium manganese zirconium oxides (LMZO) or oxyfluorides (LMZOF) or lithium vanadium oxides (LVO) or oxyfluorides (LVOF) or lithium molybdenum oxides (LMoO) or oxyfluorides (LMoOF) or other types of DRS oxide and oxyfluoride materials (which may comprise, for example, Li (in case of Li- or Li-ion batteries; or Na in case of Na- and Na-ion batteries) and one, two, three or more of the following metals: Mn, V, Ti, Mo, Ni, Fe, Cu, Nb, Y, Hf, Zr, W, Ta, Mg), which are charged to above about 4.1 V vs. Li/Li⁺ during full cell battery cycling (in some designs, above about 4.2 V vs. Li/Li⁺; in other designs, above 4.3 V vs. Li/Li⁺; in yet other designs, above about 4.4 V vs. Li/Li; in yet other designs, above about 4.5 V vs. Li/Li⁺; in yet other designs, above about 4.6 V vs. Li/Li⁺) with (ii) a subclass of high-capacity moderate volume changing anodes: anodes comprising about 5-about 100 wt. % of (nano)composite anode powders relative to all active material-comprising particles, which exhibit moderately high volume changes (e.g., about 8-about 160 or about 180 vol. %) during the first charge-discharge cycle, moderate volume changes (e.g., about 5-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only). In at least one embodiment, a particular electrolyte composition may be selected based on the value of the highest cathode charge potential or the cathode elemental composition or the highest operating temperature or the longest calendar life requirement.

In one or more embodiments of the present disclosure, a preferred battery cell may include a lithium cobalt oxide (LCO), lithium nickel cobalt manganese oxide (NCM), lithium nickel cobalt aluminum oxide (NCA), lithium nickel cobalt manganese aluminum oxide (NCMA), lithium nickel oxide (NCO), layered or spinel lithium manganese oxides (LMO), high voltage spinels such as lithium nickel manganese oxides (LMNO), lithium cobalt aluminum oxides (LCAO), LNP (lithium nickel phosphate), lithium manganese phosphate (LMP), lithium iron manganese phosphate (LMFP), lithium cobalt phosphate (LCP), various disordered rocksalt cathodes (DRS) such as lithium manganese titanium oxides (LMTO) or oxyfluorides (LMTOF) or lithium manganese zirconium oxides (LMZO) or oxyfluorides (LMZOF) or lithium vanadium oxides (LVO) or oxyfluorides (LVOF) or lithium molybdenum oxides (LMoO) or oxyfluorides (LMoOF) or other types of DRS oxide and oxyfluoride materials (which may comprise, for example, Li (in case of Li- or Li-ion batteries; or Na in case of Na- and Na-ion batteries) and one, two, three or more of the following metals: Mn, V, Ti, Mo, Ni, Fe, Cu, Nb, Y, Hf, Zr, W, Ta, Mg) as a cathode active material. In some of the preferred examples a surface of the cathode active material (e.g., LCO, NCM, NCA, LMFP, LMO, LMOF, LMTO, LMTOF, etc.) may be coated with one or more layers of ceramic material having a distinctly different composition or microstructure. Illustrative examples of a preferred coating material for a preferred active cathode material may include, but are not limited to, metal oxides that comprise one or more of the following metals: Ti, Al, Mg, Sr, Li, Si, Sn, Sb, Nb, W, Cr, Mo, Hf, Ta, B, Y, La, Ce, Zn, and Zr. Illustrative examples of such oxides may include, but are not limited to, titanium oxide (e.g., TiO₂), aluminum oxide (e.g., Al₂O₃), magnesium oxide (e.g., MgO), silicon oxide (e.g., SiO₂), boron oxide (e.g., B₂O₃), lanthanum oxide (La₂O₃), zirconium oxide (e.g., ZrO₂), tungsten oxide (e.g., WO), and other suitable metal or mixed metal oxides and their various mixtures and alloys. In other preferred examples, the cathode material (e.g., LCO, NCM, NCA, LMFP, LMO, LMOF, LMTO, LMTOF, etc.) may be doped with one or more of Al, Ti, Mg, La, Nb, Mo or other metals described above. In some designs, a preferred cathode current collector may comprise aluminum or an aluminum alloy. In some designs, a preferred battery cell may include a polymer separator, a polymer-ceramic composite separator or a ceramic separator. In some designs, such a separator may be stand-alone or may be integrated into an anode or cathode or both (e.g., as an electrode coating). In some designs, a polymer separator may comprise or be made of polyethylene, polypropylene, aramid, cellulose, or a mixture thereof. In some of the preferred examples a surface of a polymer separator may be coated with a layer of ceramic material. Examples of a preferred coating material for polymer separators may include, but not limited to, titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide. In some designs, a preferred battery cell may include a silicon- and carbon-comprising nanocomposite (e.g., as used herein, a nanocomposite or (nano)composite is at least partially comprised of active material nanomaterials or nanostructures or nanoparticles, irrespective of whether the nanocomposite or (nano)composite itself is a nanomaterial) or silicon (SiOₓ, x≥0) or natural or synthetic graphite or soft carbon or hard carbon or their various mixtures and combinations in its anode composition. In some of the preferred examples, the anode material includes a mixture of silicon- and carbon-comprising nanocomposite (sometimes abbreviated herein as Si—C nanocomposite) and graphite (e.g., the graphite being separate from the C-part of the Si—C nanocomposite). In some implementations, a Si—C nanocomposite comprises composite particles, which may include Si nanoparticles embedded in pores of a porous carbon scaffold particle. Such a porous carbon scaffold particle may comprise (e.g., curved or defective) graphene material and/or graphite material. In some designs, a preferred anode current collector may comprise copper or copper alloy.

In one or more embodiments of the present disclosure, a preferred battery cell may comprise a relatively high areal capacity loading in its electrodes (anodes and cathodes), such as from around 2.0 mAh/cm² to around 12 mAh/cm² (in some implementations, from about 2.0 to about 3.5 mAh/cm²; in other implementations, from about 3.5 to about 4.5 mAh/cm²; in other implementations, from about 4.5 to about 6.5 mAh/cm²; in other implementations, from about 6.5 to about 8 mAh/cm²; in other implementations, from about 8 to about 12 mAh/cm²).

In one or more embodiments of the present disclosure, a preferred anode for a battery cell may comprise a mixture of Si—C nanocomposite (particles) and graphite (particles) as the anode active material particles, a so-called blended anode. In addition to the anode active material particles, an anode may comprise inactive material, such as binder(s) (e.g., polymer binder) and other functional additives (e.g., surfactants, electrically conductive additives). In some implementations, the anode active material particles may be in a range of about 90 wt. % to about 98 wt. % of the anode. For example, the anode active material particles may be about 95.5 wt. % of the anode.

In some designs, a blended anode may comprise from about 7 wt. % of Si—C nanocomposite to about 97 wt. % of the Si—C nanocomposite. While the descriptions below may also describe certain examples of the blended anode formulations expressed as mass (wt. %) of Si—C nanocomposite, it will be appreciated that various aspects of this disclosure may be applicable to blended anode formulations expressed as wt. % of Si in the anode. For example, in some implementations, a blended anode composition of about 7 wt. % of Si—C nanocomposite corresponds to about 3 wt. % of Si in the blended anode. In some implementations, a blended anode composition of about 19 wt. % of Si—C nanocomposite corresponds to about 8 wt. % of Si in the blended anode. In some implementations, a blended anode composition of about 35 wt. % of Si—C nanocomposite may correspond to about 15 wt. % of Si in the blended anode. In some implementations, a blended anode composition of about 50 wt. % of Si—C nanocomposite may correspond to about 21 wt. % of Si in the blended anode. In respective implementations, blended anodes may be obtained in which the mass (weight) of the silicon is in a range of about 3 wt. % to about 30 wt. % of a total mass of the anode. Herein, the term “total mass of the anode” is used to refer to the mass of the anode only, excluding any anode current collector foil, separator, and the binder. The masses of the current collector and the separator are excluded from the mass of the anode even if the current collector and the separator are attached to the anode.

In some designs, a blended anode may comprise Si—C nanocomposite that provides from about 25% of to about 99.5% of the total anode capacity. While the descriptions below may also describe certain examples of the blended anode formulations expressed as mass (wt. %) of Si—C nanocomposite, it will be appreciated that various aspects of this disclosure may be applicable to blended anode formulations attributing a fraction (e.g., %) of the total capacity of the blended anode to the capacity of the Si of the Si—C nanocomposite. For example, in some implementations, about 25% of the total capacity of the blended anode is obtained from the Si—C nanocomposite in a blended anode composition of about 7 wt. % of Si—C nanocomposite. In some other implementations, about 50% of the total capacity of the blended anode is obtained from the Si—C nanocomposite in a blended anode composition of about 19 wt. % of Si—C nanocomposite. In some other implementations, about 70% of the total capacity of the blended anode is obtained from the Si—C nanocomposite in a blended anode composition of about 35 wt. % of Si—C nanocomposite. In some other implementations, about 80% of the total capacity of the blended anode is obtained from the Si—C nanocomposite in a blended anode composition of about 50 wt. % of Si—C nanocomposite.

In some implementations, blended anodes may comprise Si—C nanocomposites (e.g., particles) ranging from about 7 wt. % to about 99 wt. % of the anode and the graphite making up the remainder of the mass (the weight) of the anode active material. In some implementations in which the anode active material is about 95.5 wt. % of the blended anode, the blended anode (including active material and inactive material) may comprise about 7 wt. % of Si—C nanocomposite and about 88.5 wt. % of graphite, about 19 wt. % of Si—C nanocomposite and about 76.5 wt. % of graphite, about 35 wt. % of Si—C nanocomposite and about 60.5 wt. % of graphite, or about 50 wt. % of Si—C nanocomposite and about 45.5 wt. % of graphite (the graphite being separate from the C-part of the Si—C nanocomposite in all cases). In some of the preferred examples in which the anode active material particles are about 90 wt. % or more of the blended anode, the anode active material particles contain a small (e.g., about 1-20 wt. %, preferably about 1-10 wt. %, and even more preferably about 1-5 wt. %) fraction of graphite (the graphite being separate from the C-part of the Si—C nanocomposite).

In some of the illustrative examples in which the anode active material particles are about 90 wt. % of the anode, the anode active material particles may comprise almost entirely of Si—C nanocomposite and are substantially free of graphite (e.g., <about 1 wt. %) (the graphite being separate from the C-part of the Si—C nanocomposite).

In some of the illustrative examples in which the anode active material particles are about 95.5 wt. % of the anode, the anode active material particles may comprise almost entirely of graphite and is substantially free of Si—C nanocomposite (e.g., <about 1 wt. %).

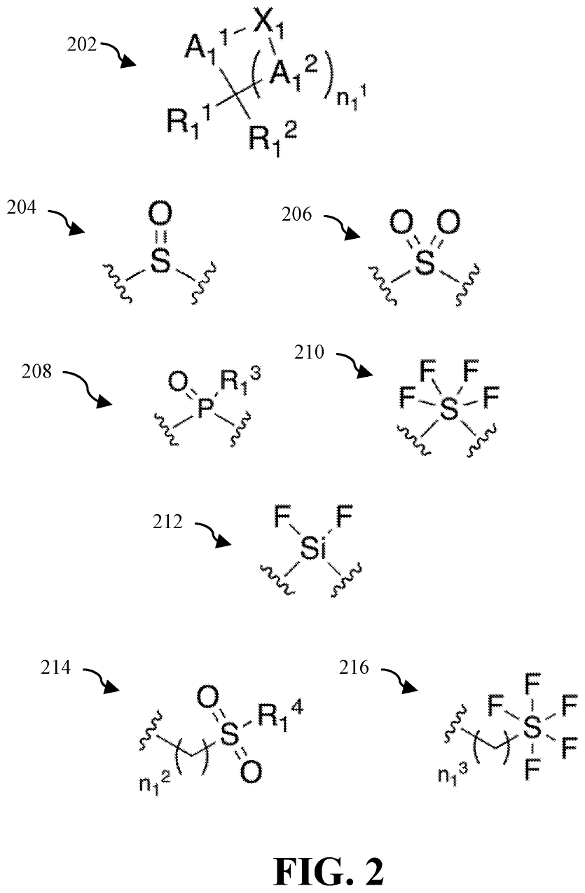

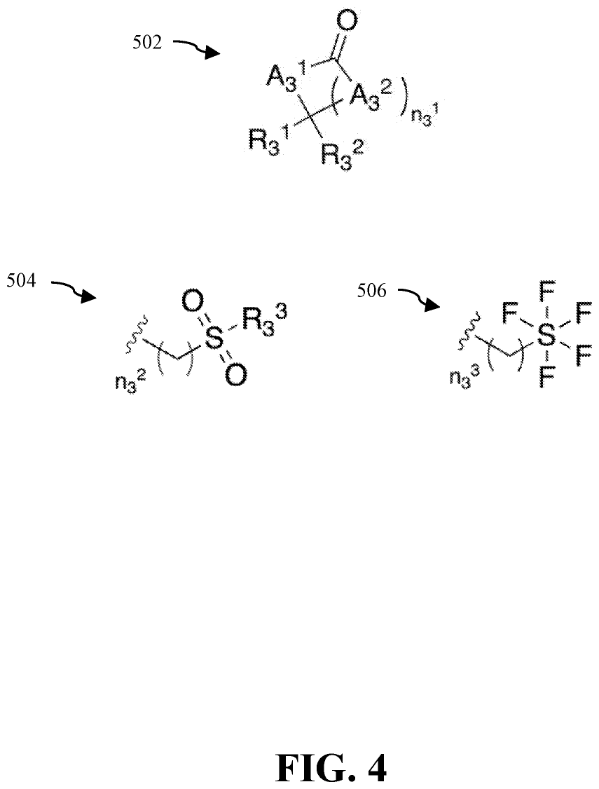

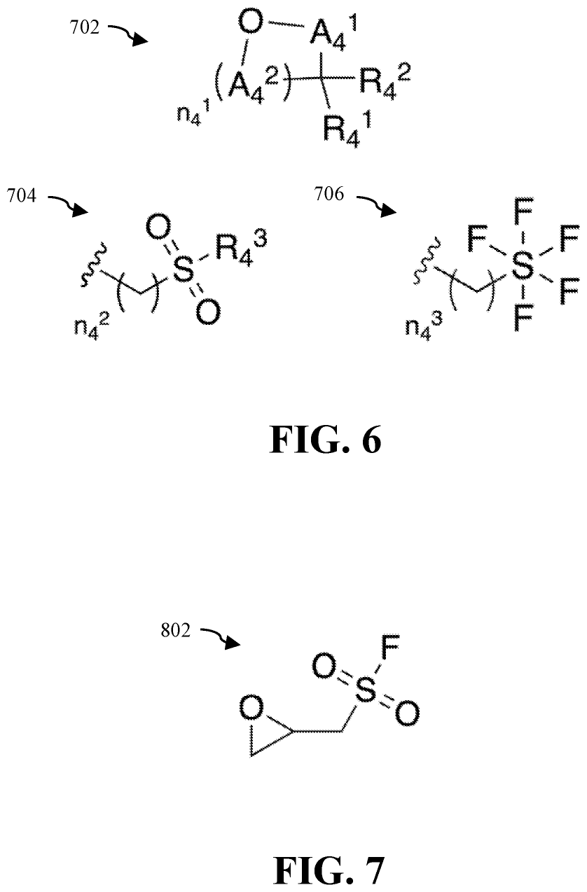

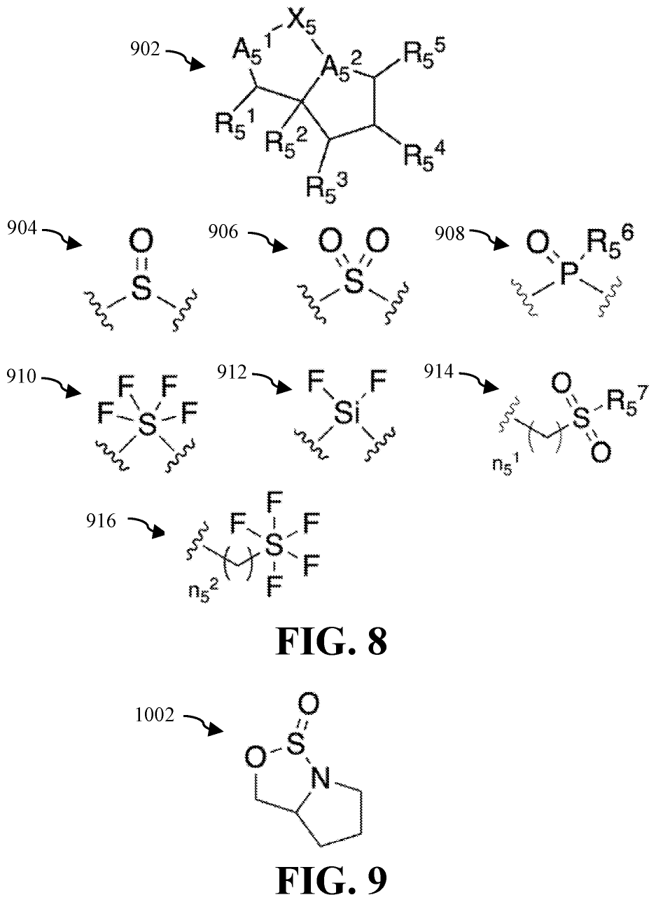

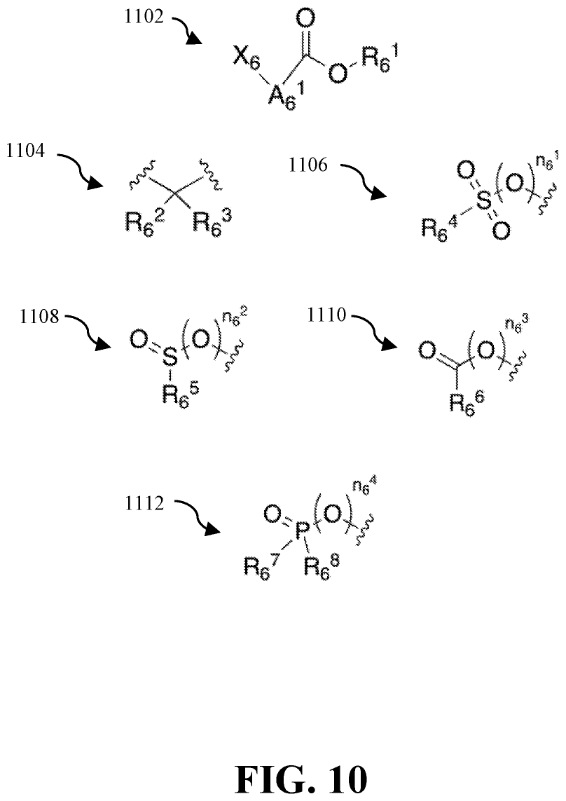

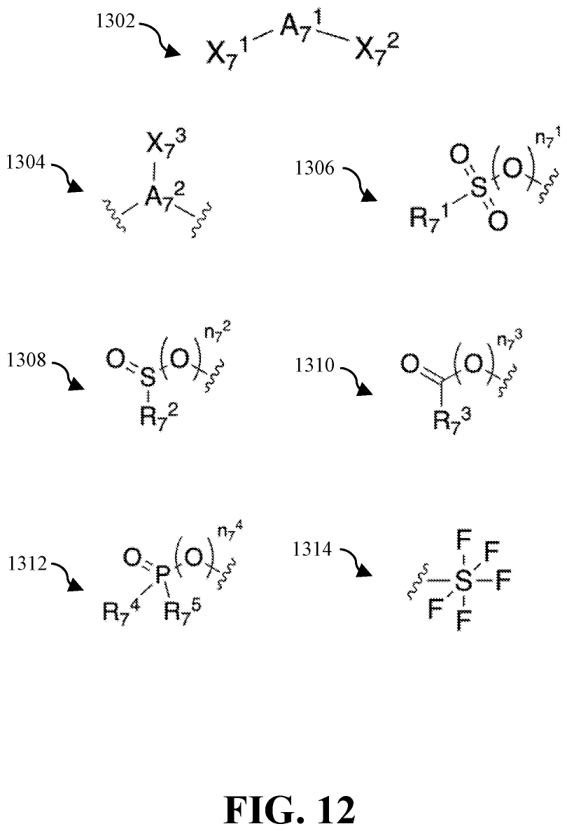

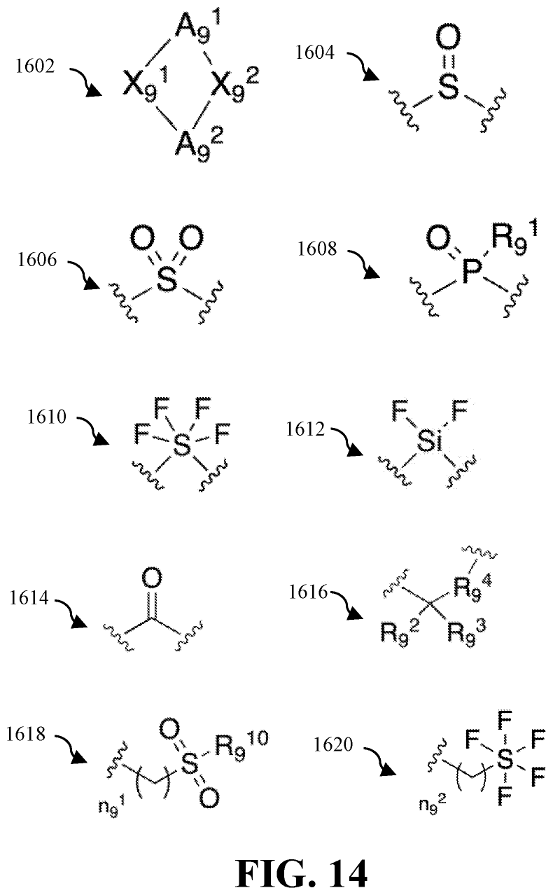

One aspect of the present disclosure is directed to an electrolyte for a lithium-ion battery. In one or more embodiments of the present disclosure, the electrolyte comprises a salt composition (e.g., lithium salt composition) and an electrolyte compound composition. Herein, the term “electrolyte compound composition” is used to refer to compositions comprising covalent (e.g., non-salt) compounds. In some cases, a covalent compound may be an organic compound. In some cases, a covalent compound may be an inorganic compound. In some cases, a covalent compound may function as a solvent (or a co-solvent) to solvate a lithium salt composition or other compounds. In some cases a salt composition is used to refer to ionic compounds. In some cases, ionic compounds are lithium salts. In some cases lithium salts comprise inorganic anions. In some cases lithium salts comprise organic anions. In some implementations, the electrolyte compound composition may include one or more compounds selected from the following: compounds of formula Cyc1 (202 in FIG. 2), compounds of formula Cyc3 (502 in FIG. 4), compounds of formula Cyc4 (702 in FIG. 6), compounds of formula Cyc5 (902 in FIG. 8), compounds of formula Est1 (1102 in FIG. 10), compounds of formula Oth1 (1302 in FIG. 12), and compounds of formula Oth3 (1602 in FIG. 14). Each of these compounds may be used singly, as part of a mixture with at least one other of these compounds, and/or as part of a mixture with compounds not represented by any of the foregoing formulas Cyc1, Cyc3, Cyc4, Cyc5, Est1, Oth1, and Oth3.

In some embodiments, compounds for use in the electrolyte compound composition of an electrolyte for a Li-ion battery may be represented by formula Cyc1 (202 in FIG. 2), wherein (a) X₁ is X₁(1) (204), X₁(2) (206), X₁(3) (208), X₁(4) (210), X₁(5) (212); (b) each of R₁¹ and R₁² is, independently, R₁(1) (214), R₁(2) (216), H, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₁₋₆ alkanediyl nitrile, C₁₋₆ fluoroalkanediyl nitrile, C₆₋₁₇ aryl, C₆₋₁₇ aryloxy, C₆₋₁₇ fluoroaryl, C₆₋₁₇ fluoroaryloxy, or NO₂; (c) each of R₁³ and R₁⁴ is, independently, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₁⁵)(R₁⁶), pyridinyl, or pyrrolidinyl; (d) each of A₁¹ and A₁² is, independently, —C₁₋₄ alkanediyl-, —C₁₋₄ fluoroalkanediyl-, —O—, —O—R₁⁷—, —N(R₁⁸)—, or —N(R₁⁹)—R₁¹⁰—; (e) each of R₁⁵ or R₁⁶, is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl; (f) each of R₁⁸ and R₁⁹ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, C₆₋₁₇ fluoroaryl, C₁₋₆ alkyl sulfonyl, C₁₋₆ fluoroalkyl sulfonyl, C₂₋₁₂ alkyl phosphonyl, or C₂₋₁₂ fluoroalkyl phosphonyl; (g) each of R₁⁷ or R₁¹⁰, is, independently, C₁₋₃ alkanediyl or C₁₋₃ fluoroalkanediyl; and (h) each of n₁¹, n₁² or n₁³ is 0 or 1. In some implementations, (i) a total number of atoms in a cycle of the compound is 6 or less. Herein, these compounds may be referred to as “Cyc1 compounds”.

In some embodiments, compounds for use in the electrolyte compound composition of an electrolyte for a Li-ion battery may be represented by formula Cyc1 (202 in FIG. 2), wherein (a) X₁ is X₁(1) (204); (b) each of R₁¹ and R₁² is, independently, R₁(1) (214), H, F, C₁₋₆ alkyl, C₁₋₆ fluoroalkyl, C₁₋₆ alkoxy, C₁₋₆ fluoroalkoxy, C₁₋₆ alkanediyl nitrile, or C₁₋₆ fluoroalkanediyl nitrile₂; (c) R₁⁴ is, independently, F, C₁₋₆ alkyl, or C₁₋₆ fluoroalkyl; (d) each of A₁¹ and A₁² is, independently, —C₁₋₄ alkanediyl-, —C₁₋₄ fluoroalkanediyl-, —O—, —O—R₁⁷—, —N(R₁⁸)—, or —N(R₁⁹)—R₁¹⁰—; (f) each of R₁⁸ and R₁⁹ is, independently, F, C₁₋₆ alkyl, or C₂₋₁₂ alkyl phosphonyl; (g) each of R₁⁷ or R₁¹⁰ is, independently, C₁₋₃ alkanediyl or C₁₋₃ fluoroalkanediyl; and (h) each of n₁¹, n₁² or n₁³ is 0 or 1. In some implementations, (i) a total number of atoms in a cycle of the compound is 6 or less. Herein, these compounds may be referred to as “Cyc1 compounds”.

Herein, the term “fluoro” when used to characterize substituent groups may refer to the mono-fluorinated, poly-fluorinated, or perfluorinated variants of the respective substituent groups. Herein, the term alkyl phosphonyl refers to —P(═O)(—R)(—R′), wherein each of R and R′ may independently be alkyl or O-alkyl. Herein, the term fluoroalkyl phosphonyl refers to —P(═O)(—R)(—R′), wherein each of R and R′ may independently be fluoroalkyl or O-fluoroalkyl.

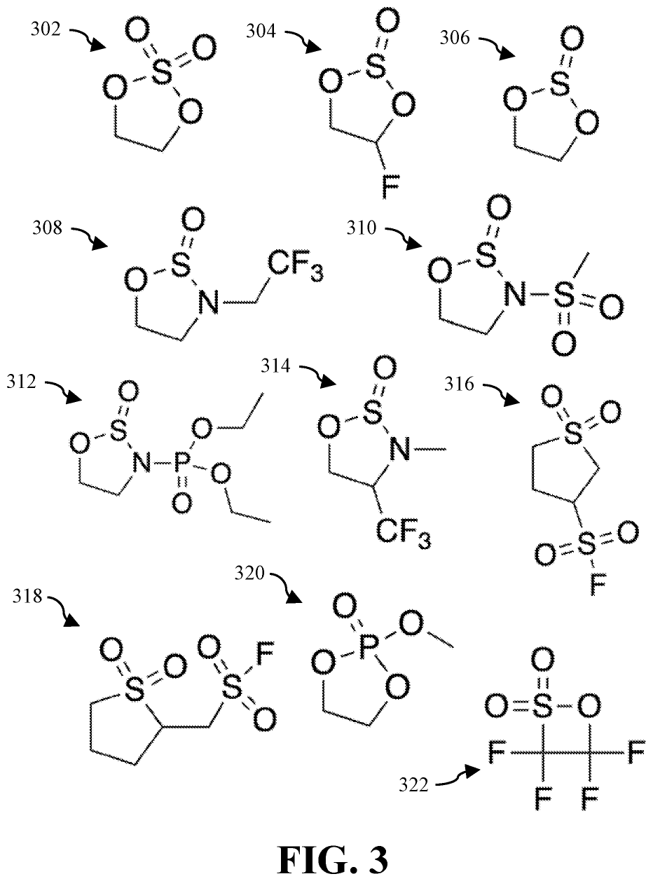

In some implementations, Cyc1 compounds for use in the electrolyte compound composition of an electrolyte for a Li-ion battery may be represented by formula Cyc1 (202 in FIG. 2) and are characterized as follows: X₁ is X₁(2); A₁¹ is —O—; A₁² is —O—R₁⁷—; R₁⁷ is C₁₋₃ alkanediyl; n₁¹ is 1; and each of R₁¹ and R₁² is H. In one example, the compound is 1,3,2-dioxathiolane 2,2-dioxide (DTD) (Compound No. 1, shown as 302 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(1); A₁¹ is —O—; A₁² is —O—R₁⁷—; R₁⁷ is C₁₋₃ alkanediyl; n₁¹ is 1; and R₁¹ is H. In some first implementations, the compounds are further characterized such that R₁² is F. In one example of these first implementations, the compound is fluoroethylene sulfite (Compound No. 2, shown as 304 in FIG. 3). In some second implementations, the compounds are further characterized such that each of R₁¹ and R₁² is H. In one example of these second implementations, the compound is ethylene sulfite (ESi) (Compound No. 3, shown as 306 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(1); A₁¹ is —O—; A₁² is —N(R₁⁹)—R₁¹⁰—; n₁¹ is 1; each of R₁¹ and R₁² is H, and R₁¹⁰ is C₁₋₃ alkanediyl. In some first implementations, the compounds are further characterized such that R₁⁹ is C₁₋₆ fluoroalkyl. In one example of these first implementations, the compound is 3-(2,2,2-trifluoroethyl)-1,2,3-oxathiazolidine 2-oxide (Compound No. 4, shown as 308 in FIG. 3). In some implementations, Cyc1 compounds for use in the electrolyte compound composition of an electrolyte for a Li-ion battery may be represented by formula Cyc1 (202 in FIG. 2) and are characterized as follows: X₁ is X₁(1); A₁¹ is —O—; A₁² is —N(R₁⁹)—R₁¹⁰—; n₁¹ is 1; each of R₁¹ and R₁² is H, and R₁¹⁰ is C₁₋₃ alkanediyl. In some second implementations, the compounds are further characterized such that R₁⁹ is C₁₋₆ alkyl sulfonyl. In one example of these second implementations, the compound is 3-(methylsulfonyl)-1,2,3-oxathiazolidine 2-oxide (Compound No. 5, shown as 310 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(1); A₁¹ is —O—; A₁² is —N(R₁⁹)—R₁¹⁰—; n₁¹ is 1; each of R₁¹ and R₁² is H, and R₁¹⁰ is C₁₋₃ alkanediyl. In some third implementations, the compounds are further characterized such that R₁⁹ is C₂₋₁₂ alkyl phosphonyl. In one example of these third implementations, the compound is diethyl (2-oxido-1,2,3-oxathiazolidin-3-yl)phosphonate (Compound No. 6, shown as 312 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(1); A₁¹ is —N(R₁⁸)—; A₁² is —O—R₁⁷—; n₁¹ is 1; R₁¹ is H; R₁² is C₁₋₆ fluoroalkyl; R₁⁷ is C₁₋₃ alkanediyl; and R₁⁸ is C₁₋₆ alkyl. In one example of these implementations, the compound is 3-methyl-4-(trifluoromethyl)-1,2,3-oxathiazolidine 2-oxide (Compound No. 7, shown as 314 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(2); A₁¹ is a —C₁₋₄ alkanediyl-; A₁² is another —C₁₋₄ alkanediyl-; n₁¹ is 1; R₁¹ is H; R₁² is R₁(1); n₁² is 0; and R₁⁴ is F. In one example of these implementations, the compound is tetrahydrothiophene-3-sulfonyl fluoride 1,1-dioxide (Compound No. 8, shown as 316 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(2); n₁¹ is 0; A₁¹ is —C₁₋₄ alkanediyl-; R₁¹ is H; R₁² is R₁(1); n₁² is 1; and R₁⁴ is F. In one example of these implementations, the compound is (1,1-dioxidotetrahydrothiophen-2-yl)methanesulfonyl fluoride (Compound No. 9, shown as 318 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(3); R₁³ is C₁₋₆ alkoxy; A₁¹ is a —O—; A₁² is a —O—R₁⁷; n₁¹ is 1; R₁⁷ is C₁₋₃ alkanediyl; and each of R₁¹ and R₁² is H. In one example of these implementations, the compound is 2-methoxy-1,3,2-dioxaphospholane 2-oxide (Compound No. 10, shown as 320 in FIG. 3).

In some implementations, Cyc1 compounds for use in the electrolyte compound composition of an electrolyte for a Li-ion battery may be represented by formula Cyc1 (202 in FIG. 2) and are characterized as follows: X₁ is X₁(2); A₁¹ is —C₁₋₄ fluoroalkanediyl-; A₁² is —O—; n₁¹ is 1; and each of R₁¹ and R₁² is F. In one example of these implementations, the compound is perfluoro-1,2-oxathietane 2,2-dioxide (Compound No. 11, shown as 322 in FIG. 3).

In some embodiments, compounds for use in the electrolyte compound composition of an electrolyte for a Li-ion battery may be represented by formula Cyc3 (502 in FIG. 4), wherein (a) each of R₃¹ and R₃² is, independently, R₃(1) (504), R₃(2) (506), H, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, nitrile, C₁₋₆ alkanediyl nitrile, C₁₋₆ fluoroalkanediyl nitrile, C₆₋₁₇ aryl, C₆₋₁₇ aryloxy, C₆₋₁₇ fluoroaryl, C₆₋₁₇ fluoroaryloxy, or NO₂; (b) each of A₃¹ and A₃² is, independently, —C₁₋₄ alkanediyl-, —C₁₋₄ fluoroalkanediyl-, —O—, —O—R₃⁴—, —N(R₃⁵)—, or —N(R₃⁶)—R₃⁷—; (c) R₃³ is F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₃⁸)(R₃⁹), pyridinyl, or pyrrolidinyl; (d) each of R₃⁴ and R₃⁷ is, independently, C₁₋₃ alkanediyl or C₁₋₃ fluoroalkanediyl; (e) each of R₃⁵ and R₃⁶ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, C₆₋₁₇ fluoroaryl, C₁₋₆ alkyl sulfonyl, C₁₋₆ fluoroalkyl sulfonyl, C₂₋₁₂ alkyl phosphonyl, or C₂₋₁₂ fluoroalkyl phosphonyl; (f) each of R₃⁸ and R₃⁹ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl; and (g) each of n₃¹, n₃², and n₃³ is, independently, 0 or 1. In some implementations, (h) a total number of atoms in a cycle of the compound is 6 or less. Herein, these compounds may be referred to as “Cyc3 compounds”.

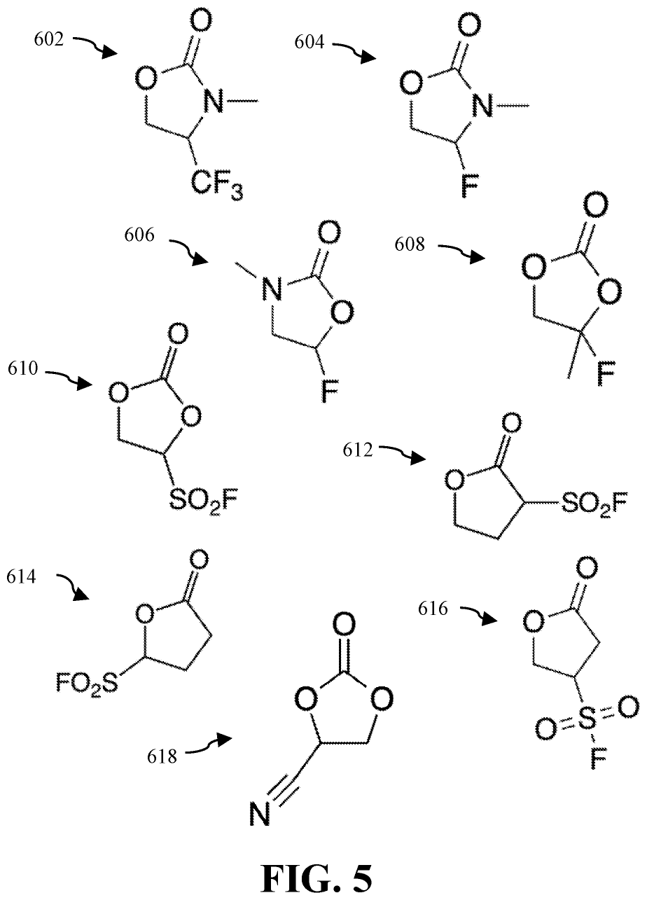

In some implementations, Cyc3 compounds for use in the electrolyte compound composition of an electrolyte for a Li-ion battery may be represented by formula Cyc3 (502 in FIG. 4) and are characterized as follows: A₃¹ is —O—R₃⁴—; A₃² is —N(R₃⁵)—; R₃⁴ is C₁₋₃ alkanediyl; R₃⁵ is C₁₋₆ alkyl; R₃¹ is H; and n₃¹ is 1. In some first implementations, the compounds are further characterized such that R₃² is C₁₋₃ fluoroalkyl. In one example of these first implementations, the compound is 3-methyl-4-(trifluoromethyl)oxazolidin-2-one (Compound No. 12, shown as 602 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —O—R₃⁴—; A₃² is —N(R₃⁵)—; R₃⁴ is C₁₋₃ alkanediyl; R₃⁵ is C₁₋₆ alkyl; R₃¹ is H; and n₃¹ is 1. In some second implementations, the compounds are further characterized such that R₃² is F. In one example of these second implementations, the compound is 4-fluoro-3-methyloxazolidin-2-one (Compound No. 13, shown as 604 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —N(R₃⁶)—R₃⁷—; A₃² is —O—; R₃⁶ is C₁₋₆ alkyl; R₃⁷ is C₁₋₆ alkanediyl; R₃¹ is H; R₃² is F; and n₃¹ is 1. In one example of these implementations, the compound is 5-fluoro-3-methyloxazolidin-2-one (Compound No. 14, shown as 606 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —O—R₃⁴—; A₃² is —O—; R₃⁴ is C₁₋₃ alkanediyl; R₃¹ is C₁₋₆ alkyl; R₃² is F; and n₃¹ is 1. In one example of these implementations, the compound is 4-fluoro-4-methyl-1,3-dioxolan-2-one (Compound No. 15, shown as 608 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —O—R₃⁴—; A₃² is —O—; R₃⁴ is C₁₋₃ alkanediyl; R₃¹ is H; R₃² is R₃(1); R₃³ is F; n₃¹ is 1; and n₃² is 0. In one example of these implementations, the compound is 2-oxo-1,3-dioxolane-4-sulfonyl fluoride (Compound No. 16, shown as 610 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —O—R₃⁴—; R₃¹ is H; R₃² is R₃(1); R₃³ is F; R₃⁴ is C₁₋₃ alkanediyl; n₃¹ is 0; and n₃² is 0. In one example of these implementations, the compound is 2-oxotetrahydrofuran-3-sulfonyl fluoride (Compound No. 17, shown as 612 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —O—; A₃² is —C₁₋₄ alkanediyl-; R₃¹ is H; R₃² is R₃(1); R₃³ is F; n₃¹ is 1; and n₃² is 0. In one example of these implementations, the compound is 5-oxotetrahydrofuran-2-sulfonyl fluoride (Compound No. 18, shown as 614 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —O—R₃⁴; A₃² is —C₁₋₄ alkanediyl-; R₃¹ is H; R₃² is R₃(1); R₃³ is F; R₃⁴ is —C₁₋₃ alkanediyl-; n₃¹ is 1; and n₃² is 0 or 1. In one example of these implementations, n₃² is 0 and the compound is 5-oxotetrahydrofuran-3-sulfonyl fluoride (GBLSF) (Compound No. 19, shown as 616 in FIG. 5).

In some implementations, Cyc3 compounds for use in the electrolyte compound composition of an electrolyte for a Li-ion battery may be represented by formula Cyc3 (502 in FIG. 4) and are characterized as follows: A₃¹ is —O—; A₃² is —O—R₃⁴; R₃¹ is H; R₃² is nitrile; R₃⁴ is —C₁₋₃ alkanediyl-; and n₃¹ is 1. In one example of these implementations, the compound is 2-oxo-1,3-dioxolane-4-carbonitrile (ECCN) (Compound No. 51, shown as 618 in FIG. 5).

In some embodiments, compounds for use in the electrolyte compound composition of an electrolyte for a Li-ion battery may be represented by formula Cyc4 (702 in FIG. 6), wherein (a) each of R₄¹ and R₄² is, independently, R₄(1) (704), R₄(2) (706), H, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₁₋₆ alkanediyl nitrile, C₁₋₆ fluoroalkanediyl nitrile, C₆₋₁₇ aryl, C₆₋₁₇ aryloxy, C₆₋₁₇ fluoroaryl, C₆₋₁₇ fluoroaryloxy, or —NO₂; (b) each of A₄¹ and A₄² is, independently, —CH₂—, —CHF—, or —CF₂—; (c) R₄³ is F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₄⁴)(R₄⁵), pyridinyl, or pyrrolidinyl; (d) each of R₄⁴ and R₄⁵ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl; and (e) each of n₄¹, n₄², and n₄³ is, independently, 0 or 1. In some implementations, (f) a total number of atoms in a cycle of the compound is 3 or 4. Herein, these compounds may be referred to as “Cyc4 compounds”.

In some embodiments, compounds for use in the electrolyte compound composition of an electrolyte for a Li-ion battery may be represented by formula Cyc4 (702 in FIG. 6), wherein (a) each of R₄¹ and R₄² is, independently, R₄(1) (704), H, F, C₁₋₆ alkyl, or C₁₋₆ fluoroalkyl; (b) each of A₄¹ and A₄² is, independently, —CH₂—, —CHF—, or —CF₂—; (c) R₄³ is F, C₁₋₆ alkyl, or C₁₋₆ fluoroalkyl; (d) each of R₄⁴ and R₄⁵ is, independently, F or C₁₋₆ alkyl; and (e) each of n₄¹, n₄², and n₄³ is, independently, 0 or 1. In some implementations, (f) a total number of atoms in a cycle of the compound is 3 or 4. Herein, these compounds may be referred to as “Cyc4 compounds”.

In some implementations, Cyc4 compounds for use in the electrolyte compound composition of an electrolyte for a Li-ion battery may be represented by formula Cyc4 (702 in FIG. 6) and are characterized as follows: A₄¹ is —CH₂—; R₄¹ is R₄(1); R₄² is H; R₄³ is F; n₄¹ is 0; and n₄² is 0 or 1 (a total number of atoms in a cycle of the compound is 3). In one example of these implementations, n₄² is 1 and the compound is oxiran-2-ylmethanesulfonyl fluoride (OrMSF) (Compound No. 20, shown as 802 in FIG. 7).

In some embodiments, compounds for use in the electrolyte compound composition of an electrolyte for a Li-ion battery may be represented by formula Cyc5 (902 in FIG. 8), wherein (a) X₅ is X₅(1) (904), X₅(2) (906), X₅(3) (908), X₅(4) (910), or X₅(5) (912); (b) each of R₅¹, R₅², R₅³, R₅⁴, and R₅⁵, is, independently, R₅(1) (914), R₅(2) (916), H, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₁₋₆ alkanediyl nitrile, C₁₋₆ fluoroalkanediyl nitrile, C₆₋₁₇ aryl, C₆₋₁₇ aryloxy, C₆₋₁₇ fluoroaryl, C₆₋₁₇ fluoroaryloxy, or NO₂; (c) each of R₅⁶ and R₅⁷ is, independently, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₅⁸)(R₅⁹), pyridinyl, or pyrrolidinyl; (d) A₅¹ is —CH₂—, —CHF—, —CF₂—, —O—, or —N(R₅¹⁰); (e) A₅² is —CH—, —CF—, or —N—; (f) each of R₅⁸ and R₅⁹ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, C₆₋₁₇ fluoroaryl; (g) R₅¹⁰ is F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, C₆₋₁₇ fluoroaryl, C₁₋₆ alkyl sulfonyl, C₁₋₆ fluoroalkyl sulfonyl, C₂₋₁₂ alkyl phosphonyl, or C₂₋₁₂ fluoroalkyl phosphonyl; and (h) each of n₅¹ and n₅² is, independently, 0 or 1. Herein, these compounds may be referred to as “Cyc5 compounds”.

In some implementations, Cyc5 compounds for use in the electrolyte compound composition of an electrolyte for a Li-ion battery may be represented by formula Cyc5 (902 in FIG. 8) and are characterized as follows: X₅ is X₅(1); A₅¹ is —O—; A₅² is —N—; and each of R₅¹, R₅², R₅³, R₅⁴, and R₅⁵, is H. In one example of these implementations, the compound is tetrahydro-3H-pyrrolo[1,2-c][1,2,3]oxathiazole 1-oxide (Compound No. 21, shown as 1002 in FIG. 9).

In some embodiments, compounds for use in the electrolyte compound composition of an electrolyte for a Li-ion battery may be represented by formula Est1 (1102 in FIG. 10), wherein (a) R₆¹ is C₁₋₆ alkyl, C₁₋₆ fluoroalkyl, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ fluoroaryl, C₁₋₆ alkanediyl nitrile, C₁₋₆ fluoroalkanediyl nitrile, tri(C₁₋₆ alkyl)silyl, or tri(C₁₋₆ fluoroalkyl)silyl; (b) A₆¹ is A₆(1) (1104), C₁₋₆ alkanediyl, C₁₋₆ fluoroalkanediyl, C₂₋₆ alkenediyl, C₂₋₆ fluoroalkenediyl, C₂₋₆ alkynediyl, C₂₋₆ fluoroalkynediyl, C₃₋₆ cycloalkanediyl, C₃₋₆ fluorocycloalkanediyl, C₆₋₁₇ arylene, C₆₋₁₇ arylene-oxy, C₆₋₁₇ fluoroarylene, or C₆₋₁₇ fluoroarylene-oxy; (c) X₆ is X₆(1) (1106), X₆(2) (1108), X₆(3) (1110), X₆(4) (1112), or NO₂; (d) each of R₆² and R₆³ is, independently, H, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, C₁₋₆ alkanediyl nitrile, C₁₋₆ fluoroalkanediyl nitrile, or NO₂; (e) each of R₆⁴, R₆⁵, R₆⁶, R₆⁷, and R₆⁸ is, independently, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₆⁹)(R₆¹⁰), pyridinyl, or pyrrolidinyl; (f) each of R₆⁹ and R₆¹⁰ is F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl; and (g) each of n₆¹, n₆², n₆³, and n₆⁴ is, independently, 0 or 1. Herein, these compounds may be referred to as “Est1 compounds”.

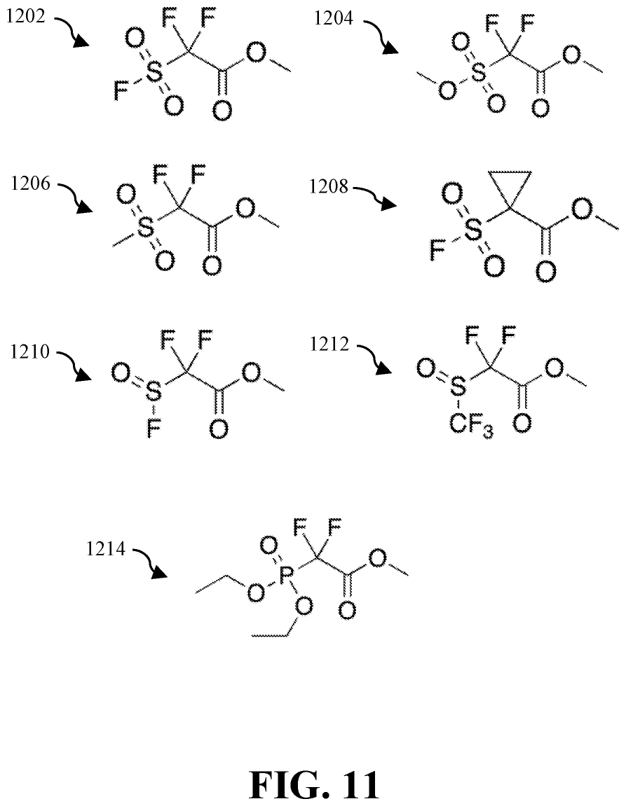

In some implementations, Est1 compounds for use in the electrolyte compound composition of an electrolyte for a Li-ion battery may be represented by formula Est1 (1102 in FIG. 10) and are characterized as follows: R₆¹ is C₁₋₆ alkyl; A₆¹ is A₆(1); each of R₆² and R₆³ is F; X₆ is X₆(1); and n₆¹ is 0 or 1. In some first implementations, the compounds are further characterized such that R₆⁴ is F. In one example of these first implementations, n₆¹ is 0 and the compound is methyl 2,2-difluoro-2-(fluorosulfonyl)acetate (MDFA) (Compound No. 22, shown as 1202 in FIG. 11).

In some implementations, Est1 compounds for use in the electrolyte compound composition of an electrolyte for a Li-ion battery may be represented by formula Est1 (1102 in FIG. 11) and are characterized as follows: R₆¹ is C₁₋₆ alkyl; A₆¹ is A₆(1); each of R₆² and R₆³ is F; X₆ is X₆(1); and n₆¹ is 0. In some second implementations, the compounds are further characterized such that R₆⁴ is C₁₋₆ alkoxy. In one example of these second implementations, the compound is methyl 2,2-difluoro-2-(methoxysulfonyl)acetate (Compound No. 23, shown as 1204 in FIG. 11).

In some implementations, Est1 compounds for use in the electrolyte compound composition of an electrolyte for a Li-ion battery may be represented by formula Est1 (1102 in FIG. 10) and are characterized as follows: R₆¹ is C₁₋₆ alkyl; A₆¹ is A₆(1); each of R₆² and R₆³ is F; X₆ is X₆(1); and n₆¹ is 0. In some third implementations, the compounds are further characterized such that R₆⁴ is C₁₋₆ alkyl. In one example of these third implementations, the compound is methyl 2,2-difluoro-2-(methylsulfonyl)acetate (Compound No. 24, shown as 1206 in FIG. 11).

In some implementations, Est1 compounds for use in the electrolyte compound composition of an electrolyte for a Li-ion battery may be represented by formula Est1 (1102 in FIG. 10) and are characterized as follows: R₆¹ is C₁₋₆ alkyl; A₆¹ is C₃₋₆ cycloalkanediyl; X₆ is X₆(1); n₆¹ is 0; and R₆⁴ is F. In one example of these implementations, the compound is methyl 1-(fluorosulfonyl)cyclopropane-1-carboxylate (Compound No. 25, shown as 1208 in FIG. 11).

In some implementations, Est1 compounds for use in the electrolyte compound composition of an electrolyte for a Li-ion battery may be represented by formula Est1 (1102 in FIG. 10) and are characterized as follows: R₆¹ is C₁₋₆ alkyl; A₆¹ is A₆(1); each of R₆² and R₆³ is F; X₆ is X₆(2); and n₆² is 0. In some first implementations, the compounds are further characterized such that R₆⁵ is F. In one example of these first implementations, the compound is methyl 2,2-difluoro-2-(fluorosulfinyl)acetate (Compound No. 26, shown as 1210 in FIG. 11).

In some implementations, Est1 compounds for use in the electrolyte compound composition of an electrolyte for a Li-ion battery may be represented by formula Est1 (1102 in FIG. 10) and are characterized as follows: R₆¹ is C₁₋₆ alkyl; A₆¹ is A₆(1); each of R₆² and R₆³ is F; X₆ is X₆(2); and n₆² is 0. In some second implementations, the compounds are further characterized such that R₆⁵ is C₁₋₆ fluoroalkyl. In one example of these second implementations, the compound is methyl 2,2-difluoro-2-((trifluoromethyl)sulfinyl)acetate (Compound No. 27, shown as 1212 in FIG. 11).

In some implementations, Est1 compounds for use in the electrolyte compound composition of an electrolyte for a Li-ion battery may be represented by formula Est1 (1102 in FIG. 10) and are characterized as follows: R₆¹ is C₁₋₆ alkyl; A₆¹ is A₆(1); each of R₆² and R₆³ is F; X₆ is X₆(4); n₆⁴ is 0; R₆⁷ is a C₁₋₆ alkoxy; and R₆⁸ is another C₁₋₆ alkoxy. In one example of these implementations, the compound is methyl 2-(diethoxyphosphoryl)-2,2-difluoroacetate (Compound No. 28, shown as 1214 in FIG. 11).

In some embodiments, compounds (i.e., covalently bonded compounds) for use in the electrolyte compound composition of an electrolyte for a Li-ion battery may be represented by formula Oth1 (1302 in FIG. 12), wherein (a) A₇¹ is A₇(1) (1304), —O—, C₁₋₆ alkanediyl, C₁₋₆ fluoroalkanediyl, C₃₋₆ cycloalkanediyl, C₃₋₆ fluorocycloalkanediyl, C₂₋₆ alkenediyl, C₂₋₆ fluoroalkenediyl, C₂₋₆ alkynediyl, C₂₋₆ fluoroalkynediyl, C₆₋₁₇ arylene, C₆₋₁₇ arylene-oxy, C₆₋₁₇ fluoroarylene, or C₆₋₁₇ fluoroarylene-oxy; (b) each of X₇¹, X₇², and X₇³ is, independently, X₇(1) (1306), X₇(2) (1308), X₇(3) (1310), X₇(4) (1312), X₇(5) (1314), H, F, —NO₂, C₁₋₆ alkyl, C₁₋₆ fluoroalkyl, C₁₋₆ alkoxy, C₁₋₆ fluoroalkoxy, C₃₋₆ cycloalkyl, C₃₋₆ fluorocycloalkyl, C₂₋₆ alkenyl, C₂₋₆ fluoroalkenyl, C₂₋₆ alkynyl, C₆₋₁₇ aryl, C₆₋₁₇ aryloxy, C₆₋₁₇ fluoroaryl, C₆₋₁₇ fluoroaryloxy, C₂₋₆ fluoroalkynyl, carbonitrile, C₁₋₆ alkanediyl nitrile, C₁₋₆ fluoroalkanediyl nitrile, tri(C₁₋₆ alkyl)silyl, or tri(C₁₋₆ fluoroalkyl)silyl; (c) A₇ is CH, CF, or N; (d) each of R₇¹, R₇², R₇³, R₇⁴, and R₇⁵ is, independently, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₇⁶)(R₇⁷), pyridinyl, or pyrrolidinyl; (e) each of R₇⁶ and R₇⁷ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl; and (f) each of n₇¹, n₇², n₇³, and n₇⁴ is, independently, 0 or 1. Herein, these covalently bonded compounds may be referred to as “Oth1-Covalent compounds”.

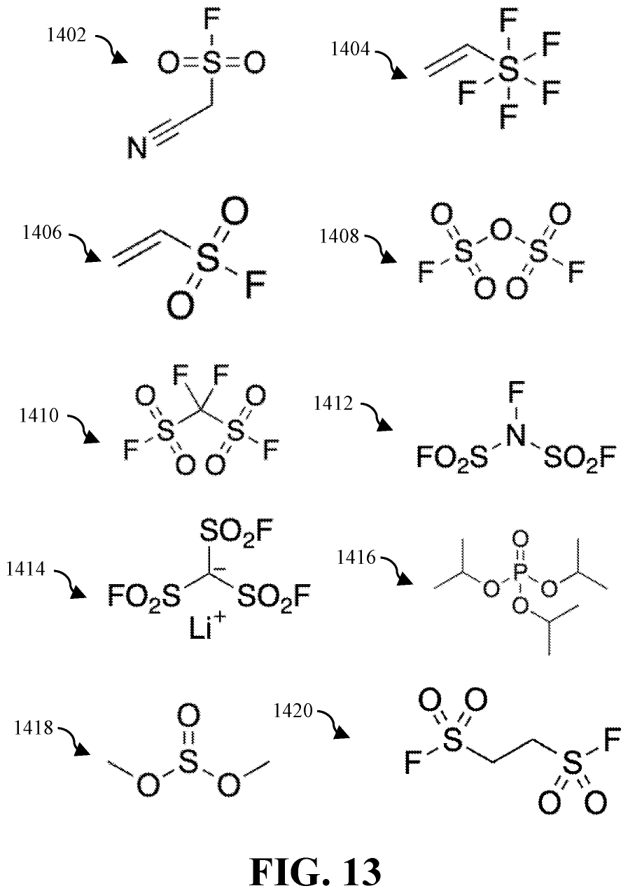

In some implementations, Oth1-Covalent compounds for use in the electrolyte compound composition of an electrolyte for a Li-ion battery may be represented by formula Oth1 (1302 in FIG. 12) and are characterized as follows: A₇¹ is C₁₋₆ alkanediyl; X₇¹ is carbonitrile; X₇² is X₇(1); n₇¹ is 0 or 1; and R₇¹ is F. In one example of these implementations, n₇¹ is 0 and the compound is cyanomethanesulfonyl fluoride (CMSF) (Compound No. 29, shown as 1402 in FIG. 13).

In some implementations, Oth1-Covalent compounds for use in the electrolyte compound composition of an electrolyte for a Li-ion battery may be represented by formula Oth1 (1302 in FIG. 12) and are characterized as follows: A₇¹ is C₂₋₆ alkenediyl; X₇¹ is H; and X₇² is X₇(5). In one example of these implementations, the compound is pentafluoro(vinyl)-λ⁶-sulfane (Compound No. 30, shown as 1404 in FIG. 13).

In some implementations, Oth1-Covalent compounds for use in the electrolyte compound composition of an electrolyte for a Li-ion battery may be represented by formula Oth1 (1302 in FIG. 12) and are characterized as follows: A₇¹ is C₂₋₆ alkenediyl; X₇¹ is H; X₇² is X₇(1); n₇¹ is 0; and R₇¹ is F. In one example of these implementations, the compound is ethenesulfonyl fluoride (ESF) (Compound No. 31, shown as 1406 in FIG. 13).

In some implementations, Oth1-Covalent compounds for use in the electrolyte compound composition of an electrolyte for a Li-ion battery may be represented by formula Oth1 (1302 in FIG. 12) and are characterized as follows: A₇¹ is C₂₋₆ alkenyl; X₇¹ is H; X₇² is X₇(1); n₇¹ is 0 for X₇¹ and X₇²; and R₇¹ is F for X₇¹ and X₇². In one example of these implementations, the compound is fluorosulfonic anhydride (Compound No. 32, shown as 1408 in FIG. 13). In some implementations, Oth1-Covalent compounds for use in the electrolyte compound composition of an electrolyte for a Li-ion battery may be represented by formula Oth1 (1302 in FIG. 12) and are characterized as follows: A₇¹ is A₇(1); A₇² is CF; X₇³ is F; each of X₇¹ and X₇² is X₇(1); n₇¹ is 0 for X₇¹ and X₇²; and R₇¹ is F for X₇¹ and X₇². In one example of these implementations, the compound is difluoromethanedisulfonyl difluoride (Compound No. 33, shown as 1410 in FIG. 13).

In some implementations, Oth1-Covalent compounds for use in the electrolyte compound composition of an electrolyte for a Li-ion battery may be represented by formula Oth1 (1302 in FIG. 12) and are characterized as follows: A₇¹ is A₇(1); A₇² is N; X₇³ is F; each of X₇¹ and X₇² is X₇(1); n₇¹ is 0 for X₇¹ and X₇²; and R₇¹ is F for X₇¹ and X₇². In one example of these implementations, the compound is bis(fluorosulfonyl)fluoroamine (Compound No. 34, shown as 1412 in FIG. 13).

In some implementations, Oth1-Covalent compounds for use in the electrolyte compound composition of an electrolyte for a Li-ion battery may be represented by formula Oth1 (1302 in FIG. 12) and are characterized as follows: A₇¹ is —O—; X₇¹ is X₇(4); R₇⁴ is a first C₁₋₆ alkoxy; R₇⁵ is a second C₁₋₆ alkoxy; n₂⁴ is 0; and X₇² is C₁₋₆ alkyl. In one example of these implementations, the compound is triisopropyl phosphate (TIP) (Compound No. 36, shown as 1416 in FIG. 13).

In some implementations, Oth1-Covalent compounds for use in the electrolyte compound composition of an electrolyte for a Li-ion battery may be represented by formula Oth1 (1302 in FIG. 12) and are characterized as follows: A₇¹ is —O—; X₇¹ is X₇(2); R₇² is a C₁₋₆ alkoxy; n₇² is 0; and X₇² is C₁₋₆ alkyl. In one example of these implementations, the compound is dimethyl sulfite (DMS) (Compound No. 37, shown as 1418 in FIG. 13).

In some implementations, Oth1-Covalent compounds for use in the electrolyte compound composition of an electrolyte for a Li-ion battery may be represented by formula Oth1 (1302 in FIG. 12) and are characterized as follows: A₇¹ is —C₁₋₆ alkanediyl-; each of X₇¹ and X₇² is X₇(1); R₇¹ is a F; each n₇¹ is 0. In one example of these implementations, the compound is ethane-1,2-disulfonyl difluoride (EDSDF) (Compound No. 52, shown as 1420 in FIG. 13).

In some embodiments, compounds for use in the electrolyte compound composition of an electrolyte for a Li-ion battery may be represented by formula Oth3 (1602 in FIG. 14), wherein (a) each of X₉¹ and X₉² is, independently, X₉(1) (1604), X₉(2) (1606), X₉(3) (1608), X₉(4) (1610), X₉(5) (1612), or X₉(6) (1614); (b) each of A₉¹ and A₉² is, independently, A₉(1) (1616), C₁₋₆ alkanediyl, C₁₋₆ fluoroalkanediyl, C₃₋₆ cycloalkanediyl, C₃₋₆ fluorocycloalkanediyl, C₂₋₆ alkenediyl, C₂₋₆ fluoroalkenediyl, C₂₋₆ alkynediyl, C₂₋₆ fluoroalkynediyl, —O—, —O—R₉⁵—, —O—R₉⁶—O—, —N(R₉⁷)—, or —N(R₉⁸)—R₉⁹—; (c) each of R₉² and R₉³ is, independently, R₉(1) (1618), R₉(2) (1620), H, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, C₁₋₆ alkanediyl nitrile, C₁₋₆ fluoroalkanediyl nitrile, or NO₂; (d) each of R₉¹ and R₉¹⁰ is, independently, F, C₁₋₆ alkyl, C₁₋₆ fluoroalkyl, C₁₋₆ alkoxy, C₁₋₆ fluoroalkoxy, C₂₋₆ alkenyl, C₂₋₆ fluoroalkenyl, C₂₋₆ alkynyl, C₂₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₉¹¹)(R₉¹²), pyridinyl, or pyrrolidinyl; (e) each of R₉⁴, R₉⁵, R₉⁶, and R₉⁹ is, independently, C₁₋₄ alkanediyl, or C₁₋₄ fluoroalkanediyl; (f) each of R₉⁷ and R₉⁸ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, C₆₋₁₇ fluoroaryl, C₁₋₆ alkyl sulfonyl, C₁₋₆ fluoroalkyl sulfonyl, C₂₋₁₂ alkyl phosphonyl, or C₂₋₁₂ fluoroalkyl phosphonyl; and (g) each of R₉¹¹ and R₉¹² is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl. In some implementations, (h) a total number of atoms in a cycle of the compound is 6 or less. Herein, these compounds may be referred to as “Oth3 compounds”.

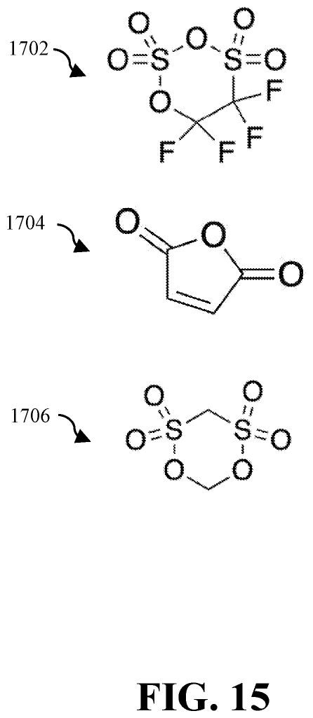

In some implementations, Oth3 compounds for use in the electrolyte compound composition of an electrolyte for a Li-ion battery may be represented by formula Oth3 (1602 in FIG. 14) and are characterized as follows: each of X₉¹ and X₉² is X₉(2); A₉¹ is —O—; A₉² is —O—R₉⁵—; and R₉⁵ is C₁₋₄ fluoroalkanediyl. In one example of these implementations, the compound is perfluoro-1,3,2,4-dioxadithiane 2,2,4,4-tetraoxide (Compound No. 38, shown as 1702 in FIG. 15).

In some implementations, Oth3 compounds for use in the electrolyte compound composition of an electrolyte for a Li-ion battery may be represented by formula Oth3 (1602 in FIG. 14) and are characterized as follows: each of X₉¹ and R₉² is X₉(6); A₉¹ is —O—; and A₉² is C₂₋₆ alkenediyl. In one example of these implementations, the compound is maleic anhydride (MAn) (Compound No. 39, shown as 1704 in FIG. 15).

In some implementations, Oth3 compounds for use in the electrolyte compound composition of an electrolyte for a Li-ion battery may be represented by formula Oth3 (1602 in FIG. 14) and are characterized as follows: each of X₉¹ and R₉² is X₉(2); A₉¹ is C₁₋₆ alkanediyl; A₉² is —O—R₉⁶—O—; and R₉⁶ is C₁₋₄ alkanediyl. In one example of these implementations, the compound is 1,5,2,4-dioxadithiane 2,2,4,4-tetraoxide (Compound No. 40, shown as 1706 in FIG. 15).

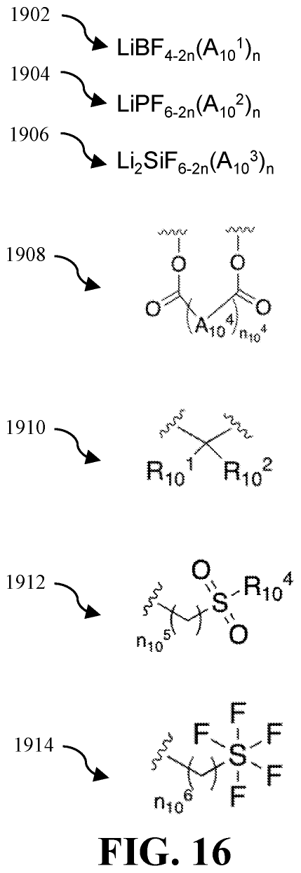

Embodiments of the present disclosure are directed to an electrolyte comprising a lithium salt composition. In some implementations, the lithium salt composition may include LiPF₆ as a primary salt. In some implementations, the lithium salt composition may include other salts, such as the salts as described herein. In some implementations, the lithium salt composition may include LiPF₆ and other salts, such as the salts as described herein. In some implementations, a lithium salt composition may comprise one or more compounds selected from the following: compounds of formula Salt1 (1902 in FIG. 16), compounds of formula Salt2 (1904 in FIG. 16), compounds of formula Salt3 (1906 in FIG. 16), and salt compounds of formula Oth1 (1302 in FIG. 12). Each of these compounds may be used singly, as part of a mixture with at least one other of these compounds, and/or as part of a mixture with compounds not represented by any of the foregoing formulas Salt1, Salt2, Salt3, and Oth1.

In some embodiments, compounds for use in the lithium salt composition of an electrolyte for a Li-ion battery may be represented by formula Salt1 (1902 in FIG. 16), Salt2 (1904), or Salt3 (1906), wherein (a) n is 1 or 2 if the formula is Salt1; (b) n is 1, 2 or 3 if the formula is Salt2 or Salt3; (c) A₁₀¹, A₁₀², or A₁₀³ is A₁₀(1) (1908); (d) A₁₀⁴ is A₁₀(2) (1910), —O—, or —N(R₁₀³)—, C₃₋₆ cycloalkanediyl, or C₃₋₆ fluorocycloalkanediyl; (e) each of R₁₀¹ and R₁₀² is, independently, R₁₀(1), R₁₀(2), H, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, C₁₋₆ alkanediyl nitrile, C₁₋₆ fluoroalkanediyl nitrile, or NO₂; (f) R₁₀⁴ is F, C₁₋₆ alkyl, C₁₋₆ fluoroalkyl, C₁₋₆ alkoxy, C₁₋₆ fluoroalkoxy, C₂₋₆ alkenyl, C₂₋₆ fluoroalkenyl, C₂₋₆ alkynyl, C₂₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₉⁵)(R₉⁶), pyridinyl, or pyrrolidinyl; (g) R₁₀³ is F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, C₆₋₁₇ fluoroaryl, C₁₋₆ alkyl sulfonyl, C₁₋₆ fluoroalkyl sulfonyl, C₂₋₁₂ alkyl phosphonyl, or C₂₋₁₂ fluoroalkyl phosphonyl; (h) each of R₁₀⁵ and R₁₀⁶ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl; and (i) each of n₁₀⁴, n₁₀⁵, and n₁₀⁶ is, independently, 0 or 1. Herein, the boron-comprising compounds represented by formula Salt1 and as described in the foregoing may be referred to as “Salt1 compounds”. Herein, the phosphorus-comprising compounds represented by formula Salt2 and as described in the foregoing may be referred to as “Salt2 compounds”. Herein, the silicon-comprising compounds represented by formula Salt3 and as described in the foregoing may be referred to as “Salt3 compounds”.

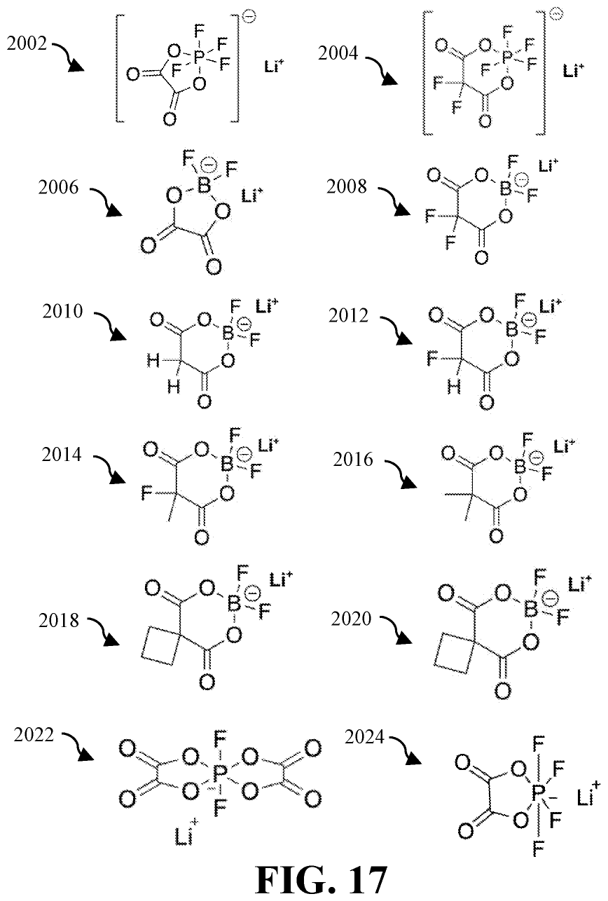

In some implementations, Salt2 compounds for use in the lithium salt composition of an electrolyte for a Li-ion battery may be represented by formula Salt2 (1904 in FIG. 16) and is characterized as follows: n is 1; and n₁₀⁴ is 0. The compound is lithium tetrafluoro(oxalato)phosphate (Compound No. 41, shown as 2002 in FIG. 17).

In some implementations, Salt2 compounds for use in the lithium salt composition of an electrolyte for a Li-ion battery may be represented by formula Salt2 (1904 in FIG. 16) and are characterized as follows: n is 1; n₁₀⁴ is 1; and A₁₀⁴ is A₁₀(2). In one example of these implementations, a compound is further characterized such that each of R₁₀¹ and R₁₀² is F and the compound is lithium tetrafluoro(2,2-difluoromalonato)phosphate (Compound No. 42, shown as 2004 in FIG. 17).

In some implementations, a Salt2 compound for use in the lithium salt composition of an electrolyte for a Li-ion battery may be represented by formula Salt2 (1904 in FIG. 16) and is characterized as follows: n is 2; A₁₀² is A₁₀(1); A₁₀⁴ is A₁₀(2); each of R₁₀¹ and R₁₀² is H; and n₁₀⁴ is 0. In one example of these implementations, the compound is lithium difluoro(bisoxalato) phosphate (Compound No. 53), shown as 2022 in FIG. 17).

In some implementations, a Salt1 compound for use in the lithium salt composition of an electrolyte for a Li-ion battery may be represented by formula Salt1 (1902 in FIG. 16) and is characterized as follows: n is 1; and n₁₀⁴ is 0. The compound is lithium difluoro(oxalato)borate (LiDFOB) (Compound No. 43, shown as 2006 in FIG. 17).

In some implementations, Salt1 compounds for use in the lithium salt composition of an electrolyte for a Li-ion battery may be represented by formula Salt1 (1902 in FIG. 16) and are characterized as follows: n is 1; n₁₀⁴ is 1; and A₁₀⁴ is A₁₀(2). In a first example of these implementations, a compound is further characterized as follows: each of R₁₀¹ and R₁₀² is F, and the compound is lithium difluoro(2,2-difluoromalonato)borate (Compound No. 44, shown as 2008 in FIG. 17). In a second example of these implementations, a compound is further characterized as follows: each of R₁₀¹ and R₁₀² is H, and the compound is lithium difluoro(malonato)borate (Compound No. 45, shown as 2010 in FIG. 17). In a third example of these implementations, a compound is further characterized as follows: R₁₀¹ is F; and R₁₀² is H, and the compound is lithium difluoro(2-fluoromalonato)borate (Compound No. 46, shown as 2012 in FIG. 17). In a fourth example of these implementations, a compound is further characterized as follows: R₁₀¹ is F; and R₁₀² is C₁₋₆ alkyl, and the compound is lithium difluoro(2-fluoro-2-methylmalonato)borate (Compound No. 47, shown as 2014 in FIG. 17). In some fifth implementations, compounds are further characterized as follows: R₁₀¹ is a C₁₋₆ alkyl; and R₁₀² is another C₁₋₆ alkyl. In one example of these fifth implementations, the compound is lithium difluoro(2,2-dimethylmalonato)borate (Compound No. 48, shown as 2016 in FIG. 17).

In some implementations, Salt1 compounds for use in the lithium salt composition of an electrolyte for a Li-ion battery may be represented by formula Salt1 (1902 in FIG. 16) and are characterized as follows: n is 1; n₁₀⁴ is 1; and A₁₀⁴ is C₃₋₆ cycloalkanediyl. In a first example of these implementations, the compound is 6,6-difluoro-4,8-dioxo-5,7-dioxa-6-boraspiro[2.5]octan-6-uide lithium salt (Compound No. 49, shown as 2018 in FIG. 17). In a second example of these implementations, the compound is 7,7-difluoro-5,9-dioxo-6,8-dioxa-7-boraspiro[3.5]nonan-7-uide lithium salt (Compound No. 50, shown as 2020 in FIG. 17).

In some implementations, a Salt2 compound for use in the lithium salt composition of an electrolyte for a Li-ion battery may be represented by formula Salt2 (1904 in FIG. 16) and is characterized as follows: n is 1; A₁₀² is A₁₀(1); A₁₀⁴ is A₁₀(2); each of R₁₀¹ and R₁₀² is H; and n₁₀⁴ is 0. In one example of these implementations, the compound is lithium tetrafluoro(oxalato) phosphate, shown as 2024 in FIG. 17).

In some embodiments of the present disclosure, the fluorine groups of the corresponding compounds represented by Salt1 and Salt2 formulas can be fully or partially replaced by nitrile groups. For example, lithium dicyano(oxalato)borate compounds can be used instead of lithium difluoro(oxalato)borate. In other embodiments, lithium tetracyano(oxalato) phosphate or lithium dicyano(bisoxalato) phosphate can be used. The presence of nitrile (CN) group can confer higher cycle life and reduced HT outgassing.

In some embodiments, compounds (i.e., salt compounds) for use in the lithium salt composition of an electrolyte for a Li-ion battery may be represented by formula Oth1 (1302 in FIG. 12), wherein (a) A₇¹ is A₇(1) (1304), —O—, C₁₋₆ alkanediyl, C₁₋₆ fluoroalkanediyl, C₃₋₆ cycloalkanediyl, C₃₋₆ fluorocycloalkanediyl, C₂₋₆ alkenediyl, C₂₋₆ fluoroalkenediyl, C₂₋₆ alkynediyl, C₂₋₆ fluoroalkynediyl, C₆₋₁₇ arylene, C₆₋₁₇ arylene-oxy, C₆₋₁₇ fluoroarylene, or C₆₋₁₇ fluoroarylene-oxy; (b) each of X₇¹, X₇², and X₇³ is, independently, X₇(1) (1306), X₇(2) (1308), X₇(3) (1310), X₇(4) (1312), X₇(5) (1314), H, F, NO₂, C₁₋₆ alkyl, C₁₋₆ fluoroalkyl, C₁₋₆ alkoxy, C₁₋₆ fluoroalkoxy, C₃₋₆ cycloalkyl, C₃₋₆ fluorocycloalkyl, C₂₋₆ alkenyl, C₂₋₆ fluoroalkenyl, C₂₋₆ alkynyl, C₆₋₁₇ aryl, C₆₋₁₇ aryloxy, C₆₋₁₇ fluoroaryl, C₆₋₁₇ fluoroaryloxy, C₂₋₆ fluoroalkynyl, carbonitrile, C₁₋₆ alkanediyl nitrile, C₁₋₆ fluoroalkanediyl nitrile, tri(C₁₋₆ alkyl)silyl, or tri(C₁₋₆ fluoroalkyl)silyl; (c) A₇² is C⁻Li⁺ or BF⁻Li⁺; (d) each of R₇¹, R₇², R₇³, R₇⁴, and R₇⁵ is, independently, F, C₁₋₆ alkyl, C₁₋₆ fluoroalkyl, C₁₋₆ alkoxy, C₁₋₆ fluoroalkoxy, C₁₋₆ alkenyl, C₁₋₆ fluoroalkenyl, C₁₋₆ alkynyl, C₁₋₆ fluoroalkynyl, C₃₋₆ cycloalkyl, C₃₋₆ fluorocycloalkyl, C₆₋₁₇ aryl, C₆₋₁₇ aryloxy, C₆₋₁₇ fluoroaryl, C₆₋₁₇ fluoroaryloxy, —N(R₇⁶)(R₇⁷), pyridinyl, or pyrrolidinyl; (e) each of R₇⁶ and R₇⁷ is, independently, F, C₁₋₆ alkyl, C₃₋₆ cycloalkyl, C₁₋₆ fluoroalkyl, C₃₋₆ fluorocycloalkyl, C₂₋₆ alkenyl, C₂₋₆ fluoroalkenyl, C₂₋₆ alkynyl, C₂₋₆ fluoroalkynyl, C₆₋₁₇ aryl, or C₆₋₁₇ fluoroaryl; and (f) each of n₇¹, n₇², n₇³, and n₇⁴ is, independently, 0 or 1. Herein, these salt compounds may be referred to as “Oth1-Salt compounds”.

In some implementations, Oth1-Salt compounds for use in the lithium salt composition of an electrolyte for a Li-ion battery may be represented by formula Oth1 (1302 in FIG. 12) and are characterized as follows: A₇¹ is A₇(1); A₇² is CF; X₇³ is F; each of X₇¹ and X₇² is X₇(1); n₇¹ is 0 for X₇¹ and X₇²; and R₇¹ is F for X₇¹ and X₇². In one example of these implementations, the compound is lithium tris(fluorosulfonyl)methanide (Compound No. 35, shown as 1414 in FIG. 13).

Embodiments of the present disclosure are directed to an electrolyte comprising a lithium salt composition. In some implementations, the lithium salt composition may include LiPF₆ as a primary salt. In some implementations, the lithium salt composition may include other salts, such as the salts as described herein. In some implementations, the lithium salt composition may comprise one or more of Salt1 compounds, Salt2 compounds, Salt3 compounds, and Oth1-Salt compounds. For brevity, the Salt1 compounds, the Salt2 compounds, the Salt3 compounds, and the Oth1-Salt compounds may be referred to as selected salt compounds. In some implementations, a lithium salt composition may comprise a mixture of (1) one or more of the selected salt compounds and (2) a primary lithium salt (e.g., LiPF₆). In some implementations, a lithium salt composition may comprise a mixture of (1) one or more of the selected salt compounds and (2) other salts. In some examples, a selected salt compound may be selected from Salt2 compounds. In some examples, the Salt2 compound may be Compound No. 53 (2022). In some examples, a selected salt compound may be selected from Salt1 compounds. In some examples, the Salt1 compound may be Compound No. 43 (2006).

In some implementations, a total concentration of the lithium salt composition in the lithium-ion battery electrolyte is in a range from about 1 mol. % to about 20 mol. %, preferably from about 8 mol. % to about 14 mol. %. In some implementations, a total concentration of the lithium salt composition in the lithium-ion battery electrolyte is in a total range from about 0.1 M to about 2.0 M, often preferably from about 0.8 M to about 1.4 M.

In some implementations, a density of the lithium-ion battery electrolyte is in a range from about 0.8 g/cc to about 2.0 g/cc (e.g., from about 0.8 to about 1.2 g/cc or from about 1.2 g/c to about 1.4 g/cc or from about 1.4 g/cc to about 1.6 g/cc or from about 1.6 g/cc to about 2.0 g/cc), often preferably from about 0.9 g/cc to about 1.4 g/cc. In some designs, lower electrolyte density (e.g., from about 0.8 g/cc to about 1.4 g/cc) was found to correlate with superior performance characteristics. In addition, lower density increases gravimetric energy density characteristics of a battery cell. As such, in some designs, it may be preferable to use low density electrolytes.

In some implementations, it may be advantageous to use electrolytes that exhibit relatively low melting point (e.g., from about minus (−) 120° C. to about −10° C.; in some designs, from about −120 to about −80° C.; in other designs, from about −80° C. to about −50° C.; in other designs, from about −50° C. to about −10° C.). Low melting points were found to enable superior battery cell characteristics (e.g., better cycle stability or better rate performance), in some designs, even if the cells are tested at around room temperature.

In some designs, it may be advantageous to use an increased (from e.g., about 0.8 M-1.0 M to about 1.1 M-1.4 M or even to about 1.4 M-2.0 M) total lithium salt concentration to improve the operation of electrolyte under the fast charge conditions, such as from 3 C to 6 C charge rate. In some designs, it may be advantageous to use an increased total lithium salt concentration to improve the operation of electrolyte at low temperatures, such as from about −30° C. to about +10° C., which may be beneficial for some applications. Such improved rate performance may be related to the reduced anode and cathode charge transfer resistance despite low electrolyte conductivity. In some designs, it may be advantageous to use an increased total lithium salt concentration to decrease HT outgassing. Such improved outcome of the HT storage test may be related to the formation of an LiF-containing protective layer on the surface of the cathode, which may impede other chemicals from the oxidative decomposition, or to the increase in the concentration of ion pairs in the electrolyte solution, which may facilitate formation of LiF in the CEI. In some designs, an increased total lithium salt concentration may lead to poor cycle life at room temperature. Such reduced cycle life stability characteristics may be related to reduced mobility of Li cations in the electrolyte and faster loss of cyclable lithium ion inventory in some designs and, in some designs, the formation of an SEI with poor stability. Higher total lithium salt concentration may also lead to increased electrolyte density and cost in some designs, which may be undesirable for some applications. Higher Li salt concentration may also undesirably lead to higher diffusion resistance in the anode and cathode coatings. Total lithium salt concentrations in the electrolyte that are too low (e.g., lower than about 0.8 M or about 8 mol. %) may lead to excessive HT outgassing, reduced ELY conductivity, and increased charge transfer resistance in some designs (e.g., when high-capacity anode materials are used), particularly when high areal capacity electrodes are used (e.g., above about 4 mAh/cm² and even more so above about 6 mAh/cm²). The optimal total lithium salt concentration may depend on the particular cell design and electrolyte composition and needs to be optimized in order to minimize bulk, diffusion, and charge-transfer resistances, reduce HT outgassing, and minimize cycle life penalty

In one or more embodiments of the present disclosure, a lithium-ion battery electrolyte includes a lithium salt composition and an electrolyte compound composition. In some implementations, the electrolyte compound composition may comprise a Cyc1 compound. In some examples, the Cyc1 compound may be selected from Compound Nos. 1 (302), 2 (304), 3 (306), 4 (308), and 6 (312). In some implementations, the electrolyte compound composition may comprise a Cyc3 compound. In some examples, the Cyc3 compound may be selected from Compound Nos. 17 (612), 19 (616), and 51 (618). In some implementations, the electrolyte compound composition may comprise a Cyc4 compound. In some examples, the Cyc4 compound may be Compound No. 20 (802). In some implementations, the electrolyte compound composition may comprise a Cyc5 compound. In some examples, the Cyc5 compound may be Compound No. 21 (1002). In some implementations, the electrolyte compound composition may comprise an Est1 compound. In some examples, the Est1 compound may be selected from Compound Nos. 22 (1202), 23 (1204), 24 (1206), 25 (1208), 26 (1210), 27 (1212), and 28 (1214). In some examples, the Est1 compound may be Compound No. 22 (1202). In some implementations, the electrolyte compound composition may comprise an Oth1-Covalent compound. In some examples, the Oth1-Covalent compound may be selected from Compound Nos. 29 (1402), 31 (1406), 36 (1416), 37 (1418), and 52 (1420). In some implementations, the electrolyte compound composition may comprise an Oth3 compound. In some examples, the Oth3 compound may be selected from Compound Nos. 38 (1702), 39 (1704), and 40 (1706). For brevity, the Cyc1 compounds, the Cyc3 compounds, the Cyc4 compounds, the Cyc5 compounds, the Est1 compounds, the Oth1-Covalent compounds, and the Oth3 compounds, may be referred to as selected covalent compounds.

In one or more embodiments of the present disclosure, a lithium-ion battery electrolyte includes a lithium salt composition (e.g., such as those described herein) and an electrolyte compound composition. In some implementations, the electrolyte compound composition may comprise one or more selected covalent compounds. In some implementations, the one or more selected covalent compounds may be present in the electrolyte at an additive-level of concentration, e.g., in a range of about 0.1 mol. % to about 5 mol. %. The electrolyte compound composition may additionally comprise fluoroethylene carbonate (FEC). In some implementations, a concentration of the FEC in the electrolyte may be in a range of about 0.1 mol. % to about 40 mol. %, about 0.1 mol. % to about 5 mol. %, about 5 mol. % to about 10 mol. %, about 10 mol. % to about 15 mol. %, about 15 mol. % to about 20 mol. %, about 20 mol. % to about 25 mol. %, about 25 mol. % to about 30 mol. %, about 30 mol. % to about 35 mol. %, or about 35 mol. % to about 40 mol. %. In some implementations, the electrolyte compound composition may additionally include a non-FEC cyclic carbonate. One example of a suitable non-FEC cyclic carbonate is ethylene carbonate (EC). A concentration of the EC in the electrolyte may range between about 0 mol. % and about 50 mol. %, e.g., about 0 mol. % to about 10 mol. %, about 10 mol. % to about 20 mol. %, about 20 mol. % to about 30 mol. %, about 30 mol. % to about 40 mol. %, or about 40 mol. % to about 50 mol. %. In some implementations, the electrolyte compound composition may include VC. The VC may be present in the electrolyte at an additive-level of concentration, e.g., about 5 mol. % or lower. In addition, the electrolyte compound composition may include one or more of the following compounds at an additive-level of concentration (e.g., up to about 5 mol. %) or a co-solvent level of concentration (e.g., up to about 95 mol. %): esters (e.g., ethyl propionate, ethyl isobutyrate, ethyl acetate, propyl propionate, ethyl isovalerate, ethyl trimethylacetate, methyl butyrate), carbonates (e.g., dimethyl carbonate, ethyl methyl carbonate, diethyl carbonate, methyl phenyl carbonate, diphenyl carbonate), ketones (e.g., hexamethyl acetone, pinacolone, methyl isopropyl ketone, diisopropyl ketone, ethyl isopropyl ketone), (fluoro)hydrocarbons (e.g., heptane, hexane, octane, cyclohexane, cycloheptane, fluorobenzenes, fluorotoluenes, fluoroxylenes, fluoroheptanes, fluorooctanes, fluorohexanes, fluoropentanes, benzoyl fluoride), sulfites (e.g., ethyl methyl sulfite, diethyl sulfite, 1,3-propylene sulfite, 1,2-propylene sulfite), sulfones (e.g., sulfolane, dimethyl sulfone, ethyl methyl sulfone, ethyl isopropyl sulfone), phosphates (e.g., triphenyl phosphate), fluorinated ethers (e.g., 1,1,2,2-tetrafluoroethyl 2,2,3,3-tetrafluoropropyl ether), fluorinated amines (e.g., perfluorotriethylamine), nitroalkanes (e.g., nitropropane), and nitriles (e.g., trimethylacetonitrile). In addition, the electrolyte compound composition may include one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB) at a total concentration in the electrolyte of about 10 mol. % or lower.

In one or more embodiments of the present disclosure, a lithium-ion battery electrolyte includes a lithium salt composition (e.g., such as those described herein) and an electrolyte compound composition. In some implementations, the electrolyte compound composition may comprise one or more selected covalent compounds. In some implementations, the one or more selected covalent compounds may be present in the electrolyte at a co-solvent-level of concentration, e.g., in a range of about 5 mol. % to about 95 mol. %, e.g., in a range of about 5 mol. % to about 15 mol. %, in a range of about 15 mol. % to about 25 mol. %, in a range of about 25 mol. % to about 35 mol. %, in a range of about 35 mol. % to about 45 mol. %, in a range of about 45 mol. % to about 55 mol. %, in a range of about 55 mol. % to about 65 mol. %, in a range of about 65 mol. % to about 75 mol. %, in a range of about 75 mol. % to about 85 mol. %, or in a range of about 85 mol. % to about 95 mol. %. The electrolyte compound composition may additionally comprise FEC. In some implementations, a concentration of the FEC in the electrolyte may be in a range of about 0.1 mol. % to about 40 mol. %, e.g., about 0.1 mol. % to about 5 mol. %, about 5 mol. % to about 10 mol. %, about 10 mol. % to about 15 mol. %, about 15 mol. % to about 20 mol. %, about 20 mol. % to about 25 mol. %, about 25 mol. % to about 30 mol. %, about 30 mol. % to about 35 mol. %, or about 35 mol. % to about 40 mol. %. In some implementations, the electrolyte compound composition may additionally include a non-FEC cyclic carbonate. One example of a suitable non-FEC cyclic carbonate is ethylene carbonate (EC). A concentration of the EC in the electrolyte may range between about 0 mol. % and about 50 mol. %, e.g., about 0 mol. % to about 10 mol. %, about 10 mol. % to about 20 mol. %, about 20 mol. % to about 30 mol. %, about 30 mol. % to about 40 mol. %, or about 40 mol. % to about 50 mol. %. In some implementations, the electrolyte compound composition may include VC. The VC may be present in the electrolyte at an additive-level of concentration, e.g., about 5 mol. % or lower. In addition, the electrolyte compound composition may include one or more of the following compounds at an additive-level of concentration (e.g., up to about 5 mol. %) or a co-solvent level of concentration (e.g., up to about 95 mol. %): esters (e.g., ethyl propionate, ethyl isobutyrate, ethyl acetate, methyl acetate, propyl propionate, ethyl isovalerate, ethyl trimethylacetate, methyl butyrate, γ-butyrolactone), carbonates (e.g., dimethyl carbonate, ethyl methyl carbonate, diethyl carbonate, methyl phenyl carbonate, diphenyl carbonate), ketones (e.g., hexamethyl acetone, pinacolone, methyl ethyl ketone, diethyl ketone, methyl isopropyl ketone, diisopropyl ketone, ethyl isopropyl ketone), (fluoro)hydrocarbons (e.g., heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride), sulfites (e.g., ethyl methyl sulfite, diethyl sulfite, 1,3-propylene sulfite, 1,2-propylene sulfite), sulfones (e.g., sulfolane, dimethyl sulfone, ethyl methyl sulfone, ethyl isopropyl sulfone), sulfoxides (e.g., dimethyl sulfoxide, tetrahydrothiophene 1-oxide), phosphates (e.g., trimethyl phosphate, triethyl phosphate, triphenyl phosphate), fluorinated ethers (e.g., 1,1,2,2-tetrafluoroethyl 2,2,3,3-tetrafluoropropyl ether), fluorinated amines (e.g., perfluorotriethylamine), amides (e.g., N,N-dimethylformamide, hexamethylphosphoramide, N-methyl-2-pyrrolidinone, tetramethylurea, N,N′-dimethylpropyleneurea, 1,3-dimethyl-2-imidazolidinone), nitroalkanes (e.g., nitromethane, nitropropane), and nitriles (e.g., acetonitrile, propionitrile, butyronitrile, valeronitrile, hexanenitrile, trimethylacetonitrile). In addition, the electrolyte compound composition may include one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB) at a total concentration in the electrolyte of about 10 mol. % or lower.

In one or more embodiments of the present disclosure, a lithium-ion battery electrolyte includes a lithium salt composition (e.g., such as those described herein) and an electrolyte compound composition. In some implementations, the electrolyte compound composition may comprise one or more selected covalent compounds. In some implementations, each of the one or more selected covalent compounds may be present in the electrolyte at an additive-level of concentration or a co-solvent-level of concentration. A compound that is present in the electrolyte at a co-solvent level of concentration is at a higher concentration than another compound that is present in the electrolyte at an additive-level of concentration. In some cases, one may refer to concentration ranges (molar fraction ranges) of about 0.1 mol. % to about 5 mol. % as an additive-level of concentration, and concentration ranges (molar fraction ranges) of about 5 mol. % to about 95 mol. % (e.g., in a range of about 5 mol. % to about 15 mol. %, in a range of about 15 mol. % to about 25 mol. %, in a range of about 25 mol. % to about 35 mol. %, in a range of about 35 mol. % to about 45 mol. %, in a range of about 45 mol. % to about 55 mol. %, in a range of about 55 mol. % to about 65 mol. %, in a range of about 65 mol. % to about 75 mol. %, in a range of about 75 mol. % to about 85 mol. %, or in a range of about 85 mol. % to about 95 mol. %) as a co-solvent level of concentration. In some implementations, the electrolyte compound composition does not comprise FEC. In some implementations, the electrolyte compound composition may additionally include a non-FEC cyclic carbonate. One example of a suitable non-FEC cyclic carbonate is ethylene carbonate (EC). A concentration of the EC in the electrolyte may range between about 0 mol. % and about 50 mol. %, e.g., about 0 mol. % to about 10 mol. %, about 10 mol. % to about 20 mol. %, about 20 mol. % to about 30 mol. %, about 30 mol. % to about 40 mol. %, or about 40 mol. % to about 50 mol. %. In some implementations, the electrolyte compound composition may include VC. The VC may be present in the electrolyte at an additive-level of concentration, e.g., about 5 mol. % or lower. In addition, the electrolyte compound composition may include one or more of the following compounds at an additive-level of concentration (e.g., up to about 5 mol. %) or a co-solvent level of concentration (e.g., up to about 95 mol. %): esters (e.g., ethyl propionate, ethyl isobutyrate, ethyl acetate, methyl acetate, propyl propionate, ethyl isovalerate, ethyl trimethylacetate, methyl butyrate, γ-butyrolactone), carbonates (e.g., dimethyl carbonate, ethyl methyl carbonate, diethyl carbonate, methyl phenyl carbonate, diphenyl carbonate), ketones (e.g., hexamethyl acetone, pinacolone, methyl ethyl ketone, diethyl ketone, methyl isopropyl ketone, diisopropyl ketone, ethyl isopropyl ketone), (fluoro)hydrocarbons (e.g., heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride), sulfites (e.g., ethyl methyl sulfite, diethyl sulfite, 1,3-propylene sulfite, 1,2-propylene sulfite), sulfones (e.g., sulfolane, dimethyl sulfone, ethyl methyl sulfone, ethyl isopropyl sulfone), sulfoxides (e.g., dimethyl sulfoxide, tetrahydrothiophene 1-oxide), phosphates (e.g., trimethyl phosphate, triethyl phosphate, triphenyl phosphate), fluorinated ethers (e.g., 1,1,2,2-tetrafluoroethyl 2,2,3,3-tetrafluoropropyl ether), fluorinated amines (e.g., perfluorotriethylamine), amides (e.g., N,N-dimethylformamide, hexamethylphosphoramide, N-methyl-2-pyrrolidinone, tetramethylurea, N,N′-dimethylpropyleneurea, 1,3-dimethyl-2-imidazolidinone), nitroalkanes (e.g., nitromethane, nitropropane), and nitriles (e.g., acetonitrile, propionitrile, butyronitrile, valeronitrile, hexanenitrile, trimethylacetonitrile). In addition, the electrolyte compound composition may include one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether (EGBE), 3-(triethoxysilyl) propionitrile, succinonitrile (SN), benzonitrile, 4-(trifluoromethyl) benzonitrile, 1,2,2,3-propanetetracarbonitrile, triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF4), lithium bis(fluorosulfonyl)imide (LiFSI), lithium bis(trifluoromethanesulfonyl)imide (LiTFSI), lithium fluorosulfate (LiSO3F), and lithium bis(oxalato)borate (LiBOB) at a total concentration in the electrolyte of about 10 mol. % or lower.

Embodiments of the present disclosure are directed to electrolytes for lithium batteries that contain a lithium salt composition and an electrolyte compound composition. In some implementations, an electrolyte contains one or more selected covalent compounds or selected salt compounds with a functional group that may react with lithium at the anode and/or cathode to form advantageous lithium salt products. In some implementations, such selected covalent compounds or selected salt compounds may contain fluorosulfonyl (—SO₂F), sultone (—OS(═O)(═O)—), sulfite (—OS(═O)O—), sulfate (—OS(═O)(═O)O—), sulfone (—S(═O)(═O)—), sulfoxide (—S(═O)—), pentafluoro-λ⁶-sulfane (—SF₅), nitro (—NO₂), borate (—OB(O—)(O—)), carbonate (—OC(═O)O—), ester (—C(═O)O—), ketone (—C(═O)—), phosphate (—OP(═O)(O—)(O—)), phosphonate (—OP(═O)(O—)—), phosphine oxide (—P(═O)(—)—), fluorophosphate (—OP(═O)(F)O—), nitrile (—CN), ether (—O—), and/or fluoro (—F) functional groups. The inventors have found that, in designs, compounds containing such functional groups may contribute several performance benefits to an electrolyte and battery cell. It is hypothesized and, in some examples identified, that such performance advantages may originate from reacting of such compounds with lithium at the anode to form lithium salt precipitates in the SEI such as LiF, Li₂S, Li₂SO₃, Li₂SO₄, Li₂O, LiNO₂, LiNO₃, Li₃N, LiCN, Li₂CO₃, Li₃PO₄, Li₃PO₃, Li salts of organophosphates, Li salts of organophosphonates, Li salts of organosulfates, Li salts of organosulfites, Li salts of organosulfonates, Li silicates, Li salts of organosilicon compounds, and other Li-comprising solids. Lithium salt precipitates in the SEI may improve the SEI ionic conductivity by enabling lithium ion conduction along the surfaces or in the bulk of the salt precipitate particles, and may improve the SEI mechanical stability by providing additional surface area for adhesion of the oligomeric and polymeric SEI components, as well as improved adhesion to the anode particle surface. Improved SEI ionic conductivity may reduce the anode charge transfer resistance, while improved SEI mechanical stability may reduce damage to the SEI by anode particle volume changes during cycling. Improved anode charge transfer resistance and SEI stability in turn may improve rate capability, reduce battery direct-current resistance (sometimes referred to here as DCR), and reduce capacity fade. Reduced DCR may reduce the heat generated by a battery during operation, which may further improve cycle life by reducing electrolyte decomposition reaction rates.

The inventors have found that, in some designs, selected covalent compounds or selected salt compounds with a functional group that may react with lithium at the anode to form lithium salt products may be particularly beneficial when used at an additive (about 0.1-about 5 mol. %, selected covalent compounds or selected salt compounds) or co-solvent (about 5 mol. %-about 95 mol. %, selected covalent compounds only) concentration in electrolytes that also comprise known SEI builders such as FEC, VC, or EC, as they may augment the SEI formed by FEC, VC, or EC by increasing the presence of lithium salt precipitates such as LiF, Li₂S, Li₂SO₃, Li₂SO₄, Li₂O, LiNO₂, LiNO₃, Li₃N, LiCN, Li₂CO₃, Li₃PO₄, Li₃PO₃. Li salts of organophosphates, Li salts of organophosphonates, Li salts of organosulfates, Li salts of organosulfites, Li salts of organosulfonates, Li silicates, Li salts of organosilicon compounds, and other Li-containing solids in the SEI. An increased presence of lithium salt precipitates in the SEI may improve the SEI ionic conductivity by enabling lithium ion conduction along the surfaces or in the bulk of the salt precipitate particles, and may improve the SEI mechanical stability by providing additional surface area for adhesion of the oligomeric and polymeric SEI components formed by FEC, VC, or EC, as well as improved adhesion to the anode particle surface. An increased presence of lithium salt precipitates in the SEI may improve the SEI ionic conductivity also by augmenting the reduced charge transfer resistance caused by lithium difluorophosphate (LFO). Improved SEI ionic conductivity may reduce the anode charge transfer resistance, while improved SEI mechanical stability may reduce damage to the SEI by anode particle volume changes during cycling. Improved anode charge transfer resistance and SEI stability in turn may improve rate capability, reduce battery direct-current resistance (sometimes referred to here as DCR), reduce capacity fade, and increase cycle life. Reduced DCR may reduce the heat generated by a battery during operation, which may further improve cycle life by reducing electrolyte decomposition reaction rates. In some designs, the improved SEI properties conferred by the selected covalent compounds or selected salt compounds that contain a functional group that may react with lithium at the anode to form lithium salt products may enable the use of electrolyte formulations with reduced concentrations of FEC (e.g., about 0.1-20 mol. %, such as about 0.1-8 mol. %, or about 0.1-3 mol. %), VC (e.g., less than about 5 mol. %, such as less than about 3 mol. %, or less than about 1 mol. %), and/or EC (e.g., less than about 30 mol. %, such as less than about 20 mol. %, or about less than 10 mol. %) without significant reductions in cycle life. Electrolytes with reduced FEC, VC, and/or EC content may exhibit less HT outgassing at the cathode or at higher cut-off voltages, higher ionic conductivity, improved rate performance, improved calendar life, and/or reduced cost. Examples of selected covalent compounds that may react with lithium at the anode to form favorable lithium salt products that may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise FEC, VC, and/or EC are MDFA (Compound No. 22, 1202), TIP (Compound No. 36, 1416), DMS (Compound No. 37, 1418), CMSF (Compound No. 29, 1402), ESi (Compound No. 3, 306), GBLSF (Compound No. 19, 616), LiDFOB (Compound No. 43, 2006), OrMSF (Compound No. 20, 802), ESF (Compound No. 31, 1406), and DTD (Compound No. 1, 302).

The inventors have found that, in some designs, selected covalent compounds or selected salt compounds with a functional group that may react at the cathode to form favorable lithium salt products may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise known cathode CEI building molecules such as FEC, VC, nitriles, such as ADN and HTCN, sulfur-based compounds, such as LiFSI, and Li salt additives, such as LFO and LiBOB, as they may decrease transition metal dissolution by augmenting the cathode CEI formed by FEC, VC, ADN, HTCN, LFO, LiBOB, or LiFSI by increasing the presence of lithium salt precipitates such as LiF, Li₂S, Li₂SO₃, Li₂SO₄, Li₂O, LiNO₂, LiNO₃, Li₃N, LiCN, Li₂CO₃, Li₃PO₄, and Li₃PO₃. Li salts of organophosphates, Li salts of organophosphonates, Li salts of organosulfates, Li salts of organosulfites, Li silicates, Li salts of organosilicon compounds, and other Li-containing solids in the CEI. An increased presence of lithium salt precipitates in the CEI may improve the cathode CEI ionic conductivity by enabling lithium ion conduction along the surfaces or in the bulk of the salt precipitate particles, and may improve the cathode CEI mechanical stability by providing additional surface area for adhesion of the oligomeric and polymeric cathode CEI components formed by FEC, VC, ADN, HTCN, LFO, LiBOB, or LiFSI as well as improved adhesion to the cathode particle surface. Improved cathode CEI ionic conductivity may reduce the cathode charge transfer resistance, while improved cathode CEI mechanical stability may reduce damage to the cathode CEI by cathode volume changes during cycling. Improved cathode charge transfer resistance and cathode CEI stability in turn may improve rate capability, reduce battery direct-current resistance (sometimes referred to here as DCR), reduce capacity fade, and increase cycle life. Reduced DCR may reduce the heat generated by a battery during operation, which may allow faster charging and/or further improve cycle life by reducing electrolyte decomposition reaction rates. In some designs, the improved cathode CEI properties conferred by the selected covalent compounds or selected salt compounds that contain a functional group that may react with the cathode surface to form lithium salt products may enable the use of electrolyte formulations with reduced concentrations of FEC (e.g., about 0.1-20 mol. %, such as about 0.1-8 mol. %, or about 0.1-3 mol. %), VC (e.g., less than about 5 mol. %, such as less than about 3 mol. %, or less than about 1 mol. %), ADN (e.g., less than about 3 mol. %), HTCN (e.g., less than about 3 mol. %), LFO (e.g., less than about 3 mol. %), LiBOB (e.g., less than about 3 mol. %), or LiFSI (e.g., less than about 3 mol. %) without significant reductions in cycle life and other performance trade-offs. Electrolytes with reduced FEC, VC, ADN, HTCN, LFO, LiBOB, and/or LiFSI content may exhibit less HT outgassing at the cathode or at higher cut-off voltages, higher ionic conductivity, improved rate performance, improved calendar life, and/or reduced cost. Examples of selected covalent compounds and selected salt compounds that may react with the cathode to form lithium salt products that may be particularly beneficial when used at an additive (e.g., about 0.1 mol. %-about 5 mol. %, selected covalent compounds or selected salt compounds) or co-solvent (e.g., about 5 mol. %-about 95 mol. %, selected covalent compounds only) concentration in electrolytes that also comprise FEC, VC, ADN, HTCN, LFO, and/or LiFSI are MDFA (Compound No. 22, 1202), DMS (Compound No. 37, 1418), ESi (Compound No. 3, 306), CMSF (Compound No. 29), 1402), DTD (Compound No. 1, 302), MMDS (Compound No. 40, 1706), LiDFOB (Compound No. 43, 2006), and MAn (Compound No. 39, 1704).

In some implementations, an electrolyte contains one or more polymerizable selected covalent compounds or selected salt compounds. In some implementations, polymerizable selected covalent compounds or selected salt compounds may be cyclic with 3-6 atoms in the ring or may contain alkenyl or alkynyl functional groups (sometimes referred to as unsaturation or unsaturated functionalities). The inventors have found that, in some designs, polymerizable compounds may confer several performance benefits to an electrolyte and battery cell through oligomerization or polymerization upon reduction or reaction with lithium at the anode or oxidation at the cathode, which may generate oligomeric or polymeric SEI or CEI components. Oligomeric and polymeric SEI components may improve the SEI ionic conductivity by enabling lithium ion conduction along and between polymer/oligomer chains, may improve the SEI mechanical stability by adhering to the anode particle surfaces and salt precipitates at the anode particle surfaces, and may improve the anode surface passivation by covering the anode particle surfaces. Improved SEI conductivity may reduce the anode charge transfer resistance, improved SEI mechanical stability may reduce damage to the SEI by anode particle volume changes during cycling, and improved anode surface passivation may inhibit reaction between the anode and the electrolyte. Reduced anode charge transfer resistance, improved SEI mechanical stability, and improved anode surface passivation may improve rate capability, reduce DCR, and reduce capacity fade. Oligomeric and polymeric CEI components may improve cathode surface passivation by covering the cathode particle surfaces and inhibiting reaction between the cathode and electrolyte, which may reduce the extent and rate of oxidation of electrolyte components at HT or high voltage to CO₂ and other gasses, reducing the extent of outgassing at the cathode. Reduced electrolyte oxidation at the cathode may also reduce capacity fade and improve cycle life.

The inventors have found that, in some designs, polymerizable selected covalent compounds or selected salt compounds may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise known SEI builders such as FEC, VC, and/or EC, as the formation of oligomeric and polymeric SEI components may improve the ionic conductivity of the SEI formed by FEC, VC, or EC by enabling lithium ion conduction along and between polymer/oligomer chains, may improve the SEI mechanical stability by adhering to the anode particle surfaces and salt precipitates formed by FEC, VC, or EC reduction at the anode particle surfaces, and may improve the anode surface passivation by covering the anode particle surfaces. Improved SEI conductivity may reduce the anode charge transfer resistance, improved SEI mechanical stability may reduce damage to the SEI by anode particle volume changes during cycling, and improved anode surface passivation may inhibit reaction between the anode and the electrolyte. Reduced anode charge transfer resistance, improved SEI mechanical stability, and improved anode surface passivation may improve rate capability, reduce charging time, reduce DCR, and reduce capacity fade. Additionally, the formation of oligomeric or polymeric CEI components at the cathode may reduce the extent and rate of oxidation of FEC, VC, or EC, reducing the HT outgassing at the cathode. Additionally, the formation of oligomeric or polymeric CEI components at the cathode may reduce transition metal dissolution and result in lower capacity loss during room temperature (RT) cycling and HT storage. In some designs, the improved SEI properties conferred by the polymerizable selected covalent compounds or selected salt compounds may enable the use of electrolyte formulations with reduced concentrations of FEC (e.g., 0.1-20 mol. %, such as about 0.1-8 mol. %, or about 0.1-3 mol. %), VC (e.g., less than about 5 mol. %, such as less than about 3 mol. %, or less than about 1 mol. %), and/or EC (e.g., less than about 30 mol. %, such as less than about 20 mol. %, or less than about 10 mol. %) without significant reductions in cycle life. Electrolytes with reduced FEC, VC, and/or EC content may exhibit less HT outgassing at the cathode, higher ionic conductivity, improved rate performance, improved calendar life, and/or reduced cost.

In some implementations, an electrolyte may advantageously contain one or more selected covalent compounds or selected salt compounds that contain both one or more polymerizable functionalities (e.g., cyclic or unsaturated compounds) and one or more functional groups that may react with lithium at the anode to form favorable lithium salt products (e.g., fluorosulfonyl (—SO₂F), sultone (—OS(═O)(═O)—), sulfite (—OS(═O)O—), sulfate (—OS(═O)(═O)O—), sulfone (—S(═O)(═O)—), sulfoxide (—S(═O)—), pentafluoro-λ⁶-sulfane (—SF₅), nitro (—NO₂), borate (—OB(O—)(O—)), carbonate (—OC(═O)O—), ester (—C(═O)O—), ketone (—C(═O)—), phosphate (—OP(═O)(O—)(O—)), phosphonate (—OP(═O)(O—)—), phosphine oxide (—P(═O)(—)—), fluorophosphate (—OP(═O)(F)O—), nitrile (—CN), ether (—O—), or fluoro (—F) functional groups), referred to here as bifunctional compounds. The inventors have found that, in some designs, such bifunctional compounds may confer several performance advantages by generating both favorable lithium salt precipitates (e.g., LiF, Li₂S, Li₂SO₃, Li₂SO₄, Li₂O, LiNO₂, LiNO₃, Li₃N, LiCN, Li₂CO₃, Li₃PO₄, Li₃PO₃. Li salts of organophosphates, Li salts of organophosphonates, Li salts of organosulfates, Li salts of organosulfonates, Li salts of organosulfites, Li silicates, Li salts of organosilicon compounds, and other Li-containing solids) as well as oligomeric or polymeric species in the SEI and/or CEI. In addition to the above-mentioned benefits that may result from the formation of lithium salt precipitates and oligomeric or polymeric species in the SEI and/or CEI, the formation of both types of SEI and/or CEI components from the reduction at the anode or oxidation at the cathode of the same bifunctional compound may result in improved mixing of these components in the SEI and/or CEI. Improved mixing of the lithium salt precipitates and oligomeric or polymeric species in the SEI and/or CEI may result in smaller salt precipitate crystal sizes, which may increase the surface area of the salt precipitate crystals and improve their adhesion to the polymeric or oligomeric components. Improved adhesion between the salt precipitates and oligomeric or polymeric species may improve the mechanical stability of the SEI and/or CEI and reduce damage to the SEI and/or CEI caused by anode and/or cathode particle volume changes during cycling, which may reduce capacity fade and improve cycle life. Additionally, an increased surface area of the salt precipitate crystals in the SEI and/or CEI may improve the SEI and/or CEI ionic conductivity by providing more surface area for lithium ion conduction, which may reduce anode and/or cathode charge transfer resistances, improve rate capability, and reduce DCR. Reduced DCR may also reduce the heat generated during battery operation which may further improve cycle life by reducing the rate of reactions between the electrolyte and anode and cathode.

The inventors have found that, in some designs, bifunctional selected covalent compounds or selected salt compounds may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise known SEI builders such as FEC, VC, or EC, as the formation of well-mixed lithium salt precipitates and oligomeric or polymeric species in the SEI may augment the SEI formed by FEC, VC, or EC by increasing the SEI mechanical stability, increasing the anode surface coverage and passivation by the SEI, and increasing the SEI ionic conductivity. Improved SEI conductivity may reduce the anode charge transfer resistance, improved SEI mechanical stability may reduce damage to the SEI by anode particle volume changes during cycling, and improved anode surface passivation may inhibit reaction between the anode and the electrolyte. Reduced anode charge transfer resistance, improved SEI mechanical stability, and improved anode surface passivation may improve rate capability, reduce DCR, and reduce capacity fade. Additionally, the formation of Li salts and oligomeric or polymeric CEI components at the cathode may reduce the extent and rate of oxidation of FEC, VC, or EC, reducing the HT outgassing at the cathode. In some designs, the improved SEI properties conferred by the bifunctional selected covalent compounds or selected salt compounds may enable the use of electrolyte formulations with reduced concentrations of FEC (e.g., about 0.1-20 mol. %, such as about 0.1-8 mol. %, or about 0.1-3 mol. %), VC (e.g., less than about 5 mol. %, such as less than about 3 mol. %, or less than about 1 mol. %), and/or EC (e.g., less than about 30 mol. %, such as less than about 20 mol. %, or less than about 10 mol. %) without significant reductions in cycle life. Electrolytes with reduced FEC, VC, and/or EC content may exhibit less HT outgassing at the cathode or at higher cut-off voltages, higher ionic conductivity, improved rate performance, improved calendar life, and/or reduced cost. The inventors have also found that, in some designs, bifunctional selected covalent compounds or selected salt compounds may enable the use of electrolytes that do not comprise FEC without significant reductions in cycle life, as they may form stable SEIs that contain both lithium salt precipitates and oligomeric or polymeric components in the absence of FEC. Electrolytes that do not comprise FEC may exhibit less HT outgassing at the cathode, higher ionic conductivity, improved rate performance, improved calendar life, and/or reduced cost. Examples of bifunctional selected covalent compounds or selected salt compounds that may be particularly beneficial when used at an additive (e.g., about 0.1 mol. %-about 5 mol. %, selected covalent compounds or selected salt compounds) or co-solvent (e.g., about 5 mol. %-about 95 mol. %, selected covalent compounds only) concentration in electrolytes that also comprise FEC, VC, and/or EC, or that may be particularly beneficial in electrolytes that do not comprise FEC are ESi (Compound No. 3, 306), MDFA (Compound No. 22, 1202), GBLSF (Compound No. 19, 616), LiDFOB (Compound No. 43, 2006), ECCN (Compound No. 51, 618), EDSDF (Compound No. 52, 1420), LiDFOP (Compound No. 53, 2022), OrMSF (Compound No. 20, 802), ESF (Compound No. 31, 1406), and DTD (Compound No. 1, 302).

The inventors have found that, in some designs, bifunctional selected covalent compounds or selected salt compounds may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise known cathode CEI building molecules such as FEC, VC, nitriles, such as ADN and HTCN, sulfur-based compounds, such as LiFSI, and Li salt additives, such as LFO and LiBOB, as they may decrease transition metal dissolution from the cathode by augmenting the cathode CEI formed by FEC, VC, ADN, HTCN, LFO, LiBOB, or LiFSI by increasing the presence of both favorable lithium salt precipitates (such as LiF, Li₂S, Li₂SO₃, Li₂SO₄, Li₂O, LiNO₂, LiNO₃, Li₃N, LiCN, Li₂CO₃, Li₃PO₄, and Li₃PO₃. Li salts of organophosphates, Li salts of organophosphonates, Li salts of organosulfates, Li salts of organosulfonates, Li salts of organosulfites, Li silicates, Li salts of organosilicon compounds, and/or other Li-containing solids) as well as polymeric or oligomeric components in the cathode CEI. Formation of well-mixed lithium salt precipitates and oligomeric or polymeric species in the cathode CEI may augment the CEI formed by FEC, VC, ADN, HTCN, LFO, LiBOB, or LiFSI by increasing the CEI mechanical stability, increasing the cathode surface coverage and passivation by the CEI, and increasing the CEI ionic conductivity. Improved cathode passivation may reduce HT outgassing from the cathode by reducing the oxidation of FEC, VC, and other electrolyte components by the cathode, particularly at high voltage. An increased presence of lithium salt precipitates in the CEI may improve the cathode CEI ionic conductivity by enabling lithium ion conduction along the surfaces or in the bulk of the Li salt precipitate particles, and may improve the cathode CEI mechanical stability by providing additional surface area for adhesion of the oligomeric and polymeric cathode CEI components formed by FEC, VC, ADN, HTCN, LFO, LiBOB, or LiFSI as well as improved adhesion to the cathode particle surface. Improved cathode CEI ionic conductivity may reduce the cathode charge transfer resistance, while improved cathode CEI mechanical stability may reduce damage to the cathode CEI by cathode volume changes during cycling. Improved cathode charge transfer resistance and cathode CEI stability in turn may improve rate capability, reduce battery direct-current resistance (sometimes referred to here as DCR), reduce capacity fade, and increase cycle life. Reduced DCR may reduce the heat generated by a battery during operation, which may further improve cycle life by reducing electrolyte decomposition reaction rates. In some designs, the improved cathode CEI properties conferred by the bifunctional selected covalent compounds or selected salt compounds that may react with cathode surface to form lithium salt products and oligomeric or polymeric CEI products may enable the use of electrolyte formulations with reduced concentrations of FEC (e.g., about 0.1-20 mol. %, such as about 0.1-8 mol. %, or about 0.1-3 mol. %), VC (e.g., less than about 5 mol. %, such as less than about 3 mol. %, or less than about 1 mol. %), ADN (e.g., less than about 3 mol. %), HTCN (e.g., less than about 3 mol. %), LFO (e.g., less than about 3 mol. %), LiBOB (e.g., less than about 3 mol. %), or LiFSI (e.g., less than about 3 mol. %) (e.g., less than about 3 mol. %) without significant reductions in cycle life and other performance trade-offs. Electrolytes with reduced FEC, VC, and/or ADN, and/or HTCN, and/or LFO, and/or LiBOB, and/or LiFSI content may exhibit less HT outgassing at the cathode or higher cut-off voltages, higher ionic conductivity, improved rate performance, reduced viscosity, improved calendar life, and/or reduced cost. Examples of bifunctional selected covalent compounds or selected salt compounds that may be particularly beneficial when used at an additive (e.g., about 0.1 mol. %-about 5 mol. %, selected covalent compounds or selected salt compounds) or co-solvent (e.g., about 5 mol. %-about 95 mol. %, selected covalent compounds only) concentration in electrolytes that also comprise FEC, VC, ADN, HTCN, LFO, LiBOB, or LiFSI or that may be particularly beneficial in electrolytes that do not comprise FEC are ESi (Compound No. 3, 306), MDFA (Compound No. 22, 1202), GBLSF (Compound No. 19, 616), LiDFOB (Compound No. 43, 2006), ECCN (Compound No. 51, 618), EDSDF (Compound No. 52, 1420), LiDFOP (Compound No. 53, 2022), OrMSF (Compound No. 20, 802), ESF (Compound No. 31, 1406), and DTD (Compound No. 1, 302).

In some implementations, an electrolyte may advantageously contain one or more selected covalent compounds or selected salt compounds with a high reduction potential (e.g., between about 1.5 V to about 3.0 V vs Li/Li). In some implementations, such selected covalent compounds or selected salt compounds may contain fluorosulfonyl (—SO₂F), sultone (—OS(═O)(═O)—), sulfite (—OS(═O)O—), sulfate (—OS(═O)(═O)O—), pentafluoro-λ⁶-sulfane (—SF₅), nitro (—NO₂), borate (—OB(O—)(O—)), nitrile (CN), and/or fluoro (—F) functional groups. The inventors have found that, in some designs, compounds containing such functional groups may confer several performance benefits to an electrolyte, for example, by reacting at high potentials at the anode to form a stable SEI that may improve the SEI ionic conductivity, reducing the anode charge transfer resistance, and improve the SEI mechanical stability, reducing damage to the SEI by anode particle volume changes during cycling. Improved anode charge transfer resistance and SEI stability in turn may improve rate capability, reduce battery direct-current resistance (sometimes referred to here as DCR), and reduce capacity fade. Reduced DCR may reduce the heat generated by a battery during operation, which may further improve cycle life by reducing electrolyte decomposition reaction rates. By reacting at high potentials at the anode (e.g., between about 1.5 V to about 3.0 V vs Li/Li⁺), compounds containing such functional groups may also inhibit the reduction of other electrolyte components at the anode that have lower reduction potentials and may not generate as stable an SEI (e.g., co-solvents such as linear and branched esters (e.g., EP, EI) and linear carbonates (e.g., DMC, EMC, DEC), PC, or non-SEI building additives such as nitriles (e.g., ADN, HTCN)). This may reduce capacity fade and increase cycle life. This may be particularly beneficial in cells containing graphitic anode active materials (e.g., blended anodes or silicon-free, graphite-based anodes), as the early formation of a stable SEI may reduce or prevent co-intercalation of co-solvents into the graphite particles, reducing or preventing exfoliation and reducing capacity fade.

The high reduction potential of fluorosulfonyl- and pentafluoro-λ⁶-sulfane-containing compounds may be due to their weak S—F and S—R (R=C or N) bonds as well as the strong electronegativity of the —SO₂F and —SF₅ functional groups, which may enable reaction with lithium in the anode at high potentials to form LiF, SO₂, Li₂S LiSO₂F, and/or LiSO₃F. The high reduction potential of sultone-, sulfite-, and sulfate-containing compounds may be due to their weak S—O bonds and the strong electronegativity of the —OS(═O)(═O)—, —OS(═O)O—, and —OS(═O)(═O)O— functional groups, which may enable reaction with lithium in the anode at high potentials to form lithium alkoxides, Li₂SO₄, Li₂SO₃, Li₂S, and/or SO₂. The high reduction potential of the nitro-containing compounds may be due to their weak C—N bonds, as well as the strong electronegativity of the —NO₂ functional group, which may enable reaction with lithium in the anode at high potentials to form LiNO₂, LiNO₃, and/or Li₃N. The high reduction potential of borate-containing compounds may be due to their weak B—O bonds, which may enable reaction with lithium in the anode at high potentials to form oligomeric borates. The high reduction potential of fluoro-containing compounds may be due to their weak C—F bonds as well as the strong electronegativity of the —F functional group, which may enable reaction with lithium in the anode at high potentials to form LiF. Li salt species such as LiF, Li₂S, Li₂SO₃, Li₂SO₄, LiSO₂F, LiSO₃F, LiNO₂, LiNO₃, Li₃N, and oligomeric borates may improve the SEI ionic conductivity by enabling lithium ion conduction along the surfaces or in the bulk of the salt precipitates, and may improve the SEI mechanical stability by providing additional surface area for adhesion of the oligomeric and polymeric SEI components, as well as improved adhesion to the anode particle surface.

The inventors have found that, in some designs, selected covalent compounds and selected salt compounds with high reduction potentials (e.g., between about 1.5 V to about 3.0 V vs Li/Li) may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise known SEI builders such as FEC, VC, or EC, as they may be preferentially consumed at the anode before FEC, VC, or EC in the first charge/discharge cycles. This may result in a greater extent of formation of salt species (e.g., LiF, Li₂S, Li₂SO₃, Li₂SO₄, LiSO₂F, LiSO₃F, LiNO₂, LiNO₃, Li₃N, and/or oligomeric borates) in the SEI before reduction of FEC, VC, or EC, which may augment the SEI formed by subsequent FEC, VC, or EC reduction by reducing the SEI resistance (anode charge transfer resistance) and facilitate Li transport across the anode-electrolyte interface, reducing DCR. The presence in the SEI of additional salt species (e.g., LiF, Li₂S, Li₂SO₃, Li₂SO₄, LiSO₂F, LiSO₃F, LiNO₂, LiNO₃, Li₃N, and/or oligomeric borates) formed by early reduction of compounds with high reduction potentials (e.g., between about 1.5 V to about 3.0 V vs Li/Li) may also augment the mechanical stability of the SEI formed by FEC, VC, or EC by improving the adhesion of the SEI layer to the anode particle surfaces and increasing the conformity of the SEI coverage on the anode particles, reducing the SEI damage and exfoliation caused by anode particle volume changes during cycling and improving cycle life. When used at additive (e.g., about 0.1 mol. %-about 5 mol. %) concentrations, selected covalent compounds or selected salt compounds with a high (e.g., between about 1.5 V to about 3.0 V vs Li/Li) reduction potential may be substantially consumed in the first two charge/discharge cycles (e.g., less than about 20% of the original concentration remaining), which may be desirable as the improved SEI properties may be conferred without substantial concentration of the selected covalent compounds or selected salt compounds with a high (e.g., between about 1.5 V to about 3.0 V vs Li/Li⁺) reduction potential remaining present in the electrolyte for subsequent oxidation to CO₂ and/or other gasses at the cathode. Electrolyte formulations containing selected covalent compounds or selected salt compounds with a high (e.g., between about 1.5 V to about 3.0 V vs Li/Li) reduction potential in additive (e.g., about 0.1 mol. %-about 5 mol. %) concentrations may therefore be particularly beneficial as they may improve cycle life, DCR, and rate performance without substantial HT outgassing at the cathode. In some designs, the improved SEI properties conferred by the selected covalent compounds or selected salt compounds with high reduction potentials (e.g., between about 1.5 V to about 3.0 V vs Li/Li) may also enable the use of electrolyte formulations with reduced concentrations of FEC (e.g., about 0.1-20 mol. %, such as about 0.1-8 mol. %, or about 0.1-3 mol. %), VC (e.g., less than about 5 mol. %, such as less than about 3 mol. %, or less than about 1 mol. %), and/or EC (e.g., less than about 30 mol. %, such as less than about 20 mol. %, or less than about 10 mol. %) without significant reductions in cycle life. Electrolytes with reduced FEC, VC, and/or EC content may exhibit less HT outgassing at the cathode, higher ionic conductivity, reduced viscosity, improved rate performance, improved calendar life, and/or reduced cost. Examples of selected covalent compounds or selected salt compounds with a high (e.g., between about 1.5 V to about 3.0 V vs Li/Li) reduction potential that may be particularly beneficial when used at an additive (e.g., about 0.1 mol. %-about 5 mol. %, selected covalent compounds or selected salt compounds) or co-solvent (e.g., about 5 mol. %-about 95 mol. %, selected covalent compounds only) concentration in electrolytes that also comprise FEC, VC, and/or EC, are ESi (Compound No. 3, 306), MDFA (Compound No. 22, 1202), GBLSF (Compound No. 19, 616), LiDFOB (Compound No. 43, 2006), ECCN (Compound No. 51, 618), EDSDF (Compound No. 52, 1420), LiDFOP (Compound No. 53, 2022), OrMSF (Compound No. 20, 802), ESF (Compound No. 31, 1406), and CMSF (Compound No. 29, 1402).

In some implementations, an electrolyte may advantageously contain one or more selected covalent compounds or selected salt compounds that passivate the cathode surface, reduce transition metal dissolution, and/or reduce HT outgassing at the cathode. In some implementations, such selected covalent compounds or selected salt compounds may contain fluorosulfonyl (—SO₂F), sultone (—OS(═O)(═O)—), sulfite (—OS(═O)O—), sulfate (—OS(═O)(═O)O—), nitrile (—CN), tri(alkyl)silyl (—Si(R)(R′)(R″)), tri(fluoroalkyl)silyl (—Si(R)(R′)(R″)), and/or fluoro (—F) functional groups. The inventors have found that, in some designs, such compounds may reduce HT outgassing on the cathode at high voltages. This may be due to the formation of LiF, Li₂S, LiSO₂F, LiSO₃F, SiO₂, and/or polymeric species at the cathode surface (CEI) upon oxidation of the fluorosulfonyl, sultone, nitrile, silyl, or fluoro functional groups, which may reduce the reactivity of the cathode with the electrolyte, inhibiting the oxidation of electrolyte components to CO₂ and other gasses by the cathode at HT. Fluorosulfonyl- and fluoro-containing compounds may also partially fluorinate the cathode surface by forming transition metal fluorides (e.g., NiF₂, CoF₂, [NiF₄]²⁻, [CoF₄]²⁻), which may also passivate the cathode surface and reduce transition metal dissolution. Passivation of the cathode surface by fluorosulfonyl-, sultone-, nitrile-, silyl-, and/or fluoro-containing compounds may also improve calendar life. Reduced transition metal dissolution may also lead to less transition metal reduction and subsequent SEI growth and/or Li-plating at the anode, which may increase cycle life.

The inventors have found that, in some designs, selected covalent compounds and selected salt compounds that passivate the cathode surface and reduce HT outgassing at the cathode may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise known SEI builders such as FEC, VC, and/or EC, as they may reduce the HT outgassing otherwise caused by FEC, VC, and/or EC, in addition to providing benefits to the SEI. Examples of selected covalent compounds or selected salt compounds that may passivate the cathode surface and reduce HT outgassing at the cathode and that may be particularly beneficial when used at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that also comprise FEC, VC, and/or EC are ESi (Compound No. 3, 306), MDFA (Compound No. 22, 1202), GBLSF (Compound No. 19, 616), LiDFOB (Compound No. 43, 2006), ECCN (Compound No. 51, 618), EDSDF (Compound No. 52, 1420), LiDFOP (Compound No. 53, 2022), OrMSF (Compound No. 20, 802), ESF (Compound No. 31, 1406), and DTD (Compound No. 1, 302).

In some implementations, an electrolyte may advantageously contain one or more selected covalent compounds with a high molecular dipole moment (e.g., above about 2.0 D), high dielectric constant (e.g., above about 10), and/or low viscosity (e.g., below about 1 cP). In some implementations, such selected covalent compounds may be cyclic and may contain sultone (—OS(═O)(═O)—), sulfite (—OS(═O)O—), sulfate (—OS(═O)(═O)O—), sulfone (—S(═O)(═O)—), sulfoxide (—S(═O)—), nitro (—NO₂), borate (—OB(O—)(O—)), carbonate (—OC(═O)O—), ester (—C(═O)O—), ketone (—C(═O)—), phosphate (—OP(═O)(O—)(O—)), phosphonate (—OP(═O)(O—)—), phosphine oxide (—P(═O)(—)—), and/or nitrile (—CN) functional groups. The inventors have found that, in some designs, such compounds may confer several performance benefits to an electrolyte such as increasing the lithium salt solvation, increasing the anion-cation separation, increasing the ionic conductivity, and reducing the viscosity, which may improve the rate capability and reduce DCR. Reduced DCR may reduce the heat generated by a battery during operation, which may further improve cycle life by reducing electrolyte decomposition reaction rates. Such benefits may be particularly pronounced when a selected covalent compound is present in an electrolyte at a co-solvent (e.g., about 5 mol. %-about 95 mol. %) concentration. Examples of selected covalent compounds with a high molecular dipole moment (e.g., above about 2.0 D), high dielectric constant (e.g., above about 10), and/or low viscosity (e.g., below about 1 cP) are DMS (Compound No. 37, 1418) and ESi (Compound No. 3, 306).

In some implementations, an electrolyte may advantageously contain one or more selected covalent compounds that contain one or more functional groups comprising a nitrogen bonded to an atom with a double bond to an oxygen atom. In some implementations, such selected covalent compounds may contain amide (—N(R)—C(═O)—), carbamate (—N(R)—C(═O)—O—), urea (—N(R)—C(═O)—N(R′)—), sulfonamide (—N(R)—S(═O)(═O)—), sulfinamide (—N(R)—S(═O)—), or phosphoramide (—N(R)—P(═O)(—OR′)—O—) functional groups (where the R and R′ groups may be as specified in the selected covalent compound and selected salt compound structure definitions). The inventors have found that, in some designs, such compounds may confer several performance benefits to an electrolyte, for example, by increasing the extent of solvation of Li⁺ in the electrolyte by the selected covalent compound(s). The increased solvation of Li⁺ by such compounds may be due to the increased electron density on the double-bonded oxygen atom, which may increase the driving force to solvate Li⁺ cations. Increased solvation of Li⁺ by such compounds may increase the reduction potential of the compounds, which may increase the extent and rate of reduction or reaction with lithium at the anode to generate decomposition products (e.g., lithium salt precipitates or oligomeric or polymeric species) that may be beneficial for SEI stability and ionic conductivity, which may in turn reduce capacity fade, increase cycle life, reduce DCR, improve rate capability, and improve calendar life. Increased solvation of Li⁺ by such compounds may also increase the lithium salt solvation and anion-cation separation in the electrolyte, which may increase the ionic conductivity, improve rate capability, and reduce DCR. Reduced DCR may reduce the heat generated by a battery during operation, which may further improve cycle life by reducing electrolyte decomposition reaction rates. Increased solvation of Li⁺ by such compounds may also reduce the extent of Li⁺ solvation by other electrolyte components that do not form as stable an SEI, which may reduce the extent and rate of reduction or reaction with lithium of such components at the anode, which may reduce capacity, increase cycle life, and improve calendar life. In some designs, such benefits may be particularly pronounced when a selected covalent compound with a nitrogen bonded to an atom with a double bond to an oxygen atom is present in an electrolyte at a co-solvent (e.g., about 5 mol. %-about 95 mol. %) concentration.

In one or more embodiments of the present disclosure, an electrolyte for a lithium-ion battery includes a primary lithium salt and an electrolyte compound composition. The electrolyte compound composition may include (1) fluoroethylene carbonate (FEC) and (2) a co-solvent composition. The co-solvent composition may include at least one non-ester and non-carbonate co-solvent, such as: ketones (e.g., hexamethyl acetone, pinacolone, methyl isopropyl ketone, diisopropyl ketone, ethyl isopropyl ketone), (fluoro)hydrocarbons (e.g., heptane, hexane, octane, cyclohexane, cycloheptane, fluorobenzenes, fluorotoluenes, fluoroxylenes, fluoroheptanes, fluorooctanes, fluorohexanes, fluoropentanes, benzoyl fluoride), sulfites (e.g., ethyl methyl sulfite, diethyl sulfite, 1,3-propylene sulfite, 1,2-propylene sulfite), sulfones (e.g., sulfolane, dimethyl sulfone, ethyl methyl sulfone, ethyl isopropyl sulfone), phosphates (e.g., triphenyl phosphate), fluorinated ethers (e.g., 1,1,2,2-tetrafluoroethyl 2,2,3,3-tetrafluoropropyl ether), fluorinated amines (e.g., perfluorotriethylamine), nitroalkanes (e.g., nitropropane), and/or nitriles (e.g., trimethylacetonitrile). The co-solvent composition may also include one or more esters (e.g., ethyl propionate, ethyl isobutyrate, ethyl acetate, propyl propionate, ethyl isovalerate, ethyl trimethylacetate, methyl butyrate) and/or non-EC and non-FEC carbonate (e.g., dimethyl carbonate, ethyl methyl carbonate, diethyl carbonate, methyl phenyl carbonate, diphenyl carbonate, propylene carbonate) co-solvents. The co-solvent composition may also include EC. A concentration of the FEC in the electrolyte may be in a range of about 1-40 mol. %, e.g., about 10-40 mol. %, or about 20-40 mol. %, or about 30-40 mol. %, or about 20-30 mol. %, or about 10-30 mol. %. A total concentration of the at least one non-ester and non-carbonate co-solvent in the electrolyte may be at least about 10 mol. %. A total concentration of the ester and non-EC and non-FEC carbonate co-solvents in the electrolyte may be less than about 60 mol. %. A total concentration of the EC in the electrolyte may be less than about 40 mol. %. Additionally, in some implementations, a total concentration of all cyclic carbonates (FEC and non-FEC cyclic carbonates) does not exceed about 40 mol. %.

The inventors have found that, in some designs, combination of non-ester and non-carbonate co-solvents with a moderate-to-high FEC concentration (e.g., about 1-40 mol. %, such as about 10-40 mol. %, or about 20-40 mol. %, or about 30-40 mol. %, or about 20-30 mol. %, or about 10-30 mol. %) may improve the performance of battery cells with FEC-based electrolytes by mitigating some of the drawbacks otherwise associated with moderate-to-high FEC concentrations, such as reducing HT outgassing at the cathode, increasing ion solvation, reducing electrolyte viscosity, increasing electrolyte ionic conductivity, reducing anode charge transfer resistance, reducing DCR, improving calendar life. The inventors have similarly found that, in some designs, moderate-to-high FEC concentrations (e.g., about 1-40 mol. %, such as about 10-40 mol. %, or about 20-40 mol. %, or about 30-40 mol. %, or about 20-30 mol. %, or about 10-30 mol. %) may mitigate some of the drawbacks otherwise associated with the presence of such non-ester and non-carbonate co-solvents (e.g., reduced cycle life) by improving SEI stability, inhibiting co-solvent reduction at the anode, inhibiting co-solvent co-intercalation into and exfoliation of graphitic anode particles, and improving cycle life.

In battery cells with blended or graphite-free anodes with a high fraction e.g., >about 25 wt. % or >about 50 wt. % of the active material portion) of nanocomposite particles, which exhibit moderately high volume changes (e.g., about 8-about 160 or-about 180 vol. %) during the first charge-discharge cycle, moderate volume changes (e.g., about 5-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only), capacity fade may become undesirably fast when the electrolyte comprises a low-to-minimum fluoroethylene carbonate (FEC) and vinylene carbonate (VC) concentration (wherein “low-to-minimum” is below about 18 mol. % in the case of FEC, and below about 5 mol. % in the case of VC, including 0 mol. % in both cases). However, HT gassing may become excessive and DCR may become undesirably high when higher concentrations of these known SEI builders are used. Some embodiments of the present invention are therefore directed to battery cells containing anodes with a high fraction (e.g., >about 25 wt. % or >about 50 wt. % of the active material particle portion) of nanocomposite particles which exhibit moderately high volume changes (e.g., about 8-about 160 or-about 180 vol. %) during the first charge-discharge cycle, moderate volume changes (e.g., about 5-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only) and electrolyte formulations that comprise a low-to-minimum fluoroethylene carbonate (FEC) and vinylene carbonate (VC) concentration and one or more selected covalent compounds or selected salt compounds at an additive (e.g., about 0.1-about 5 mol. %, selected covalent compounds or selected salt compounds) or co-solvent (e.g., about 5 mol. %-about 95 mol. %, selected covalent compounds only) concentration to increase cycle life, reduce DCR, and/or improve rate capability without causing significant HT outgassing at the cathode. Examples of selected covalent compounds or selected salt compounds that may be beneficial at an additive (e.g., about 0.1-about 5 mol. %, selected covalent compounds or selected salt compounds) or co-solvent (e.g., about 5 mol. %-about 95 mol. %, selected covalent compounds only) concentration in electrolytes that comprise low-to-minimum fluoroethylene carbonate (FEC) and vinylene carbonate (VC) concentrations are ESi (Compound No. 3, 306), MDFA (Compound No. 22, 1202), GBLSF (Compound No. 19, 616), LiDFOB (Compound No. 43, 2006), ECCN (Compound No. 51, 618), EDSDF (Compound No. 52, 1420), LiDFOP (Compound No. 53, 2022), OrMSF (Compound No. 20, 802), ESF (Compound No. 31, 1406), DTD (Compound No. 1, 302), DMS (Compound No. 37, 1418), and TIP (Compound No. 36, 1416).

In battery cells with blended or graphite-free anodes with a high fraction (e.g., >about 25 wt. % or >about 50 wt. % of the active material particle-portion) of nanocomposite particles, which exhibit moderately high volume changes (e.g., about 8-about 160 or-about 180 vol. %) during the first charge-discharge cycle, moderate volume changes (e.g., about 5-about 50 vol. %) during the subsequent charge-discharge cycles, and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only), capacity fade may become undesirably fast when the average size (e.g., average diameter) of the nanocomposite particles is below about 20 micron, such as below about 10 microns, below about 5 microns, or below about 3 microns, and the specific surface area is above about 5 m²/g, such as above about 10 m²/g, or above about 15 m²/g, normalized by the mass of the (nano)composite anode particles, and the electrolyte comprises a low-to-minimum fluoroethylene carbonate (FEC) and vinylene carbonate (VC) concentration (wherein “low-to-minimum” is below about 18 mol. % in the case of FEC, and below about 5 mol. % in the case of VC, including 0 mol. % in both cases). However, in some designs, smaller nanocomposite particle sizes may be desirable as they may increase the electrode packing density, increase the lithiation efficiency, and decrease anode charge transfer resistance, thereby increasing the cell energy density, reducing DCR, and/or improving rate capability. In addition, HT gassing may become excessive and DCR may become undesirably high when higher concentrations of FEC and VC are used. Some embodiments of the present invention are therefore directed to battery cells containing anodes with a high fraction (e.g., >about 25 wt. % or >about 50 wt. % of the active material particle portion) of nanocomposite particles which exhibit moderately high volume changes (e.g., about 8-about 160 or -about 180 vol. %) during the first charge-discharge cycle, moderate volume changes (e.g., about 5-about 50 vol. %) during the subsequent charge-discharge cycles, an average size (e.g., average diameter) below about 10 microns, such as below about 5 microns, or below about 3 microns, and specific surface area above about 5 m²/g, such as above about 10 m²/g, or above about 15 m²/g, normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only) and electrolyte formulations that comprise low-to-minimum fluoroethylene carbonate (FEC) and vinylene carbonate (VC) concentrations and one or more selected covalent compounds or selected salt compounds at an additive (e.g., about 0.1-about 5 mol. %, selected salt compounds or selected covalent compounds) or co-solvent (e.g., about 5 mol. %-about 95 mol. %, selected covalent compounds only) concentration to increase cycle life, reduce DCR, and/or improve rate capability without causing significant HT outgassing at the cathode. Examples of selected covalent compounds or selected salt compounds that may be beneficial at an additive (e.g., about 0.1-about 5 mol. %) or co-solvent (e.g., about 5 mol. %-about 95 mol. %, selected covalent compounds only) concentration in electrolytes that comprise low-to-minimum fluoroethylene carbonate (FEC) and vinylene carbonate (VC) concentrations are ESi (Compound No. 3, 306), MDFA (Compound No. 22, 1202), GBLSF (Compound No. 19, 616), LiDFOB (Compound No. 43, 2006), ECCN (Compound No. 51, 618), EDSDF (Compound No. 52, 1420), LiDFOP (Compound No. 53, 2022), OrMSF (Compound No. 20, 802), ESF (Compound No. 31, 1406), DTD (Compound No. 1, 302), DMS (Compound No. 37, 1418), and TIP (Compound No. 36, 1416).

The electrolyte compound composition may include (1) fluoroethylene carbonate (FEC) and (2) a co-solvent composition. In some designs, the co-solvent composition may include at least one linear ester and at least one branched ester. A concentration of the FEC in the electrolyte may be in a range of about 4 mol. % to about 30 mol. %. A total concentration of the at least one linear ester and the at least one branched ester in the electrolyte may be at least about 45 mol. %. A molar ratio of the at least one linear ester to the at least one branched esters may be in a range of about 1:1 to about 10:1. The electrolyte may be substantially free of four-carbon cyclic carbonate. Additionally, in some implementations, the electrolyte may also include at least one non-FEC cyclic carbonate. In some implementations, the at least one non-FEC cyclic carbonate may be ethylene carbonate, vinylene carbonate, or a combination thereof. In some implementations, a concentration of the at least one non-FEC cyclic carbonate in the electrolyte may be in a range of about 0.5 mol. % to about 30 mol. %, such as in a range of about 1 mol. % to about 6 mol. %. In some implementations, the at least one linear ester may comprise ethyl acetate and ethyl propionate. In some implementations the at least one branched ester may comprise ethyl isobutyrate. Such an electrolyte formulation may be particularly advantageous for reduced HT and end-of-life (EoL) outgassing and improved cycle life and may be advantageously used for anodes based on silicon-carbon composites and blended anodes with a high active material mass fraction of Si (e.g., greater than about 30 wt. %).

The electrolyte compound composition may include (1) fluoroethylene carbonate (FEC) and (2) a co-solvent composition. The co-solvent composition may include a mixture of two or more linear esters. A concentration of the FEC in the electrolyte may be in a range of about 4 mol. % to about 30 mol. %. A total concentration of at least one linear ester in the electrolyte may be at least about 45 mol. %. A molar ratio between the esters may be in a range of about 1:1 to about 10:1. The electrolyte may be substantially free of four-carbon cyclic carbonate. Additionally, in some implementations, the electrolyte may also include at least one non-FEC cyclic carbonate. In some implementations, the at least one non-FEC cyclic carbonate may be ethylene carbonate, vinylene carbonate, or a combination thereof. In some implementations, a concentration of the at least one non-FEC cyclic carbonate in the electrolyte may be in a range of about 0.5 mol. % to about 30 mol. %, such as in a range of about 1 mol. % to about 6 mol. %. In some implementations, the at least one linear ester may comprise ethyl acetate and ethyl propionate. Such an electrolyte formulation may be particularly advantageous for reduced charge transfer, bulk, and diffusion resistances and may be advantageously used for anodes based on silicon-carbon composites and blended anodes with a high active material mass fraction of Si (e.g., greater than about 10 wt. %).

In one or more embodiments of the present disclosure, an electrolyte for a lithium-ion battery includes a primary lithium salt and an electrolyte compound composition. The electrolyte compound composition may include (1) fluoroethylene carbonate (FEC) and (2) a co-solvent composition. The co-solvent composition may include at least one ester (e.g., at least one ester, at least one branched ester, or at least one linear ester and at least one branched ester) and at least one non-FEC cyclic carbonate. A concentration of the FEC in the electrolyte may be in a range of about 4 mol. % to about 30 mol. %. A total concentration of the at least one ester (e.g., all esters) may be at least about 40 mol. %. A total concentration of the at least one non-FEC cyclic carbonate in the electrolyte may be in a range of about 0.5 mol. % to about 30 mol. %. The electrolyte may be substantially free of four-carbon cyclic carbonate. Additionally, in some implementations, a total concentration of all cyclic carbonates (FEC and non-FEC cyclic carbonates) does not exceed about 40 mol. %. In some implementations, a total concentration of the at least one ester in the electrolyte may be in a range of about 45 mol. % to about 70 mol. %. In some implementations, a molar ratio of the at least one ester to the at least one non-FEC cyclic carbonate may be in a range of about 1.5:1 to about 20:1. Such electrolyte formulations may be advantageously used for anodes based on silicon-carbon composites and blended anodes with a high active material mass fraction of Si (e.g., greater than about 10 wt. %). Additionally, such electrolyte formulations may be advantageously used for anodes based on SiOₓ-comprising material (where the fraction x may range between 0 and 2) with a high active material mass fraction of Si (e.g., greater than about 10 wt. %)

In one or more embodiments of the present disclosure, a lithium-ion battery may include an anode current collector, a cathode current collector, an anode disposed on the anode current collector, a cathode disposed on the cathode current collector, and any one of the foregoing electrolytes ionically coupling the anode and the cathode. For example, there may be a separator interposed in a space between the anode and the cathode, with the electrolyte impregnating the separator. In some implementations, the anode may comprise a mixture of (A) silicon-carbon composite particles comprising silicon and carbon (e.g., with the silicon part being arranged as active material particles and the carbon forming an inactive or substantially inactive part of scaffolding matrix with pores in which the silicon active material disposed and/or part of a carbon coating or shell arranged around the composite particles), and (B) graphite or graphitic carbon particles (e.g., with graphite as an active material) and being substantially free of silicon. Such an anode comprising a mixture is sometimes referred to as a blended anode herein. In some implementations, a mass of the silicon is in a range of about 3 wt. % to about 30 wt. % of a total mass of the anode. In some implementations, a mass of the silicon is in a range of about 30 wt. % to about 60 wt. % of a total mass of the anode. In some implementations, a mass of the silicon is in a range of about 60 wt. % to about 80 wt. % of a total mass of the anode. A mass of the silicon may range between about 3 wt. % to about 80 wt. % depending on the particular implementations. Herein, the term “total mass of the anode” is used to refer to the mass of the anode only, excluding any anode current collector foil, separator, and the binder. The masses of the current collector and the separator are excluded from the mass of the anode even if the current collector and the separator are attached to the anode.

In some implementations, the anode may comprise graphitic carbon particles, wherein the graphitic carbon particles are substantially free of silicon. The inventors have found that, in some designs, certain electrolytes may be particularly suitable for use with graphite anodes in lithium-ion batteries. Such a suitable electrolyte for a lithium-ion battery may include a primary lithium salt and an electrolyte compound composition. The electrolyte compound composition may include (1) fluoroethylene carbonate (FEC) and (2) a co-solvent composition. The co-solvent composition may include at least one ester (e.g., at least one ester, at least one branched ester, or at least one linear ester and at least one branched ester) and at least one non-FEC cyclic carbonate. A concentration of the FEC in the electrolyte may be in a range of about 0.1 mol. % to about 30 mol. %. A total concentration of the at least one ester may be at least about 40 mol. %. A total concentration of the at least one non-FEC cyclic carbonate in the electrolyte may be in a range of about 0.5 mol. % to about 30 mol. %. The electrolyte may be substantially free of four-carbon cyclic carbonate.

In some implementations, the anode may comprise a high mass fraction of silicon. The inventors have found that, in some designs, certain electrolytes may be particularly suitable for use with high-silicon anodes in lithium-ion batteries. In some implementations, a mass of the silicon is greater than about 30 wt. % of a total mass of the anode. Herein, the term “total mass of the anode” is used to refer to the mass of the anode only, excluding any anode current collector foil, separator, and the binder. The masses of the current collector and the separator are excluded from the mass of the anode even if the current collector and the separator are attached to the anode. Such a suitable electrolyte for a lithium-ion battery may include a lithium salt composition and an electrolyte compound composition. The lithium salt composition may include (1) a primary lithium salt (e.g., LiPF₆) and (2) a selected salt compound. The electrolyte compound composition may include (1) fluoroethylene carbonate (FEC) and (2) a co-solvent composition. The co-solvent composition may include at least one ester (e.g., at least one ester, at least one branched ester, or at least one linear ester and at least one branched ester), at least one non-FEC cyclic carbonate, and at least one selected covalent compound. A concentration of the FEC in the electrolyte may be in a range of about 0.1 mol. % to about 30 mol. %. A total concentration of the at least one ester may be at least about 40 mol. %. A total concentration of the at least one non-FEC cyclic carbonate in the electrolyte may be in a range of about 0.5 mol. % to about 30 mol. %. A total concentration of the at least one selected covalent compound may be in the range of about 0.1 mol. % to about 95 mol. %, e.g., about 0.1 mol. % to about 5 mol. %, or about 5 mol. % to about 95 mol. %. The electrolyte may be substantially free of four-carbon cyclic carbonate.

In one or more embodiments of the present disclosure, a preferred electrolyte for a lithium-ion battery may include one or more cyclic carbonates (CCs) that promote the formation of solid electrolyte interphase (SEI). Three illustrative examples of such preferred SEI “builders”: fluoroethylene carbonate (FEC), vinylene carbonate (VC), and ethylene carbonate (EC). In some embodiments, FEC, VC and EC may be preferably present in the electrolyte. FEC, VC, and EC are examples of three-carbon cyclic carbonates.

In some implementations, the electrolyte compound composition of the electrolyte includes FEC. In some implementations, a concentration of FEC in the electrolyte may preferably be in a range of approximately 0.1 mol. % to approximately 40 mol. % (in some implementations, from about 0.1 mol. % to about 10 mol. %; in other implementations, from about 10 mol. % to about 18 mol. %; in yet other implementations, from about 18 mol. % to about 40 mol. %). In some preferred embodiments a concentration of FEC is in the range from about 4 mol. % to about 26 mol. %. In some implementations in which the concentration of the at least one ester in the electrolyte is in a range of approximately 45 mol. % to approximately 70 mol. %, the concentration of FEC in the electrolyte may preferably range from approximately 4 mol. % to approximately 26 mol. %. In some designs, when the concentration of FEC in the electrolyte is too low (e.g., in some implementations, less than approximately 1 to 8 mol. % or approximately 1 to 4 mol. %), the cycle life may degrade undesirably fast because of insufficient amount of suitable SEI builders. In some designs, there is more SEI formation when the FEC concentration is greater than approximately 8 mol. %. More robust SEI formation may occur when certain branched esters are present in the electrolyte. However, in some designs, increasing FEC concentrations may undesirably be accompanied by increased high-temperature outgassing, as well as lower discharge voltages (due to the overly resistive SEI formation) and/or increased viscosity of the electrolyte (due to the high viscosity of FEC). Lower discharge voltages typically result in lower volumetric energy densities (VEDs), and higher viscosities result in lower ionic conductivities. For these reasons, the FEC concentration should preferably be set to below a certain threshold (e.g., mol. % threshold) in some designs. In some implementations, the FEC concentration should preferably not exceed approximately 40 mol. %. In some implementations, the FEC concentration preferably does not exceed approximately 20 mol. %. In some implementations, the FEC concentration preferably does not exceed approximately 8 mol. %. For FEC concentrations in a preferred concentration range (such as a range of approximately 0.1 mol. % to approximately 40 mol. %, or a range of approximately 4 mol. % to approximately 26 mol. %, or a range of approximately 8 mol. % to 18 mol. %, or a range of approximately 0.1 mol. % to 8 mol. %), high-temperature outgassing may be effectively mitigated by the addition of certain high-temperature storage additive(s) (e.g., nitrile additive(s), organosulfur additive(s), or lithium salt additive(s)) or high-temperature storage additive(s) in combination with branched ester(s) as discussed hereinbelow. In some designs, within a preferred concentration range, the presence of FEC in the electrolyte may contribute to a preferable balance of sufficiently good cycle life, good ionic conductivity, high discharge voltage, mitigation of high-temperature outgassing, and/or good low-temperature performance.

In some implementations, a concentration of VC in the electrolyte may preferably be in a range of approximately 0.1 mol. % to approximately 5 mol. % (e.g., about 0.1-0.5 mol. %, about 0.5-2.5 mol. % or about 2.5-5 mol. %). In some implementations, the concentration of VC in the electrolyte may preferably be in a range of approximately 0.5 mol. % to approximately 3 mol. %. In some designs, within a preferred concentration range (e.g., in a range of approximately 1 mol. % to approximately 2 mol. %), the presence of VC in the electrolyte may contribute to a preferable balance of good cycle life, good ionic conductivity, high discharge voltage, and high first charge/discharge cycle efficiency.

In some implementations, when the concentration of VC in the electrolyte is too low (e.g., less than approximately 0.5%), the cycle life may degrade too fast because of insufficient amount of SEI formation or insufficiently robust property of the SEI. In some implementations, the cycle life may be better in electrolytes with VC concentrations greater than 0.1 mol. %, greater than about 0.5 mol. %, greater than about 1.0 mol. %, or greater than about 2.0 mol. %. In some implementations, a higher concentration of VC in the electrolyte may result in a higher concentration of VC in the Li-ion solvation shell and a higher concentration of VC (or its decomposition products) in the SEI. Accordingly, a more robust SEI may be formed during the initial 1-100 charge-discharge cycles when the VC concentration is greater than about 1.0 mol. %, greater than about 1.5 mol. %, greater than about 2.0 mol. %, greater than about 2.5 mol. %, greater than about 3.0 mol. %, greater than about 3.5 mol. %, or greater than about 4.0 mol. %. In some designs, because of its high dielectric constant (ε=126 at 25° C.), the presence of VC in the electrolyte may also enable formation of electrolytes with a higher Li-ion conductivity. Therefore, in some implementations, the ionic conductivity may be higher in electrolytes wherein the VC concentration is greater than about 0.1 mol. %, greater than about 0.5 mol. %, greater than about 1.0 mol. %, greater than about 1.5 mol. %, greater than about 2.0 mol. %, greater than about 2.5 mol. %, or greater than about 3.0 mol. %. Nevertheless, in some implementations, there is a greater tendency for high temperature outgassing in electrolytes with higher VC concentrations. Additionally, in some designs, it is advantageous to use lower concentrations of VC to reduce DCR and increase discharge voltage. In some implementations, a good balance among cycle life, ionic conductivity, high discharge voltage, and mitigation of high-temperature outgassing may be achieved when the VC concentration in the electrolyte is in a range of about 0.5 mol. % to about 5 mol. % or in a range of about 1 mol. % to about 2 mol. %.

In one or more embodiments of the present disclosure, an electrolyte for a lithium-ion battery includes a primary lithium salt and an electrolyte compound composition. The electrolyte compound composition may include at least one three-carbon cyclic carbonate and at least one ester (e.g., a linear ester and/or a branched ester, an example of a linear ester is ethyl propionate and an example of a branched ester is ethyl isobutyrate (EI)). The at least one three-carbon cyclic carbonate may include ethylene carbonate (EC). A concentration of the ester (e.g., EI) in the electrolyte may be at least about 50 mol. %. The electrolyte may be substantially free of four-carbon cyclic carbonate. In some implementations, a total concentration of the ester (e.g., EI) in the electrolyte may be in a range of about 50 mol. % to about 80 mol. %. In some implementations, a concentration of the at least one three-carbon cyclic carbonate in the electrolyte may be in a range of about 20 mol. % to about 40 mol. %. In some implementations, the at least one three-carbon cyclic carbonate may comprise fluoroethylene carbonate (FEC) and/or vinylene carbonate. In some implementations, the electrolyte may be substantially free of linear carbonates.

In one or more embodiments of the present disclosure, a lithium-ion battery may include an anode current collector, a cathode current collector, an anode disposed on the anode current collector, a cathode disposed on the cathode current collector, and any one of the foregoing electrolytes ionically coupling the anode and the cathode. For example, there may be a separator interposed in a space between the anode and the cathode, with the electrolyte impregnating the separator.

In some implementations, the anode may comprise graphitic carbon particles, wherein the graphitic carbon particles comprise carbon and are substantially free of silicon. The inventors have found that, in some designs, certain electrolytes may be particularly suitable for use with graphite anodes in lithium-ion batteries. Such a suitable electrolyte for a lithium-ion battery may include a primary lithium salt and an electrolyte compound composition. The electrolyte compound composition may include at least one three-carbon cyclic carbonate and at least one of the following esters: ethyl trimethylacetate (ET), ethyl propionate (EP), ethyl isobutyrate (EI), methyl butyrate (MB), ethyl acetate (EA), methyl acetate (MA), propyl propionate (PP), ethyl isovalerate (EIV). The at least one three-carbon cyclic carbonate may include ethylene carbonate (EC). A concentration of the ester portion of the electrolyte may be at least about 50 mol. %. The electrolyte may be substantially free of four-carbon cyclic carbonate.

In some implementations, it may be advantageous to use ethylene carbonate (EC) as an SEI builder. In some implementations, EC may be used as an SEI builder to build SEI on graphite material and Si-containing anode active material, which helps to improve cycle life. Accordingly, the use of EC in an electrolyte may be beneficial in Li-ion battery cells in which the anode includes graphite or Si-containing anode active material particles, such as blended anodes (e.g., mixture of Si—C(nano)composite particles and graphitic carbon particles), “pure” graphite anodes (e.g., the anode active material particles include graphitic carbon particles (may include soft or hard carbon) but do not include Si—C composite particles), and “pure” Si—C composite anodes (e.g., the anode active material particles include silicon-carbon composite particles but do not include graphite carbon particles). The use of EC in an electrolyte may be particularly beneficial in anodes in which the anode active material includes a large fraction of graphitic carbon particles (e.g., about 90 wt. % to about 100 wt. %). In some implementations, it may be advantageous to use from about 1 mol. % to about 50 mol. %, or 40 mol. % to about 50 mol. %, or 20 mol. % to about 40 mol. %, or about 20 mol. % to about 32 mol. % of EC in the electrolyte. In some implementations, a good balance between cycle life, ionic conductivity, discharge voltage, and low-temperature performance may be achieved when the concentration of EC in the electrolyte is about 1 mol. % to about 32 mol. %, or about 20 mol. % to about 40 mol. %, or about 40 mol. % to about 50 mol. %, or about 20 mol. % to about 32 mol. %.

Propylene carbonate (PC) is known as a co-solvent in electrolyte formulations for Li-ion battery cells. In some implementations of Li-ion batteries as considered herein, such as Li-ion batteries employing blended anodes (e.g., mixture of silicon-carbon composite particles and graphitic carbon particles) and “pure” graphite anodes (e.g., the anode active material particles include graphitic carbon particles but do not include silicon-carbon composite particles), the inventors have found that PC may be an inferior SEI “builder.” Accordingly, in some implementations, electrolytes that include PC may exhibit one or more of the following characteristics, compared to some other electrolytes that do not include PC: lower discharge voltage, inferior cycle life. In some implementations, it may be preferable to avoid the use of PC in electrolytes (e.g., either partially or altogether). PC is an example of a four-carbon cyclic carbonate. In some implementations, it may be preferable to reduce or avoid the use of four-carbon cyclic carbonates in electrolytes. In some implementations, an electrolyte for a lithium-ion battery may be substantially free of four-carbon cyclic carbonates. In some implementations, an electrolyte for a lithium-ion battery may be substantially free of propylene carbonate.

In some designs, the mechanism of the decomposition of cyclic carbonates (CCs) at high temperatures may be different on the cathode and on the anode. For example, the oxidation of CC with the formation of CO and CO₂ on the cathode may be a result of various electrolyte-cathode chemical or electrochemical interactions and result in outgassing. Several mechanisms of the decomposition of CC on the cathode may take place. For example, oxygen which may be released from the cathode at a high state of charge (SOC) (e.g., about 70-100% SOC) may oxidize CCs, leading to the generation of CO/CO₂ mixtures. Also, abstraction of hydrogen (H) from the CC, as a result of an oxidation, may result in the disproportionation of the five-membered ring of the CC with the formation of CO and CO₂. Also, electron abstraction from VC might accelerate the formation of gaseous products. Also, the changes in the magnitude of ion pairing of Li salt, which may be tuned by changing the CC and total Li salt concentration, may result in increased outgassing at elevated temperatures (e.g., battery operating temperatures, e.g., above about 50-80° C.). For example, increased ion pairing of Li⁺ and PF₆⁻ may result in reduced HT outgassing due to the decomposition of LiPF₆ and formation of an LiF protective layer on the cathode surface (CEI). Also, increased solvation of Li⁺ by CCs may result in reduced HT outgassing due to the oxidative stabilization of the CC when coordinating Li⁺.

In some designs, the mechanism of gassing on the anode may be very different from that on the cathode. At high SOC (e.g., about 70-100% SOC), the anode-sourced electrons may work as nucleophiles to attack electrophilic carbonyls of a CC. The resulting decomposition product may be CO₂. In addition to CO₂, the formation of H₂, CO, CH₄, C₂H₄, C₂H₆, C₃H₆ and/or C₃H₈ may also take place as a result of chemical or electrochemical interactions of the electrolyte and the anode surface and may induce substantial HT outgassing.

In one or more embodiments of the present disclosure, a preferred electrolyte for a lithium-ion battery may include at least one linear ester as a main (e.g., about 20 to about 80 mol. %) co-solvent. Illustrative examples of some of the suitable linear esters are: methyl acetate (sometimes abbreviated as MA), methyl propionate (MP), methyl butyrate (MB), ethyl acetate (EA), ethyl propionate (EP), ethyl butyrate (EB), propyl acetate (PA), propyl propionate (PP), propyl butyrate (PB), butyl acetate (BA), butyl propionate (BP), and butyl butyrate (BB).

In one or more embodiments of the present disclosure, a preferred electrolyte for a lithium-ion battery may include at least one branched ester as a main (e.g., about 20 to about 80 mol. %) co-solvent. Illustrative examples of some of the suitable branched esters are: methyl isobutyrate (MI), methyl trimethylacetate (MT), methyl isovalerate (MIV), methyl 2-methylbutyrate (MMB), ethyl isobutyrate (EI), ethyl trimethylacetate (ET), ethyl isovalerate (EIV), ethyl 2-methylbutyrate (EMB), propyl isobutyrate (PI), propyl trimethylacetate (PT), propyl isovalerate (PIV), propyl 2-methylbutyrate (PMB), butyl isobutyrate (BI), butyl trimethylacetate (BT), butyl isovalerate (BIV), butyl 2-methylbutyrate (BMB), isopropyl acetate (IPA), isopropyl propionate (IPP), isopropyl butyrate (IPB), isopropyl isobutyrate (IPI), isopropyl trimethylacetate (IPT), isopropyl isovalerate (IPIV), isopropyl 2-methylbutyrate (IPMB), tert-butyl acetate (TBA), tert-butyl propionate (TBP), tert-butyl butyrate (TBB), tert-butyl isobutyrate (TBI), tert-butyl trimethylacetate (TBT), tert-butyl isovalerate (TBIV), tert-butyl 2-methylbutyrate (TBMB), isobutyl acetate (IBA), isobutyl propionate (IBP), isobutyl butyrate (IBB), isobutyl isobutyrate (IBI), isobutyl trimethylacetate (IBT), isobutyl isovalerate (IBIV), and isobutyl 2-methylbutyrate (IBMB).

In some designs, a suitable mixture of ester compounds may contribute to better ionic conductivity in the electrolyte, better discharge performance (also referred to as “C-rate performance”), better fast charge performance, reduced HT outgassing, reduced end-of-life outgassing, better cycle life, better calendar life, and/or better low-temperature performance. In one or more embodiments of the present disclosure, a preferred electrolyte for a lithium-ion battery may include a mixture of at least one linear ester and at least one branched ester. In some implementations, a total concentration of the mixture (of the at least one linear ester and the at least one branched ester) may be at least about 45 mol. %. In some implementations, the total concentration of the mixture (of the at least one linear ester and the at least one branched ester) may be in a range of about 60 mol. % to about 85 mol. %. In some implementations, a molar ratio of the at least one linear ester to the at least one branched ester may be in a range of about 1:1 to about 10:1. In some implementations, a molar ratio of the at least one linear ester to the at least one branched esters may be in a range of about 1.1:1 to about 1.4:1.

In some designs, suitable ester(s) may contribute to better ionic conductivity in the electrolyte, better discharge performance (also referred to as “C-rate performance”), and/or better low-temperature performance. In some designs, the presence of branched esters in electrolytes that contain FEC, VC, and/or EC may lead to formation of a more robust SEI. Accordingly, in some designs, electrolytes containing branched esters may exhibit good (in some designs, improved) cycle life. In one or more embodiments of the present disclosure, a concentration of ester(s) (linear esters, branched esters, or a mixture of linear esters and branched esters) in the electrolyte may preferably be in a range of approximately 20 mol. % to approximately 70 mol. %. In other embodiments, the concentration of esters in the electrolyte may preferably be in a range of approximately 45 mol. % to approximately 70 mol. %. In other embodiments, the concentration of esters in the electrolyte may preferably be in a range of approximately 30 mol. % to approximately 50 mol. %. In other embodiments, the concentration of esters in the electrolyte may preferably be in a range of approximately 50 mol. % to approximately 80 mol. %. In other embodiments, the concentration of esters in the electrolyte may preferably be at least approximately 30 mol. %. In other embodiments, the concentration of esters in the electrolyte may preferably be at least approximately 40 mol. %. In other embodiments, the concentration of esters in the electrolyte may preferably be at least approximately 50 mol. %. In other embodiments, the concentration of esters in the electrolyte may preferably be at least approximately 60 mol. %.

In some implementations, ethyl propionate (EP), a linear ester, may contribute to lower viscosity, higher discharge voltages, better C-rate performance, and/or better low-temperature performance. However, in some designs, the presence of EP in an electrolyte may also undesirably lead to high-temperature outgassing, end-of-life outgassing, shorter cycle life, and/or evolution of gaseous by-products on the anode and cathode. Accordingly, in some designs, a concentration of EP in the electrolyte may preferably be in a range of approximately 20 mol. % to approximately 80 mol. % (in some designs, from about 30 mol. % to about 60 vol. %). Within this preferred concentration range, in some designs, the presence of EP in the electrolyte may contribute to a favorable balance of good cycle life, high discharge voltage, and/or mitigation of high-temperature outgassing and/or end-of-life-outgassing in a suitable electrolyte (which, in some designs, may also comprise SEI “builders” or a combination of SEI “builders” and branched esters).

In some implementations, ethyl isobutyrate (EI), a branched ester, may contribute to better cycle life, decreased high-temperature outgassing, and/or decreased end-of-life outgassing compared to the linear (non-branched) ethyl propionate (EP). Furthermore, the flash point of EI, which is approximately 20° C., is higher than that of EP which is approximately 12° C., which may reduce the flammability of the electrolyte and improve battery safety. However, in some designs, the presence of EI in an electrolyte may lead to a reduction of the discharge voltage, a reduction of the C-rate performance (e.g., due to increased charge transfer resistance), and an increase in DCR. In some designs, this reduction of C-rate performance may be mitigated by adding certain charge-transfer additive salt(s) (e.g., lithium difluorophosphate (LiPO₂F₂), abbreviated LFO, or lithium tetrafluoroborate (LiBF₄), among others and their various combinations). Accordingly, in some designs, a concentration of EI in the electrolyte may preferably be in a range of approximately 25 mol. % to approximately 80 mol. %. Within this preferred concentration range, in some designs, the presence of EI in the electrolyte may contribute to a suitable balance of good cycle life, high discharge voltage, and/or mitigation of high-temperature outgassing and/or end-of-life-outgassing in a suitable electrolyte (which, in some designs that may preferably comprise cyclic carbonates). In some implementations, a mixture of EP (linear ester) and EI (branched ester) may be employed in a suitable electrolyte (e.g., an electrolyte employing a three-carbon cyclic carbonate such as FEC), wherein a molar ratio of the EP (linear ester) to the EI (branched ester) may be in a range of about 1:1 to about 10:1. In some implementations, a molar ratio of the EP (linear ester) to the EI (branched ester) may be in a range of about 1.1:1 to about 1.4:1.

Ethyl isovalerate (EIV) is another example of a branched ester that may be used to improve some of the performance characteristics of a Li-ion battery. Accordingly, in some implementations, a mixture of EP (linear ester) and EIV (branched ester) may be employed in a suitable electrolyte (e.g., an electrolyte employing a three-carbon cyclic carbonate such as FEC), wherein a molar ratio of the EP (linear ester) to the EIV (branched ester) may be in a range of about 1:1 to about 10:1. In some implementations, a molar ratio of the EP (linear ester) to the EIV (branched ester) may be in a range of about 1.1:1 to about 1.4:1. Additionally, in some implementations, a mixture of EP (linear ester), EI (branched ester), and EIV (branched ester) may be employed in a suitable electrolyte (e.g., an electrolyte employing a three-carbon cyclic carbonate such as FEC), wherein a molar ratio of the EP (linear ester) to the sum of the EI and EIV (branched esters) may be in a range of about 1:1 to about 10:1. In some implementations, a molar ratio of the EP (linear ester) to the sum of the EI and EIV (branched esters) may be in a range of about 1.1:1 to about 1.4:1.

In some implementations, it may be beneficial to use a branched ester, ethyl trimethyl acetate (ET), as an SEI builder for anodes which employ blended anodes including graphitic carbon particles and Si—C composite particles. In some designs, the presence of ET in an electrolyte may increase the cycle life of blended anodes containing graphite particles. In some designs, an ET-comprising electrolyte may be applied to either graphite anodes or blended anodes in which graphite (e.g., graphitic carbon particles) is mixed with Si—C composite particles. In some designs, the presence of ET in the electrolyte may contribute to decreased HT outgassing at the anodes, which may be graphite anodes or blended anodes of graphite (e.g., graphitic carbon particles) and Si—C composite particles. In some designs, the presence of ET in the electrolyte may contribute to decreased HT outgassing at the cathodes. The inventors have found that, in some designs, ET may contribute to the formation of robust anode SEI on both graphitic carbon particles and Si—C composite particles. The inventors have also found that, in some designs, ET may contribute to the formation of robust CEI on the cathode particles. In some designs, the use of ET in the electrolyte may be beneficial for high voltage cathode materials (e.g., LCO, NMC811). In some designs, the use of ET in the electrolyte may be beneficial for cathodes featuring polycrystalline microstructures, thereby enabling the formation of robust CEI. In some implementations, ET may be used in an electrolyte containing ethylene carbonate (EC). In some other designs, it may be more advantageous to use ET in an electrolyte with FEC to improve low temperature performance. In some designs, it may be advantageous to use ET as a main co-solvent with the molar fraction of ET in the electrolyte being at least about 50 mol. %. In some other designs it may be advantageous to use ET as a secondary co-solvent with a molar fraction of ET in the electrolyte ranging from about 5 mol. % to about 50 mol. %.

In one or more embodiments of the present disclosure, a preferred electrolyte for a Li-ion battery may include at least one linear carbonate (LC). Two illustrative examples of linear carbonates are: dimethyl carbonate (DMC) and ethyl methyl carbonate (EMC). The molecular weights of DMC and EMC are about 90.08 g/mol (DMC) and about 104.10 g/mol (EMC), respectively. These linear carbonates are notable for their relatively low viscosities (approximately 0.59 cP for DMC and approximately 0.65 cP for EMC, at 25° C.). Accordingly, in some designs, the viscosity of an electrolyte may be decreased by adding one or more of these linear carbonates. For example, in some electrolyte formulations, EMC may increase discharge voltage and improve low-temperature performance. In some designs, linear carbonates may be used in an electrolyte at relatively low concentrations, such as in a range of approximately 6 mol. % to approximately 17 mol. % (in other designs, from about 1 mol. % to about 20 mol. %, in other designs from about 0 mol. % to about 6 mol. %, and in other designs, the LC may be omitted entirely). Another example of a linear carbonate is diethyl carbonate (DEC), which has a molecular weight of about 118.13 g/mol.

In some designs, it may be beneficial to reduce or avoid using linear carbonates in electrolytes that contain FEC. For example, this may apply to electrolytes comprising (1) an electrolyte compound composition comprising fluoroethylene carbonate (FEC) and a co-solvent composition comprising at least one linear ester and at least one branched ester, or (2) an electrolyte compound composition comprising fluoroethylene carbonate (FEC) and a co-solvent composition comprising at least one ester and at least one non-FEC cyclic carbonate. Accordingly, in some implementations, the electrolyte may be substantially free of diethyl carbonate, dimethyl carbonate, and ethyl methyl carbonate. In some implementations, the electrolyte may be substantially free of linear carbonates. In some designs, the combination of FEC with linear carbonates may decrease the cycle life due to the structure of Li-ion solvation shell (e.g., FEC is displaced from the solvation shell in the presence of linear carbonates) and due to the chemical degradation of FEC by linear carbonates or the products of electrochemical decomposition of linear carbonates (such as alkoxides). In some implementations, the FEC concentration preferably does not exceed approximately 20 mol. %. In some implementations, the FEC concentration may preferably be in a range of about 4 mol. % to about 20 mol. %. In some implementations, the FEC concentration may be lower than about 4 mol. %.

The inventors have investigated the use of ethylene carbonate (EC), a three-carbon cyclic carbonate, in certain electrolytes with the aim of improving lithium-ion batteries including graphite anodes and blended anodes of graphite particles and Si—C composite particles. The inventors have found that, in some designs, EC may be effective as a main SEI “builder”. The inventors have found that, in some designs, it is more advantageous to use EC as a main SEI builder for electrolytes in lithium-ion batteries (with graphite anodes or blended anodes comprising graphite particles and Si—C composite particles), when the electrolytes contain certain linear carbonates as main co-solvents. However, it may be advantageous to avoid using (or reduce the concentration of) FEC in the electrolytes containing EC. In some designs, the presence of FEC and EC in electrolyte may be disadvantageous to the cycle life of the anodes with “pure” graphite anodes or blended anodes of graphite particles and Si—C composite particles. These phenomena may be related to the structure of the Li-ion solvation shell in which FEC is displaced from the Li-ion solvation shell in the presence of EC.

In one or more embodiments of the present disclosure, an electrolyte for a lithium-ion battery includes a primary lithium salt and an electrolyte compound composition. The electrolyte compound composition may include fluoroethylene carbonate (FEC) and a co-solvent composition. The co-solvent composition may include at least one linear carbonate. A concentration of the FEC in the electrolyte may be in a range of about 4 mol. % to about 20 mol. %. In some designs, a total concentration of the at least one linear carbonate in the electrolyte is at least about 40 mol. %. In some designs, the electrolyte may be substantially free of four-carbon cyclic carbonate. In some implementations, it may be preferable to select ethyl methyl carbonate and/or dimethyl carbonate as the at least one linear carbonate, and to reduce or avoid using diethyl carbonate (molecular weight of about 118). In some implementations, it may be preferable to select dimethyl carbonate as the at least one linear carbonate. The electrolyte may be substantially free of any linear carbonate of molecular weight greater than 117. In some implementations, a total concentration of the linear carbonate in the electrolyte may be in a range of about 60 mol. % to about 75 mol. %. In some implementations, the electrolyte may additionally include at least one non-FEC cyclic carbonate, which may be selected from ethylene carbonate and vinylene carbonate. In some implementations, the electrolyte additionally includes a non-FEC cyclic carbonate, and a concentration of the at least one non-FEC cyclic carbonate in the electrolyte is in a range of about 1 mol. % to about 30 mol. %, or in a range of about 15 mol. % to about 30 mol. %.

In one or more embodiments of the present disclosure, a lithium-ion battery may include an anode current collector, a cathode current collector, an anode disposed on the anode current collector, a cathode disposed on the cathode current collector, and any one of the foregoing electrolytes ionically coupling the anode and the cathode. For example, there may be a separator interposed in a space between the anode and the cathode, with the electrolyte impregnating the separator. In some implementations, the anode may comprise a mixture of (A) Si—C composite particles comprising silicon and carbon, and (B) graphitic carbon particles comprising carbon and being substantially free of silicon. Such an anode comprising a mixture is sometimes referred to as a blended anode herein. In some implementations, a mass of the silicon is in a range of about 3 wt. % to about 80 wt. % of a total mass of the anode. Herein, the term “total mass of the anode” is used to refer to the mass of the anode only, excluding any anode current collector foil, separator, and the binder. The masses of the current collector and the separator are excluded from the mass of the anode even if the current collector and the separator are attached to the anode.

The inventors have found that in some implementations in which the anode comprises a graphite anode or blended anode of graphite and Si—C composite particles or graphite-free anode, it may be advantageous to use electrolytes that contain FEC but do not contain EC. In some designs, it may be beneficial to use an ester as a main co-solvent in combination with FEC. In some designs, electrolytes that contain esters and FEC are beneficial for improved cycle life of graphite anodes and blended anodes of graphite and Si—C composite particles. In some designs, the presence of EC in such electrolytes may lead to decreased cycle life. This phenomenon may be due to the poorer SEI building properties of EC compared to FEC. In some designs, the fraction of one or more esters in such electrolytes may exceed about 50 mol. %. In some other designs, the combination of linear and branched esters may be beneficial to increase discharge voltage, improve cycle life, and decrease charge transfer resistance.

The inventors have found that, in some implementations, it may be beneficial to use one or more non-carbonate and non-ester co-solvents, such as ketones (e.g., hexamethyl acetone, pinacolone, methyl ethyl ketone, diethyl ketone, methyl isopropyl ketone, diisopropyl ketone, ethyl isopropyl ketone), (fluoro)hydrocarbons (e.g., heptane, hexane, octane, cyclohexane, cycloheptane, benzene, toluene, xylene, tert-butyl benzene, fluorobenzenes, fluorotoluenes, fluoroxylenes, fluoroheptanes, fluorooctanes, fluorohexanes, fluoropentanes), sulfites (e.g., ethyl methyl sulfite, diethyl sulfite, 1,3-propylene sulfite, 1,2-propylene sulfite), phosphates (e.g., trimethyl phosphate, triethyl phosphate, triphenyl phosphate), fluorinated ethers (e.g., 1,1,2,2-tetrafluoroethyl 2,2,3,3-tetrafluoropropyl ether), sulfones (e.g., sulfolane, ethyl isopropyl sulfone, ethyl methyl sulfone), amides (e.g., N,N-dimethylformamide, hexamethylphosphoramide, N-methyl-2-pyrrolidinone, tetramethylurea, N,N′-dimethylpropyleneurea, 1,3-dimethyl-2-imidazolidinone), nitriles (e.g., acetonitrile, propionitrile, butyronitrile, valeronitrile, hexanenitrile trimethylaceonitrile), sulfoxides (e.g., dimethyl sulfoxide, tetrahydrothiophene 1-oxide), fluorinated amines (e.g., pentadecafluorotriethylamine), and nitro compounds (e.g., nitromethane, nitropropane). Such non-carbonate and non-ester co-solvents may confer one or more of the following benefits to an electrolyte and/or battery cell: reduced electrolyte viscosity, increased salt solvation, increased ionic conductivity, improved rate performance, reduced DCR, reduced HT outgassing at the cathode, reduced outgassing at the anode, improved cycle life, decreased flammability, improved calendar life, reduced cost. The inventors have found that, in some designs, it may be more advantageous to use moderate-to-high FEC concentrations (e.g., greater than about 10 mol. %, greater than about 15 mol. %, or greater than about 20 mol. %) in electrolytes in lithium-ion batteries (with graphite anodes, blended anodes comprising graphite particles and Si—C composite particles, or graphite-free anodes) when the electrolytes contain non-ester and non-carbonate co-solvents. The inventors have also found that, in some designs, it may be advantageous to use moderate-to-high concentrations (e.g., greater than about 5 mol. %, greater than about 15 mol. %, or greater than about 20 mol. %) of one or more selected covalent compounds with high reduction potentials (e.g., between about 1.5 V to about 3.0 V vs Li/Li⁺) in electrolytes in lithium-ion batteries (with graphite anodes, blended anodes comprising graphite particles and Si—C composite particles, or graphite-free anodes) when the electrolytes contain non-ester and non-carbonate co-solvents. The inventors have also found that, in some designs, it may be advantageous to use moderate-to-high concentrations (e.g., greater than about 4 mol. %, greater than about 6 mol. %, or greater than about 10 mol. %) of one or more selected salt compounds with high reduction potentials (e.g., between about 1.5 V to about 3.0 V vs Li/Li⁺) in electrolytes in lithium-ion batteries (with graphite anodes, blended anodes comprising graphite particles and Si—C composite particles, or graphite-free anodes) when the electrolytes contain non-ester and non-carbonate co-solvents.

In some implementations, the electrolyte may additionally include one or more charge transfer additives which may reduce the charge transfer resistance on the anode or cathode electrodes. Certain Li salt additives as well as some other compounds may function as charge transfer additives. In some implementations, one or more charge transfer additives may be selected from: lithium difluorophosphate (LiPO₂F₂ or LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB) (Compound No. 43, 2006), lithium bis(oxalato)borate (LiBOB), and 1,3,2-dioxathiolane 2,2-dioxide (DTD) (Compound No. 1, 302). In some implementations, a concentration of the charge transfer additives (e.g., lithium salt additives, DTD) may be in a range of approximately 0.1 mol. % to approximately 15 mol. % (e.g., from about 0.1 mol. % to about 1 mol. %; or from about 1 mol. % to about 5 mol. %; or from about 5 mol. % to about 10 mol. %; or from about 10 mol. % to about 15 mol. %). In some implementations, a concentration of the charge transfer additives may be in a range of approximately 0.5 mol. % to approximately 10 mol. %. In some implementations, a concentration of the charge transfer additives may be in a range of approximately 0.5 mol. % to approximately 1.5 mol. %. In some implementations, a concentration of the additive lithium salt(s) in the electrolyte may preferably be in a range of approximately 0.01 M to approximately 0.6 M (e.g., from about 0.01 M to about 0.05 M; or from about 0.05 M to about 0.1 M; or from about 0.1 M to about 0.2 M; or from about 0.2 M to about 0.4 M; or from about 0.4 M to about 0.6 M). In some implementations, a concentration of the additive lithium salt(s) in the electrolyte may preferably be in a range of approximately 0.01 M to approximately 0.2 M. In some implementations, a concentration of the additive lithium salt(s) in the electrolyte may preferably be in a range of approximately 0.05 M to approximately 0.15 M.

The inventors have found that, in some designs, it may be advantageous to use LFO additive to reduce HT outgassing, improve discharge voltage (V), improve charge and discharge rates and reduce DCR. In some designs, the presence of LFO may reduce HT outgassing by up to 100% compared to electrolyte formulations that do not contain LFO, which may be related to the formation of cathode surface film or fluorination of the cathode surface, which impedes other electrolyte components from oxidative decomposition. The inventors have found that, in some designs, the presence of LFO may lead to the reduced formation of carbon dioxide and carbon monoxide in the battery cells with LCO and/or NMC (e.g., NCM811, among others)—comprising cathodes and/or LMNO and/or LMTO and/or LMTOF or LMFP as the cathode, in some designs. In some designs, the presence of LFO may improve discharge V, which may be related to the formation of highly ionically conducting cathode CEI and anode SEI. In some designs, the concentration of LFO and overall electrolyte composition may need to be optimized for a particular cell chemistry and battery design. For example, in some designs, the presence or excess of LFO may undesirably reduce cycle life which may be related to poor mechanical properties of the resulting cathode CEI. In some other designs, however, the presence of LFO may increase cycle life which may be related to passivation of the cathode surface leading to inhibition of the parasitic cathode-electrolyte side reactions during cycling. In some other designs, LFO may reduce charge performance due to, for example, the chemical passivation on the surface of binders. In other designs, LFO may improve charge transfer performance.

The inventors have found that, in some designs, it may be advantageous to use LiBF4 additive to cut HT outgassing, improve discharge voltage (V), and improve charge and discharge rates. In some designs, the electrolyte formulations which contain LiBF₄ may be advantageously used to cut HT outgassing, which may be related to the formation of LiF and transition metal fluorides on the cathode surface. The LiF and transition metal fluorides may originate from reaction or decomposition of LiBF₄ at the cathode surface due to the low oxidation potential of LiBF₄. However, the LiF and transition metal fluorides may also originate from reaction or decomposition of LiPF₆ due to the changes in the Li-ion solvation shell and lower concentration of LiPF₆ contact ion pair in the presence of LiBF₄. In some designs, it may be advantageous to use LiBF₄ to improve charge and discharge rates, which may be related to the formation of highly ionically conductive cathode CEI and anode SEI. In some designs, it may be advantageous to use LiBF₄ to decrease DC resistance, which may be related to the formation of highly conducting cathode CEI and anode SEI. In some designs, the use of LiBF₄, may lead to reduced cycle life due to the formation of poor anode SEI, which is due to poor mechanical properties of SEI, possibly due to excessive formation of LiF. In some designs the use of LiBF₄ may lead to reduced ELY conductivity and increased ELY viscosity, which may be related to the stronger coordination of BF₄⁻ to Li-ion.

The inventors have found that, in some designs, it may be advantageous to use LIDFOB additive to improve discharge voltage (V), improve charge and discharge rates, and improve cycle life, which may be related to the formation of highly ionically conducting cathode CEI and anode SEI with more uniform, conformal surface coverage on the anode and cathode particles, possibly due to the formation of organo-borate oligomeric and polymeric decomposition products. In some designs it is advantageous to use LiDFOB to maintain low DCR during cycling. In some other designs, the electrolyte formulations which contain LiDFOB may increase HT outgassing on the cathode, which may be related to the low oxidative stability of the difluoro(oxalato)borate anion. In some other designs, the electrolyte formulations which contain LiDFOB may increase DC resistance.

The inventors have found that, in some designs, it may be advantageous to use DTD as an additive to improve discharge voltage (V), improve charge and discharge rates, improve cycle life, and reduce HT outgassing on the cathode. In some designs, it may be advantageous to use DTD to decrease DCR. In some designs, it may be advantageous to use DTD to improve discharge voltage (V), improve charge and discharge rates, and improve cycle life, which may be due to the formation of Li₂SO₄, other sulfate and sulfite salts, and oligomeric and polymeric organo-sulfur species in the anode SEI and cathode CEI, which increase the ionic conductivity and mechanical stability of the SEI and CEI. In some designs, it may be advantageous to use DTD to reduce HT outgassing on the cathode, which may be due to the formation of Li₂SO₄, other sulfate and sulfite salts, and oligomeric and polymeric organo-sulfur species in the cathode CEI, which impede oxidation of other electrolyte components at the cathode surface.

The inventors have found that, in some designs, it may be advantageous to use LiFSI as an additive—particularly in battery cell designs that do not exceed a maximum cell voltage of about 4.4V—to improve discharge voltage (V), improve charge and discharge rates, improve cycle life, improve high temperature cycle life, and reduce HT outgassing on the cathode. In some designs, electrolyte formulations which contain LiFSI improve discharge voltage (V) and improve charge and discharge rates, which may be due to the weaker coordination of the FSI anion to the Li cation, as well as the increased formation of LiF and LiSO₂F in the anode SEI and cathode CEI, which increase their ionic conductivity. In some designs, electrolyte formulations which contain LiFSI improve cycle life and improve high temperature cycle life, which may be due to the increased formation of LiF and LiSO₂F in the anode SEI and cathode CEI, which increase the mechanical stability and uniformity of the SEI and CEI and improve the conformality of the SEI and CEI layers on the particle surfaces. In some designs, electrolyte formulations which contain LiFSI reduce HT outgassing on the cathode, which may be due to formation of LiF at the cathode surface and fluorination of the reactive cathode surface, which impedes oxidation of other electrolyte components at the cathode.

The inventors have found that, in some designs, it may be advantageous to use LiSO₃F as an additive to improve discharge voltage (V), improve charge and discharge rates, and improve cycle life, which may be due to the increased formation of LiF, Li₂O, LiSO₃F, and LiSO₂F in the anode SEI, which increase the ionic conductivity and mechanical stability of the SEI.

Accordingly, in some implementations, it may be advantageous to employ LFO, LiBF₄, DTD, LiFSI, LiSO₃F, and LiDFOB, or a combination thereof, as charge transfer additives in an electrolyte. In some cases, a total concentration of LFO, LiBF₄, DTD, LiFSI and LiDFOB combined may be in a range of about 0.1 mol. % to about 10 mol. %, or in a range of about 0.1 mol. % to about 6 mol. %, or in a range of about 0.5 mol. % to about 1.5 mol. %.

The inventors have found that, in some designs, cells comprising anode electrodes based on Si-nanocomposite and graphite particles or powders, may benefit from electrolytes which exhibit moderate-to-low fluoroethylene carbonate (FEC) concentration and low-to-minimum vinylene carbonate (VC) concentration, wherein “moderate-to-low” is from about 18 mol. % to about 8 mol. % and “low-to-minimum” is from about 5 mol. % to about 1 mol. %. FEC and VC are examples of three-carbon cyclic carbonates. Ethylene carbonate (EC) is another three-carbon cyclic carbonate.

For example, unlike electrolytes with high concentration of FEC and VC, wherein “high” is above about 18 mol. % for FEC and above about 5 mol. % for VC, electrolytes with moderate-to-low FEC concentration and low-to-minimum VC concentration may improve the SEI stability during cycling, improve cycle life, cut HT outgassing on the cathode, improve the respective electrolyte's ionic conductivity, improve discharge voltage (V), reduce direct current (DC) resistance, decrease voltage hysteresis, and reduce anode charge transfer resistance.

The inventors have found that, in some designs, it may be advantageous to maintain a low concentration of VC in the electrolyte (including post-formation) to ensure that there is no electrolyte outgassing under HT storage conditions due to excessive decomposition of residual VC in post-formed cells on the cathode. It may be advantageous in some designs to use a suitable amount of branched ester co-solvents in electrolyte (ELY) formulations to cut HT outgassing caused by VC. In some preferential designs it might be advantageous to use some small fraction of branched ester to form a protective film at the cathode.

The inventors have found that, in some designs, particularly those with a high fraction of silicon in the anode (e.g., greater than about 25 wt. % of all active and inactive materials in the anode, excluding the mass of the current collector), it may be advantageous to supplement FEC or partially or fully replace FEC in the electrolyte formulation with selected covalent compounds and/or selected salt compounds in order to improve the SEI stability during cycling, improve cycle life, cut HT outgassing on the cathode, suppress outgassing during cycling, improve the respective electrolyte's ionic conductivity, reduce the respective electrolyte's viscosity, improve discharge voltage (V), reduce direct current (DC) resistance, decrease voltage hysteresis, reduce anode and cathode charge transfer resistance, improve battery calendar life, and reduce the respective electrolyte's cost. In some designs, supplementing FEC or partially or fully replacing FEC in the electrolyte formulation with selected covalent compounds and/or selected salt compounds may improve the SEI stability even when other components with higher reduction potentials, greater propensity to coordinate Li ions, or worse SEI forming properties compared to known SEI forming components are used (particularly co-solvents such as ethyl propionate, ethyl isobutyrate, ethyl acetate, methyl acetate, propyl propionate, ethyl isovalerate, ethyl trimethylacetate, methyl butyrate, γ-butyrolactone, dimethyl carbonate, ethyl methyl carbonate, diethyl carbonate, methyl phenyl carbonate, diphenyl carbonate, hexamethyl acetone, pinacolone, methyl ethyl ketone, diethyl ketone, methyl isopropyl ketone, diisopropyl ketone, ethyl isopropyl ketone, heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride, ethyl methyl sulfite, diethyl sulfite, 1,3-propylene sulfite, 1,2-propylene sulfite, sulfolane, dimethyl sulfone, ethyl methyl sulfone, ethyl isopropyl sulfone, dimethyl sulfoxide, tetrahydrothiophene 1-oxide, trimethyl phosphate, triethyl phosphate, triphenyl phosphate, 1,1,2,2-tetrafluoroethyl 2,2,3,3-tetrafluoropropyl ether, perfluorotriethylamine, N,N-dimethylformamide, hexamethylphosphoramide, N-methyl-2-pyrrolidinone, tetramethylurea, N,N′-dimethylpropyleneurea, 1,3-dimethyl-2-imidazolidinone, nitromethane, nitropropane, acetonitrile, propionitrile, butyronitrile, valeronitrile, hexanenitrile, trimethylacetonitrile, and others). The inventors have found that, in some designs, when the total concentration of selected covalent compounds or selected salt compounds is low (e.g., below about 5 mol. %), only a subset of such co-solvents may be beneficial (e.g., ethyl propionate, ethyl isobutyrate, ethyl acetate, methyl acetate, propyl propionate, ethyl isovalerate, ethyl trimethylacetate, methyl butyrate, γ-butyrolactone, dimethyl carbonate, ethyl methyl carbonate, diethyl carbonate, methyl phenyl carbonate, diphenyl carbonate, hexamethyl acetone, pinacolone, methyl isopropyl ketone, diisopropyl ketone, ethyl isopropyl ketone, heptane, hexane, octane, cyclohexane, cycloheptane, fluorobenzenes, fluorotoluenes, fluoroxylenes, fluoroheptanes, fluorooctanes, fluorohexanes, fluoropentanes, benzoyl fluoride, ethyl methyl sulfite, diethyl sulfite, 1,3-propylene sulfite, 1,2-propylene sulfite, sulfolane, dimethyl sulfone, ethyl methyl sulfone, ethyl isopropyl sulfone, triphenyl phosphate, 1,1,2,2-tetrafluoroethyl 2,2,3,3-tetrafluoropropyl ether, perfluorotriethylamine, nitropropane, or trimethylacetonitrile).

In some implementations, the electrolyte formulation contains a moderate concentration of FEC in the range of about 5 mol. % to about 30 mol. %, preferably about 8 mol. % to about 18 mol. %, and the electrolyte formulation may preferably contain one or more selected covalent compounds and/or selected salt compounds. A total concentration of the one or more selected covalent compounds may preferably be in the range of about 0.1 mol. % to about 95 mol. %, preferably about 5 mol. % to about 70 mol. %, about 0.1 mol. % to about 10 mol. %, about 20 mol. % to about 40 mol. %, about 30 mol. % to about 70 mol. %, or about 5 mol. % to about 30 mol. %. A total concentration of the one or more selected salt compounds may preferably be in the range of about 0.1 mol. % to about 15 mol. %, preferably about 0.1 mol. % to about 10 mol. %, about 0.1 mol. % to about 6 mol. %, or about 0.1 mol. % to about 4 mol. %. In some implementations, the electrolyte formulation may contain at least one non-ester and non-carbonate co-solvent (e.g., hexamethyl acetone, pinacolone, methyl ethyl ketone, diethyl ketone, methyl isopropyl ketone, diisopropyl ketone, ethyl isopropyl ketone, heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride, ethyl methyl sulfite, diethyl sulfite, 1,3-propylene sulfite, 1,2-propylene sulfite, sulfolane, dimethyl sulfone, ethyl methyl sulfone, ethyl isopropyl sulfone, dimethyl sulfoxide, tetrahydrothiophene 1-oxide, trimethyl phosphate, triethyl phosphate, triphenyl phosphate, 1,1,2,2-tetrafluoroethyl 2,2,3,3-tetrafluoropropyl ether, perfluorotriethylamine, N,N-dimethylformamide, hexamethylphosphoramide, N-methyl-2-pyrrolidinone, tetramethylurea, N,N′-dimethylpropyleneurea, 1,3-dimethyl-2-imidazolidinone, nitromethane, nitropropane, acetonitrile, propionitrile, butyronitrile, valeronitrile, hexanenitrile, or trimethylacetonitrile) at a total concentration of at least about 10 mol. %.

In some implementations, the electrolyte formulation contains a minimum concentration of FEC in the range of about 0.1 mol. % to about 10 mol. %, preferably about 0.1 mol. % to about 8 mol. %, about 0.1 mol. % to about 5 mol. %, or about 0.1 mol. % to about 3 mol. %, and the electrolyte formulation may preferably contain one or more selected covalent compounds and/or selected salt compounds. A total concentration of the one or more selected covalent compounds may preferably be in the range of about 0.1 mol. % to about 95 mol. %, preferably about 5 mol. % to about 70 mol. %, about 0.1 mol. % to about 10 mol. %, about 20 mol. % to about 40 mol. %, about 30 mol. % to about 70 mol. %, or about 5 mol. % to about 30 mol. %. A total concentration of the one or more selected salt compounds may preferably be in the range of about 0.1 mol. % to about 15 mol. %, preferably about 0.1 mol. % to about 10 mol. %, about 0.1 mol. % to about 6 mol. %, or about 0.1 mol. % to about 4 mol. %. In some implementations, the electrolyte formulation may contain at least one non-ester and non-carbonate co-solvent (e.g., hexamethyl acetone, pinacolone, methyl ethyl ketone, diethyl ketone, methyl isopropyl ketone, diisopropyl ketone, ethyl isopropyl ketone, heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride, ethyl methyl sulfite, diethyl sulfite, 1,3-propylene sulfite, 1,2-propylene sulfite, sulfolane, dimethyl sulfone, ethyl methyl sulfone, ethyl isopropyl sulfone, dimethyl sulfoxide, tetrahydrothiophene 1-oxide, trimethyl phosphate, triethyl phosphate, triphenyl phosphate, 1,1,2,2-tetrafluoroethyl 2,2,3,3-tetrafluoropropyl ether, perfluorotriethylamine, N,N-dimethylformamide, hexamethylphosphoramide, N-methyl-2-pyrrolidinone, tetramethylurea, N,N′-dimethylpropyleneurea, 1,3-dimethyl-2-imidazolidinone, nitromethane, nitropropane, acetonitrile, propionitrile, butyronitrile, valeronitrile, hexanenitrile, or trimethylacetonitrile) at a total concentration of at least about 10 mol. %.

In some implementations, the electrolyte formulation is substantially free of FEC and contains one or more selected covalent compounds and/or selected salt compounds. A total concentration of the one or more selected covalent compounds may preferably be in the range of about 5 mol. % to about 95 mol. %, preferably about 5 mol. % to about 70 mol. %, about 20 mol. % to about 40 mol. %, about 30 mol. % to about 70 mol. %, or about 5 mol. % to about 30 mol. %. A total concentration of the one or more selected salt compounds may preferably be in the range of about 0.1 mol. % to about 15 mol. %, preferably about 0.1 mol. % to about 10 mol. %, about 0.1 mol. % to about 6 mol. %, or about 0.1 mol. % to about 4 mol. %. In some implementations, the electrolyte formulation may contain at least one non-ester and non-carbonate co-solvent (e.g., hexamethyl acetone, pinacolone, methyl ethyl ketone, diethyl ketone, methyl isopropyl ketone, diisopropyl ketone, ethyl isopropyl ketone, heptane, hexane, octane, cyclohexane, cycloheptane, benzene, toluene, xylene, tert-butylbenzene, fluorobenzenes, fluorotoluenes, fluoroxylenes, fluoroheptanes, fluorooctanes, fluorohexanes, fluoropentanes, benzoyl fluoride, ethyl methyl sulfite, diethyl sulfite, 1,3-propylene sulfite, 1,2-propylene sulfite, sulfolane, dimethyl sulfone, ethyl methyl sulfone, ethyl isopropyl sulfone, dimethyl sulfoxide, tetrahydrothiophene 1-oxide, trimethyl phosphate, triethyl phosphate, triphenyl phosphate, 1,1,2,2-tetrafluoroethyl 2,2,3,3-tetrafluoropropyl ether, perfluorotriethylamine, N,N-dimethylformamide, hexamethylphosphoramide, N-methyl-2-pyrrolidinone, tetramethylurea, N,N′-dimethylpropyleneurea, 1,3-dimethyl-2-imidazolidinone, nitromethane, nitropropane, acetonitrile, propionitrile, butyronitrile, valeronitrile, hexanenitrile, or trimethylacetonitrile) at a total concentration of at least about 10 mol. %.

In some designs, the surface of a cathode and an anode may preferably be protected by one or more high-temperature storage additives (e.g., nitrile additives as well as other compounds) to decrease HT outgassing and mitigate transition metal dissolution. As used herein, the term “nitriles” refers to organic molecules which feature one or more CN (nitrile) groups. In some preferable examples, the nitriles may be di-nitriles. In other preferable examples, the nitriles may be tri-nitriles. In other preferable examples, the nitriles may be tetrakis-nitriles. In other preferable examples, the nitriles may be mono-nitriles.

Some examples of nitrile compounds that may be used as high-temperature storage additives are: adiponitrile (sometimes abbreviated as ADN) (dinitrile), 3-(2-cyanoethoxy) propanenitrile (dinitrile), 1,5-dicyanopentane (dinitrile), 1-(cyanomethyl)cyclopropane-1-carbonitrile (dinitrile), 4,4-dimethylheptanedinitrile (dinitrile), trans-1,4-dicyano-2-butene (dinitrile), 1,3,6-hexanetricarbonitrile (sometimes abbreviated HTCN) (trinitrile), 3-{[1,3-bis(2-cyanoethoxy)propan-2-yl]oxy} propanenitrile (trinitrile), 1-(propan-2-yl)-1H-imidazole-4,5-dicarbonitrile (dinitrile), pyridine-2,6-dicarbonitrile (dinitrile), ethylene glycol bis(propionitrile) ether (dinitrile), 3-(triethoxysilyl) propionitrile (mononitrile), succinonitrile (dinitrile), benzonitrile (mononitrile), 4-(trifluoromethyl) benzonitrile (mononitrile), 1,2,2,3-propanetetracarbonitrile (tetrakis-nitrile). Some examples of non-nitrile compounds that may be used as high-temperature (HT) storage additives are: triisopropyl borate (TIB), 1-propene 1,3-sultone (PES), 1,3-propane sultone, phenyl disulfide, sulfolane, 1,5,2,4-dioxadithiane 2,2,4,4-tetraoxide (MMDS), 1,3,2-dioxathiolane 2,2-dioxide (DTD), N,N,N,N-tetraethyl sulfamide, succinic anhydride, maleic anhydride (MAn), citraconic anhydride, tris(trimethylsilyl)phosphite (TMSPI), tris(trimethylsilyl)phosphate, dimethoxydiphenylsilane, tris(trimethylsilyl) borate (TMSB), and 3-(triethoxysilyl)propyl isocyanate.

In some designs, the nitriles may act differently when interacting with cathode or anode surfaces at high SOC (e.g., about 70-100% SOC) and at elevated temperatures (e.g., above about 50-80° C.). For example, nitriles may coordinate to the surface of the cathode via transition metal oxide centers. The coordination mechanism may be related to the high dipole moment of a nitrile group. While effective coordination may be a prerequisite to strong bonding of nitrile to the transition metal oxide, the length of the nitrile chain may play an important role in blocking the access of CC to the surface of cathode in some designs. On one hand, the length of the nitrile chain may determine the effectiveness of blocking CC molecules from reaching the surface of the cathode. The chain length may have an optimal design to form an arch on the surface of the cathode to screen off the molecules from reaching the surface. On the other hand, the steric bulk of nitriles may be used for blocking CC molecules from reaching the surface of the cathode. In some embodiments of the present disclosure, the steric bulk of the nitriles may be improved by using nitriles with (1) fused aliphatic rings, such as cyclopropane ring, (2) nitriles with a double carbon-carbon bond, or (3) branched nitriles, such as methyl or dimethyl substituted nitriles. In other embodiments of this disclosure, star-like shaped nitriles with three or four aliphatic carbon chains deviating from the center, in which aliphatic carbons may also be replaced by oxygen groups, such as O, may be used to enable steric bulk of nitriles. In some other embodiments, nitriles with four and more nitrile groups may anchor to the surface of the cathode and block other molecules from oxidation. Additionally, in some designs, the oxidative stability of nitriles may determine the onset of high-temperature (HT) outgassing. For example, a nitrile with low oxidation stability may decompose at lower oxidation potentials with the formation of electronically insulative film that is Li-ion conducting. Such surface protection may also block CC and other molecules from undesirable or excessive decomposition on the cathode in some designs. To enable the formation of an electronically insulative film that is Li-ion conducting, nitriles with ethylene glycol structural units may be used effectively in some designs.

In some designs, nitriles may be prone to decomposition on the surface of the anode when exposed to a source of electrons due to their electron acceptor properties. Therefore, in some designs, using nitriles with low reduction potentials may be beneficial to achieve a high cycle life, decrease voltage hysteresis and decrease internal resistance, while ensuring surface protection for the cathodes. In some designs, the cathodic stability of a nitrile may be regulated by electron donicity of a nitrile. For example, in some designs, the electron donicity of a nitrile may be improved by replacing hydrogen atoms by short chain aliphatic groups, such as methyl or ethyl groups. In another example, the electron donicity may be improved by incorporating oxygen (O) groups in the structure of nitriles.

The inventors have found that, in some embodiments, it may be advantageous to use a mixture of nitriles in order to achieve a good balance of cycle life, cycle life at elevated temperature, calendar life, HT storage outgassing, discharge V, C-rate and suppress transition metal dissolution. In some implementations, it may be advantageous to use a singular di-nitrile to achieve a good balance of cycle life and HT outgassing, wherein the concentration of di-nitrile is from about 0.5 mol. % to about 3 mol. %. In some other implementations, it may be advantageous to use a mixture of a di-nitrile and a tri-nitrile to achieve a good balance of cycle life and HT outgassing, wherein the concentration of di-nitrile is from about 0.5 mol. % to about 2 mol. %, and the concentration of tri-nitriles is from about 0.5 mol. % to about 1 mol. %. In some implementations, it may be beneficial to use a mixture of a di-nitrile (e.g., ADN), a tri-nitrile (e.g., HTCN), and a non-nitrile high-temperature storage additive (e.g., PES). A total concentration of such a mixture, containing a di-nitrile (e.g., ADN), a tri-nitrile (e.g., HTCN), and a non-nitrile high-temperature storage additive (e.g., PES), may be in a range of about 0.1 mol. % to about 3 mol. %., or in a range of about 1.0 mol. % to about 3 mol. %. In some implementations, a concentration of the one or more high-temperature storage additives in the electrolyte may be in a range of about 0.1 mol. % to about 3 mol. %.

The inventors have also found that, in some designs, it may be advantageous to use high-temperature storage additives such as triisopropyl borate (TIB), 1-propene 1,3-sultone (PES), 1,3-propane sultone, phenyl disulfide, sulfolane, 1,5,2,4-dioxadithiane 2,2,4,4-tetraoxide (MMDS), 1,3,2-dioxathiolane 2,2-dioxide (DTD), N,N,N,N-tetraethyl sulfamide, succinic anhydride, maleic anhydride (MAn), citraconic anhydride, tris(trimethylsilyl)phosphite (TMSPI), tris(trimethylsilyl)phosphate, dimethoxydiphenylsilane, tris(trimethylsilyl) borate (TMSB), and 3-(triethoxysilyl)propyl isocyanate, to reduce thickness change and to reduce transition metal dissolution. In some embodiments, it may be advantageous to use these additives in addition to nitrile additives. In some other embodiments, it may be advantageous to use from about 0.1 mol. % to about 3 mol. % of these additives in the electrolyte formulation.

In some embodiments of the present disclosure, the combination of nitrile additive(s), charge transfer additives (e.g., Li salt additives), or other HT storage additives with branched esters may be advantageously used to decrease HT outgassing by, for example, preventing or reducing transition metal dissolution elevated temperatures (e.g., battery operating temperatures, e.g., above about 50-80° C.) and by forming a protective cathode film (CEI). In a specific example, the branched ester may be chosen from one of the branched esters, such as ethyl isobutyrate, methyl isobutyrate, ethyl trimethyl acetate, ethyl isovalerate, methyl trimethyl acetate, methyl isovalerate, methyl 2-methyl butyrate, ethyl 2-methyl butyrate, to name a few. In a specific example, Li salt additives may be chosen from lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), lithium difluoro(oxalato)borate (LiDFOB), and lithium bis(oxalato)borate (LiBOB). In some implementations, a concentration of Li salt additives in the electrolyte may preferably be in a range of approximately 0.1 mol. % to approximately 3.0 mol. %, or in a range of approximately 0.1 mol. % to approximately 6.0 mol. %, in a range of approximately 0.5 mol. % to approximately 1.5 mol. %. In a specific example, other HT storage additives may be chosen from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, 1-(propan-2-yl)-1H-imidazole-4,5-dicarbonitrile, pyridine-2,6-dicarbonitrile, ethylene glycol bis(propionitrile) ether, 3-(triethoxysilyl) propionitrile, succinonitrile, benzonitrile, 4-(trifluoromethyl) benzonitrile, 1,2,2,3-propanetetracarbonitrile, triisopropyl borate (TIB), 1-propene 1,3-sultone (PES), 1,3-propane sultone, phenyl disulfide, sulfolane, 1,5,2,4-dioxadithiane 2,2,4,4-tetraoxide (MMDS), N,N,N,N-tetraethyl sulfamide, succinic anhydride, maleic anhydride, citraconic anhydride, tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, 1,3,2-dioxathiolane 2,2-dioxide (DTD). In some implementations, a concentration of such HT additives in the electrolyte may preferably be in a range of approximately 0.1 mol. % to approximately 3.0 mol. %, or in a range of approximately 0.1 mol. % to approximately 6.0 mol. %, in a range of approximately 0.5 mol. % to approximately 1.5 mol. %. The optimal additive concentration in the combination with branched ester may depend on the particular cell design and electrolyte composition.

In one or more embodiments of the present disclosure, the combination of suitable anode and cathode surface protection to decrease HT outgassing may be designed by using a single nitrile or a mixture of nitriles with additive Li salt(s). In a specific example, the additive Li salt(s) may be chosen from lithium difluorophosphate (LiPO₂F₂ or LFO), lithium tetrafluoroborate (LiBF₄), lithium fluorosulfate (LiSO₃F), lithium bis(fluorosulfonyl)imide (LiFSI), and lithium difluoro(oxalato)borate (LiDFOB), to name a few. In some implementations, a concentration of Li additive salts in the electrolyte may preferably be in a range of approximately 0.1 mol. % to approximately 3.0 mol %. In some implementations, there may be a tendency for an undesired reduction of cycle life when the concentration of additive salts (AS) in the electrolyte is greater than approximately 2.5 mol. %.

In one or more embodiments of the present disclosure, a preferred electrolyte for a lithium-ion battery may include lithium difluorophosphate (LFO), lithium tetrafluoroborate (LiBF₄), lithium fluorosulfate (LiSO₃F), lithium bis(fluorosulfonyl)imide (LiFSI), and/or lithium difluoro(oxalato)borate (LiDFOB). In some designs, these additive salts tend to reduce charge transfer resistance (Rct) at room, low and/or elevated temperatures. Reduction of Rct contributes to increasing the discharge voltage and improving low-temperature performance. In some cell designs, such additive salts may be particularly effective in simultaneously reducing Rct at the anode and cathode and improving the discharge voltage of a battery cell both at room temperature and at a high (e.g., elevated) temperature. In some implementations, such additive salts contribute to mitigation of high-temperature outgassing.

In one or more embodiments of the present disclosure, Li metal or Li-ion battery cells may employ electrolytes that include: (1) branched ester, (2) a nitrile additive composition that includes a suitable amount of a selected nitrile compound or a suitable amount of a mixture of selected nitrile compounds or (3) Li salt additive, (4) other HT storage additive, which may provide multiple benefits to Li or Li-ion batteries, particularly those that comprise high-capacity, moderate volume changing anodes comprising from about 5 to about 100 wt. % of (nano)composite anode powders (as a fraction of all particles that include active materials), wherein such (nano)composite anode powders exhibit moderately high volume changes during the first charge-discharge cycle, moderate volume changes during the subsequent charge-discharge cycles, an average size (e.g., average diameter) in the range from about 0.2 to about 40 microns and specific surface area in the range from about 0.5 to about 50 m²/g and, in the case of Si-comprising (nano)composite anode powders, specific reversible capacities in the range from about 800 to about 3000 mAh/g (when normalized by the mass of the composite anode particles only) or with the corresponding anode specific reversible capacities being in the range from about 400 to about 2800 mAh/g (when normalized by the total mass of all the active electrode particles, conductive additives and binders). In some designs (e.g., depending on cell chemistry, loading, operating conditions and/or other factors), suitable branched esters or related compounds (or their mixtures) may be added at the additive level (from about 0.1 mol. % to about 5-10 mol. %) or as a main solvent/co-solvent level (from about 30 mol. % to about 80 mol. %) for attaining substantial benefits. In other embodiments, such anode powders may comprise a mixture of Si—C nanocomposite and graphite, a so-called blended anode.

Examples of such benefits may include one or more of the following: (i) improving high-temperature storage stability (e.g., retaining higher reversible capacity after about 1 h to about 10 years of storage at elevated temperatures (e.g., about 40-100° C.) at high state of charge (SOC) (e.g., SOC of about 70-100%) or reducing gas generation after storage or cycling at elevated temperatures); (ii) reducing gas generation during storage or cycling at room or low temperatures; (iii) reducing or minimizing cell swelling (or built-in stresses in cells) at the end of life (e.g., after about 20-80% of the initial capacity retention); (iv) improving cycling stability when used at various (e.g., different) temperature conditions; (v) reducing or minimizing impedance growth during cycling; (vi) reducing or minimizing formation of undesirable (harmful) by-products during battery cell operation, among others; (vii) reducing carbon monoxide generation on the cathode and anode; (viii) reducing carbon dioxide generation on the cathode and anode; (ix) reducing hydrogen generation on the anode, (x) reducing methane generation on the anode; (xi) reducing C2-hydrocarbon generation on the anode, (xii) reducing C3-hydrocarbon generation on the anode, (xiii) reducing DCR, (xiv) improving rate capability.

Some of such benefits may stem from the formation of more favorable or more robust CEI film that may, for example, help to reduce or minimize electrolyte oxidation on the cathode with the formation of gaseous species or help to reduce or minimize cathode dissolution or other unfavorable/undesirable interactions between the cathode and liquid electrolyte in a Li or Li-ion battery. In some implementations, for example, in case of employing an in electrolyte that contains: (1) a nitrile additive composition, (2) a mixture of the nitrile additive composition with branched esters (such as ethyl isobutyrate, ethyl trimethylacetate, and/or other suitable esters with two or three aliphatic carbons attached at the alpha or beta position to the carboxyl group)), or (3) a mixture of the nitrile additive, Li salt additive, and branched esters, a more robust CEI film formation may be related to having a stronger adhesion to the cathode surface. Some of such benefits may also stem from the formation of more favorable or more robust SEI film on the anode (or, for example, from helping to maintain a more stable anode SEI). In some designs, improved SEI stability may be related to the dramatically reduced diffusion of suitable branched esters and related compounds through the SEI, which may prevent or greatly reduce or minimize their reduction as well as other electrolyte components on the anode surface, particularly at elevated temperatures. In some designs, improved SEI stability may be related to the reduced ability to form gaseous species upon electrolyte reduction. In some designs, improved SEI stability may be related to the reduced ability to form more elastically or plastically deformable (in the electrolyte) SEI or, for example, less resistive SEI. Such improved SEI stability or properties may, for example, help reduce or minimize electrolyte reduction on the anode (with the associated undesirable irreversible losses of cyclable Li or with the undesirable formation of gaseous species or undesirable anode swelling, etc.) or may help to reduce or minimize anode dissolution or other unfavorable/undesirable interactions between the anode and liquid electrolyte in a Li or Li-ion battery, which may lead to impedance growth or gas generation or other undesirable processes or performance degradations in cells. Some of such benefits may stem from the reduction in elastic modulus of the electrode binders upon exposure of electrodes to electrolytes during cell formation or cell operation (cycling). In some designs, it may be preferable to select an electrolyte composition based on some suitable nitriles; or suitable nitrile mixtures or suitable mixtures of nitriles with branched esters, such as ethyl isobutyrate or other suitable esters with two or three aliphatic carbons in alpha or beta position to carboxyl group and others), or suitable nitriles and Li salt additives, such as LIFSI, LFO, LiBF₄, LIDFOB, LiSO₃F; or suitable nitriles, Li salt additives, other HT storage additives, such as DTD, MMDS, PES, and branched esters; where the binder in at least one of the electrodes reduces its elastic modulus by less than about 30 vol. % (e.g., more preferably in some designs, by less than about 10 vol. %) when exposed to electrolyte.

In some designs, employing an electrolyte that contains: (1) a nitrile additive composition, (2) a mixture of the nitrile additive composition with branched esters (such as ethyl isobutyrate, ethyl trimethylacetate, and/or other suitable esters with two or three aliphatic carbons attached at the alpha or beta position to the carboxyl group), or (3) a mixture of the nitrile additive, branched ester, other HT storage additives, and Li salt additive in a Li-ion battery cell may offer greatly reduced gassing on the anode surface (including, but not limited to, the case of Li plating on the anode surface). In some designs, branched esters with two or three alkyl groups in the alpha position to the carboxyl group of the branched ester may offer particularly improved performance. In some designs, branched esters with two or three alkyl groups in the alpha position to carboxyl group of the branched ester may offer reduced rates of hydrogen, methane, ethane, ethylene, propene, propane, butane and/or butene formation on the anode.

In some designs, employing an electrolyte that contains: (1) a branched ester (such as ethyl isobutyrate, ethyl trimethylacetate, and/or other suitable esters with two or three aliphatic carbons attached at the alpha or beta position to the carboxyl group), or (2) a branched ester with Li salt additive (such as LFO, LiBF₄, LiSO₃F, LIDFOB, LiFSI) in a Li-ion battery cell may mitigate parasitic (highly undesirable) degradation of common SEI “builders” (such as fluoroethylene carbonate (FEC), vinylene carbonate (VC), ethylene carbonate (EC), among others) present in the electrolyte due to the reduced rate of the alkoxide formation. In some designs, esters with two or three alkyl groups in the alpha position to carboxyl group of the ester may offer particularly improved performance due to the steric bulk of esters and reduced rate of alkoxide formation.

In some designs, employing an electrolyte that contains branched esters (such as ethyl isobutyrate, ethyl trimethylacetate, and/or other suitable esters with two or three aliphatic carbons attached at the alpha or beta position to the carboxyl group) in a Li-ion battery cell may reduce or completely eliminate the undesirable formation of enol form of the corresponding ester (or reduce the formation of tautomeric enol form) (e.g., by shifting the equilibrium towards the ester). In some designs, by reducing or avoiding the enol presence in the electrolyte, the parasitic degradation of Li salt(s) (e.g., lithium hexafluorophosphate (LiPF₆)) or other electrolyte components by, for example, alcoholysis may be greatly reduced or minimized. Similarly, in some designs, formation of hydrofluoric acid (HF) or other undesirable by-products of, e.g., LiPF₆ alcoholysis, may be greatly reduced or minimized.

In some of the embodiments of the present disclosure, it may be beneficial to use low molecular weight ester solvent, such as ethyl acetate, in combination with high molecular weight ester solvent, such as ethyl propionate. In some designs, the low molecular weight solvent has a molecular weight of not more than about 90 g/mol. In some designs, the high molecular weight solvent has a molecular weight of more than about 90 g/mol. In some designs, it is preferred to use a volumetric ratio between the esters (volumetric ratio of low molecular weight ester to high molecular weight ester) from approximately 3 to 1 to approximately 1 to 4 (e.g., in some designs, from about 3:1 to about 1:1; in other designs, from about 1:1 to about 1:2; in other designs, from about 1:2 to about 1:4). In such designs, the combination of ethyl acetate and ethyl propionate may be advantageously used to reduce charge transfer resistance, bulk resistance, and diffusion resistance and improve low temperature performance and reduce DCR.

In some of the embodiments of the present disclosure, it may be advantageous to use a combination of dimethyl carbonate (DMC) and ethyl methyl carbonate (EMC) with FEC and VC. In some designs, it may be preferred to use about 2-15 vol. % (e.g., in a range of about 2 vol. % to about 7 vol. %, or in a range of about 3 vol. % to about 6 vol. %, or around 5 vol. %) of EMC in the total liquid electrolyte mixture to improve low temperature performance of such formulations. In such designs, the combination of DMC, EMC, FEC and VC may be advantageously used to reduce diffusion resistance and DCR. In some other embodiments of the present disclosure, it may be beneficial to use low viscosity co-solvent, selected from but not limited to open chain carbonates, such as dimethyl carbonate and ethyl methyl carbonate. In some designs, such co-solvents, may be beneficial for improving HT outgassing and extending cycle life. In some other designs the use of such solvents may lead to the extensive out gassing at low SOC and during the prolonged gassing. In some other designs, in order to avoid outgassing at low SOC and during prolonged cycles, it may be advantageous to use high concentration of FEC and VC to build robust SEI.

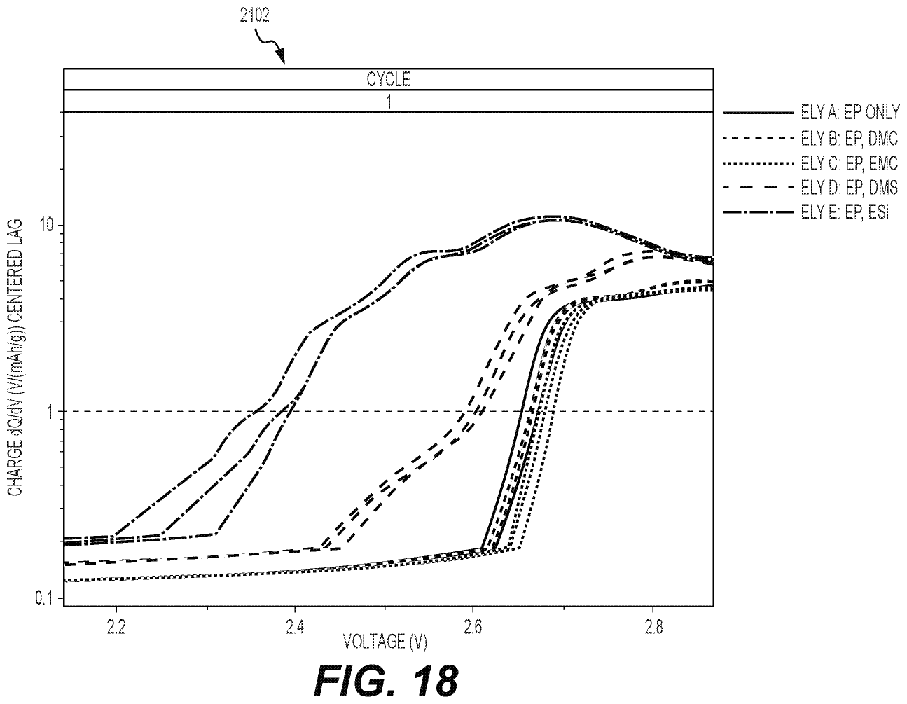

FIG. 18 is a graphical plot 2102 of the differential capacity (dQ/dV) of the first charge showing the onset voltages of reduction of example electrolytes. Test battery cells with a capacity of about 0.155 Ah were made using: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, and (iii) a polymer-ceramic separator. Test cells with the following respective electrolytes (ELY) were made and tested: ELY A (about 10.8 mol. % LiPF₆, about 25.6 mol. % FEC, about 2.9 mol. % VC, about 60.7 mol. % EP), ELY B (about 9.6 mol. % LiPF₆, about 22.8 mol. % FEC, about 2.6 mol. % VC, about 27.8 mol. % EP, about 37.2 mol. % DMC), ELY C (about 10.3 mol. % LiPF₆, about 24.4 mol. % FEC, about 2.8 mol. % VC, about 29.7 mol. % EP, about 32.7 mol. % EMC), ELY D (about 9.9 mol. % LiPF₆, about 23.5 mol. % FEC, about 2.6 mol. % VC, about 35.7 mol. % DMS (Compound No. 37, 1418), about 28.3 mol. % EP), and ELY E (about 9.2 mol. % LiPF₆, about 21.7 mol. % FEC, about 2.5 mol. % VC, about 40.0 mol. % ESi (Compound No. 3, 306), about 26.6 mol. % EP). Three cells were made and tested for each electrolyte and a graphical plot is shown for each electrolyte. Observed reduction voltages (defined as the voltage at which the differential capacity first exceeds 1 V/(mAh/g)) were as follows: ELY E (reduction voltage ranging between 2.34 V and 2.38 V), ELY D (reduction voltage ranging between 2.57 V and 2.59 V), ELY A (reduction voltage ranging between 2.63 V and 2.66 V), ELY B (reduction voltage of about 2.65 V), and ELY C (reduction voltage ranging between 2.66 V and 2.68 V). Due to the higher onset of reduction, ELYs D and E may be advantageously used over ELYs A, B and C to supplement FEC with selected covalent compounds (DMS and ESi, respectively) and increase the presence of Li salt and oligomeric or polymeric species in the SEI, augment the SEI formed by FEC and VC, improve SEI stability, decrease DCR, and reduce anode charge transfer resistance.

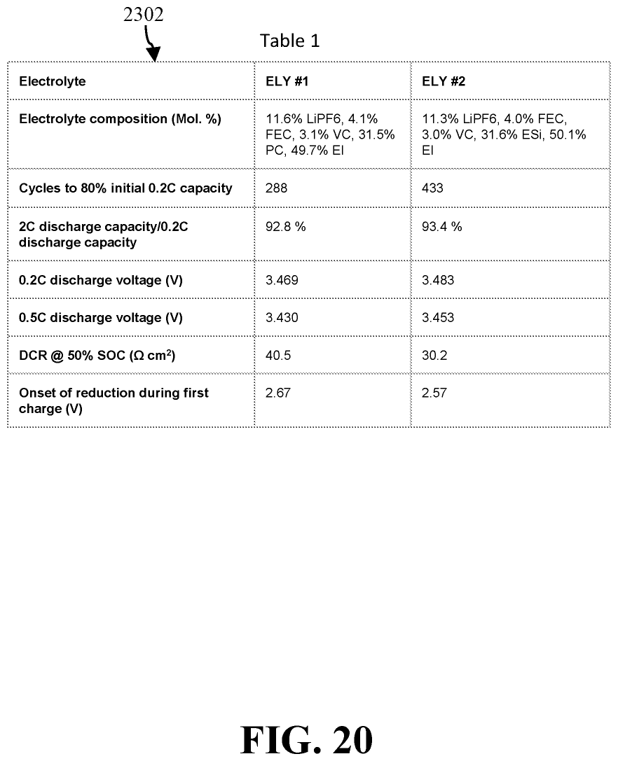

In one illustrative example (cells utilizing ELY #1, as shown in Table 1 (2302) of FIG. 20), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #1 comprising: about 11.6 mol. % LiPF₆, about 4.1 mol. % FEC, about 3.1 mol. % VC, about 31.5 mol. % PC, about 49.7 mol. % EI. Hereinbelow, particular electrolyte formulations may be denoted as ELY followed by a number (e.g., ELY #1, ELY #2, etc.).

In one illustrative example (cells utilizing ELY #2, as shown in Table 1 (2302) of FIG. 20), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #2 comprising: about 11.3 mol. % LiPF₆, about 4.0 mol. % FEC, about 3.0 mol. % VC, about 31.6 mol. % ESi (Compound No. 3, 306), about 50.1 mol. % EI.

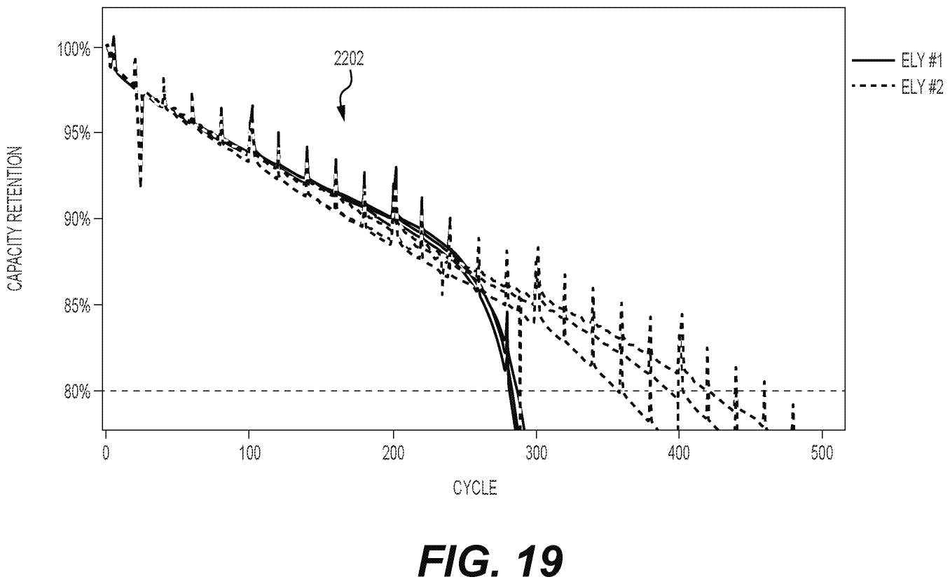

Li-ion battery test cells respectively comprising ELY #1 and ELY #2 were tested in a cycle life test (FIG. 19, Table 1 of FIG. 20). FIG. 19 is graphical plot 2202 of the capacity retention (in % of initial capacity) as a function of cycle number, for Li-ion battery cells comprising electrolytes ELY #1 and 2. ELY #2 is an example of an electrolyte comprising ethylene sulfite (ESi) or compound No. 3, shown as 306 in FIG. 3. FIG. 20 shows a Table 1 (2302) which shows the electrolyte compositions and associated selected battery performance characteristics for electrolytes ELY #1 and 2. ELY #2 is an example of an electrolyte comprising ethylene sulfite (ESi) or compound No. 3, shown as 306 in FIG. 3. The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (ELY #1, ELY #2) contain LiPF₆, FEC, VC, and EI. ELY #1 contains PC and ELY #2 contains ESi. The ELY #2 cells exhibited significantly better cycle life (cycles to 80% of initial 0.2 capacity) at 433 cycles compared to ELY #1 cells at 288 cycles. ESi may be able to make higher molecular weight, more branched, more mechanically stable polymers in the SEI at the anode upon reduction compared to PC (e.g., through formation of oligoethers, polysulfites, polysulfides, and sulfur-containing salts such as Li₂SO₃, Li₂S, and Li₂SO₄), which may improve the surface coverage and mechanical stability of the SEI layer, reducing the extent of parasitic reaction during cycling. The SEI generated by ESi may augment that generated by FEC and VC, which may improve anode particle surface coverage and the mechanical stability of the SEI layer, reducing the extent of parasitic reactions and reducing damage caused by particle morphology changes and swelling during cycling. The 2 C discharge capacity as a fraction of 0.2 C discharge capacity increased from 92.8% (ELY #1) to 93.4% (ELY #2). The direct current resistance (sometimes referred to herein as DCR) was measured in the 4th cycle during a 0.2 C discharge by applying a 2 C discharge current at 50% SOC and measuring the difference in voltage after 10 seconds compared to immediately before the 2 C current was applied. The DCR decreased from 40.5 (2 cm² (ELY #1) to 30.2 (2 cm² (ELY #2). The cell resistance and rate capability are significantly improved, which may be due to ESi better solvating lithium ions in solution, resulting in greater ionic conductivity in the electrolyte and faster lithium transport. ESi may also contribute polymeric and salt reduction and oxidation products to the electrode surfaces with high ionic conductivities (e.g., oligoethers, polysulfites, polysulfides, and sulfur-containing salts such as Li₂SO₃, Li₂S, and Li₂SO₄), which may reduce the interfacial resistances. The voltage for the onset of reduction during the first charge decreased from 2.67 V (ELY #1) to 2.57 V (ELY #2). ESi may be reduced earlier in the first charge due to its greater presence in the Li solvation shell, as well as its weak S—O bonds, both of which may raise the reduction potential. This may allow ESi to contribute to the SEI preferentially over other molecules with lower reduction potentials that do not form stable SEIs (e.g., EI), which may improve the stability of the SEI and reduce side reaction rates and capacity fade.

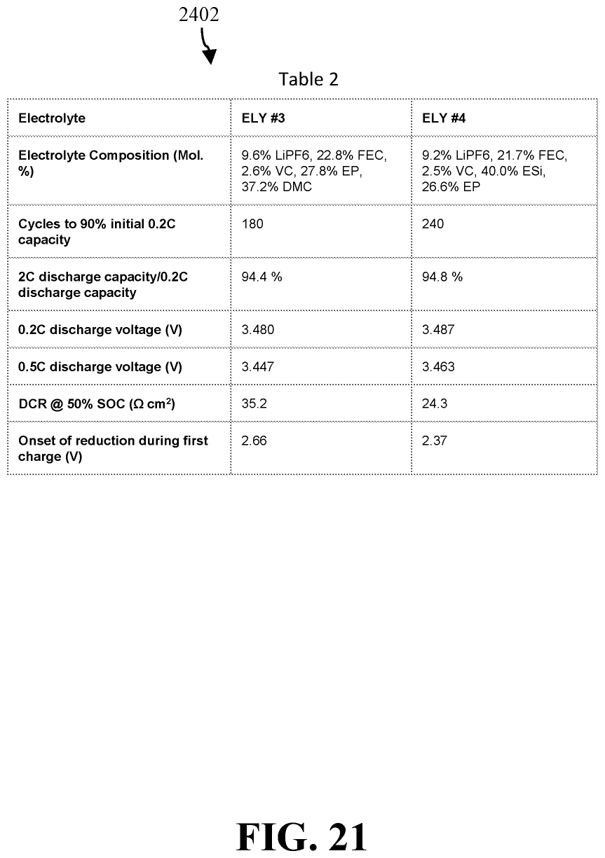

FIG. 21 shows a Table 2 (2402) which shows the electrolyte compositions and associated selected battery performance characteristics for electrolytes ELY #3 and 4. ELY #4 is an example of an electrolyte comprising ethylene sulfite (ESi) or compound No. 3, shown as 306 in FIG. 3. In one illustrative example (cells utilizing ELY #3, as shown in Table 2 (2402) of FIG. 21), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #3 comprising: about 9.6 mol. % LiPF₆, about 22.8 mol. % FEC, about 2.6 mol. % VC, about 27.8 mol. % EP, about 37.2 mol. % DMC.

In one illustrative example (cells utilizing ELY #4, as shown in Table 2 of FIG. 21), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #4 comprising: about 9.2 mol. % LiPF₆, about 21.7 mol. % FEC, about 2.5 mol. % VC, about 40.0 mol. % ESi (Compound No. 3, 306), about 26.6 mol. % EP.

Li-ion battery test cells respectively comprising ELY #3 and ELY #4 were tested in a cycle life test (Table 2 of FIG. 21). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (ELY #3 and ELY #4) contain LiPF₆, FEC, VC, and EP. ELY #3 contains DMC and ELY #4 contains ESi. The cycle life (cycles to 90% of initial 0.2 C capacity) increased from 180 cycles (ELY #3) to 240 cycles (ELY #4). The better cycle life compared to DMC may be due to ESi generating higher molecular weight, more branched, more mechanically stable polymers in the SEI at the anode upon reduction (e.g., through formation of oligoethers, polysulfites, polysulfides, and sulfur-containing salts such as Li₂SO₃, Li₂S, and Li₂SO₄), which may lead to a more conformal, more mechanically stable SEI layer on the anode particles, improved passivation, and reduced capacity fade. The SEI generated by ESi may augment that generated by FEC and VC, which may improve anode particle surface coverage and the mechanical stability of the SEI layer, reducing the extent of parasitic reactions and reducing damage caused by particle morphology changes and swelling during cycling. The DCR was measured in the 4th cycle during a 0.2 C discharge by applying a 2 C discharge current at 50% SOC and measuring the difference in voltage after 10 seconds compared to immediately before the 2 C current was applied. DCR decreased from 35.2 (2 cm² (ELY #3) to 24.3 (2 cm² (ELY #4), which may be due to ESi better solvating lithium than DMC due to its higher dipole moment and higher dielectric constant, resulting in better ion separation, higher concentration of free charges, and higher conductivity. ESi may also contribute polymeric and Li salt reduction and oxidation products to the electrode surfaces with high ionic conductivities (e.g., oligoethers, polysulfites, polysulfides, and sulfur-containing salts such as Li₂SO₃, Li₂S, and Li₂SO₄), reducing the interfacial resistances. The voltage for the onset of reduction during the first charge decreased from 2.66 V (ELY #3) to 2.37 V (ELY #4). ESi may be reduced earlier in the first charge due to its greater presence in the Li solvation shell, as well as its weak S—O bonds, both of which may raise the reduction potential. This may allow ESi to contribute to the SEI preferentially over other molecules with lower reduction potentials that do not form stable SEIs (e.g., EP), which may improve the stability of the SEI and reduce side reaction rates and capacity fade.

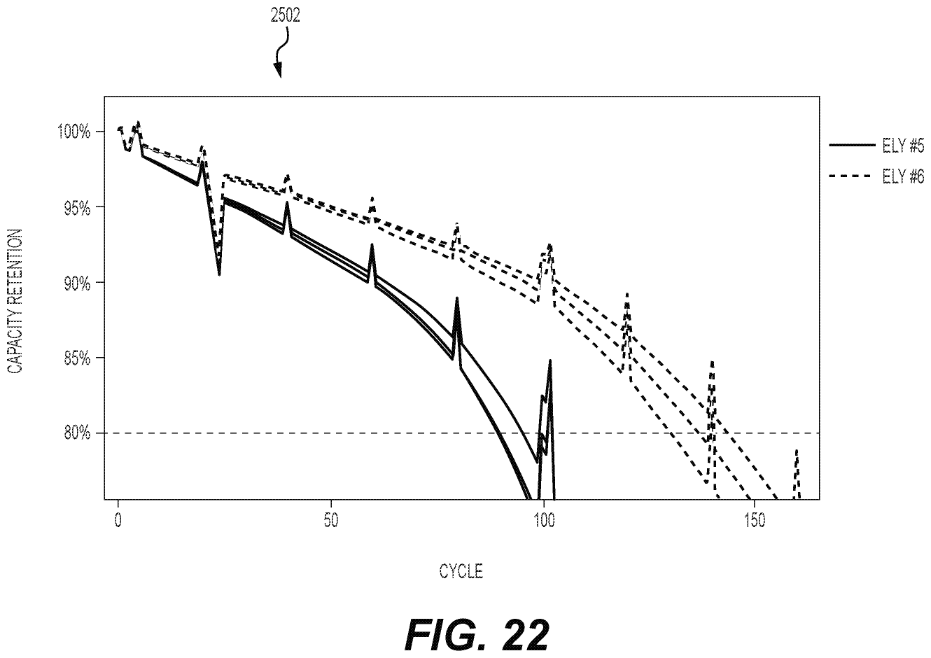

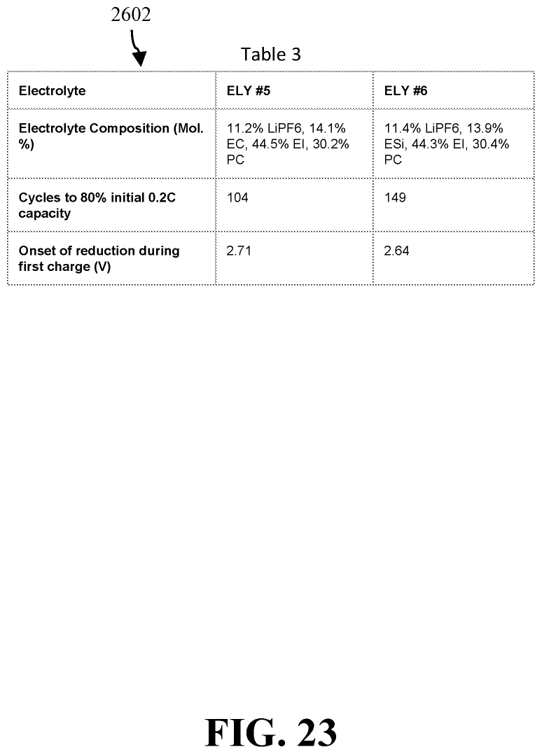

FIG. 22 is graphical plot 2502 of the capacity retention (in % of initial capacity) as a function of cycle number, for Li-ion battery cells comprising electrolytes ELY #5 and 6. ELY #6 is an example of an electrolyte comprising ethylene sulfite (ESi) or compound No. 3, shown as 306 in FIG. 3. FIG. 23 shows a Table 3 (2602) which shows the electrolyte compositions and associated selected battery performance characteristics for electrolytes ELY #5 and 6. ELY #6 is an example of an electrolyte comprising ethylene sulfite (ESi) or Compound No. 3, shown as 306 in FIG. 3.

In one illustrative example (cells utilizing ELY #5, as shown in Table 3 of FIG. 23), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #5 comprising: about 11.2 mol. % LiPF₆, about 14.1 mol. % EC, about 44.5 mol. % EI, about 30.2 mol. % PC.

In one illustrative example (cells utilizing ELY #6, as shown in Table 3 of FIG. 23), a consumer Li-ion battery cell (Li-ion battery cell for use in consumer electronics products) with capacity of about 0.155 Ah may comprise: (i) an anode with about 89.6% by weight of Si—C nanocomposite active material (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #6 comprising: about 11.4 mol. % LiPF₆, about 13.9 mol. % ESi (Compound No. 3, 306), about 44.3 mol. % EI, about 30.4 mol. % PC.

Li-ion battery test cells respectively comprising ELY #5 and ELY #6 were tested in a cycle life test (Table 3 of FIG. 23). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (ELY #5 and ELY #6) contain LiPF₆, EI, and PC. ELY #5 contains EC and ELY #6 contains ESi. The cycle life (cycles to 80% of initial 0.2 C capacity) increased from 104 cycles (ELY #5) to 149 cycles (ELY #6). This may be due to ESi generating higher molecular weight, more branched, more mechanically stable polymers in the SEI at the anode upon reduction relative to EC (e.g., through formation of oligoethers, polysulfites, polysulfides, and sulfur-containing salts such as Li₂SO₃, Li₂S, and Li₂SO₄), which may lead to a more conformal, more mechanically stable SEI layer on the anode particles, improved passivation, and reduced capacity fade. The voltage for onset of reduction decreased from 2.71 V (ELY #5) to 2.64 V (ELY #6). ESi may be reduced earlier in the first charge due to its greater presence in the Li solvation shell due to its higher dielectric constant, as well as its weak S—O bonds, both of which may raise its reduction potential. This may allow ESi to contribute to the SEI preferentially over other molecules with lower reduction potentials that do not form stable SEIs (e.g., EI and PC), which may reduce side reaction rates and capacity fade.

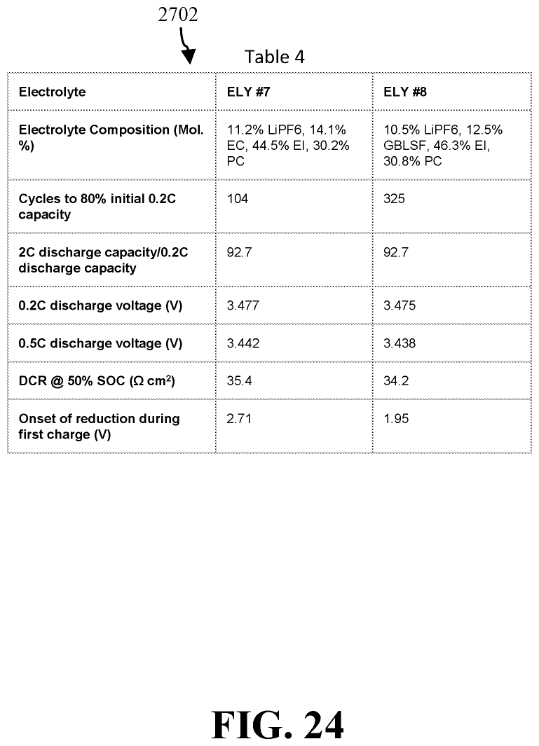

FIG. 24 shows a Table 4 (2702) which shows the electrolyte compositions and associated selected battery performance characteristics for electrolytes ELY #7 and 8. ELY #8 is an example of an electrolyte comprising 5-oxotetrahydrofuran-3-sulfonyl fluoride (GBLSF) or Compound No. 19, shown as 616 in FIG. 5. In one illustrative example (cells utilizing ELY #7, as shown in Table 4 of FIG. 24), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #7 comprising: about 11.2 mol. % LiPF₆, about 14.1 mol. % EC, about 44.5 mol. % EI, about 30.2 mol. % PC.

In one illustrative example (cells utilizing ELY #8, as shown in Table 4 of FIG. 24), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #8 comprising: about 10.5 mol. % LiPF₆, about 12.5 mol. % GBLSF (Compound No. 19, 616), about 46.3 mol. % EI, about 30.8 mol. % PC.

Li-ion battery test cells respectively comprising ELY #7 and ELY #8 were tested in a cycle life test (Table 4 of FIG. 24). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (#7 and #8) contain LiPF₆, EI, and PC. ELY #7 contains EC and ELY #8 contains GBLSF. The cycle life (cycles to 80% of initial 0.2 C capacity) increased from 104 cycles (ELY #7) to 325 cycles (ELY #8). Relative to EC, GBLSF may create a denser, more conformal, more polymeric, more mechanically stable, and more adhesive SEI passivation layer containing more LiF and LiSO₂F at the anode-electrolyte interface, which may reduce parasitic electrolyte decomposition rates and reduce damage to the passivation layer due to particle morphology changes/swelling during cycling, which may reduce capacity fade. This may be due to GBLSF creating larger, more branched, more mechanically stable polyethers, polyesters, and polyalkanes upon reduction at the anode compared to EC. The DCR was measured in the 4th cycle during a 0.2 C discharge by applying a 2 C discharge current at 50% SOC and measuring the difference in voltage after 10 seconds compared to immediately before the 2 C current was applied. DCR decreased slightly from 35.4 (2 cm² (ELY #7) to 34.2 cm² (ELY #8). Resistance metrics are approximately equal to EC, indicating that GBLSF may have a similar capacity to solvate lithium ions in solution to give high ionic conductivity as EC. The cell resistance is slightly lower for GBLSF, which may be due to the SEI being less resistive due to the higher content of LiF and LiSO₂F, which may facilitate Li transport across the anode-electrolyte interface. The voltage for onset of reduction during first charge decreased from 2.71 V (ELY #7) to 1.95 V (ELY #8). GBLSF may be reduced earlier in the first charge due to its weak C—S and S—F bonds and the strongly electronegative —SO₂F functional group, both of which may raise the reduction potential. This may allow GBLSF to contribute to the SEI preferentially over other molecules with lower reduction potentials that do not form stable SEIs (e.g., EI and PC), which may reduce side reaction rates and capacity fade.

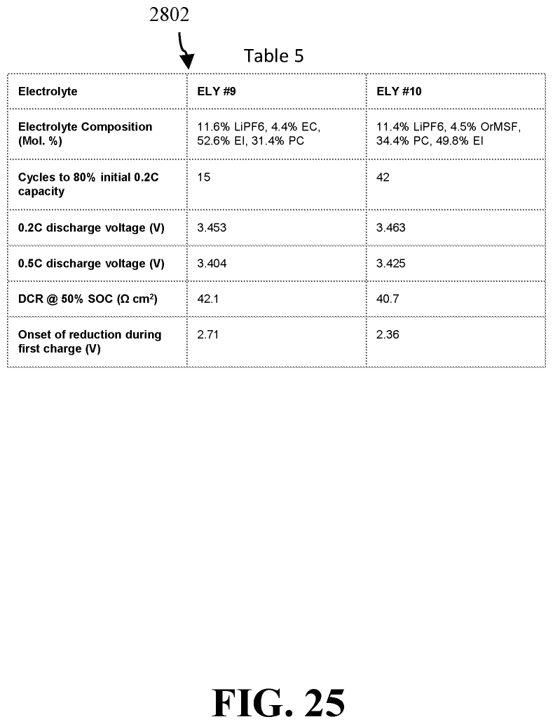

FIG. 25 shows a Table 5 (2802) which shows the electrolyte compositions and associated selected battery performance characteristics for electrolytes ELY #9 and 10. ELY #10 is an example of an electrolyte comprising oxiran-2-ylmethanesulfonyl fluoride (OrMSF) or Compound No. 20, shown as 802 in FIG. 7. In one illustrative example (cells utilizing ELY #9, as shown in Table 5 of FIG. 25), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #9 comprising: about 11.6 mol. % LiPF₆, about 4.4 mol. % EC, about 52.6 mol. % EI, about 31.4 mol. % PC.

In one illustrative example (cells utilizing ELY #10, as shown in Table 5 of FIG. 25), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #10 comprising: about 11.4 mol. % LiPF₆, about 4.5 mol. % OrMSF (Compound No. 20, 802), about 34.4 mol. % PC, about 49.8 mol. % EI.

Li-ion battery test cells respectively comprising ELY #9 and ELY #10 were tested in a cycle life test (Table 5 of FIG. 25). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (ELY #9, ELY #10) contain LiPF₆, EI, and PC. ELY #9 contains EC and ELY #10 contains OrMSF. Cycle life (cycles to 80% of initial 0.2 C capacity) increased from 15 cycles (ELY #9) to 42 cycles (ELY #10). OrMSF may create a denser, more conformal, more polymeric, and more adhesive passivation layer containing more LiF and LiSO₂F at anode-electrolyte interface (SEI) compared to EC, reducing parasitic electrolyte decomposition rates and reducing damage to passivation layer due to particle morphology changes/swelling during cycling, which may reduce capacity fade. The DCR was measured in the 4th cycle during a 0.2 C discharge by applying a 2 C discharge current at 50% SOC and measuring the difference in voltage after 10 seconds compared to immediately before the 2 C current was applied. DCR decreased from 42.1 (2 cm² (ELY #9) to 40.7 Ωcm² (ELY #10). The cell resistance is slightly lower for OrMSF, which may be due to the SEI being less resistive due to the higher content of LiF and LiSO₂F, which may facilitate Li transport across the anode-electrolyte interface. The voltage for onset of reduction during the first charge decreased from 2.71 V (ELY #9) to 2.36 V (ELY #10). This may be due to OrMSF being reduced earlier in the first charge due to its weak C—S and S—F bonds and the strongly electronegative —SO₂F functional group, all of which may raise the reduction potential. This may allow OrMSF to contribute to the SEI preferentially over other molecules with lower reduction potentials that do not form effective SEI (e.g., EI, PC), which may reduce side reaction rates and capacity fade.

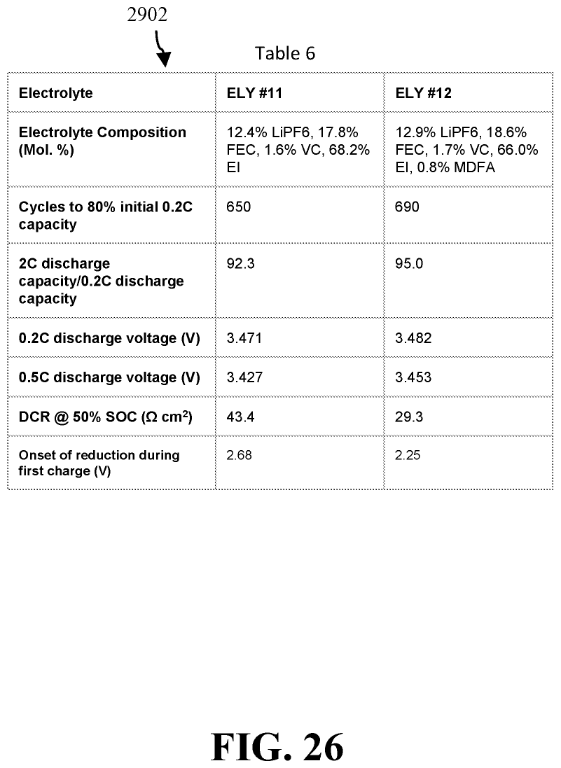

FIG. 26 shows a Table 6 (2902) which shows the electrolyte compositions and associated selected battery performance characteristics for electrolytes ELY #11 and 12. ELY #12 is an example of an electrolyte comprising Methyl 2,2-difluoro-2-(fluorosulfonyl)acetate (MDFA) or Compound No. 22, shown as 1202 in FIG. 11. In one illustrative example (cells utilizing ELY #11, as shown in Table 6 of FIG. 26), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #11 comprising: about 12.4 mol. % LiPF₆, about 17.8 mol. % FEC, about 1.6 mol. % VC, about 68.2 mol. % EI.

In one illustrative example (cells utilizing ELY #12, as shown in Table 6 of FIG. 26), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #12 comprising: about 12.9 mol. % LiPF₆, about 18.6 mol. % FEC, about 1.7 mol. % VC, about 66.0 mol. % EI, about 0.8 mol. % MDFA (Compound No. 22, 1202).

Li-ion battery test cells respectively comprising ELY #11 and ELY #12 were tested in a cycle life test (Table 6 of FIG. 26). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (ELY #11, ELY #12) contain LiPF₆, FEC, VC, and EI. ELY #12 additionally contains MDFA at an additive-level of concentration (0.8 mol. %). Cycle life (cycles to 80% of initial 0.2 C capacity) increased from 650 cycles (ELY #11) to 690 cycles (ELY #12). A denser, more conformal, and more adhesive passivation layer containing more LiF and LiSO₂F may be formed at anode-electrolyte interface (SEI) when MDFA is present in the electrolyte, which may reduce parasitic electrolyte decomposition rates and reduce damage to the passivation layer due to particle morphology changes/swelling during cycling, which may reduce capacity fade. The DCR was measured in the 4th cycle during a 0.2 C discharge by applying a 2 C discharge current at 50% SOC and measuring the difference in voltage after 10 seconds compared to immediately before the 2 C current was applied. DCR decreased from 43.4 (ELY #11) to 29.3 (ELY #12). This may be due to significant reduction in the charge transfer resistance at the anode-electrolyte interface when MDFA is present in the electrolyte, which may be due to higher LiF and LiSO₂F content in the interfacial (SEI) layer, facilitating Li-ion transport across the interface. The voltage for onset of reduction during the first charge decreased from 2.68 V (ELY #11) to 2.25 V (ELY #12). MDFA may be reduced earlier in the first charge due to its weak C—S and S—F bonds and the strongly electronegative —SO₂F functional group, both of which may raise the reduction potential at the anode. This may allow MDFA to contribute to the SEI preferentially over other molecules with lower reduction potentials that may not form stable SEIs (e.g., EI), which may reduce side reaction rates and capacity fade.

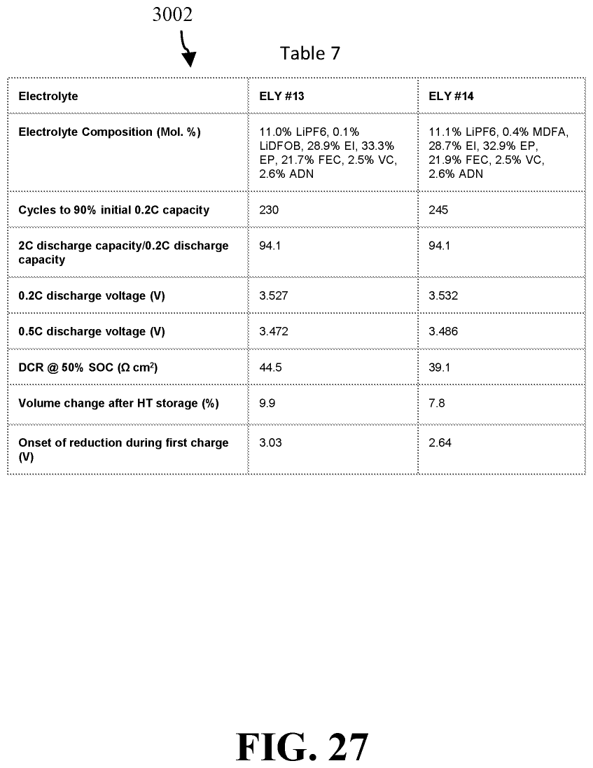

FIG. 27 shows a Table 7 (3002) which shows the electrolyte compositions and associated selected battery performance characteristics for electrolytes ELY #13 and 14. ELY #14 is an example of an electrolyte comprising methyl 2,2-difluoro-2-(fluorosulfonyl)acetate (MDFA) or Compound No. 22, shown as 1202 in FIG. 11. In one illustrative example (cells utilizing ELY #13, as shown in Table 7 of FIG. 27), a consumer Li-ion battery cell (Li-ion battery cell for use in consumer electronics products) with capacity of about 0.220 Ah may comprise: (i) an anode with about 87.6% by weight of Si—C nanocomposite active material particles (with specific reversible capacity of about 1280 mAh/g when normalized by the weight of active material particles in the anode) casted on Cu current collector foil from a water-based suspension comprising a polyacrylate binder and a carbon black conductive additive, (ii) a cathode with high-voltage LCO (LiCoO₂) active material (with specific reversible capacity of about 170 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.10:1 and areal reversible capacity loading of about 3.15 mAh/cm², charge voltage of about 4.4V, (iii) a polymer-ceramic separator, and (iv) an ELY #13 comprising: about 11.0 mol. % LiPF₆, about 0.1 mol. % LiDFOB, about 28.9 mol. % EI, about 33.3 mol. % EP, about 21.7 mol. % FEC, about 2.5 mol. % VC, about 2.6 mol. % adiponitrile (ADN).

In one illustrative example (cells utilizing ELY #14, as shown in Table 7 of FIG. 27), a consumer Li-ion battery cell (Li-ion battery cell for use in consumer electronics products) with capacity of about 0.220 Ah may comprise: (i) an anode with about 87.6% by weight of Si—C nanocomposite active material particles (with specific reversible capacity of about 1280 mAh/g when normalized by the weight of active material particles in the anode) casted on Cu current collector foil from a water-based suspension comprising a polyacrylate binder and a carbon black conductive additive, (ii) a cathode with high-voltage LCO active material (with specific reversible capacity of about 170 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.10:1 and areal reversible capacity loading of about 3.15 mAh/cm², charge voltage of about 4.4V, (iii) a polymer-ceramic separator, and (iv) an ELY #14 comprising: about 11.1 mol. % LiPF₆, about 0.4 mol. % MDFA, about 28.7 mol. % EI, about 32.9 mol. % EP, about 21.9 mol. % FEC, about 2.5 mol. % VC, 2.6% ADN.

Li-ion battery test cells respectively comprising ELY #13 and ELY #14 were tested in a discharge rate test (Table 7 of FIG. 27). The test cells were fabricated, and an initial charge-discharge formation procedure was carried out on the test cells. The cells were then cut open and re-sealed under vacuum to remove any gasses formed during the formation process (sometimes referred to here as a degas procedure). The cells were then cycled with charge/discharge test conditions comprising a constant current, constant potential (CCCP) at 1 C charge to 4.0V and taper to 0.5 C, then a CCCP at 0.5° C. charge to 4.4V and taper to 0.05 C followed by a 0.5 C discharge to 2.5V. Every 20th cycle the cells underwent a discharge at 0.2 C instead of 0.5 C to measure the 0.2 C capacity. The electrolytes in this series (#13, #14) contain LiPF₆, EI, EP, FEC, VC, and ADN. ELY #13 contains LiDFOB and ELY #14 contains MDFA. Cycle life (cycles to 90% initial 0.2 C capacity) increased from 230 cycles (ELY #13) to 245 cycles (ELY #14). The presence of MDFA in the electrolyte may lead to a denser, more conformal, more mechanically stable, and more adhesive passivation layer containing more LiF and LiSO₂F being formed at the anode SEI, which may reduce parasitic electrolyte decomposition rates and reduce damage to the passivation layer due to particle morphology changes/swelling during cycling, which may reduce capacity fade. The DCR was measured in the 4th cycle during a 0.2 C discharge by applying a 2 C discharge current at 50% SOC and measuring the difference in voltage after 10 seconds compared to immediately before the 2 C current was applied. DCR decreased from 44.5 (2 cm² (ELY #13) to 39.1 (2 cm² (ELY #14). The significant reduction in the charge transfer resistance at the anode-electrolyte interface may be due to higher LiF and LiSO₂F content in the interfacial (SEI) layer, facilitating Li-ion transport across the interface. Volume change after high-temperature storage (60 hours at 72° C. after a full charge to about 4.4V) decreased from 9.9% (ELY #13) to 7.8% (ELY #14). This may be due to passivation of the cathode surface through generation of LiSO₂F and LiF as well as partial fluorination of the transition metal oxide surface making cobalt fluorides during oxidation of MDFA, which may reduce the chemical and electrochemical reactivity of the cathode with the electrolyte, reducing the rate at which electrolyte components are oxidized to CO₂ and other gasses at high voltage. The voltage of onset of reduction during the first charge decreased from 3.03 V (ELY #13) to 2.64 V (ELY #14). MDFA may be reduced earlier in the first charge due to its weak C—S and S—F bonds and the strongly electronegative —SO₂F functional group, all of which may raise the reduction potential. This may allow MDFA to contribute to the SEI preferentially over other molecules with lower reduction potentials that may not form effective SEIs (e.g., EI, EP, ADN), which may reduce side reaction rates and capacity fade.

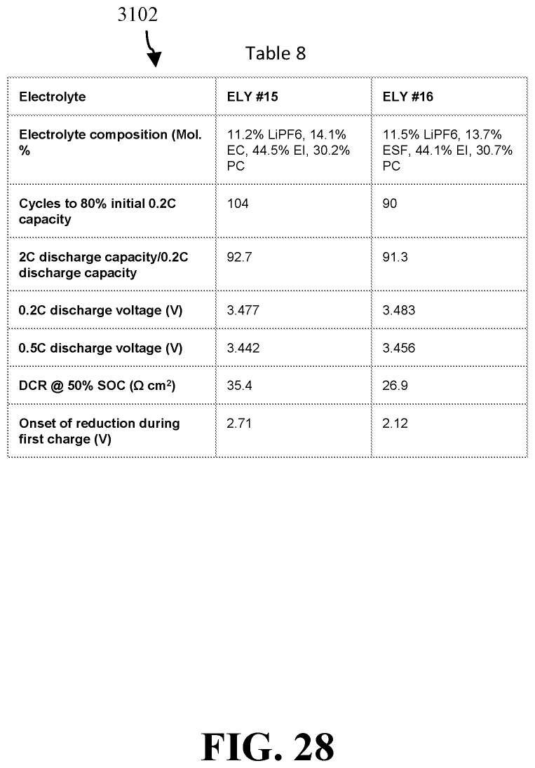

FIG. 28 shows a Table 8 (3102) which shows the electrolyte compositions and associated selected battery performance characteristics for electrolytes ELY #15 and 16. ELY #16 is an example of an electrolyte comprising ethenesulfonyl fluoride (ESF) or Compound No. 31, shown as 1404 in FIG. 13. In one illustrative example (cells utilizing ELY #15, as shown in Table 8 of FIG. 28), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO active material (with specific reversible capacity of about 140 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #15 comprising: about 11.2 mol. % LiPF₆, about 14.1 mol. % EC, about 44.5 mol. % EI, about 30.2 mol. % PC.

In one illustrative example (cells utilizing ELY #16, as shown in Table 8 of FIG. 28), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO active material (with specific reversible capacity of about 140 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #16 comprising: about 11.5 mol. % LiPF₆, about 13.7 mol. % ESF (Compound No. 31, 1406), about 44.1 mol. % EI, about 30.7 mol. % PC.

Li-ion battery test cells respectively comprising ELY #15 and ELY #16 were tested in a discharge rate test (Table 8 of FIG. 28). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5° C. charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (#15, #16) contain LiPF₆, EI, and PC. ELY #15 contains EC and ELY #16 contains ESF. Cycle life (cycles to 80% of initial 0.2 C capacity) slightly decreased from 104 cycles (ELY #15) to 90 cycles (ELY #16). The cycle life with ESF is similar to when EC is present in the electrolyte, indicating that ESF may form a passivating SEI that reduces parasitic reactions at the anode-electrolyte interface and reduces capacity fade similar to EC. Slightly lower cycle life may indicate that the polymeric components of the ESF-derived SEI are not as extensive, high molecular weight, or mechanically robust as those for EC. The DCR was measured in the 4th cycle during a 0.2 C discharge by applying a 2 C discharge current at 50% SOC and measuring the difference in voltage after 10 seconds compared to immediately before the 2 C current was applied. DCR decreased from 35.4 Ωcm² (ELY #15) to 26.9 Ωcm² (ELY #16). The cell resistance is dramatically decreased by using ESF, while cycle life is mostly maintained, which may be due to the formation of an SEI with a high content of LiF and LiSO₂F, which may reduce the interfacial resistance and facilitate Li transport between the electrolyte and the anode. The voltage for the onset of reduction during the first charge decreased from 2.71 V (ELY #15) to 2.12 V (ELY #16). ESF may be reduced earlier in the first charge due to its weak C—S and S—F bonds and the strongly electronegative —SO₂F functional group, both of which may raise the reduction potential. This may allow ESF to contribute to the SEI preferentially over other molecules with lower reduction potentials that may not form stable SEI (e.g., EI, PC), which may reduce side reaction rates and capacity fade.

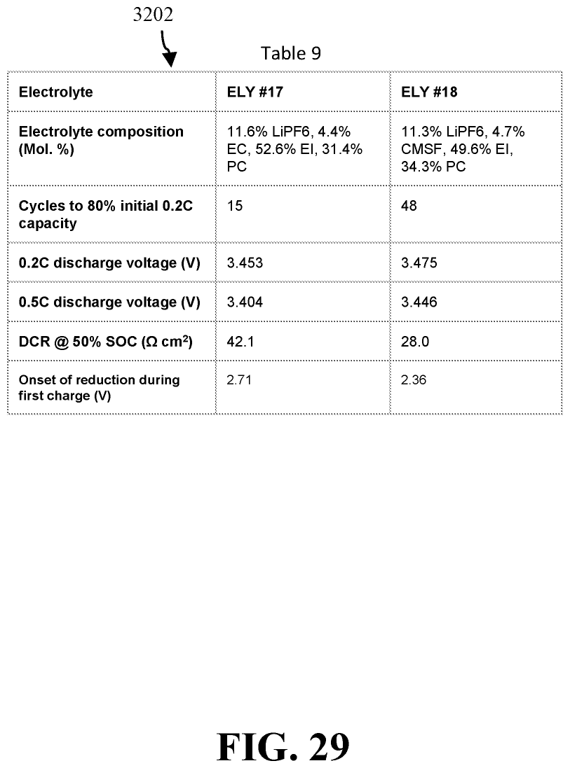

FIG. 29 shows a Table 9 (3202) which shows the electrolyte compositions and associated selected battery performance characteristics for electrolytes ELY #17 and 18. ELY #18 is an example of an electrolyte comprising cyanomethanesulfonyl fluoride (CMSF) or Compound No. 29, shown as 1402 in FIG. 13. In one illustrative example (cells utilizing ELY #17, as shown in Table 9 of FIG. 29), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO active material (with specific reversible capacity of about 140 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #17 comprising: about 11.6 mol. % LiPF₆, about 4.4 mol. % EC, about 52.6 mol. % EI, about 31.4 mol. % PC.

In one illustrative example (cells utilizing ELY #18, as shown in Table 9 of FIG. 29), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #18 comprising: about 11.3 mol. % LiPF₆, about 4.7 mol. % CMSF (Compound No. 29, 1402), about 49.6 mol. % EI, about 34.3 mol. % PC.

Li-ion battery test cells respectively comprising ELY #17 and ELY #18 were tested in a discharge rate test (Table 9 of FIG. 29). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (#17, #18) contain LiPF₆, EI, and PC. ELY #17 contains EC and ELY #18 contains CMSF. Cycle life (cycles to 80% of initial 0.2 C capacity) increased from 15 cycles (ELY #17) to 48 cycles (ELY #18). The presence of CMSF in the electrolyte may lead to the formation of a denser, more conformal, more polymeric, more mechanically stable, and more adhesive passivation layer containing more LiF and LiSO₂F at anode SEI, reducing parasitic electrolyte decomposition rates and reducing damage to passivation layer due to particle morphology changes/swelling during cycling, which may reduce capacity fade. The DCR was measured in the 4th cycle during a 0.2 C discharge by applying a 2 C discharge current at 50% SOC and measuring the difference in voltage after 10 seconds compared to immediately before the 2 C current was applied. DCR decreased from 42.1 (2 cm² (ELY #17) to 28.0 (2 cm² (ELY #18). The cell resistance is significantly reduced with CMSF, which may be due to a higher content of LiF and LiSO₂F in the SEI, which may facilitate Li transport across the anode-electrolyte interface. The voltage for the onset of reduction during the first charge decreased from 2.71 V (ELY #17) to 2.36 V (ELY #18). CMSF may be reduced earlier in the first charge due to its weak C—S and S—F bonds and the strongly electronegative —SO₂F functional group, all of which may raise the reduction potential. This may allow CMSF to contribute to the SEI preferentially over other molecules with lower reduction potentials that may not form stable SEI (e.g., EI, PC), which may reduce side reaction rates and capacity fade.

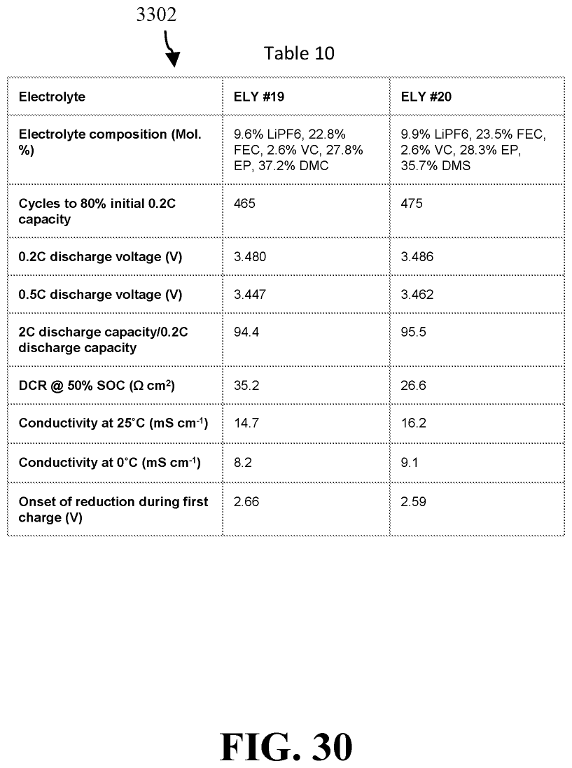

FIG. 30 shows a Table 10 (3302) which shows the electrolyte compositions and associated selected battery performance characteristics for electrolytes ELY #19 and 20. ELY #20 is an example of an electrolyte comprising dimethyl sulfite (DMS) or Compound No. 37, shown as 1418 in FIG. 13. In one illustrative example (cells utilizing ELY #19, as shown in Table 10 of FIG. 30), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO active material (with specific reversible capacity of about 140 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #19 comprising: about 9.6 mol. % LiPF₆, about 22.8 mol. % FEC, about 2.6 mol. % VC, about 27.8 mol. % EP, about 37.2 mol. % DMC.

In one illustrative example (cells utilizing ELY #20, as shown in Table 10 of FIG. 30), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO active material (with specific reversible capacity of about 140 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #20 comprising: about 9.9 mol. % LiPF₆, about 23.5 mol. % FEC, about 2.6 mol. % VC, about 28.3 mol. % EP, about 35.7 mol. % DMS (Compound No. 37, 1418).

Li-ion battery test cells respectively comprising ELY #19 and ELY #20 were tested in a discharge rate test (Table 10 of FIG. 30). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (ELY #19, ELY #20) contain LiPF₆, FEC, VC, and EP. ELY #19 contains DMC at co-solvent levels (37.2 mol. %) and ELY #20 contains DMS at co-solvent levels (35.7 mol %). Cycle life (cycles to 80% of initial 0.2 C capacity) increased from 465 cycles (ELY #19) to 475 cycles (ELY #20). The cycle life is approximately the same with DMC or DMS, which indicates that DMS may have relatively little impact on the mechanical stability of the SEI, which may be primarily formed by FEC and VC. The DCR was measured in the 4th cycle during a 0.2 C discharge by applying a 2 C discharge current at 50% SOC and measuring the difference in voltage after 10 seconds compared to immediately before the 2 C current was applied. DCR decreased from 35.2 (2 cm² (ELY #19) to 26.6 (2 cm² (ELY #20). This may be due to DMS increasing the separation of the ions in the solution, increasing the concentration of mobile charges and increasing conductivity, due to its higher dielectric constant compared to DMC. DMS may also reduce the resistance at the electrode interfaces, particularly at the cathode, by decomposing to form ionically conductive sulfur-containing phases (e.g., Li₂SO₃, Li₂SO₄, Li₂S) in the SEI and CEI. The voltage for the onset of reduction during the first charge decreased from 2.66 V (ELY #19) to 2.59 V (ELY #20). DMS may be reduced earlier in the first charge due to its greater presence in the Li solvation shell, as well as the weak S—O bonds, both of which may raise its reduction potential.

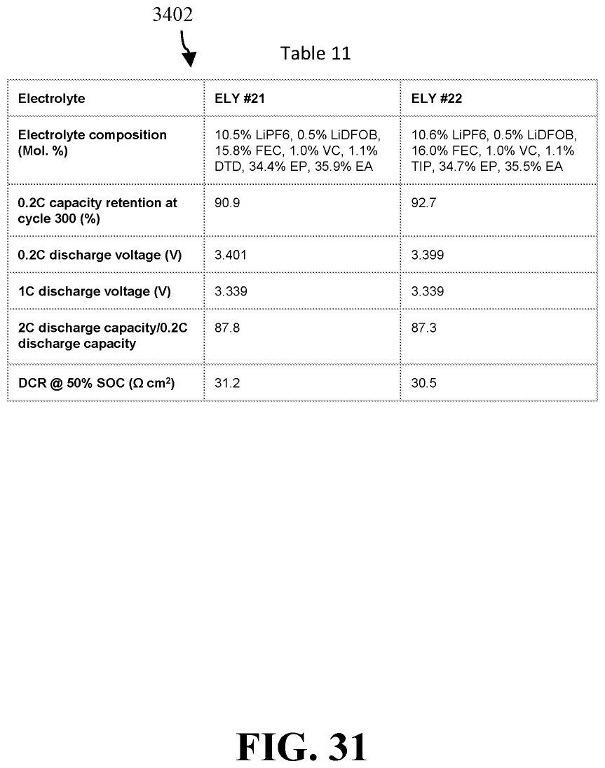

FIG. 31 shows a Table 11 (3402) which shows the electrolyte compositions and associated selected battery performance characteristics for electrolytes ELY #21 and 22. ELY #21 is an example of an electrolyte comprising 1,3,2-dioxathiolane 2,2-dioxide (DTD) or Compound No. 1, shown as 302 in FIG. 3. ELY #22 is an example of an electrolyte comprising triisopropyl phosphate (TIP) or Compound No. 36, shown as 1416 in FIG. 13. In one illustrative example (cells utilizing ELY #21, as shown in Table 11 of FIG. 31), a consumer Li-ion battery cell (Li-ion battery cell for use in consumer electronics products) with capacity of about 0.023 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from a water-based suspension comprising a polyacrylate binder and a carbon black conductive additive, (ii) a cathode with NMC811 (composition approximately LiNi_{0.8}Mn_{0.1}Co_{0.1}O₂) active material (with specific reversible capacity of about 200 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 4.10 mAh/cm², charge voltage of about 4.2V, (iii) a polymer-ceramic separator, and (iv) an ELY #21 comprising: about 10.5 mol. % LiPF₆, about 0.5 mol. % LiDFOB, about 15.8 mol. % FEC, about 1.0 mol. % VC, about 1.1 mol. % 1,3,2-dioxathiolane 2,2-dioxide (DTD), about 34.4 mol. % EP, about 35.9 mol. % ethyl acetate (EA).

In one illustrative example (cells utilizing ELY #22, as shown in Table 11 of FIG. 31), a consumer Li-ion battery cell (Li-ion battery cell for use in consumer electronics products) with capacity of about 0.023 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from a water-based suspension comprising a polyacrylate binder and a carbon black conductive additive, (ii) a cathode with NMC811 (composition approximately LiNi_{0.8}Mn_{0.1}Co_{0.1}O₂) active material (with specific reversible capacity of about 200 mAh/g when normalized by the weight of active material particles in the cathode) casted on Al current collector foil from an organic solvent suspension comprising a PVDF-based binder and a carbon black conductive additive, anode:cathode areal capacity ratio of about 1.11:1 and areal reversible capacity loading of about 4.06 mAh/cm², charge voltage of about 4.2V, (iii) a polymer-ceramic separator, and (iv) an ELY #22 comprising: about 10.6 mol. % LiPF₆, about 0.5 mol. % LiDFOB, about 16.0 mol. % FEC, about 1.0 mol. % VC, about 1.1 mol. % TIP (Compound No. 36, 1416), about 34.7 mol. % EP, about 35.5 mol. % EA.

Li-ion battery test cells respectively comprising ELY #21 and ELY #22 were tested in a discharge rate test (Table 11 of FIG. 31). The test cells were fabricated, and an initial charge-discharge formation procedure was carried out on the test cells. The cells were then cycled with charge/discharge test conditions comprising a constant current, constant potential (CCCP) at 1 C charge to 4.2V and taper to 0.05 C, followed by a 1 C discharge to 2.5V. Every 20th cycle the cells underwent a CCCP charge at 0.5° C. with taper to 0.05 C followed by a discharge at 0.2 C instead of 1 C to measure the 0.2 C capacity. The electrolytes in this series (ELY #21, ELY #22) contain LiPF₆, LiDFOB, FEC, VC, EP, and EA. ELY #21 contains DTD and ELY #22 contains TIP. Cycle life (0.2 C capacity retention at cycle number 300, in %) increased from 90.9% (ELY #21) to 92.7% (ELY #22). TIP may increase the formation of Li₃PO₄ in the SEI, which may reduce the rate of decomposition reactions of the electrolyte at the anode and improve the mechanical stability of the SEI, reducing damage during the swelling of the anode particles, which in turn may improve cycle life and reduce capacity fade. The DCR was measured in the 4th cycle during a 0.2 C discharge by applying a 2 C discharge current at 50% SOC and measuring the difference in voltage after 10 seconds compared to immediately before the 2 C current was applied. DCR decreased from 31.2 (2 cm² (ELY #21) to 30.5 (2 cm² (ELY #22). This may be because of the presence of Li₃PO₄ in the SEI and/or CEI when TIP is present in the electrolyte, which may increase the ionic conductivity of the electrode interfaces and facilitate lithium ion transport across the interfaces, which may reduce the charge transfer resistances of the anode and/or cathode.

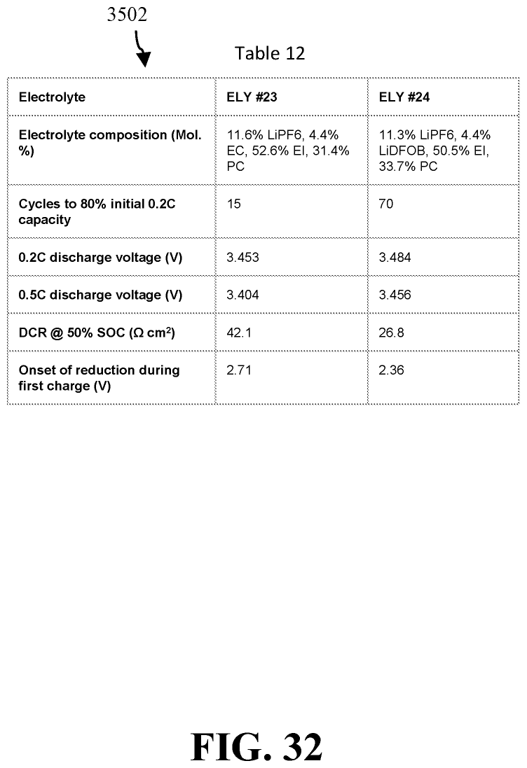

FIG. 32 shows a Table 12 (3502) which shows the electrolyte compositions and associated selected battery performance characteristics for electrolytes ELY #23 and 24. ELY #24 is an example of an electrolyte comprising lithium difluoro(oxalato)borate (LiDFOB) or Compound No. 43, shown as 2006 in FIG. 17. In one illustrative example (cells utilizing ELY #23, as shown in Table 12 of FIG. 32), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO active material (with specific reversible capacity of about 140 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #23 comprising: about 11.6 mol. % LiPF₆, about 4.4 mol. % EC, about 52.6 mol. % EI, about 31.4 mol. % PC.

In one illustrative example (cells utilizing ELY #24, as shown in Table 12 of FIG. 32), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO active material (with specific reversible capacity of about 140 mAh/g when normalized by the weight of active material particles in the cathode) casted on Al current collector foil from an organic solvent suspension comprising a PVDF-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #24 comprising: about 11.3 mol. % LiPF₆, about 4.4 mol. % LiDFOB (Compound No. 43, 2006), about 50.5 mol. % EI, about 33.7 mol. % PC.

Li-ion battery test cells respectively comprising ELY #23 and ELY #24 were tested in a discharge rate test (Table 12 of FIG. 32). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5° C. charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series (#23, #24) contain LiPF₆, EI, and PC. ELY #24 contains LIDFOB. Cycle life (cycles to 80% of initial 0.2 C capacity) increased from 15 cycles (ELY #23) to 70 cycles (ELY #24). This may be due to the formation of a denser, more conformal, more polymeric, and more adhesive SEI passivation layer containing more LiF at anode-electrolyte interface when LiDFOB is present in the electrolyte. This may reduce parasitic electrolyte decomposition rates and reduce damage to the passivation layer due to particle morphology changes/swelling during cycling, which may reduce capacity fade. This may be due to the formation of oligomeric and polymeric organoborates as well as LiF upon reduction of LiDFOB. The DCR was measured in the 4th cycle during a 0.2 C discharge by applying a 2 C discharge current at 50% SOC and measuring the difference in voltage after 10 seconds compared to immediately before the 2 C current was applied. DCR decreased from 42.1 (ELY #23) to 26.8 (ELY #24). The cell resistance is significantly reduced with LiDFOB, which may be due to a reduction in the anode charge transfer resistance, which may be due to a higher content of LiF in the SEI, which may facilitate Li transport across the anode-electrolyte interface. The voltage for the onset of reduction during the first charge decreased from 2.71 V (ELY #23) to 2.36 V (ELY #24). LiDFOB may be reduced earlier in the first charge due to its weak B—O bonds and the strongly electronegative C₂O₄ and F functional groups, both of which may raise the reduction potential. This may allow LiDFOB to contribute to the SEI preferentially over other molecules with lower reduction potentials that may not generate stable SEI (e.g., EI, PC), which may reduce side reaction rates and capacity fade.

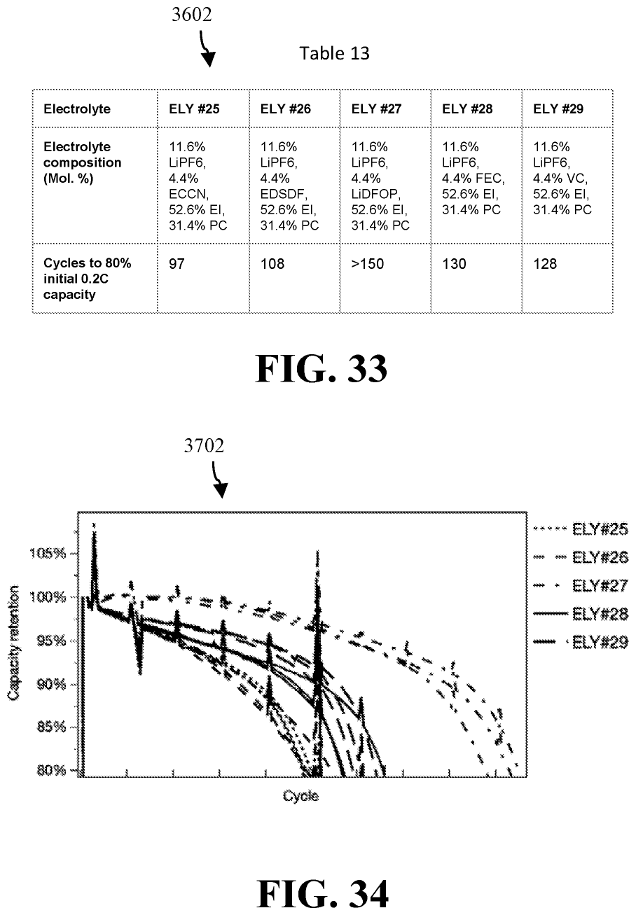

In one illustrative example (cells utilizing ELY #25, as shown in Table 13 of FIG. 33), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #25 comprising: about 11.4 mol. % LiPF₆, about 4.5 mol. % ECCN (Compound No. 51), about 34.4 mol. % PC, about 49.8 mol. % EI.

In one illustrative example (cells utilizing ELY #26, as shown in Table 13 of FIG. 33), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #26 comprising: about 11.4 mol. % LiPF₆, about 4.5 mol. % EDSDF (Compound No. 52), about 34.4 mol. % PC, about 49.8 mol. % EI.

In one illustrative example (cells utilizing ELY #27, as shown in Table 13 of FIG. 33), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #27 comprising: about 11.4 mol. % LiPF₆, about 4.5 mol. % LiDFOP (Compound No. 53), about 34.4 mol. % PC, about 49.8 mol. % EI.

In one illustrative example (cells utilizing ELY #28, as shown in Table 13 of FIG. 33), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #28 comprising: about 11.4 mol. % LiPF₆, about 4.5 mol. % FEC, about 34.4 mol. % PC, about 49.8 mol. % EI.

In one illustrative example (cells utilizing ELY #29, as shown in Table 13 of FIG. 33), a consumer Li-ion battery cell (Li-ion battery cell for use in consumer electronics products) with capacity of about 0.155 Ah may comprise: (i) an anode with about 89.6% by weight of Si—C nanocomposite active material particles (with specific reversible capacity of about 1280 mAh/g when normalized by the weight of active material particles in the anode) casted on Cu current collector foil from an N-methyl-2-pyrrolidone-based suspension comprising a polyvinyl alcohol binder and a carbon nanotube conductive additive, (ii) a cathode with high-voltage LCO (LiCoO₂) active material (with specific reversible capacity of about 140 mAh/g when normalized by the weight of active material particles in the cathode) casted on Al current collector foil from an organic solvent suspension comprising a polyvinylidene fluoride (PVDF)-based binder and a carbon black conductive additive, anode:cathode areal capacity ratio of about 1.08:1 and areal reversible capacity loading of about 2.75 mAh/cm², charge voltage of about 4.2V, (iii) a polymer-ceramic separator, and (iv) an ELY #29 comprising: about 11.4 mol. % LiPF₆, about 4.5 mol. % VC, about 34.4 mol. % PC, about 49.8 mol. % EI.

Li-ion battery test cells respectively comprising ELY #25, ELY #26, ELY #27, ELY #28 and ELY #29 were tested in a cycle life test (Table 13 of FIG. 33). The test cells were fabricated, and an initial charge-discharge formation procedure was carried out on the test cells. The cells were then cut open and re-sealed under vacuum to remove any gases formed during the formation process (sometimes referred to here as a degas procedure). The cells were then cycled with charge/discharge test conditions comprising a constant current, constant potential (CCCP) at 1 C charge to 3.8V and taper to 0.5 C, then a CCCP at 0.5 C charge to 4.2V and taper to 0.05 C followed by a 0.5 C discharge to 2.5V. Every 20th cycle the cells underwent a discharge at 0.2 C instead of 0.5 C to measure the 0.2 C capacity. The electrolytes in this series compare the SEI forming properties of ECCN, EDSDF, LiDFOP to FEC and VC. Cycle life (cycles to 80% of initial 0.2 C capacity) of ELY #25, ELY #26 and ELY #27 is comparable to or higher than ELY #28 and ELY #29 (FIG. 34). ECCN may create a dense, conformal, polymeric, and adhesive passivation layer containing LiCN and Li₂CO₃, at anode-electrolyte interface (SEI) compared to FEC and VC, reducing parasitic electrolyte decomposition rates and reducing damage to passivation layer due to particle morphology changes/swelling during cycling, which may reduce capacity fade. EDSDF may create a dense, conformal, polymeric, and adhesive passivation layer containing LiF, LiSO₂F, Li₂SO₃, Li₂SO₄, at anode-electrolyte interface (SEI) compared to FEC and VC, reducing parasitic electrolyte decomposition rates and reducing damage to passivation layer due to particle morphology changes/swelling during cycling, which may reduce capacity fade. LiDFOP may create a dense, conformal, polymeric, and adhesive passivation layer containing LiF, Li₂CO₃, Li₃PO₄, Li₃PO₃, or other phosphates, fluorophosphates, organophosphates, oxalates, at anode-electrolyte interface (SEI) compared to FEC and VC, reducing parasitic electrolyte decomposition rates and reducing damage to passivation layer due to particle morphology changes/swelling during cycling, which may reduce capacity fade.

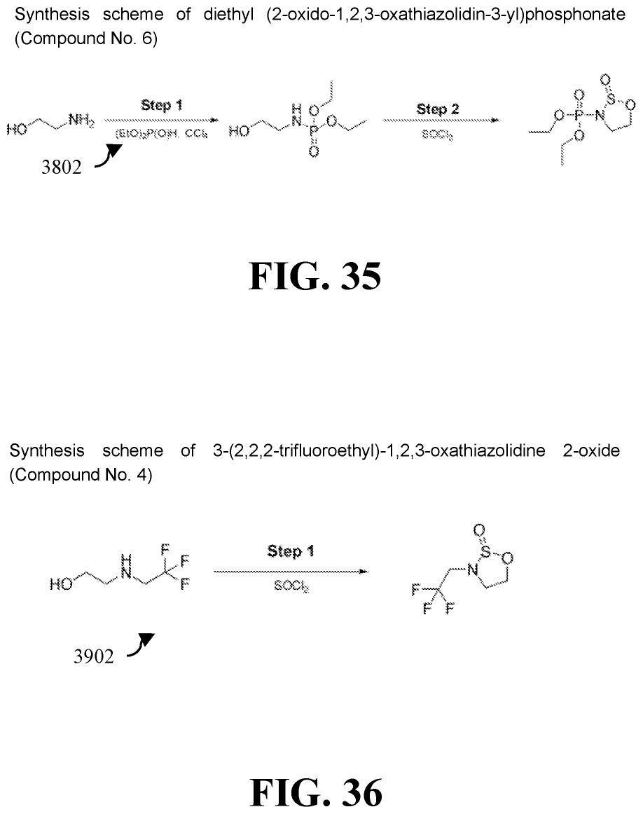

The compounds of Cyc1, such as diethyl (2-oxido-1,2,3-oxathiazolidin-3-yl)phosphonate or Compound No. 6, can be synthesized using the following general synthesis procedure (FIG. 35):

Step 1. To a stirred solution of 2-aminoethanol (20.2 g, 331 mmol) and triethylamine (46.1 ml, 331 mmol) in THF (400 ml) a solution of carbon tetrachloride (31.9 ml, 331 mmol) and diethyl phosphite (42.7 ml, 331 mmol) solution in THF (100 ml) was added at 0-10° C. Resulting mixture was stirred at RT overnight. After completion of the reaction, RM was filtered, and filtrate evaporated under reduced pressure. The resulting crude material was purified by flash chromatography to afford diethyl (2-hydroxyethyl)phosphoramidate (30.0 g, 152 mmol, 46% yield). 1H NMR (400 MHZ, Chloroform-d) δ 4.08 (q, J=7.3 Hz, 4H), 3.67 (t, J=4.8 Hz, 2H), 3.06 (dt, J=10.2, 4.9 Hz, 2H), 2.83 (s, 2H), 1.34 (t, J=7.1 Hz, 6H).

Step 2. To a stirred solution of phosphorylated amino alcohol (26.22 g, 133 mmol) in dry DCM (250 ml) was added TEA (22.27 ml, 160 mmol) at −15-0° C. followed by addition of SOCl₂ (10.2 ml, 140 mmol) and the resulting yellow suspension was stirred at 0° C. for 3 h. The reaction mixture was filtered and the filtrate concentrated to remove all the volatiles before being re-dissolved in 200 ml of Et₂O, filtered and concentrated again. The resulting crude material was purified by flash chromatography to afford target diethyl (2-oxo-1,2,3-oxathiazolidin-3-yl)phosphoramidate (Compound No. 6) (15.52 g, 63.84 mmol, 48% yield).

MS (GC, m/z): 243.0 (100% purity), LC/MS ([M+H]+, m/z): 244.0,

1H NMR (500 MHz, Chloroform-d) δ 4.93 (ddd, J=9.6, 6.8, 2.2 Hz, 1H), 4.66 (ddd, J=9.6, 8.1, 6.8 Hz, 1H), 4.29-4.09 (m, 4H), 3.76 (dddd, J=11.0, 9.3, 6.1, 2.4 Hz, 1H), 3.48 (ddd, J=11.0, 9.3, 7.0, 2.4 Hz, 1H), 1.37 (t, J=7.0 Hz, 6H).

Compound No. 4 (3-(2,2,2-trifluoroethyl)-1,2,3-oxathiazolidine 2-oxide) was prepared in 65% yield as a colorless liquid following by general procedure described for Compound No. 6 in Step 2 starting from 2-((2,2,2-trifluoroethyl)amino)ethanol and purified by vacuum distillation b.p. 88-89° C./10 mm Hg (scheme 3902 of FIG. 36). LC/MS ([M+H]+, m/z) 349.2

1H NMR (500 MHz, Chloroform-d) δ 4.83 (ddd, J=15.3, 8.1, 7.0, Hz, 1H), 4.46 (ddd, J=15.3, 8.1, 7.0, Hz, 1H), 3.80 (ddd, J=15.4, 8.8, 7.6 Hz, 1H), 3.56 (dq, J=8.0, 7.2 Hz, 2H), 3.40 (ddd, J=15.4, 8.8, 7.6 Hz, 1H), 19F NMR δ −71.42.

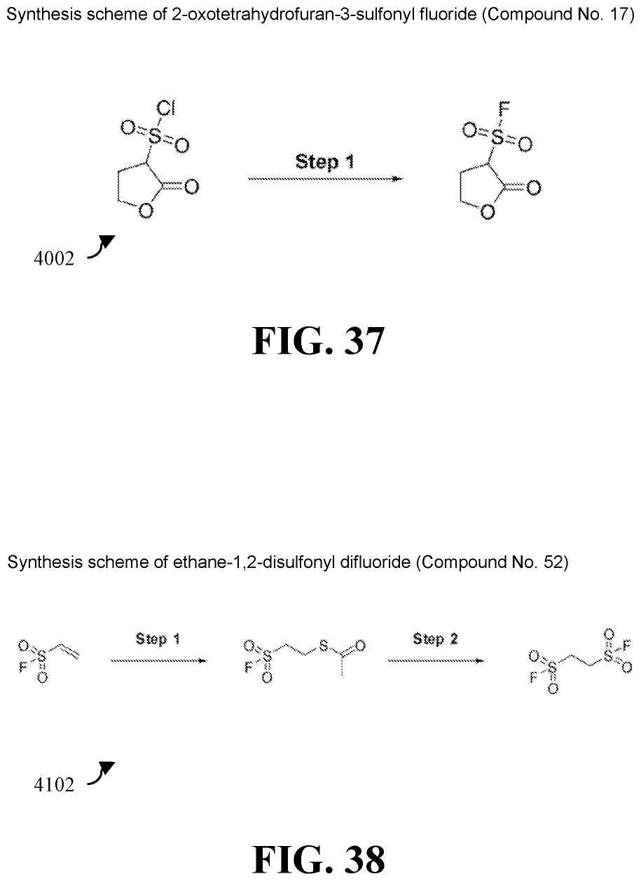

Some of the compounds of formula Cyc3, can be synthesized using the following general procedure of synthesis of sulfonyl fluorides from the corresponding sulfonyl chlorides (FIG. 37):

To a stirred solution of a sulfonyl chloride (35.5 mmol) in acetonitrile (150 ml) potassium fluoride (4.13 g, 71.0 mmol) was added and reaction mixture was stirred at room temperature overnight. After completing the reaction, the solid material was filtered off and filtrate was evaporated under reduced pressure. The residue was re-dissolved in chloroform (200 ml) and filtered again. The Compound No. 17 (2-oxotetrahydrofuran-3-sulfonyl fluoride) was synthesized as brown liquid according to general method for preparation of sulfonyl fluorides from sulfonyl chlorides. Yield—71%. MS (ES+, m/z): 167.99

1H NMR (500 MHZ, CDCl₃): δ 4.63-4.57 (m, 1H), 4.53-4.46 (m, 2H) 2.96-2.9 (m, 2H).

Compounds of formula Oth1 such as ethane-1,2-disulfonyl difluoride or EDSDF, or Compound No. 52, can be synthesized using the following synthesis procedure (FIG. 38):

Step 1. Triethylamine (40.3 ml, 289 mmol) was added dropwise to a stirred solution of vinyl sulfonyl fluoride (28.9 g, 263 mmol) and thioacetic acid (24.53 ml, 342 mmol) in chloroform (500 ml) at 0° C. and the mixture allowed to stay overnight at room temperature. After completing the reaction, reaction mixture was diluted and washed with water (2×150 ml). The organic layer was separated, dried over Na₂SO₄ and evaporated under reduced pressure to give S-(2-(fluor sulfonyl)ethyl) ethanethioate (45 g, 242 mmol, 92% yield) as a brown oil. The material was used for the next step without further purification. MS (ES+, m/z): 185.98.

Step 2. Select Fluor (117 g, 329 mmol) was added portion wise to a stirred solution of S-(2-(fluor sulfonyl)ethyl) ethanethioate (17.5 g, 94 mmol) in 1:1 acetonitrile-water mixture (200 ml) and reaction mixture was allowed to stay overnight at room temperature. After completion of the reaction, the solution diluted with additional portion of water (200 ml) and extracted with MTBE (2×150 ml). The organic layer dried over Na₂SO₄ filtered and evaporated under reduced pressure. The residue was recrystallized from hexane to give pure ethane-1,2-disulfonyl difluoride Compound No. 52 (14 g, 72.1 mmol, 77% yield) as a yellow solid. MS (ES+, m/z): 193.95 [M+H]⁺ C₂H₄F₂O₄S₂. ¹H NMR (500 MHz, DMSO-d₆) δ 3.94 (m, 2H). ¹⁹F NMR (500 MHZ, DMSO-d₆) δ 55.83 (s, 2F).

The above-described exemplary nanocomposite particles (e.g., anode or cathode particles) may generally be of any shape (e.g., near-spherical or a spheroidal or an ellipsoid (e.g., including oblate spheroid), cylindrical, plate-like, have a random shape, etc.) and of any size. The maximum size of the particle may depend on the rate performance requirements, on the rate of the ion diffusion into the partially filled particles, and/or on other parameters. For most applications, the average diffusion distance from the solid-electrolyte interphase (e.g., from the surface of the composite particles) to the inner core of the composite particles may be smaller than about 10 microns for optimal performance.

Some aspects of this disclosure may also be applicable to conventional intercalation-type electrodes (e.g., lower voltage cathodes) and provide benefits of improved rate performance or improved stability, particularly for electrodes with medium and high-capacity loadings (e.g., greater than about 3-4 mAh/cm²).

Some aspects of this disclosure may also be applicable to conversion-type cathodes (e.g., lower voltage cathodes) and provide benefits of improved rate performance or improved stability, particularly for electrodes with medium and high-capacity loadings (e.g., greater than about 3-4 mAh/cm²).

In one or more of the embodiments of the detailed description above, it may be seen that different features are grouped together in examples. However, it will be appreciated that these examples may be readily modified by one of ordinary skill in the art to tune to particular applications, and such modified examples may include additional feature(s) and/or fewer feature(s), depending upon the application.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A lithium-ion battery electrolyte, comprising: an electrolyte compound composition; and a lithium salt composition comprising one or more of compounds of formula Salt2: LiPF₍₆₋₂ₙ₎(A₁₀²)ₙ Salt2, wherein:

A₁₀² is of formula A₁₀(1):

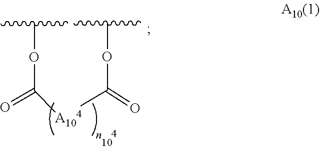

A₁₀⁴ is of formula A₁₀(2):

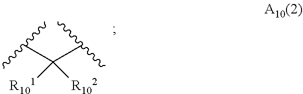

each of R₁₀¹ and R₁₀² is H; and n₁₀⁴ is 0; and a concentration of the one or more compounds in the lithium-ion battery electrolyte is in a range of about 0.1 mol. % to about 20 mol. %.

Clause 2. The lithium-ion battery electrolyte of clause 1, wherein: the one or more compounds comprise lithium difluoro(bisoxalato) phosphate (LiDFOP) with formula Compound No. 53:

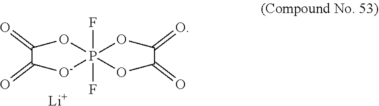

Clause 3. The lithium-ion battery electrolyte of clause 2, wherein: the lithium-ion battery electrolyte comprises fluoroethylene carbonate (FEC).

Clause 4. The lithium-ion battery electrolyte of any of clauses 1 to 3, wherein the lithium salt composition comprises lithium difluoro(oxalato)borate (LiDFOB) of formula Compound No. 43:

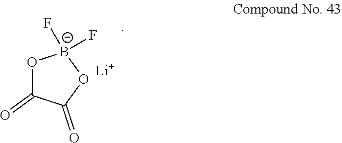

Clause 5. The lithium-ion battery electrolyte of any of clauses 1 to 4, wherein the lithium salt composition comprises LiPF₆.

Clause 6. The lithium-ion battery electrolyte of any of clauses 1 to 5, wherein a concentration of the lithium salt composition in the lithium-ion battery electrolyte is in a range from about 1 mol. % to about 20 mol. %.

Clause 7. The lithium-ion battery electrolyte of any of clauses 1 to 6, wherein: the lithium-ion battery electrolyte does not comprise fluoroethylene carbonate (FEC).

Clause 8. The lithium-ion battery electrolyte of any of clauses 1 to 7, wherein: the electrolyte compound composition comprises a non-fluoroethylene carbonate (FEC) cyclic carbonate.

Clause 9. The lithium-ion battery electrolyte of clause 8, wherein: the non-FEC cyclic carbonate is ethylene carbonate (EC); and a concentration of the EC in the lithium-ion battery electrolyte is about 50 mol. % or lower.

Clause 10. The lithium-ion battery electrolyte of any of clauses 8 to 9, wherein: the non-FEC cyclic carbonate is vinylene carbonate (VC), and a concentration of the VC in the lithium-ion battery electrolyte is about 5 mol. % or lower.

Clause 11. The lithium-ion battery electrolyte of any of clauses 1 to 10, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 12. The lithium-ion battery electrolyte of any of clauses 1 to 11, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 13. A lithium-ion battery, comprising: an anode current collector; a cathode current collector; an anode disposed on or in the anode current collector; a cathode disposed on or in the cathode current collector; and the lithium-ion battery electrolyte of clause 1 ionically coupling the anode and the cathode, wherein: the anode comprises composite particles comprising silicon and carbon.

Clause 14. The lithium-ion battery of clause 13, wherein: the composite particles comprise porous carbon in which the silicon is deposited.

Clause 15. The lithium-ion battery of clause 14, wherein: at least some of the silicon is present in the porous carbon as Si nanoparticles.

Clause 16. The lithium-ion battery of any of clauses 13 to 15, wherein: a mass of the silicon is in a range of about 3 wt. % to about 80 wt. % of a total mass of the anode.

Clause 17. The lithium-ion battery of any of clauses 13 to 16, wherein: the anode comprises graphitic carbon particles substantially free of silicon.

Clause 18. A lithium-ion battery electrolyte, comprising: a lithium salt composition comprising LiPF₆; and an electrolyte compound composition comprising one or more compounds of formula Cyc3:

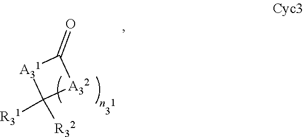

wherein: R₃¹ is H; R₃² is nitrile; A₃¹ is —O—; A₃² is —O—R₃⁴; R₃⁴ is C₁₋₃ alkanediyl; n₃¹ is 1; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

Clause 19. The lithium-ion battery electrolyte of clause 18, wherein: the one or more compounds comprise 2-oxo-1,3-dioxolane-4-carbonitrile (ECCN) of formula Compound No. 51:

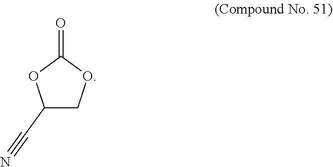

Clause 20. The lithium-ion battery electrolyte of clause 19, wherein: the lithium-ion battery electrolyte comprises fluoroethylene carbonate (FEC).

Clause 21. The lithium-ion battery electrolyte of any of clauses 18 to 20, wherein the lithium salt composition comprises lithium difluoro(bisoxalato) phosphate (LiDFOP) of formula Compound No. 53:

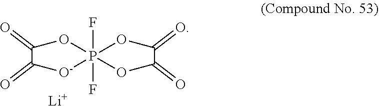

Clause 22. The lithium-ion battery electrolyte of any of clauses 18 to 21, wherein the lithium salt composition comprises lithium difluoro(oxalato)borate (LiDFOB) of formula Compound No. 43:

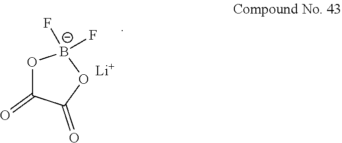

Clause 23. The lithium-ion battery electrolyte of any of clauses 18 to 22, wherein: the lithium-ion battery electrolyte does not comprise fluoroethylene carbonate (FEC).

Clause 24. The lithium-ion battery electrolyte of any of clauses 18 to 23, wherein: the electrolyte compound composition comprises a non-fluoroethylene carbonate (FEC)cyclic carbonate.

Clause 25. The lithium-ion battery electrolyte of clause 24, wherein: the non-FEC cyclic carbonate is ethylene carbonate (EC); and a concentration of the EC in the lithium-ion battery electrolyte is about 50 mol. % or lower.

Clause 26. The lithium-ion battery electrolyte of any of clauses 24 to 25, wherein: the non-FEC cyclic carbonate is vinylene carbonate (VC); and a concentration of the VC in the lithium-ion battery electrolyte is about 5 mol. % or lower.

Clause 27. The lithium-ion battery electrolyte of any of clauses 18 to 26, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 28. The lithium-ion battery electrolyte of any of clauses 18 to 27, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 29. A lithium-ion battery, comprising: an anode current collector; a cathode current collector; an anode disposed on or in the anode current collector; a cathode disposed on or in the cathode current collector; and the lithium-ion battery electrolyte of clause 18 ionically coupling the anode and the cathode, wherein: the anode comprises composite particles comprising silicon and carbon.

Clause 30. The lithium-ion battery of clause 29, wherein: the composite particles comprise porous carbon in which the silicon is deposited.

Clause 31. The lithium-ion battery of clause 30, wherein: at least some of the silicon is present in the porous carbon as Si nanoparticles.

Clause 32. The lithium-ion battery of any of clauses 29 to 31, wherein: a mass of the silicon is in a range of about 3 wt. % to about 80 wt. % of a total mass of the anode.

Clause 33. The lithium-ion battery of any of clauses 29 to 32, wherein: the anode comprises graphitic carbon particles substantially free of silicon.

Clause 34. A lithium-ion battery electrolyte, comprising: a lithium salt composition comprising LiPF₆; and an electrolyte compound composition comprising one or more compounds of formula Oth1:

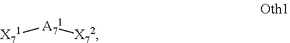

wherein: A₇¹ is C₁₋₆ alkanediyl; each of X₇¹ and X₇² is of formula X₇(1):

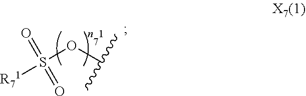

each R₇¹ is F; each n₇¹ is 0; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

Clause 35. The lithium-ion battery electrolyte of clause 34, wherein: the one or more compounds comprise ethane-1,2-disulfonyl difluoride (EDSDF) of formula Compound No. 52:

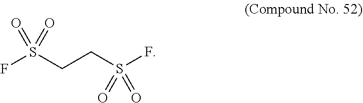

Clause 36. The lithium-ion battery electrolyte of clause 35, wherein: the lithium-ion battery electrolyte comprises fluoroethylene carbonate (FEC).

Clause 37. The lithium-ion battery electrolyte of any of clauses 34 to 36, wherein the lithium salt composition comprises lithium difluoro(bisoxalato) phosphate (LiDFOP) of formula Compound No. 53):

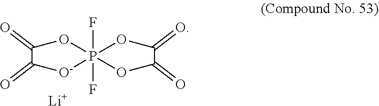

Clause 38. The lithium-ion battery electrolyte of any of clauses 34 to 37, wherein the lithium salt composition comprises lithium difluoro(oxalato)borate (LiDFOB) of formula Compound No. 43:

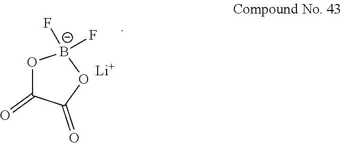

Clause 39. The lithium-ion battery electrolyte of any of clauses 34 to 38, wherein: the lithium-ion battery electrolyte does not comprise fluoroethylene carbonate (FEC).

Clause 40. The lithium-ion battery electrolyte of any of clauses 34 to 39, wherein: the electrolyte compound composition comprises a non-FEC cyclic carbonate.

Clause 41. The lithium-ion battery electrolyte of clause 40, wherein: the non-FEC cyclic carbonate is ethylene carbonate (EC); and a concentration of the EC in the lithium-ion battery electrolyte is about 50 mol. % or lower.

Clause 42. The lithium-ion battery electrolyte of any of clauses 40 to 41, wherein: the non-FEC cyclic carbonate is vinylene carbonate (VC); and a concentration of the VC in the lithium-ion battery electrolyte is about 5 mol. % or lower.

Clause 43. The lithium-ion battery electrolyte of any of clauses 34 to 42, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 44. The lithium-ion battery electrolyte of any of clauses 34 to 43, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 45. A lithium-ion battery, comprising: an anode current collector; a cathode current collector; an anode disposed on or in the anode current collector; a cathode disposed on or in the cathode current collector; and the lithium-ion battery electrolyte of clause 34 ionically coupling the anode and the cathode, wherein: the anode comprises composite particles comprising silicon and carbon.

Clause 46. The lithium-ion battery of clause 45, wherein: the composite particles comprise porous carbon in which the silicon is deposited.

Clause 47. The lithium-ion battery of clause 46, wherein: at least some of the silicon is present in the porous carbon as Si nanoparticles.

Clause 48. The lithium-ion battery of any of clauses 45 to 47, wherein: a mass of the silicon is in a range of about 3 wt. % to about 80 wt. % of a total mass of the anode.

Clause 49. The lithium-ion battery of any of clauses 45 to 48, wherein: the anode comprises graphitic carbon particles substantially free of silicon.

Clause 50. A lithium-ion battery electrolyte, comprising: a lithium salt composition comprising LiPF₆; and an electrolyte compound composition comprising fluoroethylene carbonate (FEC) and one or more compounds of formula Cyc1:

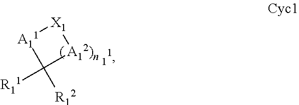

wherein: X₁ is of formula X₁(1):

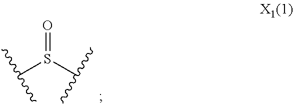 [SMILES: *S(*)=O]

each of R₁¹ and R₁² is H; A₁¹ is —O—; A₁² is —O—R₁⁷—; R₁⁷ is C₁₋₃ alkanediyl; n₁¹ is 1; and a concentration of the FEC in the lithium-ion battery electrolyte is in a range of about 0.1 mol. % to about 40 mol. %; a concentration of the one or more compounds in the lithium-ion battery electrolyte is in a range of about 5 mol. % to about 95 mol. %; and a concentration of the lithium salt composition in the lithium-ion battery electrolyte is in a range from about 1 mol. % to about 20 mol. %.

Clause 51. The lithium-ion battery electrolyte of clause 50, wherein: the one or more compounds comprise ethylene sulfite (ESi) of formula Compound No. 3:

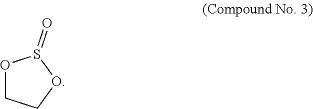

Clause 52. The lithium-ion battery electrolyte of any of clauses 50 to 51, wherein the lithium salt composition comprises lithium difluoro(bisoxalato) phosphate (LiDFOP) of formula Compound No. 53:

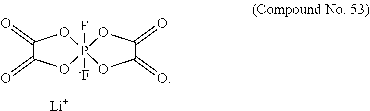

Clause 53. The lithium-ion battery electrolyte of any of clauses 50 to 52, wherein the lithium salt composition comprises lithium difluoro(oxalato)borate (LiDFOB) of formula Compound No. 43:

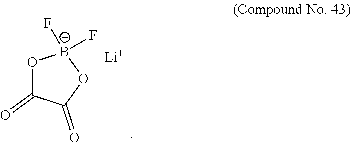

Clause 54. The lithium-ion battery electrolyte of any of clauses 50 to 53, wherein: the electrolyte compound composition comprises a non-FEC cyclic carbonate.

Clause 55. The lithium-ion battery electrolyte of clause 54, wherein: the non-FEC cyclic carbonate is ethylene carbonate (EC); and a concentration of the EC in the lithium-ion battery electrolyte is about 50 mol. % or lower.

Clause 56. The lithium-ion battery electrolyte of any of clauses 54 to 55, wherein: the non-FEC cyclic carbonate is vinylene carbonate (VC); and a concentration of the VC in the lithium-ion battery electrolyte is about 5 mol. % or lower.

Clause 57. The lithium-ion battery electrolyte of any of clauses 50 to 56, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 58. The lithium-ion battery electrolyte of any of clauses 50 to 57, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 59. A lithium-ion battery, comprising: an anode current collector; a cathode current collector; an anode disposed on and/or in the anode current collector; a cathode disposed on and/or in the cathode current collector; and the lithium-ion battery electrolyte of clause 50 ionically coupling the anode and the cathode, wherein: the anode comprises composite particles comprising silicon and carbon.

Clause 60. The lithium-ion battery of clause 59, wherein: the composite particles comprise porous carbon in which the silicon is deposited.

Clause 61. The lithium-ion battery of clause 60, wherein: at least some of the silicon is present in the porous carbon as Si nanoparticles.

Clause 62. The lithium-ion battery of any of clauses 59 to 61, wherein: a mass of the silicon is in a range of about 3 wt. % to about 80 wt. % of a total mass of the anode.

Clause 63. The lithium-ion battery of any of clauses 59 to 62, wherein: the anode comprises graphitic carbon particles substantially free of silicon.

Clause 64. A lithium-ion battery electrolyte, comprising: a lithium salt composition comprising LiPF₆; and an electrolyte compound composition comprising fluoroethylene carbonate (FEC) and one or more compounds of formula Cyc3:

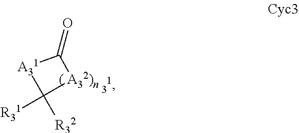

wherein: R₃¹ is H; R₃² is of formula R₃(1):

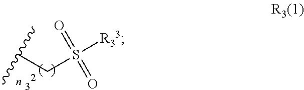

A₃¹ is O—R₃⁴—; A₃² is —C₁₋₄ alkanediyl-; R₃³ is F; R₃⁴ is C₁₋₃ alkanediyl; n₃¹ is 1; n₃² is 0 or 1; a concentration of the one or more compounds in the lithium-ion battery electrolyte is in a range of about 5 mol. % to about 95 mol. %.; and a concentration of the lithium salt composition in the lithium-ion battery electrolyte is in a range from about 1 mol. % to about 20 mol. %.

Clause 65. The lithium-ion battery electrolyte of clause 64, wherein: n₃² is 0; and the one or more compounds comprise 5-oxotetrahydrofuran-3-sulfonyl fluoride (GBLSF) of formula Compound No. 19:

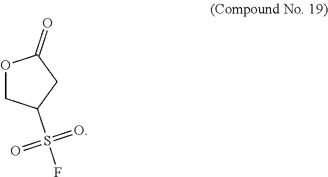

Clause 66. The lithium-ion battery electrolyte of any of clauses 64 to 65, wherein the lithium salt composition comprises lithium difluoro(bisoxalato) phosphate (LiDFOP) (of formula Compound No. 53:

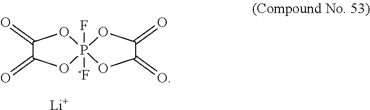

Clause 67. The lithium-ion battery electrolyte of any of clauses 64 to 66, wherein the lithium salt composition comprises lithium difluoro(oxalato)borate (LiDFOB) of formula Compound No. 43:

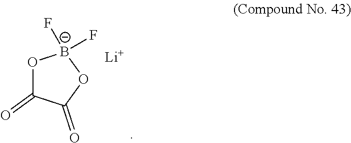

Clause 68. The lithium-ion battery electrolyte of any of clauses 64 to 67, wherein: the electrolyte compound composition comprises a non-FEC cyclic carbonate.

Clause 69. The lithium-ion battery electrolyte of clause 68, wherein: the non-FEC cyclic carbonate is ethylene carbonate (EC); and a concentration of the EC in the lithium-ion battery electrolyte is about 50 mol. % or lower.

Clause 70. The lithium-ion battery electrolyte of any of clauses 68 to 69, wherein: the non-FEC cyclic carbonate is vinylene carbonate (VC); and a concentration of the VC in the lithium-ion battery electrolyte is about 5 mol. % or lower.

Clause 71. The lithium-ion battery electrolyte of any of clauses 64 to 70, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 72. The lithium-ion battery electrolyte of any of clauses 64 to 71, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 73. A lithium-ion battery, comprising: an anode current collector; a cathode current collector; an anode disposed on and/or in the anode current collector; a cathode disposed on and/or in the cathode current collector; and the lithium-ion battery electrolyte of clause 64 ionically coupling the anode and the cathode, wherein: the anode comprises composite particles comprising silicon and carbon.

Clause 74. The lithium-ion battery of clause 73, wherein: the composite particles comprise porous carbon in which the silicon is deposited.

Clause 75. The lithium-ion battery of clause 74, wherein: at least some of the silicon is present in the porous carbon as Si nanoparticles.

Clause 76. The lithium-ion battery of any of clauses 73 to 75, wherein: a mass of the silicon is in a range of about 3 wt. % to about 80 wt. % of a total mass of the anode.

Clause 77. The lithium-ion battery of any of clauses 73 to 76, wherein: the anode comprises graphitic carbon particles substantially free of silicon.

Clause 78. A lithium-ion battery electrolyte, comprising: a lithium salt composition comprising LiPF₆; and an electrolyte compound composition comprising one or more compounds of formula Cyc4:

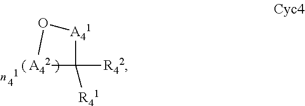

wherein: R₄¹ is of formula R₄(1):

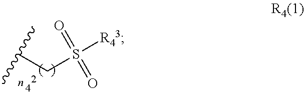

R₄² is H; A₄¹ is —CH₂—; R₄³ is F; n₄¹ is 0; n₄² is 0 or 1; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

Clause 79. The lithium-ion battery electrolyte of clause 78, wherein: n₄² is 1; and the one or more compounds comprise oxiran-2-ylmethanesulfonyl fluoride (OrMSF) of formula Compound No. 20:

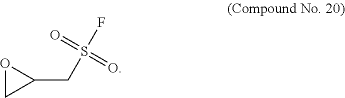

Clause 80. The lithium-ion battery electrolyte of clause 79, wherein: the lithium-ion battery electrolyte comprises fluoroethylene carbonate (FEC).

Clause 81. The lithium-ion battery electrolyte of any of clauses 78 to 80, wherein the lithium salt composition comprises lithium difluoro(bisoxalato) phosphate (LiDFOP) of formula Compound No. 53:

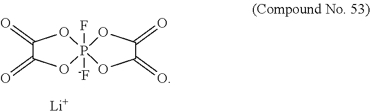

Clause 82. The lithium-ion battery electrolyte of any of clauses 78 to 81, wherein the lithium salt composition comprises lithium difluoro(oxalato)borate (LiDFOB) of formula Compound No. 43:

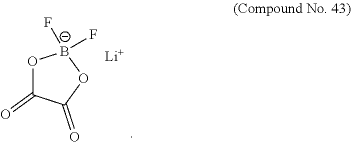

Clause 83. The lithium-ion battery electrolyte of any of clauses 78 to 82, wherein: the lithium-ion battery electrolyte does not comprise fluoroethylene carbonate (FEC).

Clause 84. The lithium-ion battery electrolyte of any of clauses 78 to 83, wherein: the electrolyte compound composition comprises a non-fluoroethylene carbonate (FEC) cyclic carbonate.

Clause 85. The lithium-ion battery electrolyte of clause 84, wherein: the non-FEC cyclic carbonate is ethylene carbonate (EC); and a concentration of the EC in the lithium-ion battery electrolyte is about 50 mol. % or lower.

Clause 86. The lithium-ion battery electrolyte of any of clauses 84 to 85, wherein: the non-FEC cyclic carbonate is vinylene carbonate (VC); and a concentration of the VC in the lithium-ion battery electrolyte is about 5 mol. % or lower.

Clause 87. The lithium-ion battery electrolyte of any of clauses 78 to 86, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 88. The lithium-ion battery electrolyte of any of clauses 78 to 87, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 89. A lithium-ion battery, comprising: an anode current collector; a cathode current collector; an anode disposed on or in the anode current collector; a cathode disposed on or in the cathode current collector; and the lithium-ion battery electrolyte of clause 78 ionically coupling the anode and the cathode, wherein: the anode comprises composite particles comprising silicon and carbon.

Clause 90. The lithium-ion battery of clause 89, wherein: the composite particles comprise porous carbon in which the silicon is deposited.

Clause 91. The lithium-ion battery of clause 90, wherein: at least some of the silicon is present in the porous carbon as Si nanoparticles.

Clause 92. The lithium-ion battery of any of clauses 89 to 91, wherein: a mass of the silicon is in a range of about 3 wt. % to about 80 wt. % of a total mass of the anode.

Clause 93. The lithium-ion battery of any of clauses 89 to 92, wherein: the anode comprises graphitic carbon particles substantially free of silicon.

Clause 94. A lithium-ion battery electrolyte, comprising: a lithium salt composition comprising LiPF₆; and an electrolyte compound composition comprising fluoroethylene carbonate (FEC) and one or more of the compounds of formula Est1:

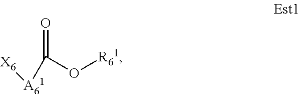

wherein: R₆¹ is C₁₋₆ alkyl; A₆¹ is of formula A₆(1):

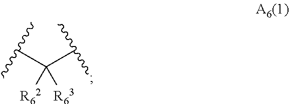

### X₆ is

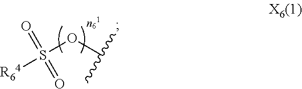

each of R₆² and R₆³ is F; R₆⁴ is F; n₆¹ is 0 or 1; a concentration of the FEC in the lithium-ion battery electrolyte is in a range of about 0.1 mol. % to about 40 mol. %; and a concentration of the FEC in the lithium-ion battery electrolyte is in a range of about 0.1 mol. % to about 40 mol. %; and a concentration of the one or more compounds in the lithium-ion battery electrolyte is in a range of about 0.1 mol. % to about 5 mol. %; and a concentration of the lithium salt composition in the lithium-ion battery electrolyte is in a range from about 1 mol. % to about 20 mol. %.

Clause 95. The lithium-ion battery electrolyte of clause 94, wherein: n₆¹ is 0; and the one or more compounds comprise methyl 2,2-difluoro-2-(fluorosulfonyl)acetate (MDFA) of formula Compound No. 22:

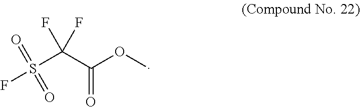

Clause 96. The lithium-ion battery electrolyte of any of clauses 94 to 95, wherein the lithium salt composition comprises lithium difluoro(bisoxalato) phosphate (LiDFOP) of formula Compound No. 53:

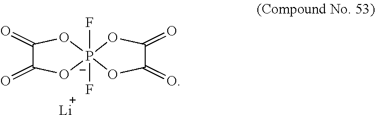 [SMILES: O=C1O[P-]2(F)(F)(OC1=O)OC(=O)C(=O)O2 ; [Li+]]

Clause 97. The lithium-ion battery electrolyte of any of clauses 94 to 96, wherein the lithium salt composition comprises lithium difluoro(oxalato)borate (LiDFOB) of formula Compound No. 43:

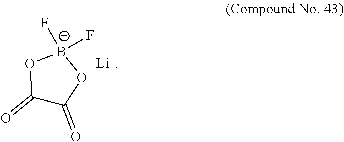

Clause 98. The lithium-ion battery electrolyte of any of clauses 94 to 97, wherein: the electrolyte compound composition comprises a non-FEC cyclic carbonate.

Clause 99. The lithium-ion battery electrolyte of clause 98, wherein: the non-FEC cyclic carbonate is ethylene carbonate (EC); and a concentration of the EC in the lithium-ion battery electrolyte is about 50 mol. % or lower.

Clause 100. The lithium-ion battery electrolyte of any of clauses 98 to 99, wherein: the non-FEC cyclic carbonate is vinylene carbonate (VC); and a concentration of the VC in the lithium-ion battery electrolyte is about 5 mol. % or lower.

Clause 101. The lithium-ion battery electrolyte of any of clauses 94 to 100, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 102. The lithium-ion battery electrolyte of any of clauses 94 to 101, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 103. A lithium-ion battery, comprising: an anode current collector; a cathode current collector; an anode disposed on or in the anode current collector; a cathode disposed on or in the cathode current collector; and the lithium-ion battery electrolyte of clause 94 ionically coupling the anode and the cathode, wherein: the anode comprises composite particles comprising silicon and carbon.

Clause 104. The lithium-ion battery of clause 103, wherein: the composite particles comprise porous carbon in which the silicon is deposited.

Clause 105. The lithium-ion battery of clause 104, wherein: at least some of the silicon is present in the porous carbon as Si nanoparticles.

Clause 106. The lithium-ion battery of any of clauses 103 to 105, wherein: a mass of the silicon is in a range of about 3 wt. % to about 80 wt. % of a total mass of the anode.

Clause 107. The lithium-ion battery of any of clauses 103 to 106, wherein: the anode comprises graphitic carbon particles substantially free of silicon.

Clause 108. A lithium-ion battery electrolyte, comprising: a lithium salt composition comprising LiPF₆; and an electrolyte compound composition comprising one or more compounds of formula Oth1:

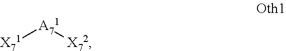

wherein: A₇¹ is C₁₋₆ alkanediyl; X₇¹ is carbonitrile; X₇² is of formula X₇(1):

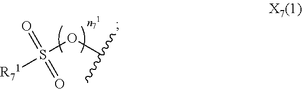

R₇¹ is F; n₇¹ is 0 or 1; a concentration of the one or more compounds in the lithium-ion battery electrolyte is in a range of about 0.1 mol. % to about 95 mol. %; and a concentration of the lithium salt composition in the lithium-ion battery electrolyte is in a range from about 1 mol. % to about 20 mol. %.

Clause 109. The lithium-ion battery electrolyte of clause 108, wherein: n₇¹ is 0; and the one or more compounds comprise cyanomethanesulfonyl fluoride (CMSF) of formula Compound No. 29:

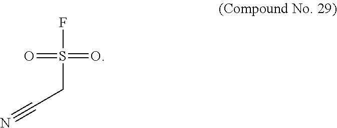

Clause 110. The lithium-ion battery electrolyte of clause 109, wherein: the lithium-ion battery electrolyte comprises fluoroethylene carbonate (FEC).

Clause 111. The lithium-ion battery electrolyte of any of clauses 108 to 110, wherein the lithium salt composition comprises lithium difluoro(bisoxalato) phosphate (LiDFOP) of formula Compound No. 53:

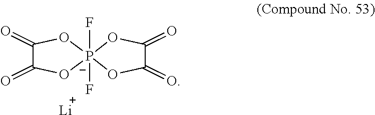 [SMILES: O=C1O[P-]2(F)(F)(OC1=O)OC(=O)C(=O)O2 ; [Li+]]

Clause 112. The lithium-ion battery electrolyte of any of clauses 108 to 111, wherein the lithium salt composition comprises lithium difluoro(oxalato)borate (LiDFOB) of formula Compound No. 43:

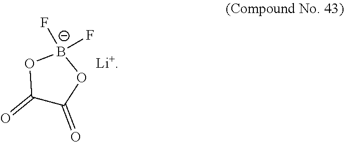

Clause 113. The lithium-ion battery electrolyte of any of clauses 108 to 112, wherein: the lithium-ion battery electrolyte does not comprise fluoroethylene carbonate (FEC).

Clause 114. The lithium-ion battery electrolyte of any of clauses 108 to 113, wherein: the electrolyte compound composition comprises a non-fluoroethylene carbonate (FEC) cyclic carbonate.

Clause 115. The lithium-ion battery electrolyte of clause 114, wherein: the non-FEC cyclic carbonate is ethylene carbonate (EC); and a concentration of the EC in the lithium-ion battery electrolyte is about 50 mol. % or lower.

Clause 116. The lithium-ion battery electrolyte of any of clauses 114 to 115, wherein: the non-FEC cyclic carbonate is vinylene carbonate (VC); and a concentration of the VC in the lithium-ion battery electrolyte is about 5 mol. % or lower.

Clause 117. The lithium-ion battery electrolyte of any of clauses 108 to 116, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 118. The lithium-ion battery electrolyte of any of clauses 108 to 117, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 119. A lithium-ion battery, comprising: an anode current collector; a cathode current collector; an anode disposed on or in the anode current collector; a cathode disposed on or in the cathode current collector; and the lithium-ion battery electrolyte of clause 108 ionically coupling the anode and the cathode, wherein: the anode comprises composite particles comprising silicon and carbon.

Clause 120. The lithium-ion battery of clause 119, wherein: the composite particles comprise porous carbon in which the silicon is deposited.

Clause 121. The lithium-ion battery of clause 120, wherein: at least some of the silicon is present in the porous carbon as Si nanoparticles.

Clause 122. The lithium-ion battery of any of clauses 119 to 121, wherein: a mass of the silicon is in a range of about 3 wt. % to about 80 wt. % of a total mass of the anode.

Clause 123. The lithium-ion battery of any of clauses 119 to 122, wherein: the anode comprises graphitic carbon particles substantially free of silicon.

Clause 124. A lithium-ion battery electrolyte, comprising: a lithium salt composition comprising LiPF₆; and an electrolyte compound composition comprising fluoroethylene carbonate (FEC) and one or more of the compounds of formula Oth1:

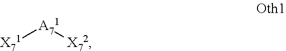

wherein: A₇¹ is C₂₋₆ alkenediyl; X₇¹ is H; X₇² is of formula X₇(1):

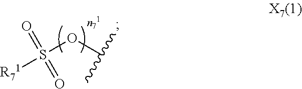

R₇¹ is F; n₇¹ is 0; a concentration of the FEC in the lithium-ion battery electrolyte is in a range of about 0.1 mol. % to about 40 mol. %; and a concentration of the one or more compounds in the lithium-ion battery electrolyte is in a range of about 5 mol. % to about 95 mol. %; and a concentration of the lithium salt composition in the lithium-ion battery electrolyte is in a range from about 1 mol. % to about 20 mol. %.

Clause 125. The lithium-ion battery electrolyte of clause 124, wherein: the one or more compounds comprise ethenesulfonyl fluoride (ESF) of formula Compound No. 31:

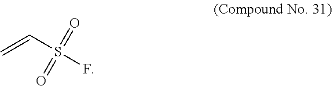

Clause 126. The lithium-ion battery electrolyte of any of clauses 124 to 125, wherein the lithium salt composition comprises lithium difluoro(bisoxalato) phosphate (LiDFOP) of formula Compound No. 53:

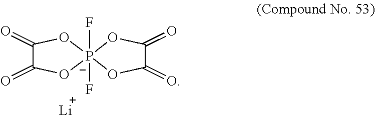 [SMILES: O=C1O[P-]2(F)(F)(OC1=O)OC(=O)C(=O)O2 ; [Li+]]

Clause 127. The lithium-ion battery electrolyte of any of clauses 124 to 126, wherein the lithium salt composition comprises lithium difluoro(oxalato)borate (LiDFOB) of formula Compound No. 43:

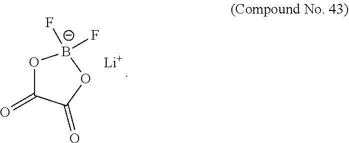

Clause 128. The lithium-ion battery electrolyte of any of clauses 124 to 127, wherein: the electrolyte compound composition comprises a non-FEC cyclic carbonate.

Clause 129. The lithium-ion battery electrolyte of clause 128, wherein: the non-FEC cyclic carbonate is ethylene carbonate (EC); and a concentration of the EC in the lithium-ion battery electrolyte is about 50 mol. % or lower.

Clause 130. The lithium-ion battery electrolyte of any of clauses 128 to 129, wherein: the non-FEC cyclic carbonate is vinylene carbonate (VC); and a concentration of the VC in the lithium-ion battery electrolyte is about 5 mol. % or lower.

Clause 131. The lithium-ion battery electrolyte of any of clauses 124 to 130, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 132. The lithium-ion battery electrolyte of any of clauses 124 to 131, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 133. A lithium-ion battery, comprising: an anode current collector; a cathode current collector; an anode disposed on and/or in the anode current collector; a cathode disposed on and/or in the cathode current collector; and the lithium-ion battery electrolyte of clause 124 ionically coupling the anode and the cathode, wherein: the anode comprises composite particles comprising silicon and carbon.

Clause 134. The lithium-ion battery of clause 133, wherein: the composite particles comprise porous carbon in which the silicon is deposited.

Clause 135. The lithium-ion battery of clause 134, wherein: at least some of the silicon is present in the porous carbon as Si nanoparticles.

Clause 136. The lithium-ion battery of any of clauses 133 to 135, wherein: a mass of the silicon is in a range of about 3 wt. % to about 80 wt. % of a total mass of the anode.

Clause 137. The lithium-ion battery of any of clauses 133 to 136, wherein: the anode comprises graphitic carbon particles substantially free of silicon.

Clause 138. A lithium-ion battery electrolyte, comprising: a lithium salt composition comprising LiPF₆; and an electrolyte compound composition comprising fluoroethylene carbonate (FEC) and one or more of the compounds of formula Oth1:

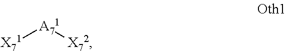

wherein: A₇¹ is —O—; X₇¹ is of formula X₇(4):

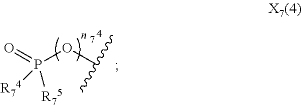

X₇² is C₁₋₆ alkyl; each of R₇⁴ and R₇⁵ is, independently, C₁₋₆ alkoxy; n₇⁴ is 0; a concentration of the FEC in the lithium-ion battery electrolyte is in a range of about 0.1 mol. % to about 40 mol. %; a concentration of the one or more compounds in the lithium-ion battery electrolyte is in a range of about 0.1 mol. % to about 5 mol. %; and a concentration of the lithium salt composition in the lithium-ion battery electrolyte is in a range from about 1 mol. % to about 20 mol. %.

Clause 139. The lithium-ion battery electrolyte of clause 138, wherein: the one or more compounds comprise triisopropyl phosphate (TIP) of formula Compound No. 36:

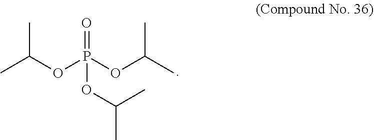

Clause 140. The lithium-ion battery electrolyte of any of clauses 138 to 139, wherein the lithium salt composition comprises lithium difluoro(bisoxalato) phosphate (LiDFOP) of formula Compound No. 53:

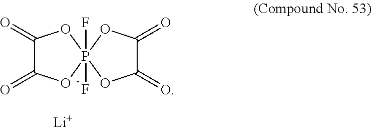

Clause 141. The lithium-ion battery electrolyte of any of clauses 138 to 140, wherein the lithium salt composition comprises lithium difluoro(oxalato)borate (LiDFOB) of formula Compound No. 43:

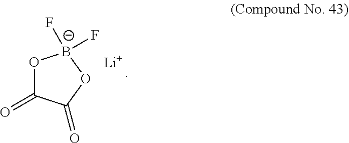

Clause 142. The lithium-ion battery electrolyte of any of clauses 138 to 141, wherein: the electrolyte compound composition comprises a non-FEC cyclic carbonate.

Clause 143. The lithium-ion battery electrolyte of clause 142, wherein: the non-FEC cyclic carbonate is ethylene carbonate (EC); and a concentration of the EC in the lithium-ion battery electrolyte is about 50 mol. % or lower.

Clause 144. The lithium-ion battery electrolyte of any of clauses 142 to 143, wherein: the non-FEC cyclic carbonate is vinylene carbonate (VC); and a concentration of the VC in the lithium-ion battery electrolyte is about 5 mol. % or lower.

Clause 145. The lithium-ion battery electrolyte of any of clauses 138 to 144, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 146. The lithium-ion battery electrolyte of any of clauses 138 to 145, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 147. A lithium-ion battery, comprising: an anode current collector; a cathode current collector; an anode disposed on or in the anode current collector; a cathode disposed on or in the cathode current collector; and the lithium-ion battery electrolyte of clause 138 ionically coupling the anode and the cathode, wherein: the anode comprises composite particles comprising silicon and carbon.

Clause 148. The lithium-ion battery of clause 147, wherein: the composite particles comprise porous carbon in which the silicon is deposited.

Clause 149. The lithium-ion battery of clause 148, wherein: at least some of the silicon is present in the porous carbon as Si nanoparticles.

Clause 150. The lithium-ion battery of any of clauses 147 to 149, wherein: a mass of the silicon is in a range of about 3 wt. % to about 80 wt. % of a total mass of the anode.

Clause 151. The lithium-ion battery of any of clauses 147 to 150, wherein: the anode comprises graphitic carbon particles substantially free of silicon.

Clause 152. A lithium-ion battery electrolyte, comprising: a lithium salt composition comprising LiPF₆; and an electrolyte compound composition comprising fluoroethylene carbonate (FEC) and one or more compounds of formula Oth1:

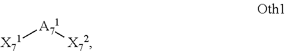

wherein: A₇¹ is —O—; X₇¹ is of formula X₇(2):

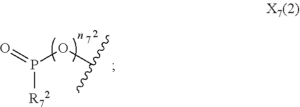

X₇² is C₁₋₆ alkyl; R₇² is C₁₋₆ alkoxy; n₇² is 0; a concentration of the FEC in the lithium-ion battery electrolyte is in a range of about 0.1 mol. % to about 40 mol. %; a concentration of the one or more compounds in the lithium-ion battery electrolyte is in a range of about 5 mol. % to about 95 mol. %; and a concentration of the lithium salt composition in the lithium-ion battery electrolyte is in a range from about 1 mol. % to about 20 mol. %.

Clause 153. The lithium-ion battery electrolyte of clause 152, wherein: the one or more compounds comprise dimethyl sulfite (DMS) of formula Compound No. 37:

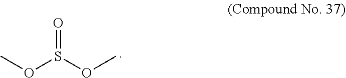

Clause 154. The lithium-ion battery electrolyte of any of clauses 152 to 153, wherein the lithium salt composition comprises lithium difluoro(bisoxalato) phosphate (LiDFOP) of formula Compound No. 53:

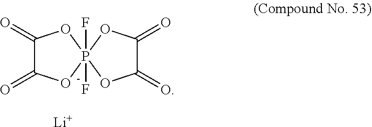

Clause 155. The lithium-ion battery electrolyte of any of clauses 152 to 154, wherein the lithium salt composition comprises lithium difluoro(oxalato)borate (LiDFOB) of formula Compound No. 43:

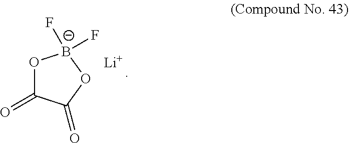

Clause 156. The lithium-ion battery electrolyte of any of clauses 152 to 155, wherein: the electrolyte compound composition comprises a non-FEC cyclic carbonate.

Clause 157. The lithium-ion battery electrolyte of clause 156, wherein: the non-FEC cyclic carbonate is ethylene carbonate (EC); and a concentration of the EC in the lithium-ion battery electrolyte is about 50 mol. % or lower.

Clause 158. The lithium-ion battery electrolyte of any of clauses 156 to 157, wherein: the non-FEC cyclic carbonate is vinylene carbonate (VC); and a concentration of the VC in the lithium-ion battery electrolyte is about 5 mol. % or lower.

Clause 159. The lithium-ion battery electrolyte of any of clauses 152 to 158, wherein: the electrolyte compound composition comprises one or more of ethyl propionate, ethyl isobutyrate, ethyl acetate, propyl propionate, dimethyl carbonate, ethyl methyl carbonate, and diethyl carbonate.

Clause 160. The lithium-ion battery electrolyte of any of clauses 152 to 159, wherein: the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

Clause 161. A lithium-ion battery, comprising: an anode current collector; a cathode current collector; an anode disposed on and/or in the anode current collector; a cathode disposed on and/or in the cathode current collector; and the lithium-ion battery electrolyte of clause 152 ionically coupling the anode and the cathode, wherein: the anode comprises composite particles comprising silicon and carbon.

Clause 162. The lithium-ion battery of clause 161, wherein: the composite particles comprise porous carbon in which the silicon is deposited.

Clause 163. The lithium-ion battery of clause 162, wherein: at least some of the silicon is present in the porous carbon as Si nanoparticles.

Clause 164. The lithium-ion battery of any of clauses 161 to 163, wherein: a mass of the silicon is in a range of about 3 wt. % to about 80 wt. % of a total mass of the anode.

Clause 165. The lithium-ion battery of any of clauses 161 to 164, wherein: the anode comprises graphitic carbon particles substantially free of silicon.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A lithium-ion battery electrolyte, comprising:
an electrolyte compound composition; and
a lithium salt composition comprising one or more of compounds of formula Salt2:
LiPF₍₆₋₂ₙ₎(A₁₀²)ₙ Salt2,
wherein:
n is 2;
A₁₀² is of formula A₁₀(1): 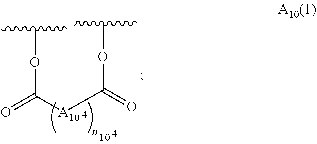
A₁₀⁴ is of formula A₁₀(2): 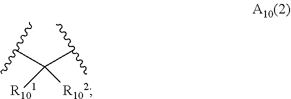
each of R₁₀¹ and R₁₀² is H; and
n₁₀⁴ is 0; and
a concentration of the one or more compounds in the lithium-ion battery electrolyte is in a range of about 0.1 mol. % to about 20 mol. %.

2. The lithium-ion battery electrolyte of claim 1, wherein:
the one or more compounds comprise lithium difluoro(bisoxalato) phosphate (LiDFOP) with formula Compound No. 53:

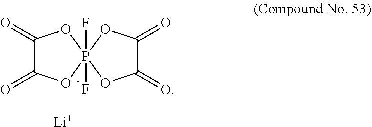

3. The lithium-ion battery electrolyte of claim 2, wherein:
the lithium-ion battery electrolyte comprises fluoroethylene carbonate (FEC).

4. The lithium-ion battery electrolyte of claim 1, wherein the lithium salt composition comprises lithium difluoro(oxalato)borate (LiDFOB) of formula Compound No. 43:

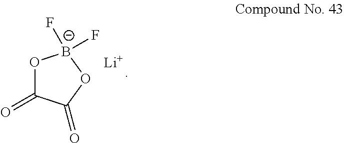

5. The lithium-ion battery electrolyte of claim 1, wherein the lithium salt composition comprises LiPF₆.

6. The lithium-ion battery electrolyte of claim 1, wherein a concentration of the lithium salt composition in the lithium-ion battery electrolyte is in a range from about 1 mol. % to about 20 mol. %.

7. The lithium-ion battery electrolyte of claim 1, wherein:
the lithium-ion battery electrolyte does not comprise fluoroethylene carbonate (FEC).

8. The lithium-ion battery electrolyte of claim 1, wherein:
the electrolyte compound composition comprises a non-fluoroethylene carbonate (FEC) cyclic carbonate.

9. The lithium-ion battery electrolyte of claim 8, wherein:
the non-FEC cyclic carbonate is ethylene carbonate (EC); and
a concentration of the EC in the lithium-ion battery electrolyte is about 50 mol. % or lower.

10. The lithium-ion battery electrolyte of claim 8, wherein:
the non-FEC cyclic carbonate is vinylene carbonate (VC), and
a concentration of the VC in the lithium-ion battery electrolyte is about 5 mol. % or lower.

11. The lithium-ion battery electrolyte of claim 1, wherein:
the electrolyte compound composition comprises one or more of ethyl propionate, ethyl isobutyrate, ethyl acetate, propyl propionate, dimethyl carbonate, ethyl methyl carbonate, and diethyl carbonate.

12. The lithium-ion battery electrolyte of claim 1, wherein:
the electrolyte compound composition comprises one or more additive compounds selected from adiponitrile (ADN), 3-(2-cyanoethoxy) propanenitrile, 1,5-dicyanopentane, 1-(cyanomethyl)cyclopropane-1-carbonitrile, 4,4-dimethylheptanedinitrile, trans-1,4-dicyano-2-butene, 1,3,6-hexanetricarbonitrile (HTCN), 3-{[1,3-bis(2-cyanoethoxy)propan-2-yl]oxy} propanenitrile, ethylene glycol bis(propionitrile) ether (EGBE), 3-(triethoxysilyl) propionitrile, succinonitrile (SN), triisopropyl borate (TIB), 1-propene 1,3-sultone (PES), 1,3-propane sultone (PS), phenyl disulfide, sulfolane, N,N,N,N-tetraethyl sulfamide, succinic anhydride (SA), citraconic anhydride (CA), tris(trimethylsilyl)phosphite (TMSPI), tris(trimethylsilyl)phosphate, dimethoxydiphenylsilane, tris(trimethylsilyl) borate (TMSB), 3-(triethoxysilyl)propyl isocyanate, lithium difluorophosphate (LFO), lithium tetrafluoroborate (LiBF₄), lithium bis(fluorosulfonyl)imide (LiFSI), lithium bis(trifluoromethanesulfonyl)imide (LiTFSI), lithium fluorosulfate (LiSO₃F), and lithium bis(oxalato)borate (LiBOB), a total concentration of the one or more additive compounds in the lithium-ion battery electrolyte being about 10 mol. % or lower.

13. A lithium-ion battery, comprising:
an anode current collector;
a cathode current collector;
an anode disposed on or in the anode current collector;
a cathode disposed on or in the cathode current collector; and
the lithium-ion battery electrolyte of claim 1 ionically coupling the anode and the cathode,
wherein:
the anode comprises composite particles comprising silicon and carbon.

14. The lithium-ion battery of claim 13, wherein:
the composite particles comprise porous carbon in which the silicon is deposited.

15. The lithium-ion battery of claim 14, wherein:
at least some of the silicon is present in the porous carbon as Si nanoparticles.

16. The lithium-ion battery of claim 13, wherein:
a mass of the silicon is in a range of about 3 wt. % to about 80 wt. % of a total mass of the anode.

17. The lithium-ion battery of claim 13, wherein:
the anode comprises graphitic carbon particles substantially free of silicon.

18.-165. (canceled)
